(19) United States
(12) Patent Application Publication
(10) Pub. No.: US 2009/0271154 A1
(43) Pub. Date: Oct. 29, 2009

(54) Method and Apparatus for Facilitating HVAC Design for a Building

(75) Inventors: William J. Coad, St. Louis, MO (US); David A. Pollack, Maplewood, MO (US); Albert W. Black, St. Louis, MO (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Coad Engineering Enterprises, Inc., St. Louis, MO (US)

(21) Appl. No.: 12/110,347

(22) Filed: Apr. 28, 2008

(51) Int. Cl. G06F 17/50

(52) U.S. Cl. 703/1

(57) ABSTRACT

A system which facilitates HVAC design for buildings or portions thereof is disclosed. The system comprises a server and one or more remotely situated terminals. The server, which can be a secure server, comprises software that facilitates calculation of HVAC design. A user can access one or more calculation modules in a session of use of a project. The user can provide alphanumeric information items in one or more data input fields. A calculation module can determine a variety of HVAC design output information items using the data added by the user. Both input and output information items can be securely recorded by the server in a record of a session for a project. Furthermore, multiple users can collaborate by accessing the system and contributing to the record of a project in separate sessions. A record of a session or project can be provided in a printable text file.

HVAC building design can involve a large number of engineering considerations. Decisions made by an HVAC engineer can have profound effects on the utility, comfort, and energy efficiency of a building. However, calculations for determination of appropriate values for various parameters regarding HVAC building design can be difficult, tedious, and/or unknown to builders. As a result, buildings can often be built or remodeled without thorough consideration of HVAC requirements. As a result, a building can be, for example, wasteful of energy and/or uncomfortable to live or work in, and remediation can be difficult or expensive.

Currently available aids for calculating values for HVAC requirements involve “stand-alone” software, such as “Green Toolbox 5.0” (Carmel Software, San Rafael, Calif.); “CHVAC” (Elite Software Development, Inc., College Station, Tex.); HVAC Design Solutions (San Diego, Calif.); Trace™ 700 Load Design software (Trane®, Piscataway, N.J.). However, these software packages are not comprised by a server or accessed over the Internet, do not provide a filing system for HVAC calculations and projects or for development of a user-initiated collaboration on HVAC calculations and projects over the Internet, using the World Wide Web.

### SUMMARY

In view of a need for more efficient methods for HVAC design, the inventors have developed systems and methods for facilitating determination of HVAC (Heating, Cooling and Air Conditioning) design features for a building. In some aspects of the present teachings, a system comprises at least one terminal, and a server configured to a) provide a web-based user interface comprising a plurality of web pages, wherein one or more web pages are configured to receive as input information one or more descriptors, each descriptor selected from a descriptor of a building, a descriptor of a portion of a building and a descriptor of a building environment; b) receive, from at least one user via at least one terminal operably connected to the server, at least one selection of a program comprising at least one web page configured to receive one or more input information items and at least one calculation module; and c) receive one or more input information items from the at least one user via the at least one terminal. In some configurations of these aspects, a system can be further configured to d) determine at least one HVAC building design specification using at least one HVAC building design executable program and at least one input information item of the one or more input information items. Furthermore, in some configurations, a system can be further configured to e) provide at least one HVAC building design specification as at least one output information item.

In some aspects of the present teachings, a web service is described for providing one or more HVAC design features for a building to one or more users. A web service of these aspects can include a server which comprises software for determining HVAC building specifications as described herein and which can be accessed by one or more users using the World Wide Web. A web service of these aspects can further include an IT staff that can maintain, repair and/or update all server hardware and/or software. In addition, in some configurations, a web service can provide a user access to an SSL secure server, which can be, for example, a RAID 1 SSL secure server. In some configurations, a web service can also provide at least one mirrored hard drive, which can be physically situated at a site remote from the server. In some configurations, a web service of the present teachings can reduce administrative overhead for a user or subscriber of a system.

In some aspects of the present teachings, methods are disclosed for providing one or more HVAC design features for a building to one or more users. In various configurations, these methods comprise: a) providing a web-based user interface comprising a plurality of web pages, wherein one or more web pages are configured to receive as input information one or more descriptors, each descriptor selected from a descriptor of a building, a descriptor of a portion of a building and a descriptor of a building environment; b) receiving, from at least one user accessing the web-based user interface at a terminal located remote from a server comprising software encoding the web-based user interface, at least one selection of a program comprising at least one web page configured to receive one or more input information items and at least one calculation module; c) receiving one or more input information items from the at least one user; d) determining at least one HVAC building design specification using at least one HVAC building design executable program and at least one input information item of the one or more input information items, and e) providing at least one HVAC building design specification as at least one output information item.

In some aspects of the present teachings, methods are disclosed for designing heating, ventilation and/or air conditioning for a building or a portion thereof. In various configurations, these methods comprise: accessing from a terminal a web-based user interface comprised by a server, wherein the user interface comprises a plurality of web pages configured to receive data for at least one selection of an HVAC design calculation module of a plurality of HVAC design calculation modules; submitting to the web-based user interface at least one selection of a plurality of selections of HVAC design calculation modules; submitting input data for a building design or a portion thereof; and receiving from the web-based user interface one or more calculated HVAC building parameters.

In various configurations of these aspects, at least one terminal can be operably connected to a server via the Internet. In addition, the server can be a secure server, such as a dedicated secure server.

In some other configurations, at least one web page can comprise a web-based user interface, which can be an interactive user interface. In addition, in certain configurations, a server can validate the one or more input information items, and/or check for errors in the one or more input information items. In some configurations, at least one web page can comprise one or more data input fields, and can further require entry of at least one password and/or require entry of at least one user identification for user access to a program or calculation module. Furthermore, a server can be configured to require and/or allow user access to a program or a calculation module on a subscription basis.

In some configurations, a web page of the present teachings can comprise a navigation bar (the “Navbar”) which can appear at the top of a screen for a user using a computer as a terminal. A Navbar can comprise links, such as Main, Contact, Projects, Misc, and Logout, and can provide an “escape route” from a screen for a user, without saving anything entered or edited on the screen exited.

In some configurations, a web page of the present teachings can comprise a link to miscellaneous calculations. By selecting a miscellaneous calculation link (e.g., by mouse click), a user can leave a web page wherein a calculation is not complete, and explore further calculations which are not incorporated in the record of the session. Similarly, a web page of the present teachings can also comprise a link to the Main Entry Screen. Such a link facilitates a user returning to the main entry page.

In some configurations, a server can record a session of use of a building HVAC design project. In these configurations, after a user enters a user identification and a password, the server can record the web pages accessed, the data entries (such as, for example, alphanumeric data added to data input fields and/or selection of radio buttons) and/or the output information generated in a session. In some configurations, the server can generate and/or store a record of a session, comprising the web pages accessed, the data entries, and/or the output information generated. In addition, a record of a session can further comprise one or more of a user's identification, a title of a project, time of a session, and date of a session. In some configurations, a server can record a session in a manner in which the user, accessing the server from a terminal remote from the server, is prevented from erasing or altering the record of the session, either during the session, or subsequently. Furthermore, in some configurations a server can create a record of a project, which can comprise each record of the sessions recorded for the project. Accordingly, in a multi-user, collaborative project, a record of the project can include all the records of sessions recorded by each user.

In some configurations, one or more web pages can comprise one or more data input fields configured to receive at least one input information item for at least one calculation not comprised by the project. A server in these configurations can thus be configured not to record the data entries or output information in the record of a session.

In various configurations of the present teachings, a web-based user interface can be a graphical user interface, and a web page can comprise one or more data input fields, and/or output information on at least one terminal. Input information items can be displayed in the input data field(s). In addition, in some configurations, the server can generate a printable report comprising input information and/or output information comprised by a session. A printable report can comprise, in non-limiting example, information recorded and/or displayed using ASCII code. In some configurations, a printable report can be saved in electronic form by a user on the user's terminal, which can be situated remote from the server.

In various configurations, a calculation module of the present teachings can be any of a number of different calculation modules, such as, without limitation, a heating and cooling load calculation module, a psychrometric processes calculation module, a psychrometric properties calculation module, a psychrometric mixing process calculation module, a psychrometric cooling and dehumidifying process calculation module, a psychrometric sensible heating or cooling process calculation module, a psychrometric isothermal humidification process calculation module, a psychrometric evaporative cooling process calculation module, a psychrometric differences between two state points calculation module, a heating and cooling coil selection calculation module, a heating and cooling coil diagnostics calculation module, a cooling/dehumidifying coil selection calculation module, a cooling/dehumidifying coil diagnostics calculation module, a heating coil diagnostics calculation module, a heating coil selection calculation module, a steam properties calculation module, a hydronic pipe sizing calculation module, a steam expansion (Power) process calculation module, a steam processes calculation module, a fuel heat required to generate steam calculation module, a steam control valve sizing calculation module, a steam orifice size/capacity calculation module, a steam differences between two state points calculation module, and an expansion tank calculation module. When the module is a psychrometric process module, it can be, without limitation, a psychrometric mixing process calculation module, a psychrometric cooling and dehumidifying process calculation module, a psychrometric sensible heating or cooling process calculation module, a psychrometric isothermal humidification process calculation module, a psychrometric evaporative cooling process calculation module, and a psychrometric differences between two state points calculation module.

In some configurations, a calculation module can comprise a web page for steam processes, which can include, without limitation, one or more of expansion (power) process, fuel heat required to generate steam, control valve sizing, steam orifice size/capacity, and differences between two state points.

In some configurations, a calculation module can comprise an input/output summary, which can be comprised by a flat text file. A flat text file can, for example, be configured to be printable or printed as a WYSIWYG document by a user, who can be situated at a terminal located remote from the server.

In some configurations, a calculation module can retain the input information items even after a user ends a session prior to completion of data entry into the calculation module. In some configurations, a calculation module which retains input information when a user ends a session prior to completing data entry can be, for example, heating and cooling load calculation module.

In some configurations, a server of the present teachings can be used for determining HVAC specifications in collaborative projects. In these configurations, multiple users, such as, for example, multiple HVAC building engineers collaborating on a project, can each access the web pages for the project under his or her own personal identification and password. Any data or information item that is added or modified by a user can be recorded by the server, and attributed to the user who entered the changes. Collaborative users can be, for example, a plurality of users employed by a business entity such as an engineering firm. Hence, in some configurations, one user can continue a project of a different user.

In some configurations, a web page of the present teachings can also include educational guidance, such as educational guidance for HVAC design.

In some configurations, a calculation module can be configured to receive one or more psychrometric properties as input information items. In various configurations, an input information item can be, without limitation, a barometric pressure information item, or a properties information items such as, without limitation, a wet bulb temperature information item, a dew point temperature information item, a humidity ratio in grains/lb information item, a humidity ratio information item, a relative humidity information item, an enthalpy information item, and a specific volume information item.

In some calculation modules, a server can provide, as output information items, one or more properties information items not provided by a user. In addition, in some calculation modules, a web page can comprise at least one button configured to receive a calculation selection and/or a button configured to receive units selection from a user.

In some configurations, a web page can comprise a menu configured to receive a request from a user to initiate a new load calculation, continue a previously initiated load calculation, review a previously initiated load calculation, provide master load data, provide a printable input summary, and/or calculate loads. In various configurations, a load calculation can be selected from design conditions, thermal characteristics of building elements, and/or zones and spaces.

In various configurations, a server can comprise one or more calculation modules, such as, without limitation, an initiating load calculation module, a design conditions calculation module, a thermal characteristics of building input elements calculation module, a mixing process calculation module, a cooling and dehumidifying process calculation module, a sensible heating or cooling process calculation module, an isothermal humidification process calculation module, an evaporative cooling process calculation module, a differences between two state points calculation module, a heating and cooling coil selection calculation module, an expansion tank sizing calculation module, a heating and cooling coil diagnostics calculation module, a steam properties calculation module, a hydronic pipe sizing calculation module, a steam expansion processes calculation module, a fuel heat required to generate steam calculation module, a control valve sizing calculation module, or a steam orifice size/capacity calculation module.

In some configurations, a web page can comprise a master load data input field or can be configured to receive as an input information item, a new zone designation, and/or information items concerning individual space input. A web page of these configurations can also be configured to receive input information items concerning individual space input, such as exposed walls information items, exposed roofs information items, doors exposed to outside conditions information items, floors exposed to outside conditions information items, floors—winter loss from slab perimeter information items, floor over unconditioned spaces information items, and partitions adjoining unconditioned spaces information items.

In some configurations, a web page can be configured to display an input summary, an output summary, or an input/output summary such as, without limitation, a heating and cooling load calculation summary. A summary of these configurations can be a printable summary. In some configurations, a summary can be viewed by a user operating a terminal, printed by a user operating a terminal, or saved by a user.

The present application includes the following aspects.

Aspect 1. A method of providing one or more HVAC design features for a building to one or more users, the method comprising:

a) providing a web-based user interface comprising a plurality of web pages, wherein one or more web pages are configured to receive as input information one or more descriptors, each descriptor selected from a descriptor of a building, a descriptor of a portion of a building and a descriptor of a building environment;

b) receiving, from at least one user accessing the web-based user interface at a terminal located remote from a server comprising software encoding the web-based user interface, at least one selection of a program comprising at least one web page configured to receive one or more input information items and at least one calculation module;

c) receiving one or more input information items from the at least one user;

d) determining at least one HVAC building design specification using at least one HVAC building design executable program and at least one input information item of the one or more input information items, and

e) providing at least one HVAC building design specification as at least one output information item.

Aspect 2. A method in accordance with aspect 1, wherein the server is a secure server.

Aspect 3. A method in accordance with aspect 1, wherein the at least one user accesses the web site over the Internet.

Aspect 4. A method in accordance with aspect 2, wherein at least one web page comprises an interactive user interface.

Aspect 5. A method in accordance with aspect 1, wherein the server performs input validation on the one or more input information items.

Aspect 6. A method in accordance with aspect 1, wherein the server performs error checking on the one or more input information items.

Aspect 7. A method in accordance with aspect 1, wherein at least one web page comprises one or more data input entry fields.

Aspect 8. A method in accordance with aspect 1, wherein access to the one or more web pages configured to receive the one or more descriptors requires entry of at least one password.

Aspect 9. A method in accordance with aspect 8, wherein a user initiates a session of use of a building HVAC design project upon accessing the web-based user interface and entering a user identification and at least one password.

Aspect 10. A method in accordance with aspect 8, wherein the user interface is accessed by the at least one user on a subscription basis.

Aspect 11. A method in accordance with aspect 9, further comprising generating or adding to a record of the project.

Aspect 12. A method in accordance with aspect 11, wherein the generating or adding to a record of the project comprises recording at each session, one or more of: the at least one user's identification, a title of the project, date of the session, the at least one selection of a web page, at least one input information item, and at least one output information item.

Aspect 13. A method in accordance with aspect 12, wherein after the determining of the at least one HVAC building design specification, at least one of a) the date of the session, b) the at least one input information item and c) the at least one output information item, cannot be erased or altered during a subsequent session of use by a user accessing the web-based user interface at a terminal located remote from the server.

Aspect 14. A method in accordance with aspect 13, wherein one or more web pages of the plurality of web pages comprises one or more data input fields configured to receive at least one input information item for at least one calculation not comprised by the project.

Aspect 15. A method in accordance with aspect 1, wherein one or more web pages of the plurality of web pages comprises one or more data input fields.

Aspect 16. A method in accordance with aspect 1, wherein the web-based user interface is a graphical user interface.

Aspect 17. A method in accordance with aspect 1, wherein the output information is displayed at the terminal.

Aspect 18. A method in accordance with aspect 15, wherein the one or more input information items are displayed on the one or more data input fields.

Aspect 19. A method in accordance with aspect 1, wherein the providing the at least one output information item comprises displaying the at least one output information item on a web page of the plurality of web pages.

Aspect 20. A method in accordance with aspect 1, wherein the providing the at least one output information item comprises providing a printable report.

Aspect 21. A method in accordance with aspect 20, wherein the printable report is configured to be saved by the at least one user.

Aspect 22. A method in accordance with aspect 1, wherein a calculation module is selected from the group consisting of a heating and cooling load calculation module, a psychrometric mixing process calculation module, a psychrometric cooling and dehumidifying process calculation module, a psychrometric sensible heating or cooling process calculation module, a psychrometric isothermal humidification process calculation module, a psychrometric evaporative cooling process calculation module, a psychrometric differences between two state points calculation module, a heating and cooling coil selection calculation module, a heating and cooling coil diagnostics calculation module, a steam properties calculation module, a hydronic pipe sizing calculation module, a steam expansion (Power) process calculation module, a fuel heat required to generate steam calculation module, a steam control valve sizing calculation module, a steam orifice size/capacity calculation modules, a steam differences between two state points calculation module and an expansion tank calculation module.

Aspect 23. A method in accordance with aspect 22, wherein the plurality of web pages further comprise a web page comprising at least one data entry field linking to calculation modules of psychrometric processes, wherein the psychrometric processes include one or more of mixing process, cooling and dehumidifying process, sensible heating or cooling process, isothermal humidification process, evaporative cooling process, and differences between two state points.

Aspect 24. A method in accordance with aspect 22, wherein the plurality of web pages further comprise a web page comprising a menu linking to calculation modules for steam processes, wherein the steam processes include one or more of expansion (power) process, fuel heat required to generate steam, control valve sizing, steam orifice size/capacity, and differences between two state points.

Aspect 25. A method in accordance with aspect 1, wherein a calculation module generates an input/output summary.

Aspect 26. A method in accordance with aspect 21, wherein the input/output summary is a flat text file.

Aspect 27. A method in accordance with aspect 26, wherein the flat text file is configured to be printed as a WYSIWYG document by the at least one user at a terminal located remote from the server.

Aspect 28. A method in accordance with aspect 11, wherein a calculation module retains the input information items prior to or after completion of data entry into the module by the at least one user.

Aspect 29. A method in accordance with aspect 22, wherein the module is the heating and cooling load calculation module.

Aspect 30. A method in accordance with aspect 1, wherein the at least one user comprises a plurality of collaborative users.

Aspect 31. A method in accordance with aspect 30, wherein the plurality of collaborative users consists of persons employed by a business entity employing the at least one user.

Aspect 32. A method in accordance with aspect 1, wherein at least one web page comprises educational guidance for HVAC design.

Aspect 33. A system for facilitating determination of one or more HVAC design features for a building, the system comprising:

a server configured to a) provide a web-based user interface comprising a plurality of web pages, wherein one or more web pages are configured to receive as input information one or more descriptors, each descriptor selected from a descriptor of a building, a descriptor of a portion of a building and a descriptor of a building environment; b) receive, from at least one user via at least one terminal operably connected to the server, at least one selection of a program comprising at least one web page configured to receive one or more input information items and at least one calculation module; and c) receive one or more input information items from the at least one user via the at least one terminal; and the at least one terminal.

Aspect 34. A system for facilitating determination of one or more HVAC design features for a building in accordance with aspect 33, wherein the server is further configured to d) determine at least one HVAC building design specification using at least one HVAC building design executable program and at least one input information item of the one or more input information items.

Aspect 35. A system for facilitating determination of one or more HVAC design features for a building in accordance with aspect 34, wherein the server is further configured to e) provide at least one HVAC building design specification as at least one output information item.

Aspect 36. A system for facilitating determination of one or more HVAC design features for a building in accordance with aspect 33, wherein the least one terminal is communicatively connected to the server via the Internet.

Aspect 37. A system for facilitating determination of one or more HVAC design features for a building in accordance with aspect 33, wherein the server is a secure server.

Aspect 38. A system for facilitating determination of one or more HVAC design features for a building in accordance with aspect 37, wherein the secure server is a dedicated secure server.

Aspect 39. A system for facilitating determination of one or more HVAC design features for a building in accordance with aspect 33, wherein the server is further configured to require entry of at least one password for user access to the at least one selection of a program.

Aspect 40. A system for facilitating determination of one or more HVAC design features for a building in accordance with aspect 39, wherein the server is further configured to require entry of at least one user identification for user access to the at least one selection of a program.

Aspect 41. A system for facilitating determination of one or more HVAC design features for a building in accordance with aspect 33, wherein the server is further configured to allow user access to the at least one selection of a program on a subscription basis.

Aspect 42. A system for facilitating determination of one or more HVAC design features for a building in accordance with aspect 39, wherein the server records a session of use of a building HVAC design project upon the at least one user entering a user identification and at least one password.

Aspect 43. A system for facilitating determination of one or more HVAC design features for a building in accordance with aspect 42, wherein the server stores the record.

Aspect 44. A system for facilitating determination of one or more HVAC design features for a building in accordance with aspect 42, wherein the record comprises one or more of: the at least one user's identification, a title of the project, date of the session, the at least one selection of at least one web page, at least one input information item, and at least one output information item.

Aspect 45. A system for facilitating determination of one or more HVAC design features for a building in accordance with aspect 42, wherein the record cannot be erased or altered during a subsequent session of use by the at least one user from the at least one terminal operably connected to the server.

Aspect 46. A system for facilitating determination of one or more HVAC design features for a building in accordance with aspect 42, wherein one or more web pages of the plurality of web pages comprises one or more data input fields configured to receive at least one input information item for at least one calculation not comprised by the project.

Aspect 47. A system for facilitating determination of one or more HVAC design features for a building in accordance with aspect 33, wherein at least one web page comprises a web-based interactive user interface.

Aspect 48. A system for facilitating determination of one or more HVAC design features for a building in accordance with aspect 33, wherein the server validates the one or more input information items.

Aspect 49. A system for facilitating determination of one or more HVAC design features for a building in accordance with aspect 33, wherein the server checks for errors on the one or more input information items.

Aspect 50. A system for facilitating determination of one or more HVAC design features for a building in accordance with aspect 33, wherein at least one web page comprises one or more data input entry fields.

Aspect 51. A system for facilitating determination of one or more HVAC design features for a building in accordance with aspect 33, wherein one or more web pages of the plurality of web pages comprises one or more data input fields.

Aspect 52. A system for facilitating determination of one or more HVAC design features for a building in accordance with aspect 33, wherein the web-based user interface is a graphical user interface.

Aspect 53. A system for facilitating determination of one or more HVAC design features for a building in accordance with aspect 33, wherein the at least one output information is displayed at the terminal.

Aspect 54. A system for facilitating determination of one or more HVAC design features for a building in accordance with aspect 52, wherein the one or more input information items are displayed on the one or more data input fields.

Aspect 55. A system for facilitating determination of one or more HVAC design features for a building in accordance with aspect 33, wherein the at least one output information is displayed on a web page of the plurality of web pages.

Aspect 56. A system for facilitating determination of one or more HVAC design features for a building in accordance with aspect 33, wherein the at least one output information is comprised by a printable report.

Aspect 57. A system for facilitating determination of one or more HVAC design features for a building in accordance with aspect 56, wherein the printable report is configured to be saved by the at least one user at a terminal located remote from the server.

Aspect 58. A system for facilitating determination of one or more HVAC design features for a building in accordance with aspect 33, wherein a calculation module is selected from the group consisting of a heating and cooling load calculation module, a psychrometric mixing process calculation module, a psychrometric cooling and dehumidifying process calculation module, a psychrometric sensible heating or cooling process calculation module, a psychrometric isothermal humidification process calculation module, a psychrometric evaporative cooling process calculation module, a psychrometric differences between two state points calculation module, a heating and cooling coil selection calculation module, a heating and cooling coil diagnostics calculation module, a steam properties calculation module, a hydronic pipe sizing calculation module, a steam expansion (Power) process calculation module, a fuel heat required to generate steam calculation module, a steam control valve sizing calculation module, a steam orifice size/capacity calculation modules, a steam differences between two state points calculation module and an expansion tank calculation module.

Aspect 59. A system for facilitating determination of one or more HVAC design features for a building in accordance with aspect 58, wherein the psychrometric processes include one or more of mixing process, cooling and dehumidifying process, sensible heating or cooling process, isothermal humidification process, evaporative cooling process, and differences between two state points.

Aspect 60. A system for facilitating determination of one or more HVAC design features for a building in accordance with aspect 59, wherein the plurality of web pages further comprise a web page comprising a menu linking to calculation modules for steam processes, wherein the steam processes include one or more of expansion (power) process, fuel heat required to generate steam, control valve sizing, steam orifice size/capacity, and differences between two state points.

Aspect 61. A system for facilitating determination of one or more HVAC design features for a building in accordance with aspect 33, wherein a calculation module comprises an input/output summary.

Aspect 62. A system for facilitating determination of one or more HVAC design features for a building in accordance with aspect 61, wherein the input/output summary is a flat text file.

Aspect 63. A system for facilitating determination of one or more HVAC design features for a building in accordance with aspect 61, wherein the flat text file is configured to be printed as a WYSIWYG document by the at least one user at a terminal located remote from the server.

Aspect 64. A system for facilitating determination of one or more HVAC design features for a building in accordance with aspect 59, wherein a calculation module retains the input information items upon the at least one user ending a session prior to completion of data entry into the module.

Aspect 65. A system for facilitating determination of one or more HVAC design features for a building in accordance with aspect 64, wherein the module is the heating and cooling load calculation module.

Aspect 66. A system for facilitating determination of one or more HVAC design features for a building in accordance with aspect 33, wherein the at least one user comprises a plurality of collaborative users.

Aspect 67. A system for facilitating determination of one or more HVAC design features for a building in accordance with aspect 66, wherein the plurality of collaborative users consists of persons employed by a business entity employing the at least one user.

Aspect 68. A system for facilitating determination of one or more HVAC design features for a building in accordance with aspect 33, wherein the at least one web page further comprises educational guidance for HVAC design.

Aspect 69. A system for facilitating determination of one or more HVAC design features for a building in accordance with aspect 33, wherein the calculation module is configured to receive one or more psychrometric properties input information items,

Aspect 70. A system for facilitating determination of one or more HVAC design features for a building in accordance with aspect 69, wherein the calculation module is configured to receive one or more input information items, wherein an input information item is selected from an elevation information item, a barometric pressure information item, and properties information items selected from a dry bulb temperature information item, a wet bulb temperature information item, a dew point temperature information item, a humidity ratio in grains/lb information item, a humidity ratio in lb/lb information item, a relative humidity information item, an enthalpy information item, and a specific volume information item.

Aspect 71. A system for facilitating determination of one or more HVAC design features for a building in accordance with aspect 70, wherein the calculation module is further configured to provide as output information items, the properties information items not provided by the at least one user.

Aspect 72. A system for facilitating determination of one or more HVAC design features for a building in accordance with aspect 70, wherein the at least one web page further comprises at least one button configured to receive a calculation selection from the at least one user.

Aspect 73. A system for facilitating determination of one or more HVAC design features for a building in accordance with aspect 70, wherein the web page is further configured to receive a units selection from the at least one user.

Aspect 74. A system for facilitating determination of one or more HVAC design features for a building in accordance with aspect 39, wherein at least one web page comprises a menu configured to receive a request from the at least one user to initiate a new load calculation, continue a previously initiated load calculation, review a previously initiated load calculation, provide master load data, provide a printable input summary, or calculate loads, wherein a load calculation is selected from the group consisting of design conditions, thermal characteristics of building elements, and zones and spaces.

Aspect 75. A method of designing heating, ventilation and/or air conditioning for a building or a portion thereof, the method comprising:

accessing from a terminal a web-based user interface comprised by a server, wherein the user interface comprises a plurality of web pages configured to receive data for at least one selection of an HVAC design calculation module of a plurality of HVAC design calculation modules;

submitting to the web-based user interface at least one selection of a plurality of selections of HVAC design calculation modules;

submitting input data for a building design or a portion thereof; and

receiving from the web-based user interface one or more calculated HVAC building parameters.

Aspect 76. A method in accordance with aspect 75, wherein the terminal is operatively connected to the server via the internet.

Aspect 77. A method in accordance with aspect 75, wherein the server is a secure server.

Aspect 78. A method in accordance with aspect 77, wherein the secure server is a dedicated secure server.

Aspect 79. A method in accordance with aspect 75, wherein at least one web page comprises a web-based interactive user interface.

Aspect 80. A method in accordance with aspect 75, wherein at least one web page comprises a user-accessible input menu.

Aspect 81. A method in accordance with aspect 75, wherein the server validates the one or more input information items.

Aspect 82. A method in accordance with aspect 75, wherein the server checks for errors on the one or more input information items.

Aspect 83. A method in accordance with aspect 75, wherein at least one web page comprises one or more data input entry fields.

Aspect 84. A method in accordance with aspect 75, wherein the accessing from a terminal a web-based user interface comprises providing at least one password.

Aspect 85. A method in accordance with aspect 84, wherein the accessing from a terminal a web-based user interface further comprises providing at least one user identification.

Aspect 86. A method in accordance with aspect 75, wherein the server is configured to allow user access to the at least one selection of a program on a subscription basis.

Aspect 87. A method in accordance with aspect 84, further comprising initiating a session of use of a building HVAC design project.

Aspect 88. A method in accordance with aspect 87, wherein the server records data entered during the session of use.

Aspect 89. A method in accordance with aspect 87, wherein the server generates or adds to a record of a project, data entered during the session of use.

Aspect 90. A method in accordance with aspect 89, wherein the server records, in the record at each session, one or more of: the at least one user's identification, a title of the project, date of the session, the at least one selection of a web page, at least one input information item, and at least one output information item.

Aspect 91. A method in accordance with aspect 75, wherein one or more web pages of the plurality of web pages comprises one or more data input fields

Aspect 92. A method in accordance with aspect 75, wherein the output information is displayed by the terminal.

Aspect 93. A method in accordance with aspect 92, wherein the one or more input information items are displayed on the one or more data input fields.

Aspect 94. A method in accordance with aspect 75, wherein the at least one output information item is displayed on a web page of the plurality of web pages.

Aspect 95. A method in accordance with aspect 75, wherein the providing the at least one output information item comprises providing a printable report.

Aspect 96. A method in accordance with aspect 75, wherein the at least one user comprises a plurality of collaborative users.

Aspect 97. A method in accordance with aspect 75, wherein the plurality of collaborative users consists of persons employed by a business entity employing the at least one user.

Aspect 98. A method in accordance with aspect 75, wherein at least one web page comprises educational guidance for HVAC design.

### BRIEF DESCRIPTION OF THE DRAWINGS

FIG. 1 illustrates a system block diagram of a system of the present teachings.

FIG. 2 illustrates a flow diagram of a method of designing heating, ventilation and/or air conditioning for a building or a portion thereof.

FIG. 3 illustrates an exemplary web page comprising data input fields for initiating load calculations in a heating and cooling load calculation module.

FIG. 4 illustrates an exemplary web page comprising data input fields for design conditions in a heating and cooling load calculation module.

FIG. 5 illustrates an exemplary web page comprising data input fields for thermal characteristics of building elements in a heating and cooling load calculation module.

FIG. 6 illustrates an exemplary web page comprising data input fields for master load data in a heating and cooling load calculation module.

FIG. 7 illustrates an exemplary web page comprising a data input field for selection of spaces on a zones and spaces web page of a heating and cooling load calculation module.

FIG. 8 illustrates an exemplary web page comprising data input fields for individual space input (with exposures) in a heating and cooling load calculation module.

FIG. 9 illustrates a second exemplary web page comprising data input fields for individual space input (with exposures) in a heating and cooling load calculation module.

FIG. 10 illustrates a third exemplary web page comprising data input fields for individual space input (with exposures) in a heating and cooling load calculation module.

FIG. 11 illustrates a fourth exemplary web page comprising data input fields for individual space input (with exposures) in a heating and cooling load calculation module.

FIG. 12 illustrates a fifth exemplary web page comprising data input fields for individual space input (with exposures) in a heating and cooling load calculation module.

FIG. 13 illustrates a sixth exemplary web page comprising data input fields for individual space input (with exposures) in a heating and cooling load calculation module.

FIG. 14 illustrates an exemplary web page comprising data input fields for a psychrometric properties calculation module.

FIG. 15 illustrates an exemplary web page comprising calculated output for a psychrometric properties calculation module.

FIG. 16 illustrates an exemplary web page comprising a menu of processes for a psychrometric processes calculation module.

FIG. 17 illustrates an exemplary web page comprising data input fields for a mixing process psychrometric processes calculation module.

FIG. 18 illustrates an exemplary web page comprising calculated values based upon input data for a mixing process psychrometric processes calculation module (button “To Main Entry Screen” not shown).

FIG. 19 illustrates an exemplary web page comprising data input fields for a cooling and dehumidifying process psychrometric processes calculation module.

FIG. 20 illustrates an exemplary web page comprising calculated values based upon input data for a cooling and dehumidifying process psychrometric processes calculation module (button “To Main Entry Screen” not shown).

FIG. 21 illustrates an exemplary web page comprising data input fields for a sensible heating or cooling process psychrometric processes calculation module.

FIG. 22 illustrates an exemplary web page comprising calculated values based upon input data for a sensible heating or cooling process psychrometric processes calculation module. (Button “To Main Entry Screen” not shown).

FIG. 23 illustrates an exemplary web page comprising data input fields for an isothermal humidification process psychrometric processes calculation module.

FIG. 24 illustrates an exemplary web page comprising calculated values based upon input data for a for an isothermal humidification process psychrometric processes calculation module (button “To Main Entry Screen” not shown).

FIG. 25 illustrates an exemplary web page comprising data input fields for an evaporative cooling process psychrometric processes calculation module.

FIG. 26 illustrates an exemplary web page comprising calculated output values based upon input data for an evaporative cooling process psychrometric processes calculation module (button “To Main Entry Screen” not shown).

FIG. 27 illustrates an exemplary web page comprising data input fields for a difference between two state points psychrometric processes calculation module.

FIG. 28 illustrates an exemplary web page comprising calculated values based upon input data for a difference between two state points psychrometric processes calculation module (button “To Main Entry Screen” not shown).

FIG. 29 illustrates an exemplary web page comprising data input fields for a heating and cooling coil selection calculation module, in which the web page is configured for cooling input data.

FIG. 30 illustrates an exemplary web page comprising data input fields for liquid conditions for a cooling/dehumidifying coil selection calculation module.

FIG. 31 illustrates an exemplary web page comprising calculated values for a cooling/dehumidifying coil selection calculation module.

FIG. 32 illustrates an exemplary web page comprising data input fields for a refrigerant fluid in a heating and cooling coil diagnostics calculation module.

FIG. 33 illustrates an exemplary web page comprising data input fields for physical characteristics of coil in a cooling/dehumidifying coil diagnostics calculation module.

FIG. 34 illustrates an exemplary web page comprising input and output values for a cooling/dehumidifying coil diagnostics calculation module.

FIG. 35 illustrates an exemplary web page comprising data input fields for cooling/dehumidifying coil diagnostics calculation module, wherein the tube side includes water as liquid.

FIG. 36 illustrates an exemplary web page comprising data input fields for physical characteristics of coil, entering conditions and performance conditions on a heating coil diagnostics calculation module.

FIG. 37 illustrates an exemplary web page comprising input values for coil description, entering conditions and performance conditions, and calculated output values for air side and liquid side, in a heating coil diagnostics calculation module.

FIG. 38 illustrates an exemplary web page comprising data input fields for wherein the type of coil is heating and the fluid is steam, in a heating and cooling coil diagnostics calculation module.

FIG. 39 illustrates an exemplary web page comprising data input fields for physical characteristics of coil with a tube side stream, in a heating coil diagnostics calculation module.

FIG. 40 illustrates an exemplary web page comprising input data for coil description, entering conditions, and performance conditions, and calculated output regarding coil performance on air side, in a heating coil diagnostics calculation module.

FIG. 41 illustrates an exemplary web page comprising data input fields for water as liquid fluid, in a heating and cooling coil selection calculation module.

FIG. 42 illustrates an exemplary web page comprising data input fields for liquid conditions in a cooling/dehumidifying coil selection calculation module.

FIG. 43 illustrates an exemplary output page, which includes input and/or calculated values for input requirements and coil selection, for a liquid water tube side in a cooling/dehumidifying coil selection calculation module.

FIG. 44 illustrates an exemplary web page comprising selection of a cooling/dehumidifying coil in a heating and cooling coil selection calculation module.

FIG. 45 illustrates an exemplary web page comprising data input fields for air conditions and coil conditions in a cooling/dehumidifying coil selection calculation module.

FIG. 46 illustrates an exemplary web page comprising input requirements and coil selection data in a cooling/dehumidifying coil selection calculation module.

FIG. 47 illustrates an exemplary web page comprising data input fields, wherein the selection of type of coil is for heating and the fluid is liquid water, in a heating and cooling coil selection calculation module.

FIG. 48 illustrates an exemplary web page comprising data input fields for liquid conditions, air conditions and coil specifications in a heating coil selection calculation module wherein the tube side is liquid water.

FIG. 49 illustrates an exemplary web page comprising calculated input requirements and coil selection as output, in a heating coil selection calculation module.

FIG. 50 illustrates an exemplary web page comprising data input fields wherein the type of coil is heating and the fluid is steam, in a heating and cooling coil selection calculation module.

FIG. 51 illustrates an exemplary web page comprising data input fields for air conditions and coil specification, in a heating coil selection calculation module, wherein the tube side is steam.

FIG. 52 illustrates an exemplary web page comprising calculated output, including input requirements and coil selection, in a heating coil selection calculation module, wherein the tube side is steam.

FIG. 53 illustrates an exemplary web page comprising a selection of diaphragm or bladder as type of tank, selection of water as fluid in a data input field, and data input field for temperature and pressure at lower temperature and higher temperature, for an expansion tank sizing calculation module.

FIG. 54 illustrates an exemplary web page comprising calculated output wherein the type of tank is a diaphragm (bladder), the fluid is water, and wherein the user selects options for approximate calculation based on building size and chilled or hot/chilled system or heating water system, temperature and pressure at lower temperature and at higher temperature are disclosed, and actual total size (Volume) for tank or tanks is entered in a data input field, in an expansion tank sizing calculation module.

FIG. 55 illustrates an exemplary web page comprising output data including temperature and pressure at lower temperature and at higher temperature, tank volume, actual total size (volume) of tank or tanks, and actual pressure at higher temperature, in an expansion tank sizing calculation module.

FIG. 56 illustrates an exemplary web page comprising a menu of process in a steam processes calculation module.

FIG. 57 illustrates an exemplary web page comprising data input fields for initial (throttle) conditions and outlet conditions, in a steam processes calculation module, wherein isentropic expansion is selected.

FIG. 58 illustrates an exemplary web page comprising calculated output for initial (throttle) conditions and outlet conditions, in a steam processes calculation module.

FIG. 59 illustrates an exemplary web page comprising data input fields for initial (throttle) conditions and outlet conditions, in a steam processes calculation module, wherein nonisentropic expansion is selected at an efficiency of 65%.

FIG. 60 illustrates an exemplary web page comprising calculated output initial (throttle) conditions and outlet conditions, for a non-isentropic expansion (power) process, in a steam processes calculation module.

FIG. 61 illustrates an exemplary web page comprising data input fields for fuel heat required to generate steam, in a steam processes calculation module.

FIG. 62 illustrates an exemplary web page comprising calculated output for fuel heat required to generate steam, in a steam processes calculation module.

FIG. 63 illustrates an exemplary web page comprising data input fields for control or regulator valve sizing (Cv), in a steam processes calculation module.

FIG. 64 illustrates an exemplary web page comprising calculated output for control or regulator valve sizing (Cv), in a steam processes calculation module, wherein the steam flow rate is 1 Aspect 00.00 lb/hr.

FIG. 65 illustrates an exemplary web page comprising data input fields for steam orifice size/capacity, in a steam processes calculation module, wherein the steam flow rate is 100.00 lb/hr.

FIG. 66 illustrates an exemplary web page comprising calculated output for steam orifice size/capacity, in a steam processes calculation module, wherein the steam flow rate is 100.00 lb/hr.

FIG. 67 illustrates an exemplary web page comprising data input fields for steam orifice size/capacity, in a steam processes calculation module, wherein the orifice diameter is 0.100 in.

FIG. 68 illustrates an exemplary web page comprising calculated output for steam orifice size/capacity, in a steam processes calculation module, wherein the orifice diameter is 0.100 in.

FIG. 69 illustrates an exemplary web page comprising data input fields for differences between two state points, in a steam processes calculation module.

FIG. 70 illustrates an exemplary web page comprising calculated output for differences between two state points, in a steam processes calculation module.

FIG. 71 illustrates an exemplary web page comprising data input fields for saturated properties, in a steam properties calculation module.

FIG. 72 illustrates an exemplary web page comprising data input fields for saturated properties, in a steam properties calculation module, wherein the saturated pressure is 500 psia.

FIG. 73 illustrates an exemplary web page comprising calculated output for properties of saturated liquid and saturated vapor, in a steam properties calculation module, wherein the saturated pressure is 500 psia.

FIG. 74 illustrates an exemplary web page comprising data input fields for saturated properties, in a steam properties calculation module, wherein the saturation temperature is 500° F.

FIG. 75 illustrates an exemplary web page comprising calculated output for properties of saturated liquid and saturated vapor, in a steam properties calculation module, wherein the saturation temperature is 500° F.

FIG. 76 illustrates an exemplary web page comprising data input fields for saturated properties, in a steam properties calculation module, wherein the saturated pressure is 500 psia, at a quality of 50%.

FIG. 77 illustrates an exemplary web page comprising calculated output for saturated properties, in a steam properties calculation module, wherein the saturated pressure is 500 psia, at a quality of 50%.

FIG. 78 illustrates an exemplary web page comprising data input fields for saturated properties, in a steam properties calculation module, wherein the temperature is 500° F., at a quality of 50%.

FIG. 79 illustrates an exemplary web page comprising calculated output for saturated properties, in a steam properties calculation module, wherein the temperature is 500° F., at a quality of 50%.

FIG. 80 illustrates an exemplary web page comprising data input fields for superheated or supercritical vapor or subcooled liquid properties, in a steam properties calculation module, wherein the wherein the pressure is 500 psia, and the temperature is 400° F.

FIG. 81 illustrates an exemplary web page comprising calculated output for superheated or supercritical vapor or subcooled liquid properties, in a steam properties calculation module, wherein the pressure is 500 psia and the temperature is 400° F.

FIG. 82 illustrates an exemplary web page comprising data input fields for superheated or supercritical vapor or subcooled liquid properties, in a steam properties calculation module, wherein the pressure is 500 psia, and the temperature is 500° F.

FIG. 83 illustrates an exemplary web page comprising calculated output for superheated or supercritical vapor or subcooled liquid properties, in a steam properties calculation module, wherein the pressure is 500 psia, and the temperature is 500° F.

FIG. 84 illustrates an exemplary web page comprising data input fields for superheated or supercritical vapor or subcooled liquid properties, in a steam properties calculation module, wherein the pressure is 500 psia, and the temperature is 900° F.

FIG. 85 illustrates an exemplary web page comprising calculated output for superheated or supercritical vapor or subcooled liquid properties, in a steam properties calculation module, wherein the pressure is 500 psia, and the temperature is 900° F.

FIG. 86 illustrates an exemplary web page comprising data input fields for pipe material, pipe strength and fluid, in a hydronic pipe sizing calculation module.

FIG. 87 illustrates an exemplary web page comprising data input fields for pipe material, pipe strength and fluid, in a hydronic pipe sizing calculation module, wherein the mean fluid temperature is 60° F., the design head loss is 4 ft/100 ft, and the maximum velocity is 8 ft/sec.

FIG. 88 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm.

FIG. 89 illustrates an exemplary web page comprising calculated output for pipe material, pipe strength and fluid, in a hydronic pipe sizing calculation module, wherein the mean fluid temperature is 60° F., the design head loss is 4 ft/TOO ft, the maximum velocity is 8 ft/sec, and the flow rate is 0.10 gpm or 1.00 gpm.

FIG. 90 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm or 10.00 gpm.

FIG. 91 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm or 100.00 gpm.

FIG. 92 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm, 100.00 gpm or 1,000.00 gpm.

FIG. 93 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm, 100.00 gpm, 1,000.00 gpm or 10,000.00 gpm.

FIG. 94 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm, 100.00 gpm, 1,000.00 gpm, 10,000.00 gpm or 100,000.00 gpm.

FIG. 95 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm, 100.00 gpm, 1,000.00 gpm, 10,000.00 gpm or 100,000.00 gpm, plus 138,000 comprised by a data input field for an additional entry.

FIG. 96 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm, 100.00 gpm, 1,000.00 gpm, 10,000.00 gpm, 100,000.00 gpm, or 138,000.00 gpm, plus a data input field for an additional entry.

FIG. 97 illustrates an exemplary web page comprising calculated output for pipe material, pipe strength and fluid, in a hydronic pipe sizing calculation module, wherein the mean fluid temperature is 60° F., the design head loss is 4 ft/100 ft, the maximum velocity is 8 ft/sec, and the flow rate is 0.10 gpm, 1.00 gpm, 10.00 gpm, 100.00 gpm, 1,000.00 gpm, 10,000.00 gpm, 100,000.00 gpm, or 138,000.00 gpm.

FIG. 98 illustrates an exemplary Psychrometric Properties Input/Output summary.

FIG. 99 illustrates an exemplary Psychrometric Processes Input/Output summary.

FIG. 100 illustrates an exemplary Steam Properties Input/Output summary.

FIG. 101 illustrates an exemplary Hydronic Pipe Sizing Input/Output summary.

FIG. 102 illustrates an exemplary Heating and Cooling Loads Input/Output summary.

FIG. 103 illustrates an exemplary Expansion Tank Sizing Input/Output summary.

FIG. 104 illustrates an exemplary Heating and Cooling Coil Diagnostics Input/Output summary.

FIG. 105 illustrates an exemplary Heating and Cooling Coil Selection Input/Output summary.

FIG. 106 illustrates an exemplary Steam Processes Input/Output summary.

### DETAILED DESCRIPTION

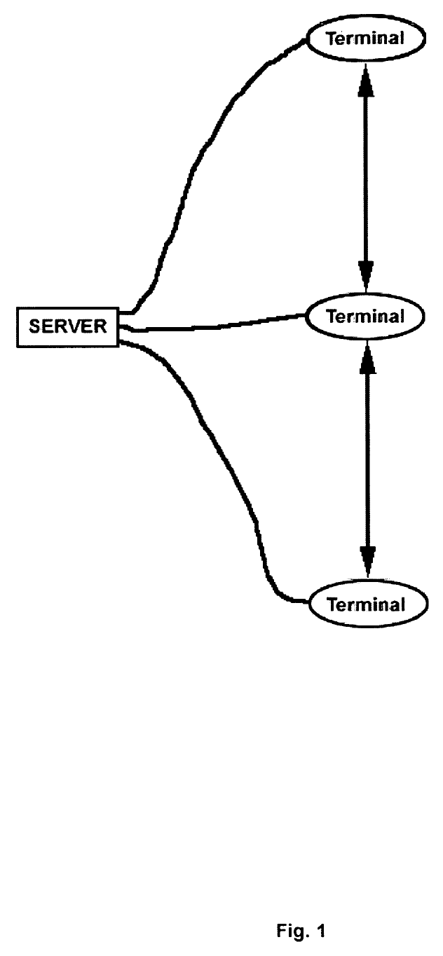

The present inventors have developed methods and systems for facilitating design of HVAC specifications for a building or portion thereof. In some aspects of the present teachings, a system can comprise at least one terminal, and a server. With reference to FIG. 1, a server can be operably connected to one or more terminals. The connection can be through a network which can be, for example, the Internet, an intranet, a WAN or a LAN. The server and terminal(s) can be connected by wire, wirelessly, or a combination thereof. A “terminal,” as used herein, can be any sort of device for receiving data from and/or sending data to a server. The terminals in various configurations can communicate not only with the server, but with each other via the network. In some configurations, a system can comprise a plurality of terminals which can be situated remotely from one another (e.g., in two different cities); multiple users can thus contribute in a collaborative project. Without limitation, examples of a terminal include a desktop computer, a laptop computer, a portable desk assistant (PDA) device, and a wireless telephone. In various configurations, a server can be a secure server, such as a dedicated server.

In various configurations, a server can provide a web-based user interface comprising a plurality of web pages, wherein one or more web pages are configured to receive as input information one or more identifiers and/or descriptors, wherein each descriptor can be selected from a descriptor of a building, a descriptor of a portion of a building and a descriptor of a building environment. An identifier, as used herein, is any sort of information that can be used to identify a user, a calculation, a project or a session of use.

In some configurations, a server can record a session of use of a building HVAC design project. In these configurations, after a user enters a user identification and a password, the server can record the web pages accessed, the data entries (such as, for example, alphanumeric data added to data input fields and/or selection of radio buttons) and/or the output information generated in a session. In some configurations, the server can generate and/or store a record of a session, comprising the web pages accessed, the data entries, and/or the output information generated. A record of a session can further comprise one or more identifiers, which can include, for example, one or more of a user's identification, a title of a project, time of a session, and date of a session, a company name, a project name, a project file number, and/or a calculation label. In some configurations, a server can record a session in a manner in which the user, accessing the server from a terminal remote from the server, is prevented from erasing or altering the record of the session, either during the session, or subsequently. Furthermore, in some configurations a server can create a record of a project, which can comprise each record of the sessions recorded for the project. Accordingly, in a multi-user, collaborative project, a record of the project can include all the records of sessions recorded by each user, including, for example, dates when calculation modules were accessed and calculations were performed for a project. In a non-limiting example, a user can log in securely to a website providing access to a server of the present teachings, access a project and a calculation module, provide new values for one or more data fields, execute calculation by the calculation modules, and exit from the web site. The server automatically and securely records the new calculations, along with one or more identifiers which indicate the user who inputted the new values, as well as the date when the changes were made.

In some aspects, calculations related to a project can be automatically filed in a project file comprised by a server, for example in connection with an identifier, which can be, in non-limiting example, a company name, a project name, a project file number, a calculation label, an user's name, date of a user session and/or time of a user session. In some configurations, a calculation not related to a project can be automatically filed as a “Miscellaneous” calculation. Because a server can be a secure server, confidentiality of a project can be maintained. Furthermore,

A descriptor, as used herein, can be a numerical value of a physical property of a building or portion thereof, such as, for example, a space height of a room, a coil width of a heating coil, or an environmental property, such as, for example, the elevation of a building. In some configurations, a user can select a calculation module using methods known to skilled artisans, such as by selecting from a menu by a mouse click. A calculation module can comprise a web page, which, in some configurations, can comprise one or more input fields. A user accessing a web page via a terminal can enter alphanumerical data for descriptors and/or identifiers. Upon a user entering alphanumerical data in the input fields on a web page for a calculation module, the server can determine if the data items required for a calculation have been entered, and/or if the data items entered are compatible with the calculations to be performed by the calculation module, and/or if too many data items have been added. If the server determines an omission or error in the data added, the user can receive an error message, and the user can then modify the input data. For example, on a web page comprising a calculation module for heating and cooling diagnostics, if the user selects steam as a fluid, data input fields are presented for three descriptors: saturated steam temperature in ° F., saturated steam pressure in psig, and saturated steam pressure in psia. The web page instructs the user to add a numerical value for only one descriptor. If a user adds values to more than one field, the user receives an error message; the user can then correct the values of the descriptors to comport with the requirements of the calculation module. If all required values added are compatible with the requirements for the calculation module, upon the user selecting “proceed,” the server calculates output values for various HVAC parameters. In various configurations, the output values can be displayed on a web page and/or can be comprised by a computer file such as a text file, which can be viewed and/or saved by the user, e.g., by downloading onto a hard drive comprised by the user's terminal.

In some cases, a web page can provide a cumulative table, in which different values are iteratively provided to a data input field in a calculation module. A cumulative table can thus report both input values and calculated output values, thereby allowing a user to compare the effects of varying the value of an input item.

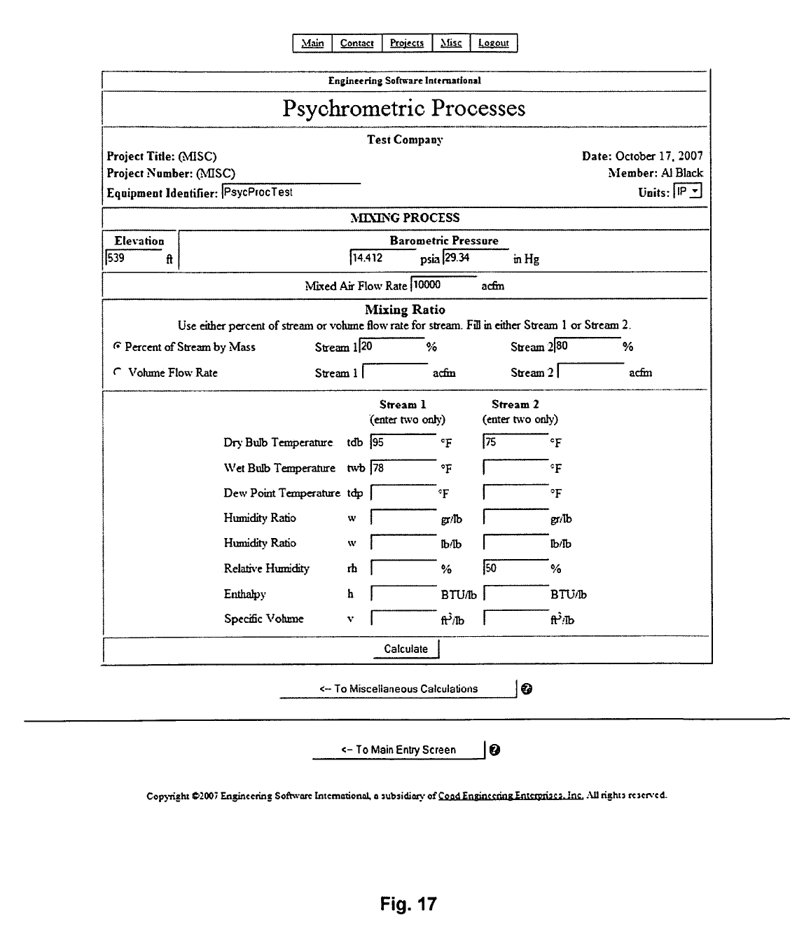

In some cases, an HVAC specification can be either an input information item or an output information item, and the value of the output information items can be calculated by a calculation module using the input information items. In a non-limiting example, a web page such as a Psychrometric Processes calculation module for mixing process (FIG. 17) includes data input fields for mixing ratio by percent of stream by mass. A user can enter a value for a percentage of either Stream 1 or Stream 2. For example, if a user enters a number between 0 and 100 in the data input field for Stream 1, a calculated value will appear in the data input field for Stream 2. If the user then overwrites the calculated value in the data input field for Stream 2, a calculated value will appear in the data input field for Stream 1, overwriting the value initially entered for in the data input field for Stream 1.

In addition, in some cases, a calculation module can limit the number of data input fields for which alphanumeric data is accepted. In non-limiting example, a web page such as a Psychrometric Processes calculation module for mixing process (FIG. 17) includes data input fields not only for mixing ratio by percent of stream by mass, but also for mixing ratio by volume flow rate. If a user attempts to enter numbers in the data input data field for volume flow rate for Stream 1 and for Stream 2, an error message is displayed stating that the user may enter only one volume flow rate. Furthermore, in another non-limiting example using the Psychrometric Processes calculation module for mixing process, if a user attempts to enter data into data input fields for both percent of stream by mass and volume flow rate, the calculation module will erase the first data entered.

In addition, in some cases, a calculation module will perform a calculation only when necessary data has been entered. In non-limiting example, a web page such as a Psychrometric Processes calculation module for mixing process (FIG. 17), the calculation module will not perform a calculation unless alphanumeric text is included in the data input field for Equipment Identifier, or numerical text is included in the data input fields for Mixed Air Flow Rate and Barometric Pressure.

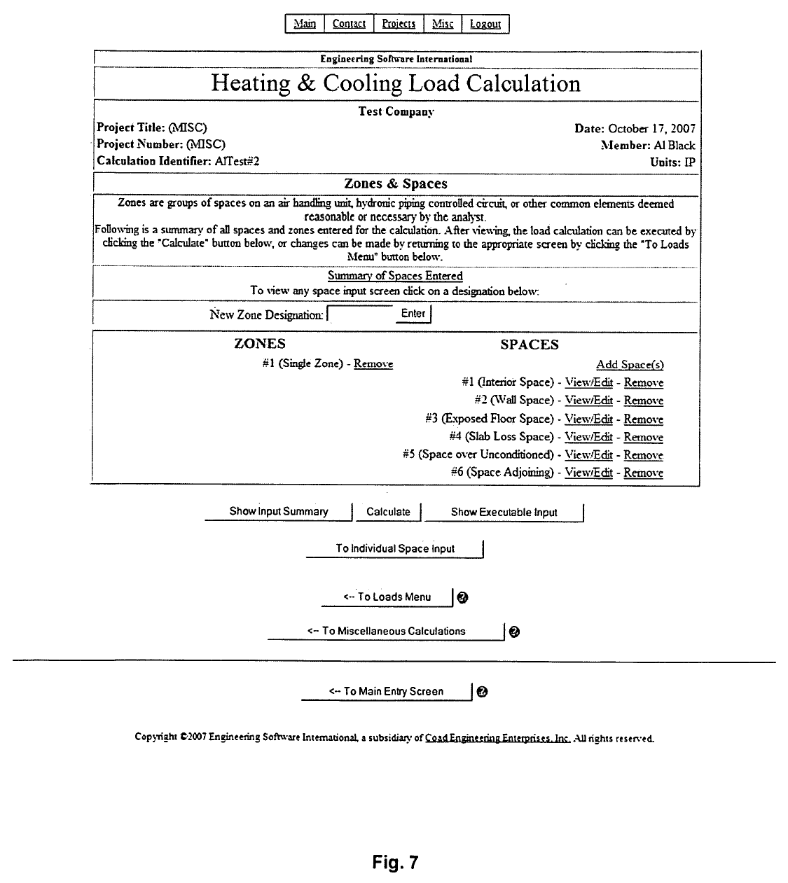

In some cases, a web page of a system of the present teachings can comprise educational material. In non-limiting example, FIG. 7 includes a statement that “Each constituent of a mixture of perfect gases behaves as though the other constituents were not present (at least as far as pressure is concerned).—Dalton's Law.” In some configurations, such educational statements can be added or replaced on a web page by an entity such as a web master (but not a user) who has access privileges to modify the software as comprised by a server.

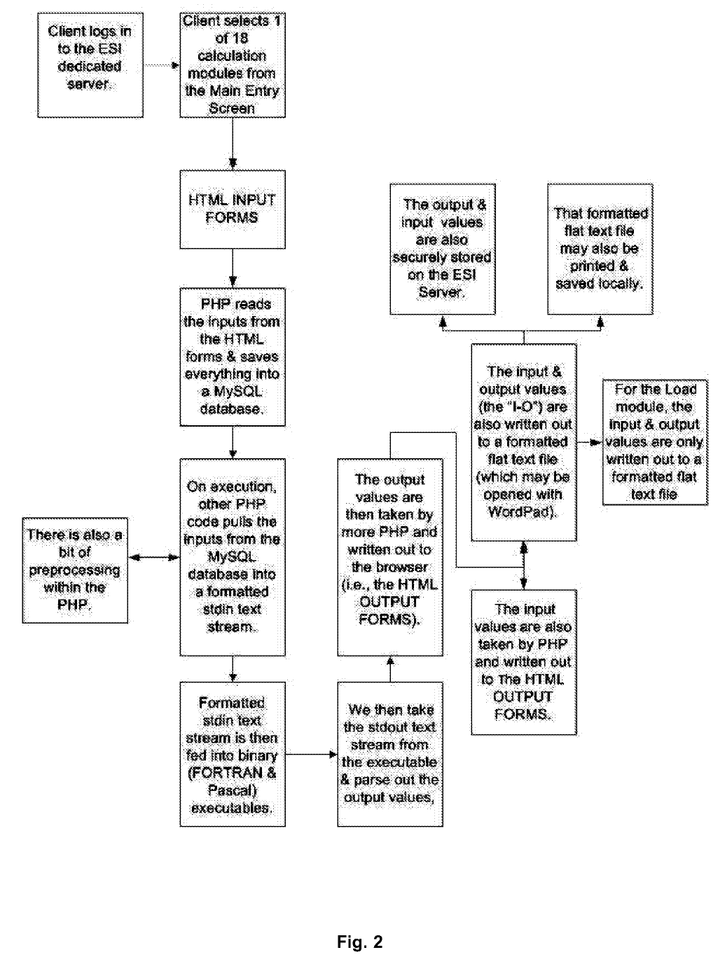

With reference to the flowchart set forth in FIG. 2, in various configurations of the present teachings, a user can log into a dedicated server by entering a user identification and a password (step 1). The user can then select a calculation module from a Main Entry Screen (step 2). On a web page for the selected calculation module, the user can then enter alphanumeric data into data input field(s) and/or can select one or more radio buttons in an HTML form (step 3). The calculation module can then read inputs from the HTML form, and can save the data in a database (step 4). In some configurations, PHP code can be used to read the inputs and the data can be saved in any database known to skilled artisans, such as a MySQL database. On execution, other code (which can also be PIP code) can pull inputs from the MySQL database into a formatted standard input (stdin) text stream (step 5). Furthermore, the calculation module can, in some cases, perform additional preprocessing of the data (step 6). The calculation module can then feed the formatted stdin text stream in binary executables, which can be, without limitation, programs written in computer languages such as FORTRAN and/or Pascal (step 7). Stdout stream generated by the executable(s) can then be parsed out for output values (step 8). Output values can then be taken by more code (which can be PHP code) and written out to a browser (e.g., to an HTML output form which can be displayed on a browser) (step 9). In some configurations, input values can be taken by more code (which can be PHP code) and written out to a browser (e.g., to an HTML output form which can be displayed on a client such as a web browser) (step 10). In some other configurations, input and output (“I-O”) values can be written out to a formatted flat text file (step 11). In some configurations, for the Load module, the I-O values can be separately written out to a formatted flat text file (step 12). In other configurations, I-O values can be stored securely on a server (step 13), and/or a formatted flat text file can be printed or saved locally by the user (step 14). A non-limiting example of formatted text file is provided in table 1.

In some aspects of the present teachings, a system can comprise a collaborative feature. This feature can allow individual users and/or firms to create an on-line virtual company comprising, for example, professionals and/or expert consultants from anywhere on the planet, without the use of any additional collaboration software. In some configurations, such collaborative groups may be formed at will, for example, on an “as needed” or an “on-the-fly” basis. In various configurations, a collaborator can be added or deleted as a member company wishes.

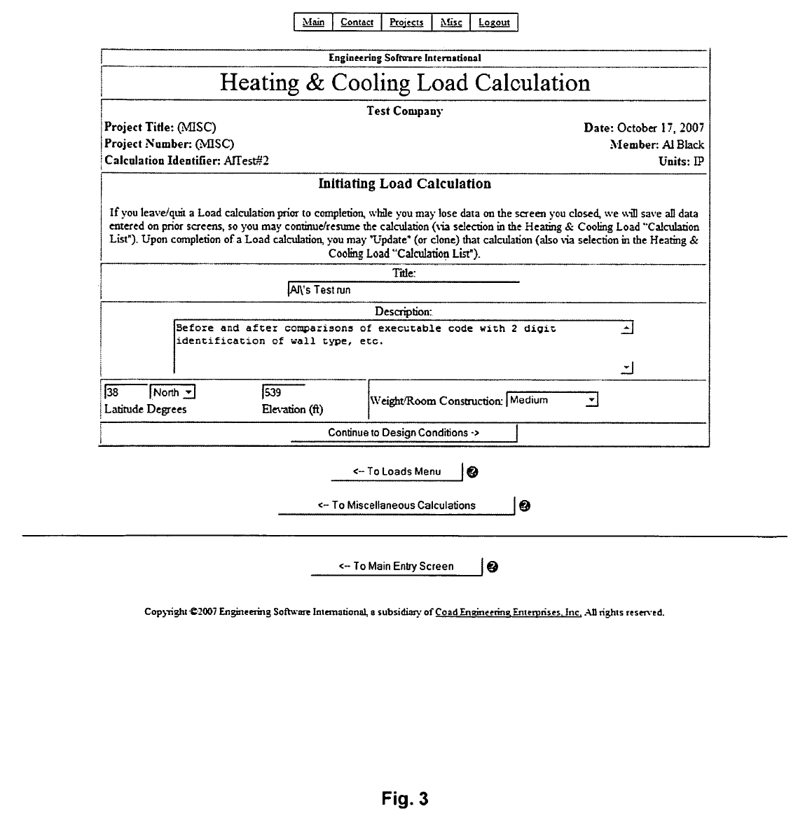

In some configurations, a system of the present teachings can comprise a Heating & Cooling Load Calculation calculation module. This calculation module can include an input web page for initiating load calculation (e.g., FIG. 3). This web page can comprise data input fields for alphanumeric data, such as fields for title, description, latitude, elevation, and weight/room construction.

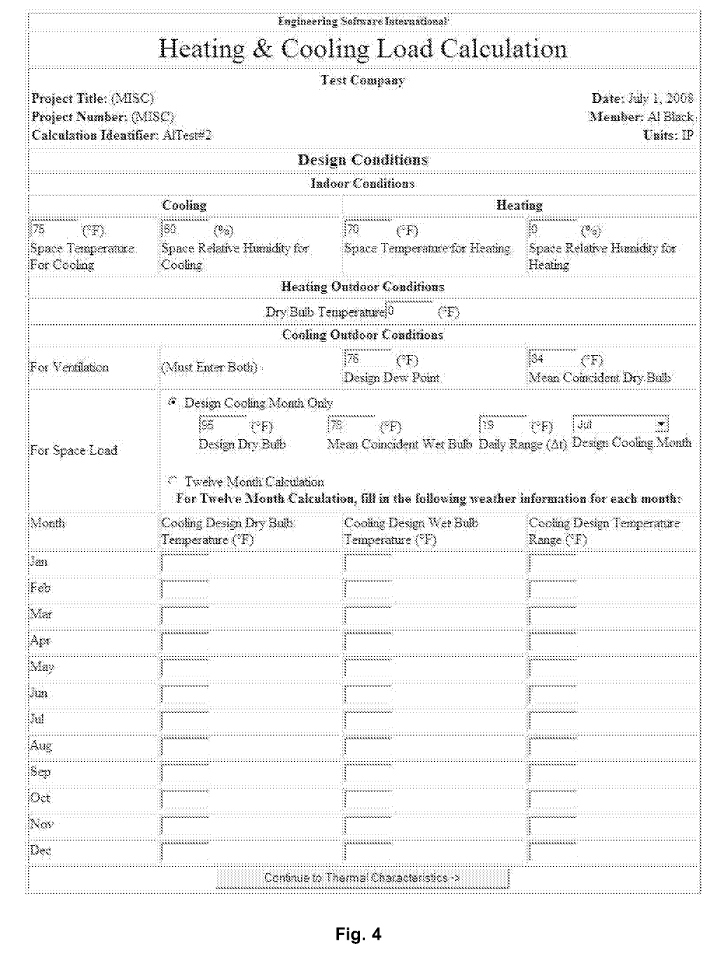

In some configurations, a system of the present teachings can comprise a calculation module for Heating & Cooling Load Calculation which can include an input web page for Design Conditions (e.g., FIG. 4). This web page can comprise data input fields for alphanumeric data, such as fields for indoor conditions, including, for example, fields for space temperature for cooling, space relative humidity for cooling, space temperature for heating, and space relative humidity for heating. This web page can further comprise a data input field for heating outdoor conditions such as dry bulb temperature; cooling outdoor conditions for ventilation such as design dew point temperature and mean coincident dry bulb temperature; and cooling outdoor conditions for space load such as design dry bulb temperature, mean coincident wet bulb temperature, daily temperature range, and design cooling month. In addition, the page can further comprise, for cooling outdoor conditions for space load, data input fields for each month, including cooling design dry bulb temperature, cooling design web bulb temperature, and cooling design range.

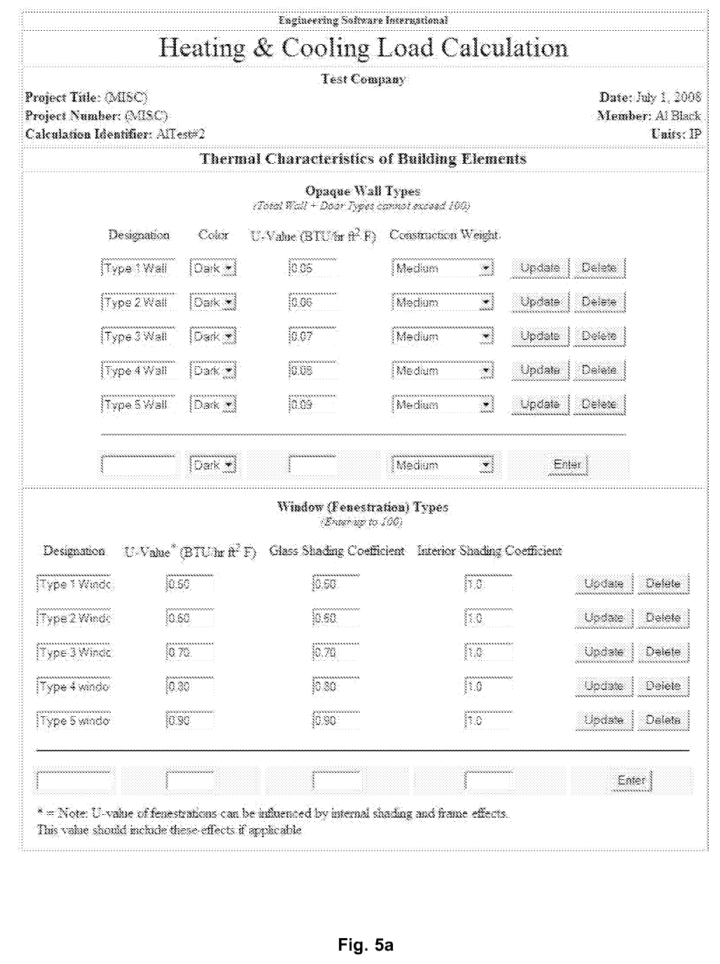

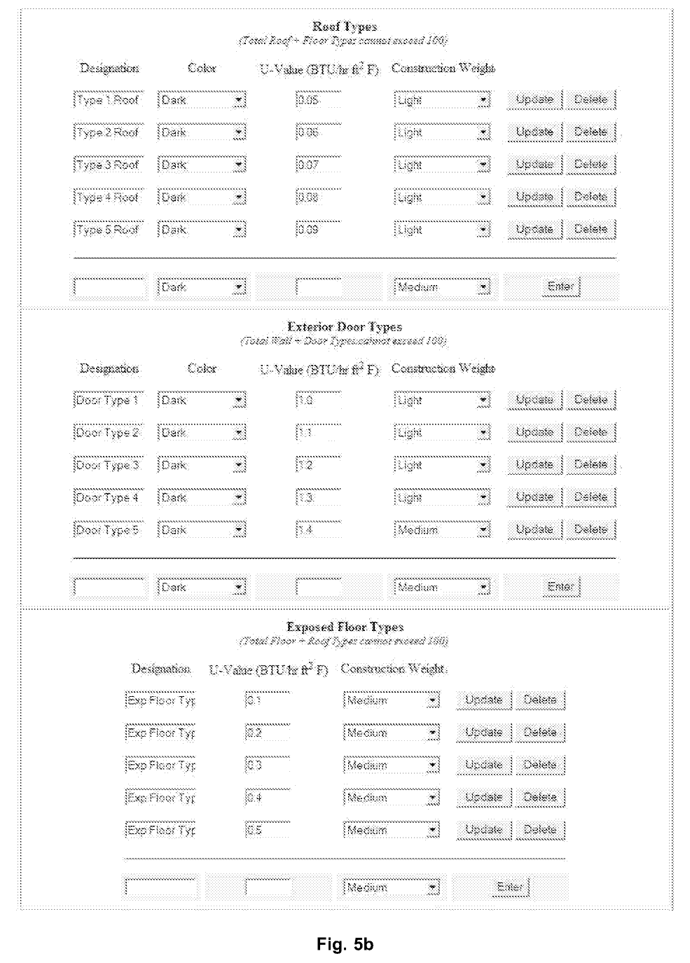

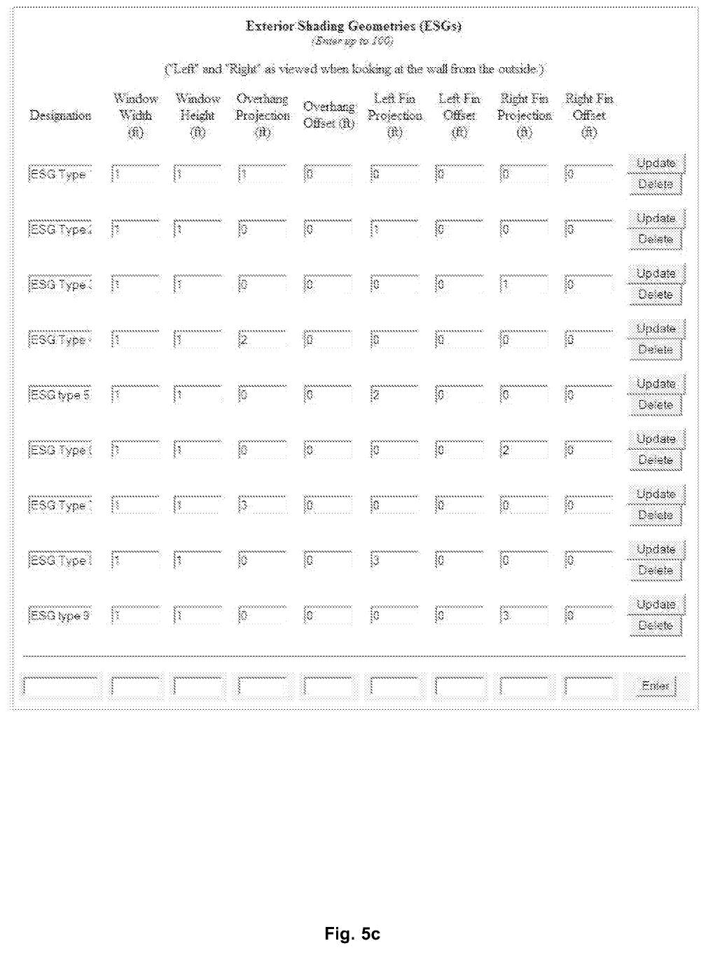

In some configurations, a system of the present teachings can comprise a calculation module for Heating & Cooling Load Calculation which can include an input web page for Thermal Characteristics of Building Elements (e.g., FIG. 5). This web page can comprise data input fields for alphanumeric data, such as data input fields for opaque wall types, such as designation, color, U-value, and construction weight; data input fields for window (fenestration) types, such as designation, U-value, glass shading coefficient, and interior shading coefficient; data input fields for roof types, such as designation, color, U-value, and construction weight; data input fields for exterior door types, such as designation, color, U-value, and construction weight; data input fields for exposed floor types, such as designation, U-value, and construction weight; and data input fields for exterior shading geometries, such as designation, window width, window height, overhang projection, overhang offset, left fin projection, left fin offset, right fin projection, and right fin offset.

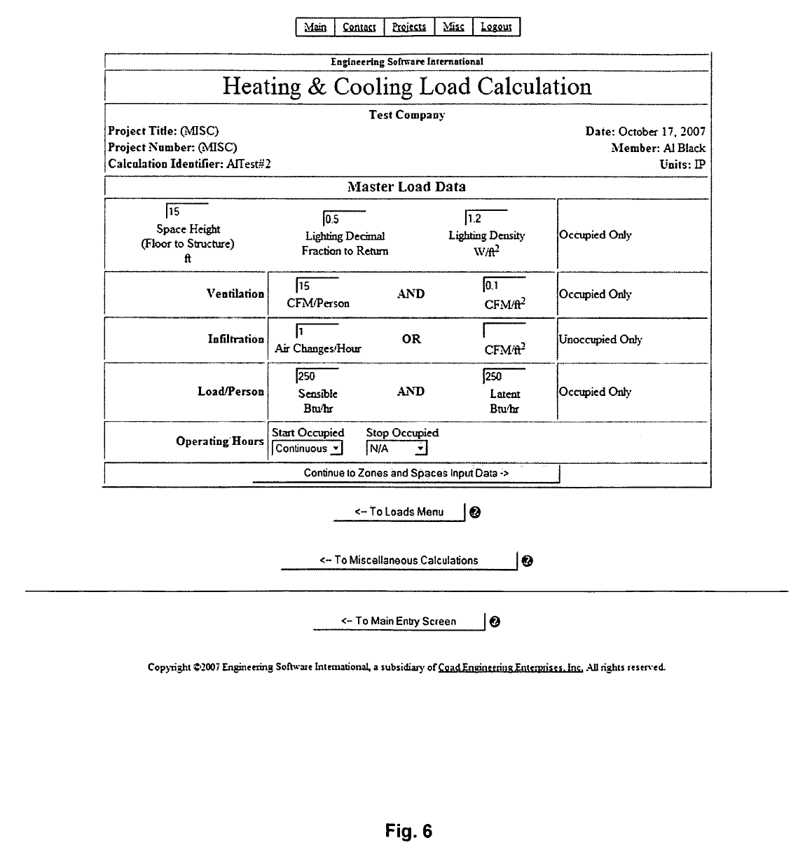

In some configurations, a system of the present teachings can comprise a calculation module for Heating & Cooling Load Calculation which can include an input web page for Master Load Data (e.g., FIG. 6). This web page can comprise data input fields for alphanumeric data, such as data input fields for space height, lighting decimal fraction to return, and lighting density. The web page can further comprise data input fields for ventilation, CFM/person and CFM/ft²; for infiltration, air changes/hour and CFM/ft²; for load/person, sensible Btu/hr and latent Btu/hr; and for operating hours, start occupied and stop occupied.

In some configurations, a system of the present teachings can comprise a calculation module for Heating & Cooling Load Calculation which can include a summary web page for Zones and Spaces (e.g., FIG. 7). This web page can comprise a data input field for alphanumeric data, such as data input field for a new zone designation, and can also provide a summary of all spaces and zones entered for a calculation. From this web page, a load calculation can be executed by a user clicking a ‘Calculate’ button, or a user can return to an appropriate screen by clicking on a ‘To Loads Menu’ button.

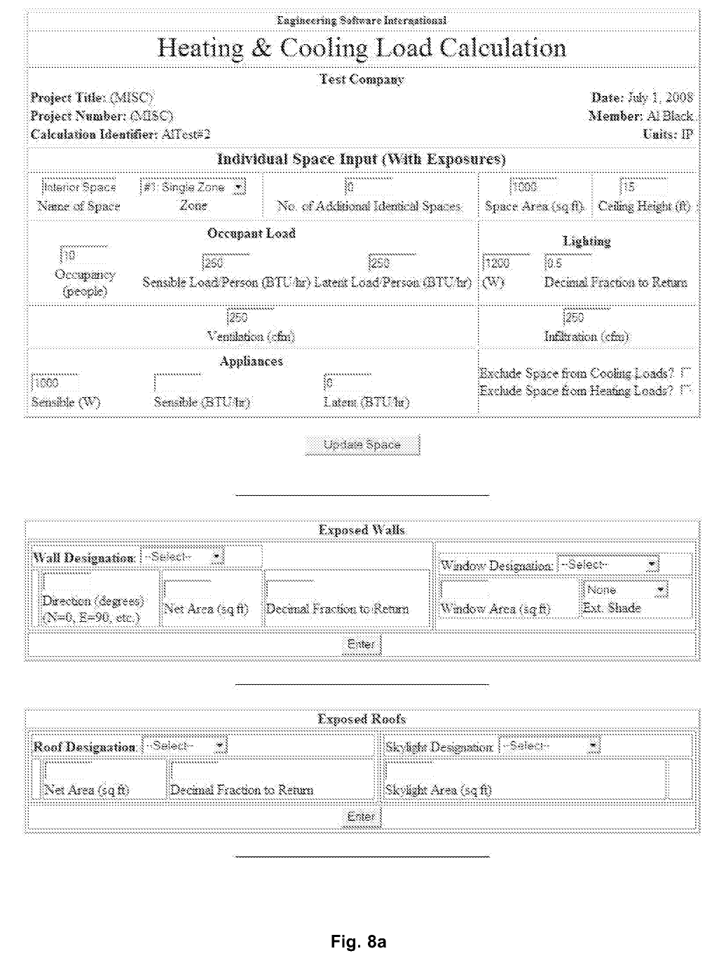

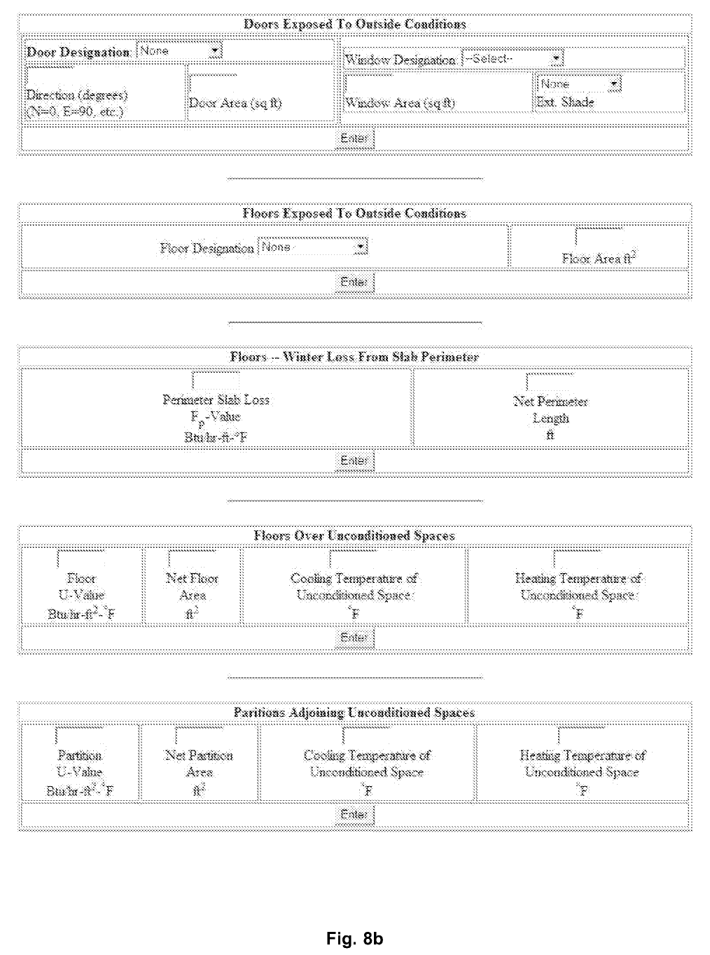

In some configurations, a system of the present teachings can comprise a calculation module for Heating & Cooling Load Calculation which can include an input web page for Individual Space Input (With Exposures) (e.g., FIG. 8). This web page can comprise data input fields for alphanumeric data, such as data input fields for name of space, zone, number of additional identical spaces, space area, and ceiling height; for occupant load: occupancy (people), sensible load/person, latent load/person; for lighting: wattage and decimal fraction to return; for ventilation (cfm); for infiltration (cfm); for appliances: sensible (W), sensible (BTU/hr), latent (BTU/hr); and for infiltration (cfm). The web page can further comprise check boxes for excluding space from cooling loads and for excluding space from heating loads.

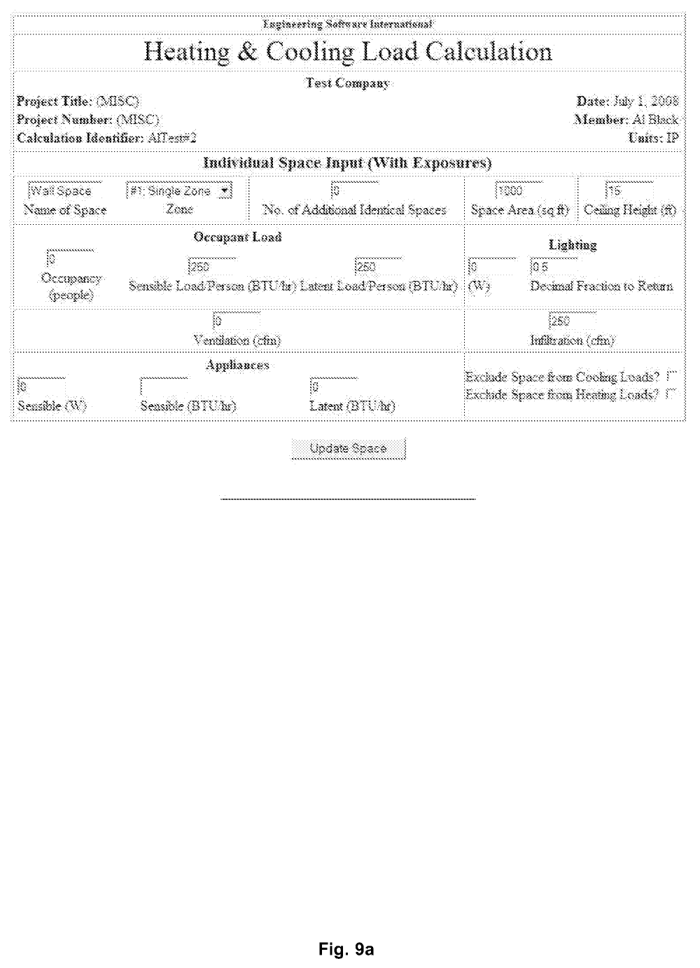

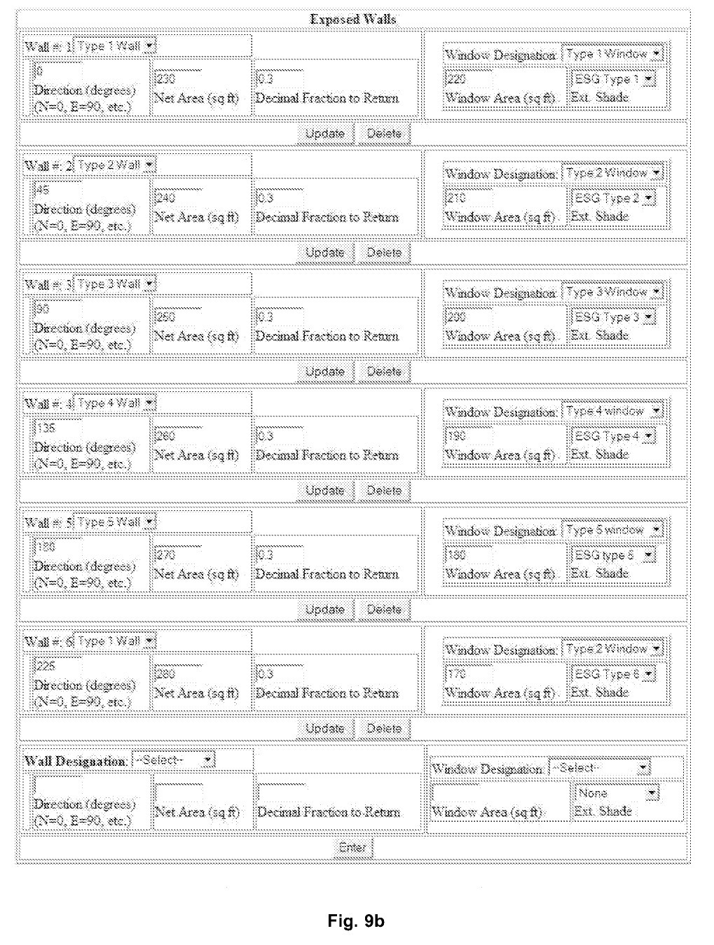

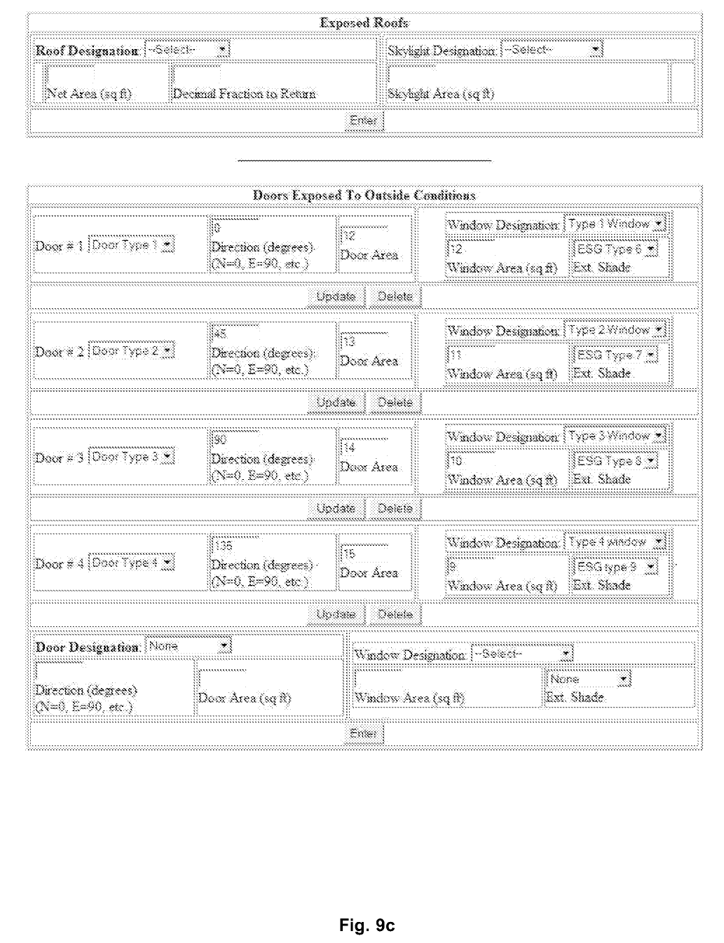

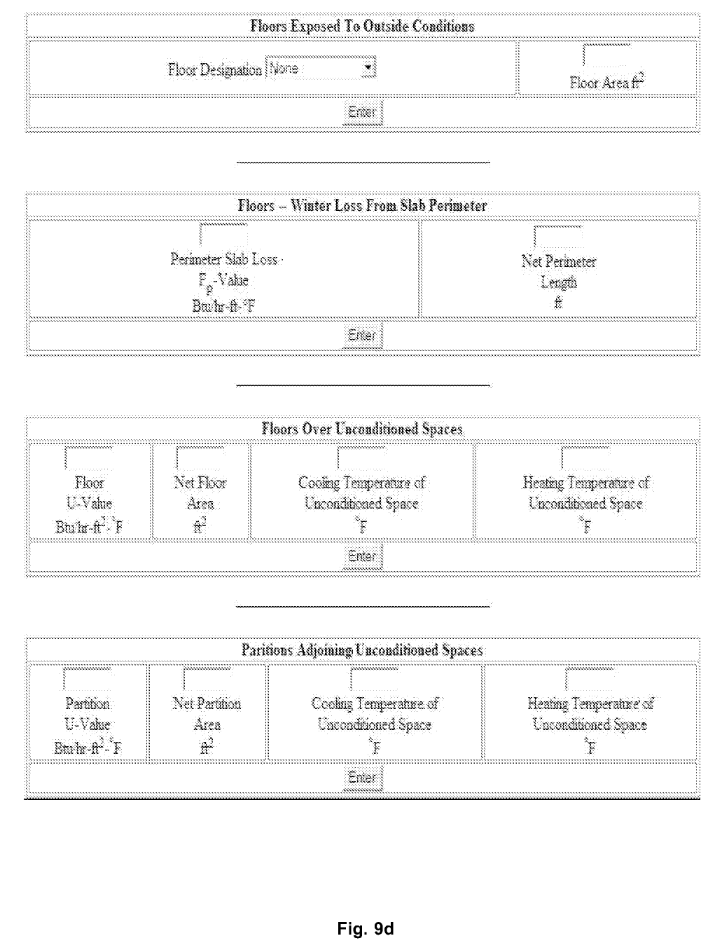

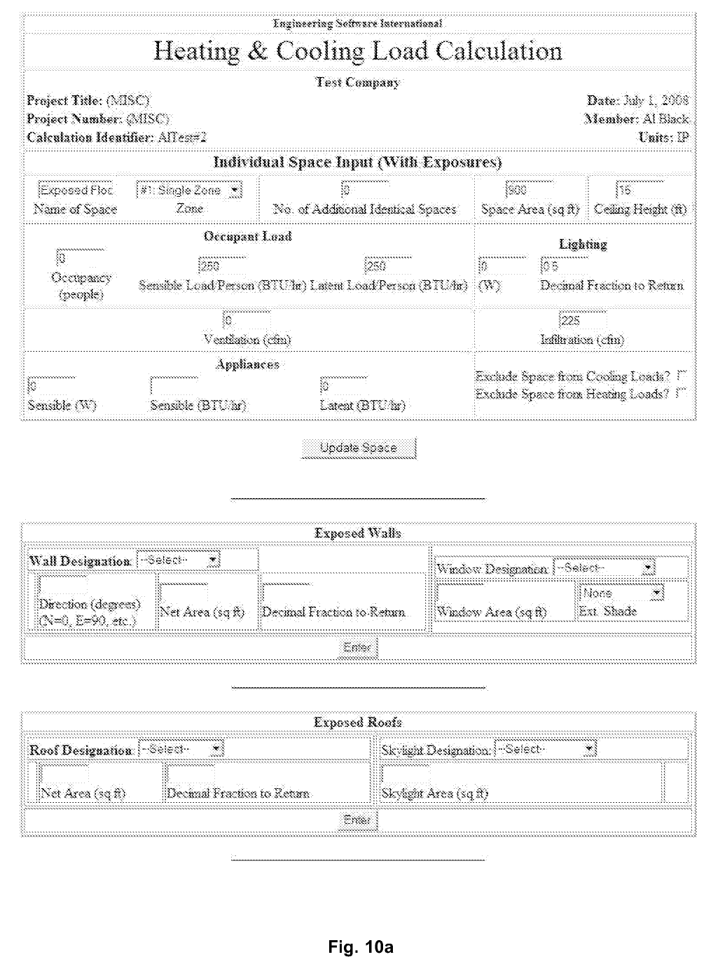

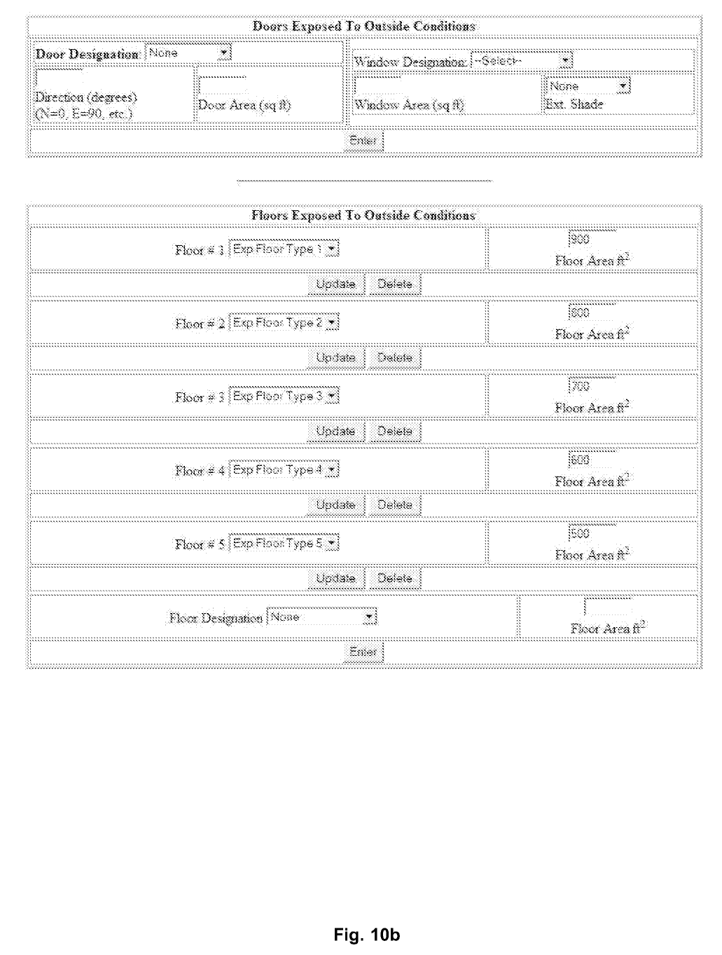

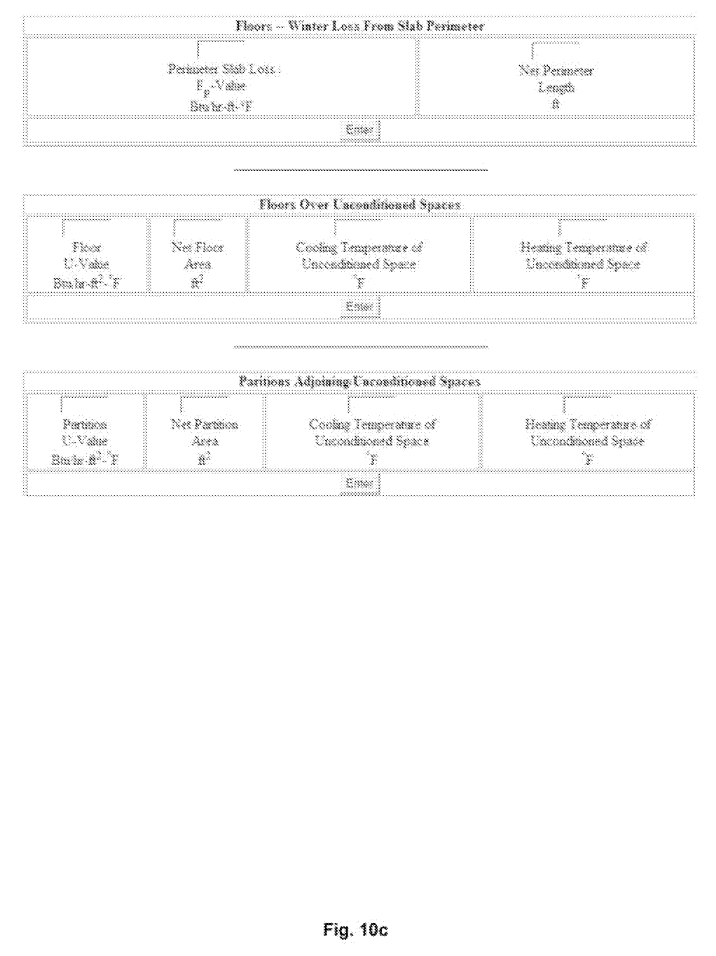

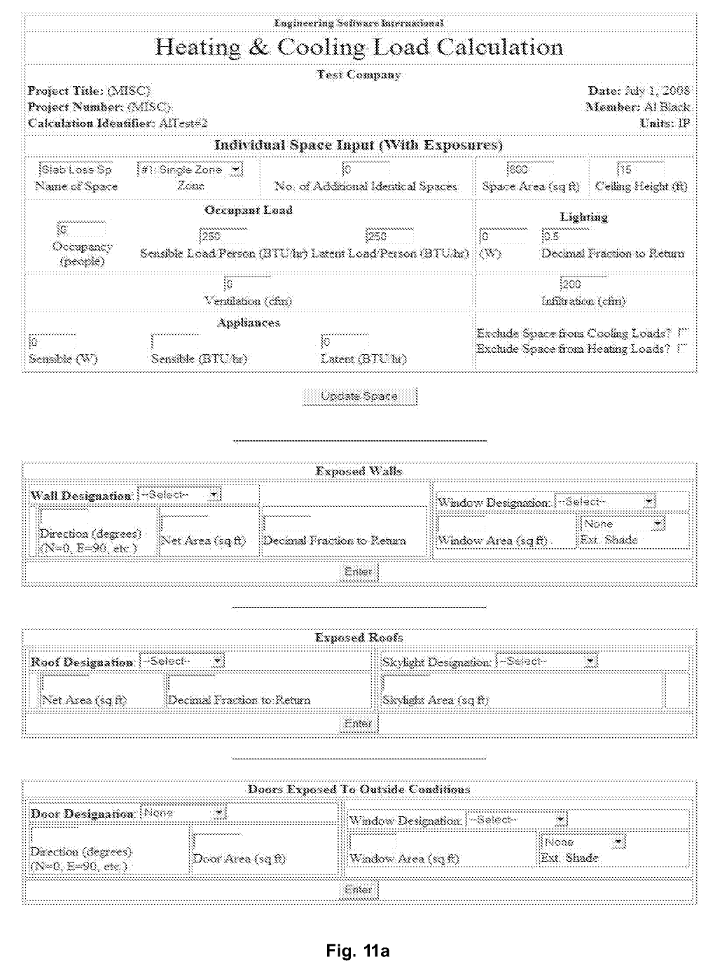

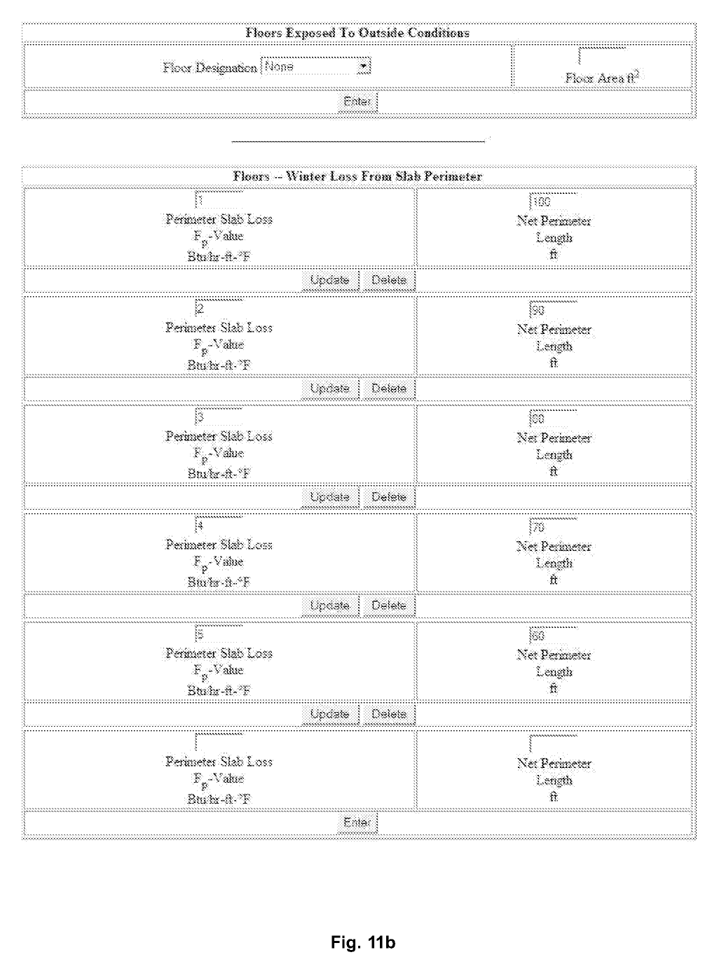

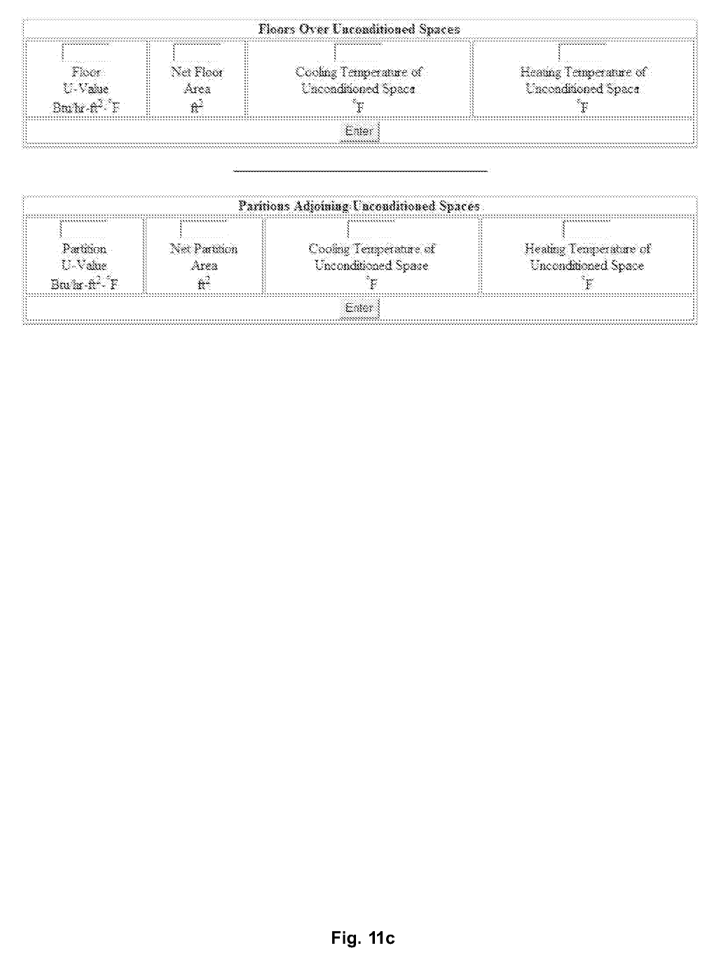

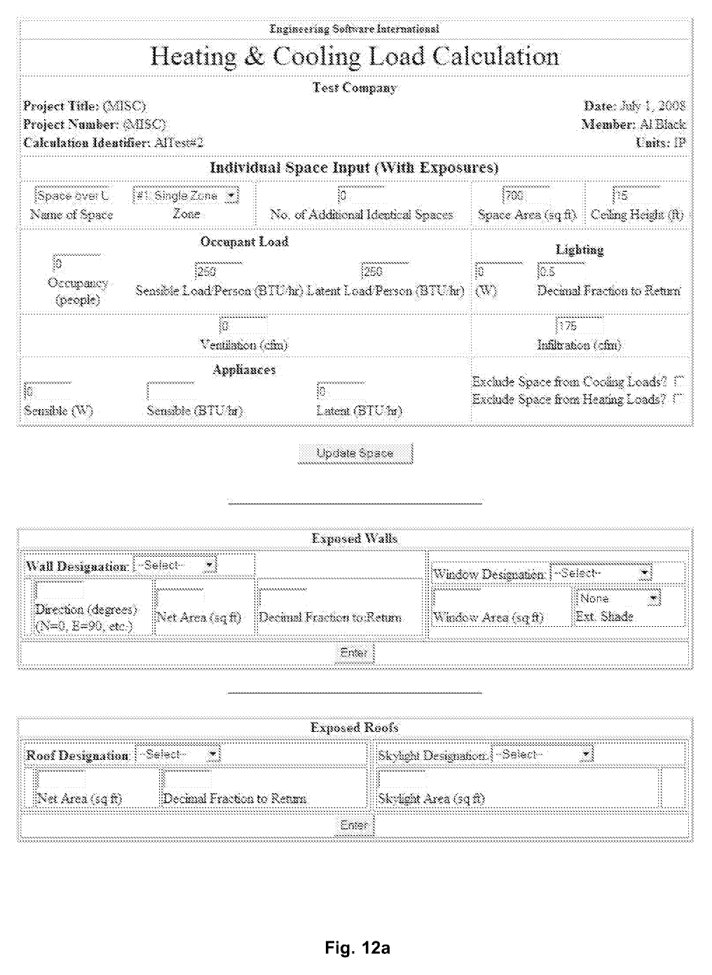

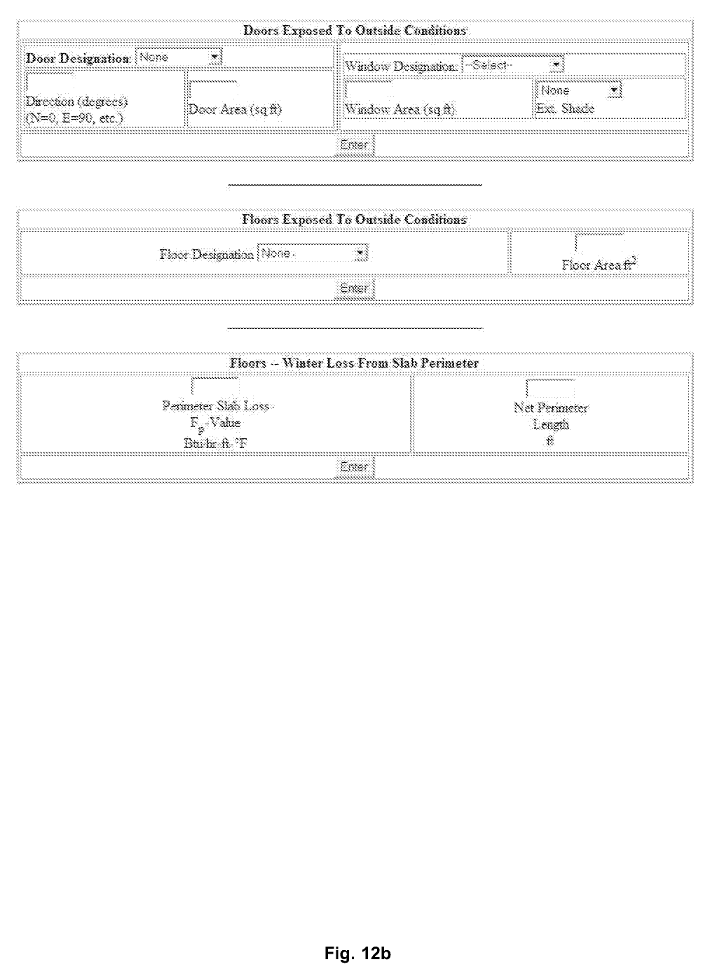

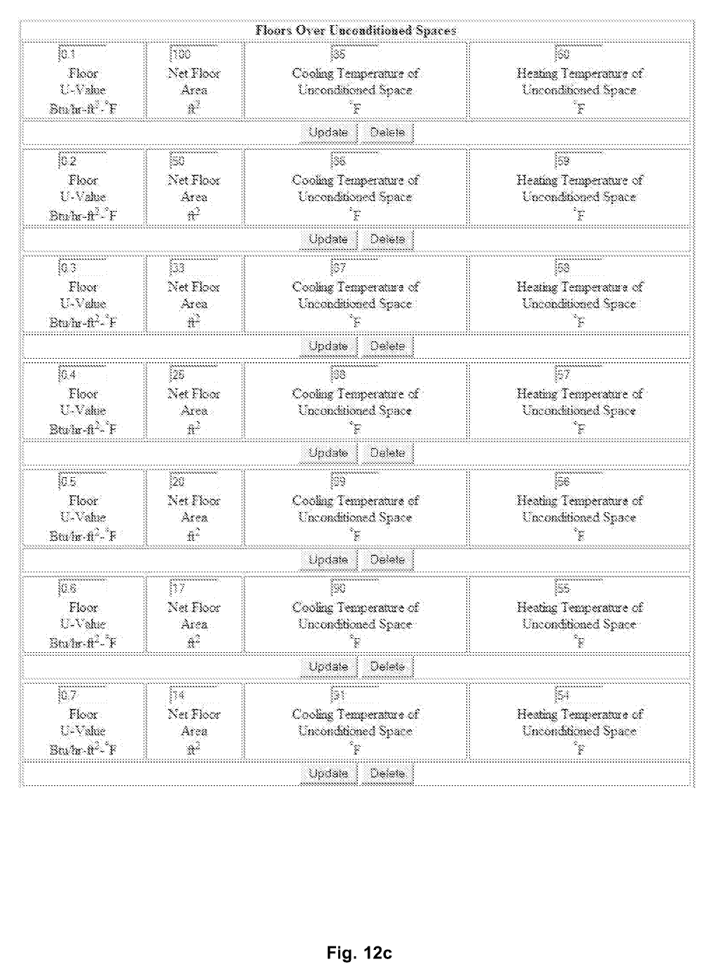

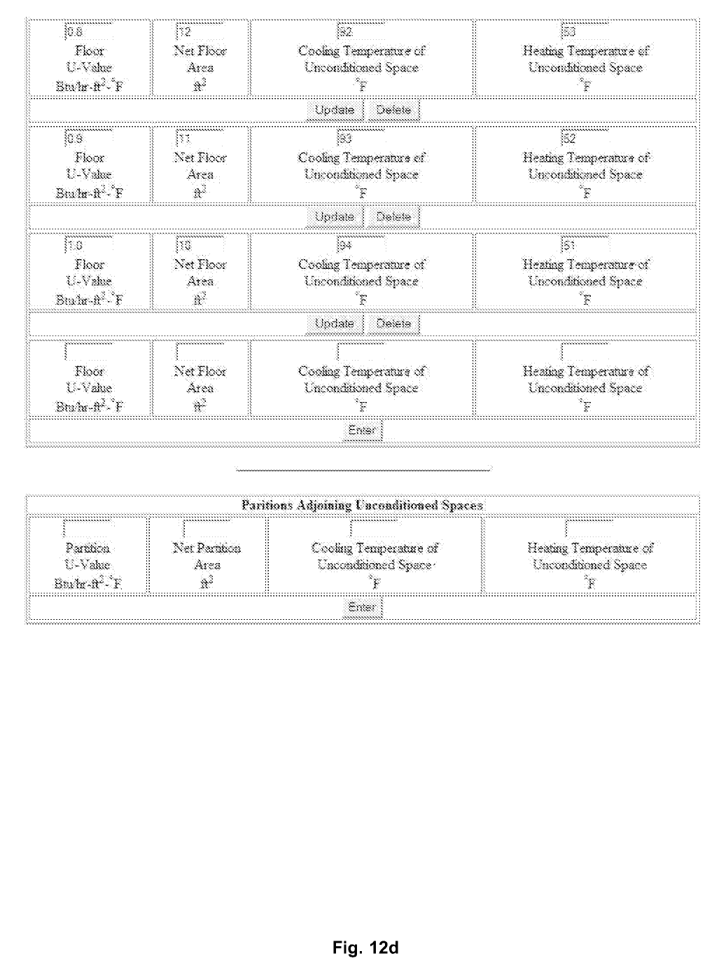

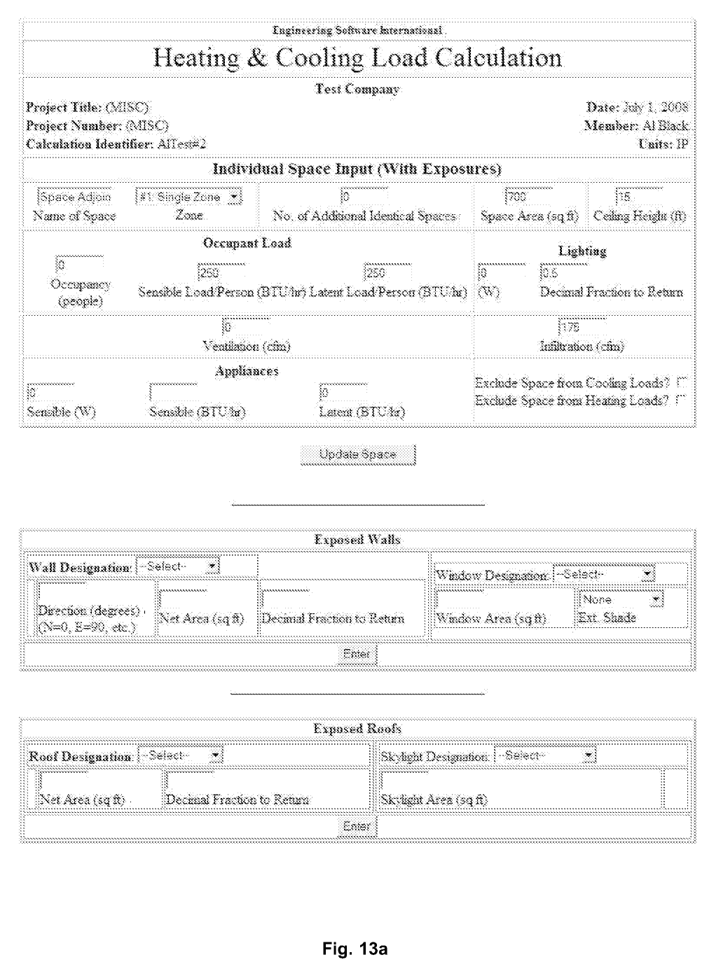

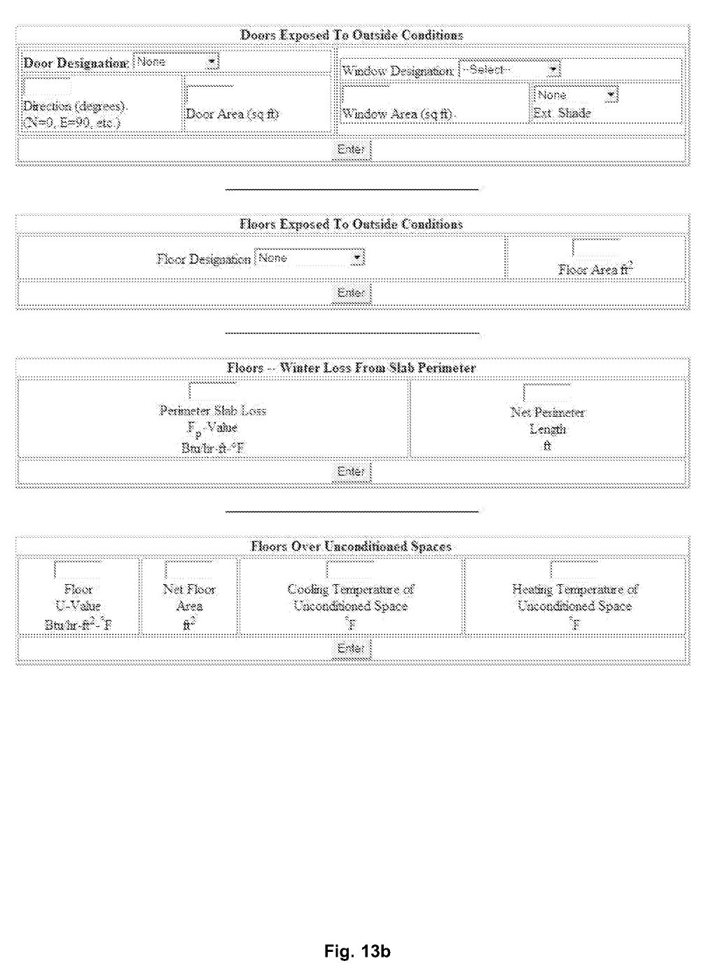

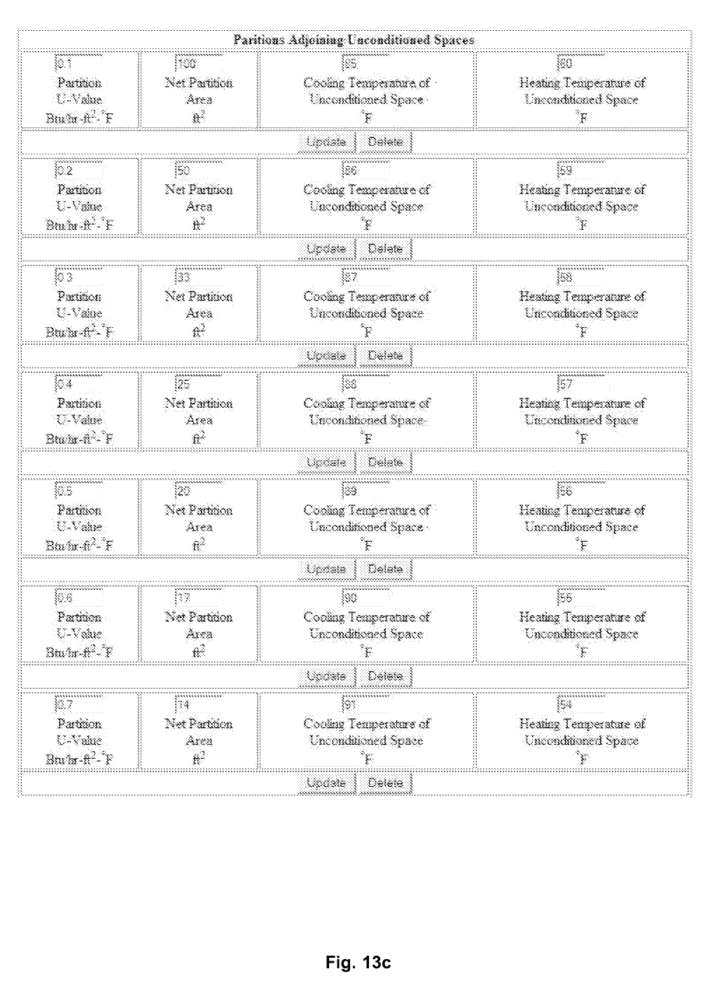

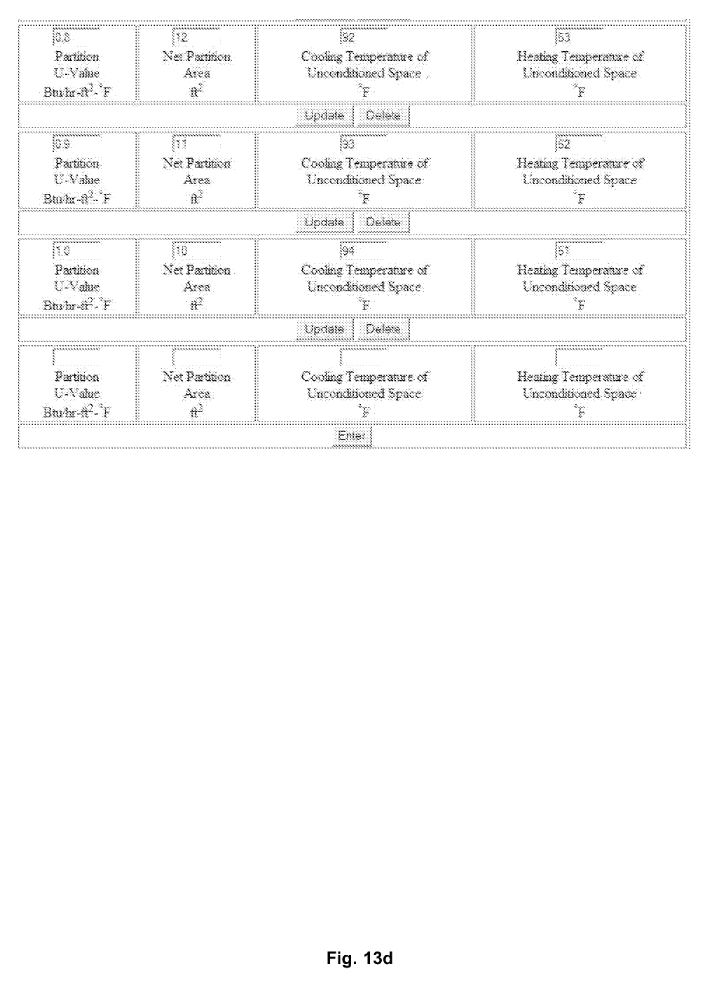

In some configurations, a system of the present teachings can comprise a calculation module for Heating & Cooling Load Calculation which can include an input web page for Individual Space Input (With Exposures) as shown in FIG. 8, and can further comprise data input fields for exposed walls, such as, for example, data input fields for wall designation, direction, net area, decimal fraction to return, as well data input fields for window designation, window areas and estimated shade. Furthermore, this web page can also include data input fields regarding exposed roofs, including roof designation, net area, decimal fraction to return, skylight designation, and skylight area; data input fields regarding doors exposed to outside conditions, including door designation, direction, door area, window area, and estimated shade; input fields regarding floors exposed to outside conditions, including floor designation and floor area; input fields regarding floors—winter loss from slab perimeter, including perimeter slab loss net perimeter length; input fields regarding floors over unconditioned spaces, including floor U-value, net floor area, cooling temperature of unconditioned spaces, and heating temperature of unconditioned spaces; input fields regarding partitions adjoining unconditioned spaces, including partition U-value, net partition area, cooling temperature of unconditioned space, and heating temperature of unconditioned space. Examples of such web pages are provided in FIG. 9, FIG. 10, FIG. 11, FIG. 12 and FIG. 13.

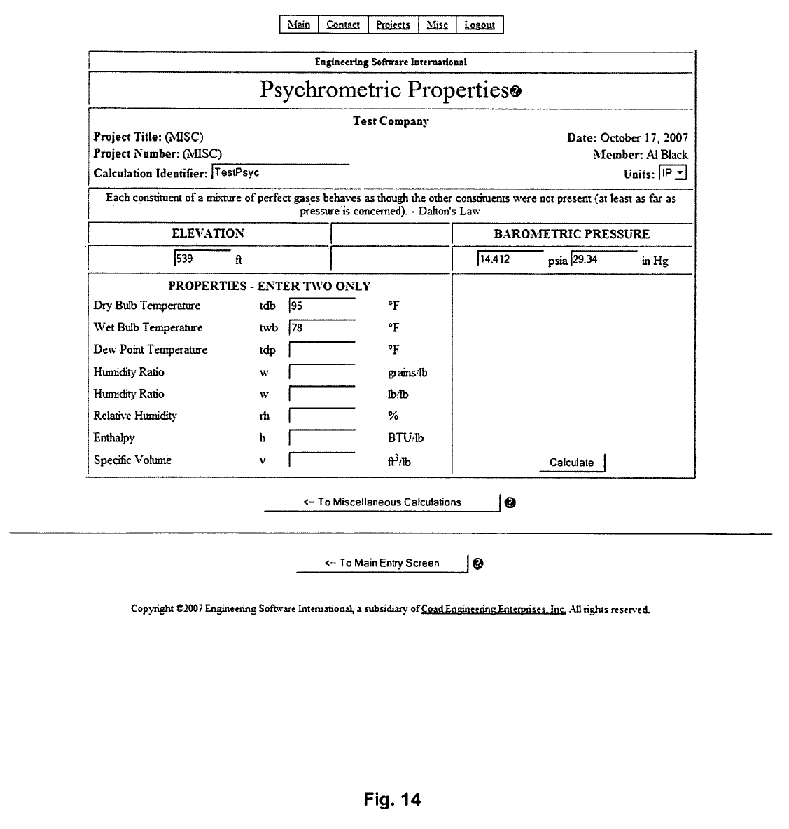

In some configurations, a system of the present teachings can comprise a calculation module for Psychrometric Properties which can include an input web page which can comprise data entry fields for calculation identifier, units, elevation, barometric pressure (which can be in psia or in Hg), and properties including dry bulb temperature, wet bulb temperature, dew point temperature, humidity ratio (grains/lb), humidity ratio (lb/lb) relative humidity, enthalpy, and specific volume (e.g., FIG. 14).

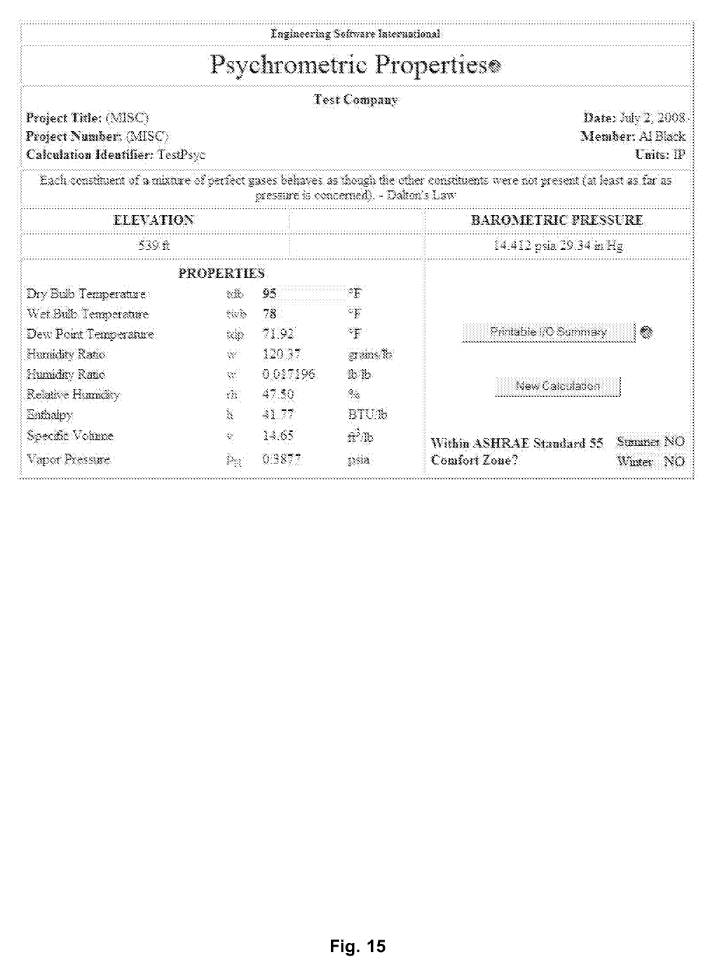

In some configurations, a system of the present teachings can comprise a calculation module for Psychrometric Properties which can include an output web page (e.g., FIG. 15) which can report data entered into an input web page such as a page illustrated in FIG. 14, and can also present inputted or calculated values for properties, such as dry bulb temperature, wet bulb temperature, dew point temperature, humidity ratio (grains/lb), humidity ratio (lb/lb) relative humidity, enthalpy, specific volume, and vapor pressure. In some configurations, such web pages can further specify whether the reported properties are within ASHRAE standard 55 comfort zone in summer or winter.

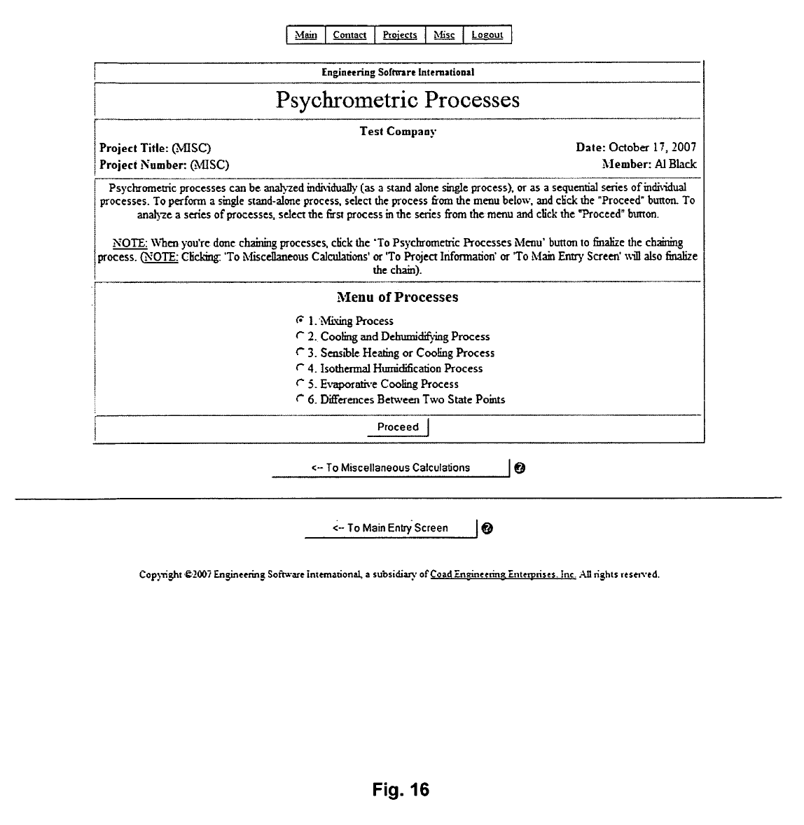

in some configurations, a system of the present teachings can comprise a calculation module for Psychrometric Processes which can include a web page comprising a Menu of Processes (e.g., FIG. 16), with radio buttons for a user to choose from Mixing Process, Cooling and Dehumidifying Process, Sensible Heating or Cooling Process, Isothermal Humidification Process, Evaporative Cooling Process, and/or Differences Between Two State Points.

In some configurations, a system of the present teachings can comprise a calculation module for Psychrometric Processes which can include an input web page which can comprise data entry fields regarding Mixing Process (e.g., FIG. 17). These web pages can include data entry fields for equipment identifier, elevation, barometric pressure (in psia and in Hg), and mixed air flow rate. A web page of these configurations can further comprise data entry fields regarding mixing ratio, which can include, for percent of stream by mass, data entry fields for stream 1 and stream 2; for volume flow rate, data entry fields for stream 1 and stream 2, and for each of stream 1 and stream 2, data entry fields for dry bulb temperature, wet bulb temperature, dew point temperature, humidity ratio (grains/lb), humidity ratio (lb/lb) relative humidity, enthalpy, and specific volume.

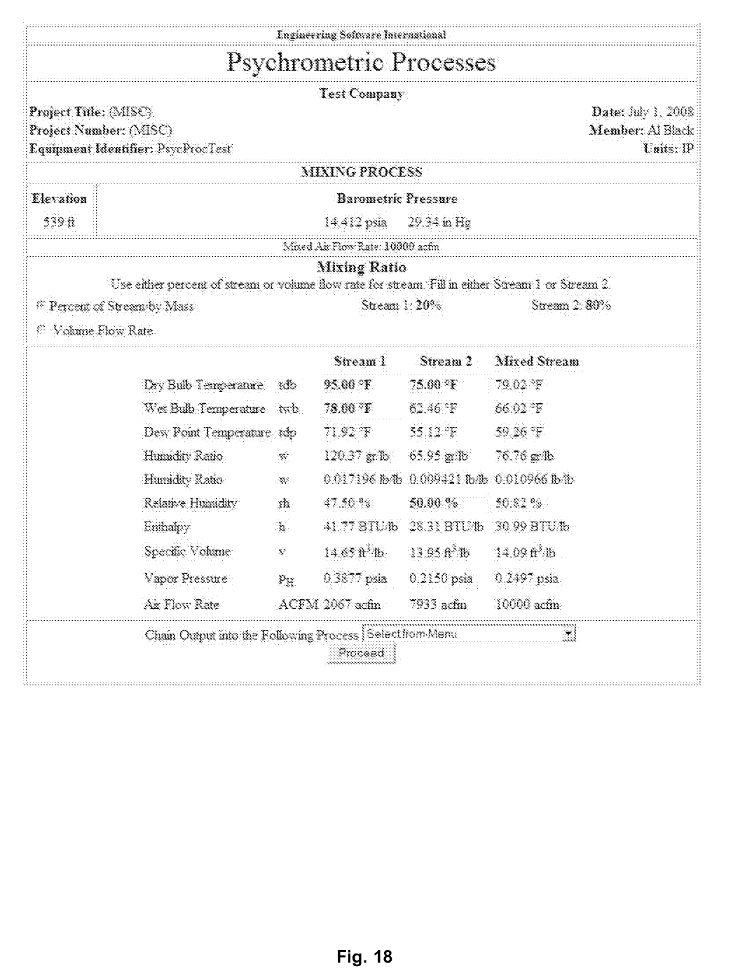

In some configurations, a system of the present teachings can comprise a calculation module for Psychrometric Processes which can include an output web page regarding Mixing Process (e.g., FIG. 18), which comprises data entered into an input web page such as a page presented in FIG. 17, and can also present inputted or calculated values for properties for stream 1, stream 2 and mixed stream, such as dry bulb temperature, wet bulb temperature, dew point temperature, humidity ratio (grains/lb), humidity ratio (lb/lb) relative humidity, enthalpy, specific volume, vapor pressure and air flow rate. An output page of these configurations can further comprise a selection of Chain Output into another process.

In some configurations, a system of the present teachings can comprise a calculation module for Psychrometric Processes which can include an input web page which can comprise data entry fields regarding Cooling and Dehumidifying Process (e.g., FIG. 19). These web pages can include data entry fields for equipment identifier, elevation, barometric pressure (in psia and in Hg), and initial air flow rate. A web page of these configurations can further comprise data entry fields regarding mixing ratio, which can include, for percent of stream by mass, data entry fields for stream 1 and stream 2; for volume flow rate, data entry fields for stream 1 and stream 2, and for each of stream 1 and stream 2, data entry fields for dry bulb temperature, wet bulb temperature, dew point temperature, humidity ratio (grains/lb), humidity ratio (lb/lb) relative humidity, enthalpy, and specific volume.

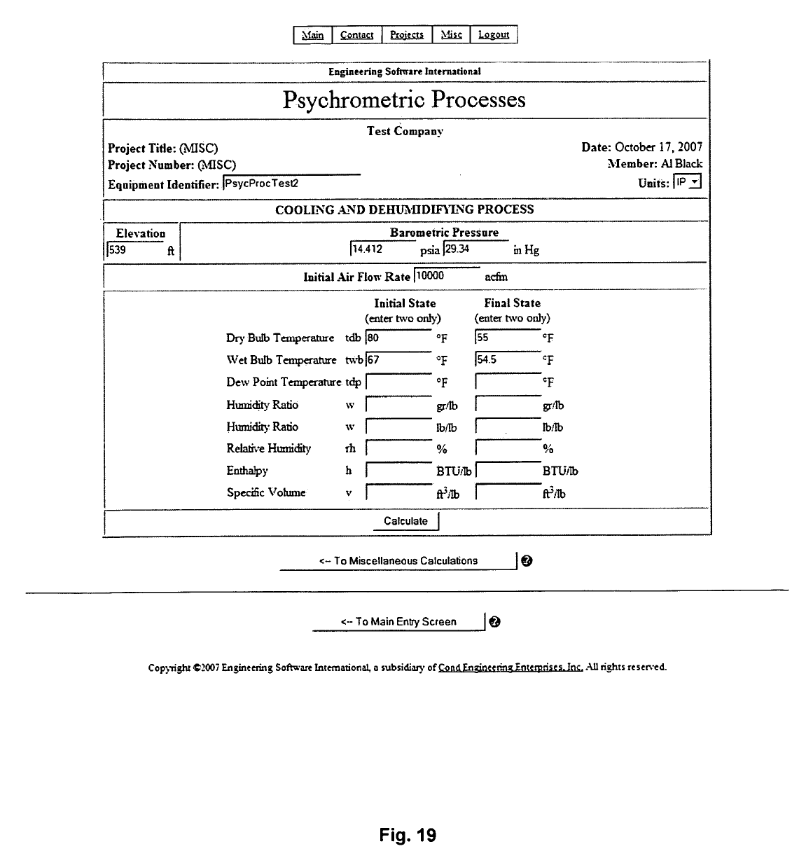

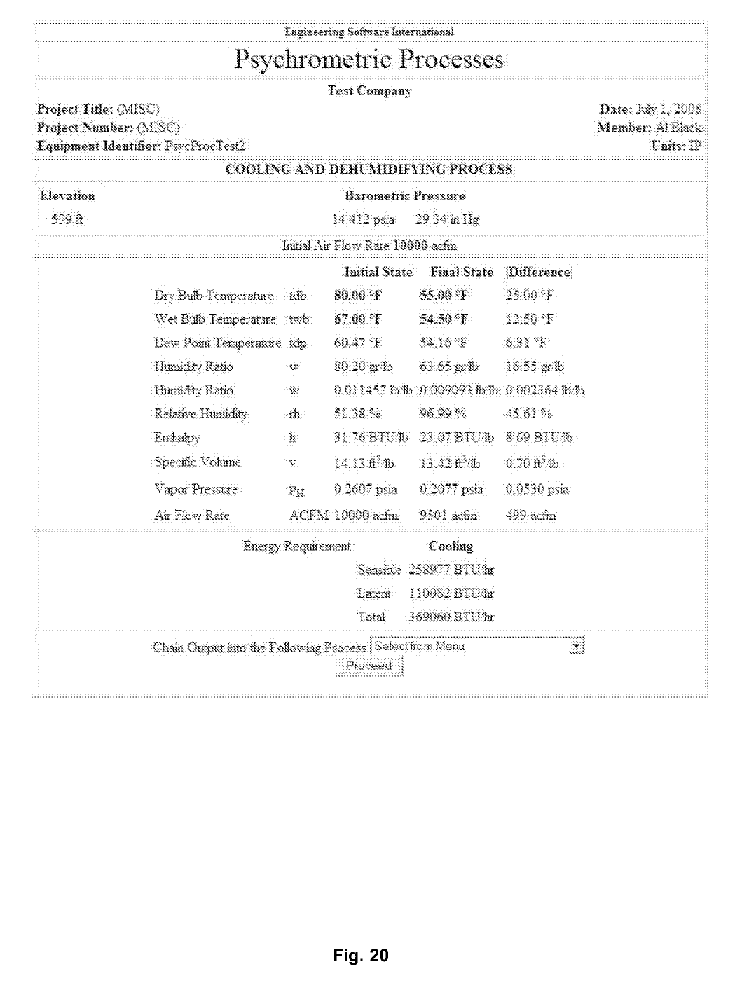

In some configurations, a system of the present teachings can comprise a calculation module for Psychrometric Processes which can include an output web page regarding Cooling and Dehumidifying Process (e.g., FIG. 20), which comprises data entered into an input web page such as a page presented in FIG. 19, and can also present inputted or calculated values for properties for initial state, final state, and difference for dry bulb temperature, wet bulb temperature, dew point temperature, humidity ratio (grains/lb), humidity ratio (lb/lb) relative humidity, enthalpy, and specific volume, vapor pressure and/or air flow rate. A page of these configurations can further include energy requirements, such as energy requirement for cooling, including sensible, latent, and/or total energy requirements for cooling. An output page of these configurations can further comprise a selection of Chain Output into another process.

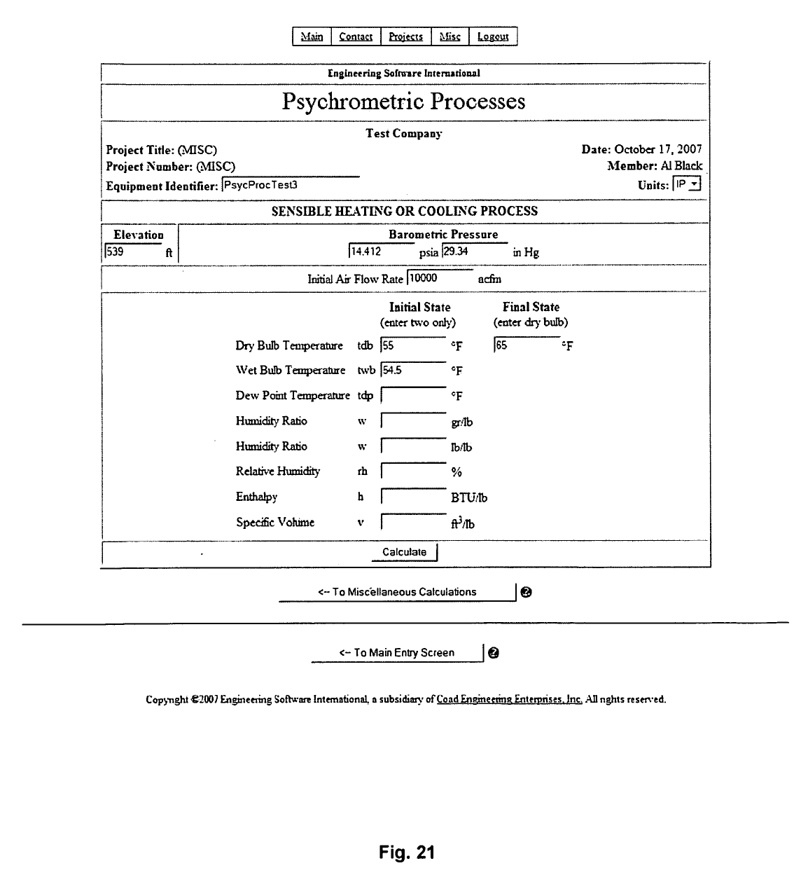

In some configurations, a system of the present teachings can comprise a calculation module for Psychrometric Processes which can include an input web page which can comprise data entry fields regarding Sensible Heating or Cooling Process (e.g., FIG. 21). These web pages can include data entry fields for equipment identifier, units, elevation, barometric pressure (in psia and in Hg), and initial air flow rate. A web page of these configurations can further comprise data entry fields for initial and/or final state, regarding dry bulb temperature, wet bulb temperature, dew point temperature, humidity ratio (grains/lb), humidity ratio (lb/lb) relative humidity, enthalpy, and/or specific volume.

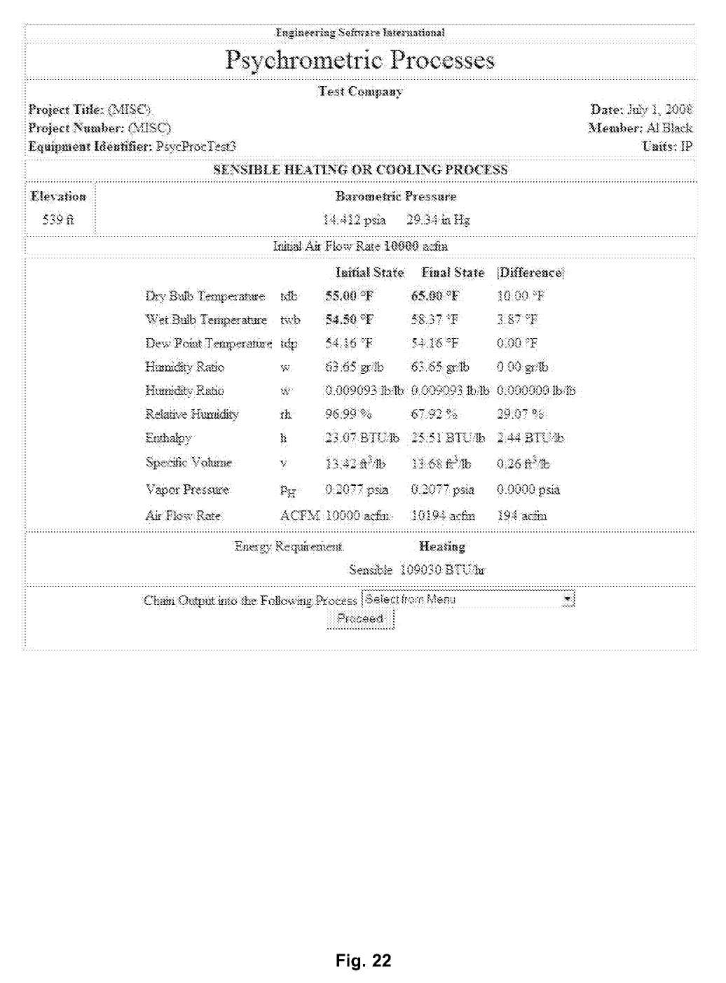

In some configurations, a system of the present teachings can comprise a calculation module for Psychrometric Processes which can include an output web page regarding Sensible Heating or Cooling Process (e.g., FIG. 22), which comprises data entered into an input web page such as a page represented in FIG. 21, and can also present inputted or calculated values for properties for initial state, final state, and difference for dry bulb temperature, wet bulb temperature, dew point temperature, humidity ratio (grains/lb), humidity ratio (lb/lb) relative humidity, enthalpy, and specific volume, vapor pressure and/or air flow rate. A page of these configurations can further include energy requirements, such as energy requirement for heating, such as sensible energy requirements for heating. An output page of these configurations can further comprise a selection of Chain Output into another process.

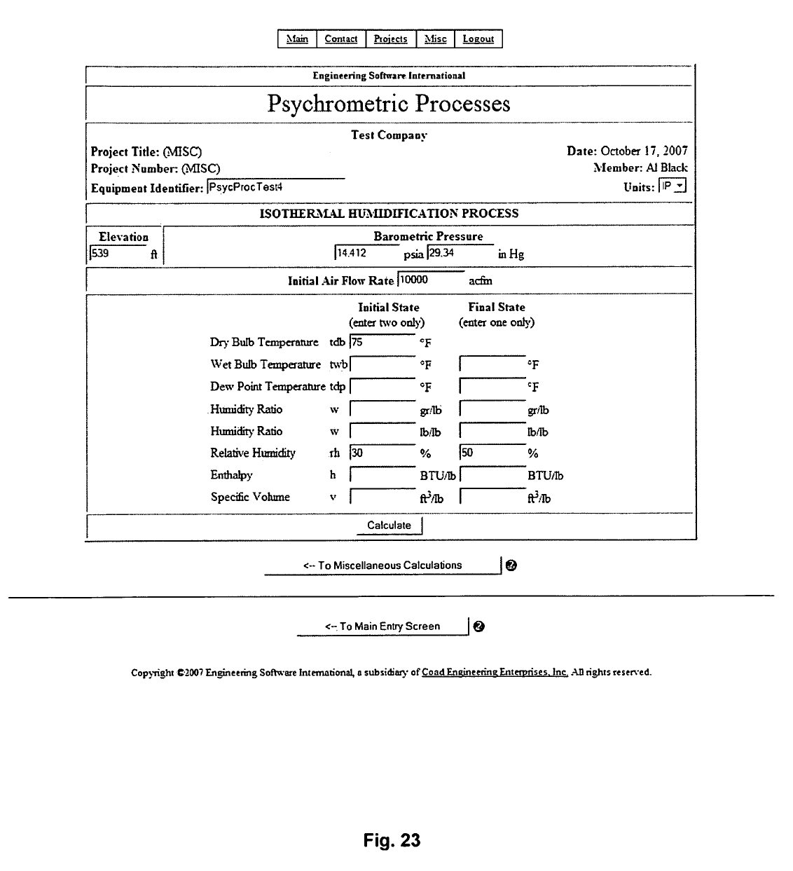

In some configurations, a system of the present teachings can comprise a calculation module for Psychrometric Processes which can include an input web page which can comprise data entry fields regarding Isothermal Humidification Process (e.g., FIG. 23). These web pages can include data entry fields for equipment identifier, units, elevation, barometric pressure (in psia and in Hg), and initial air flow rate. A web page of these configurations can further comprise data entry fields for initial and/or final state, regarding dry bulb temperature, wet bulb temperature, dew point temperature, humidity ratio (grains/lb), humidity ratio (lb/lb) relative humidity, enthalpy, and/or specific volume.

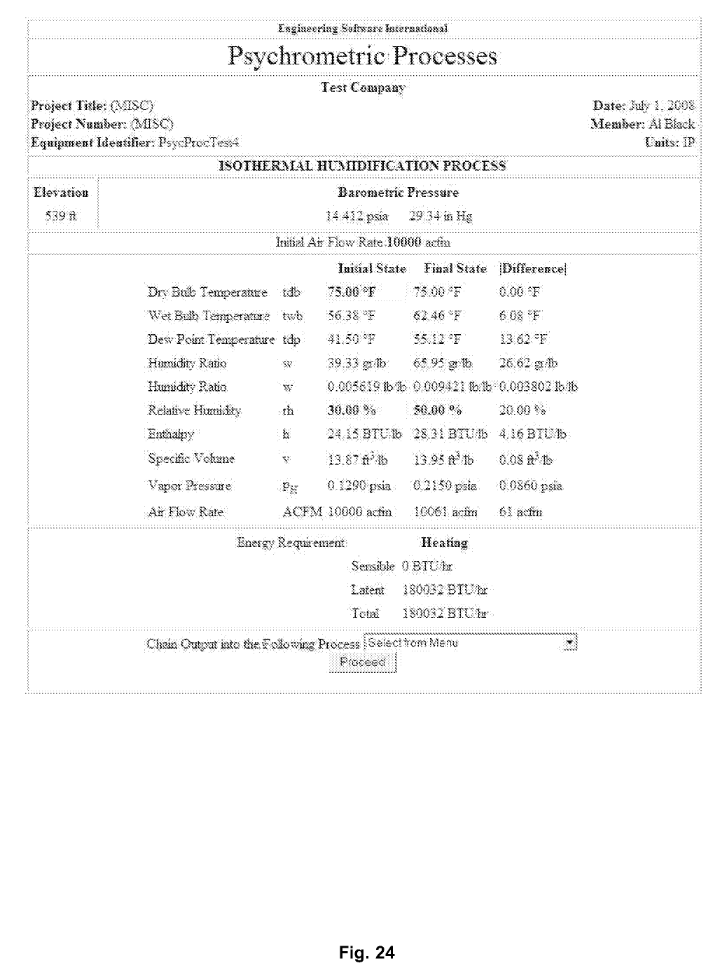

In some configurations, a system of the present teachings can comprise a calculation module for Psychrometric Processes which can include an output web page regarding Isothermal Humidification Process (e.g., FIG. 24), which comprises data entered into an input web page such as a page represented in FIG. 23, and can also present inputted or calculated values for properties for initial state, final state, and difference for dry bulb temperature, wet bulb temperature, dew point temperature, humidity ratio (grains/lb), humidity ratio (lb/lb) relative humidity, enthalpy, and specific volume, vapor pressure and/or air flow rate. A page of these configurations can further include energy requirements, such as energy requirement for heating, such as sensible energy requirements for heating, including requirements for sensible heating, latent heating and total heating. An output page of these configurations can further comprise a selection of Chain Output into another process.

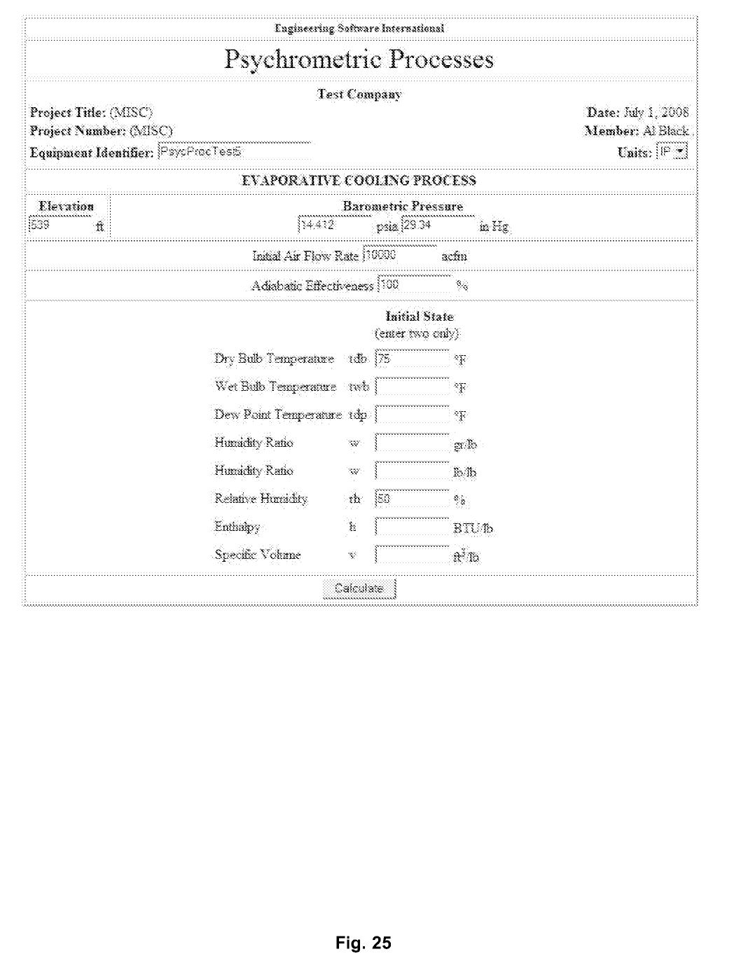

In some configurations, a system of the present teachings can comprise a calculation module for Psychrometric Processes which can include an input web page which can comprise data entry fields regarding Evaporative Cooling Process (e.g., FIG. 25). These web pages can include data entry fields for equipment identifier, units, elevation, barometric pressure (in psia and in Hg), initial air flow rate, and adiabatic effectiveness. A web page of these configurations can further comprise data entry fields for initial state, regarding dry bulb temperature, wet bulb temperature, dew point temperature, humidity ratio (grains/lb), humidity ratio (lb/lb) relative humidity, enthalpy, and/or specific volume.

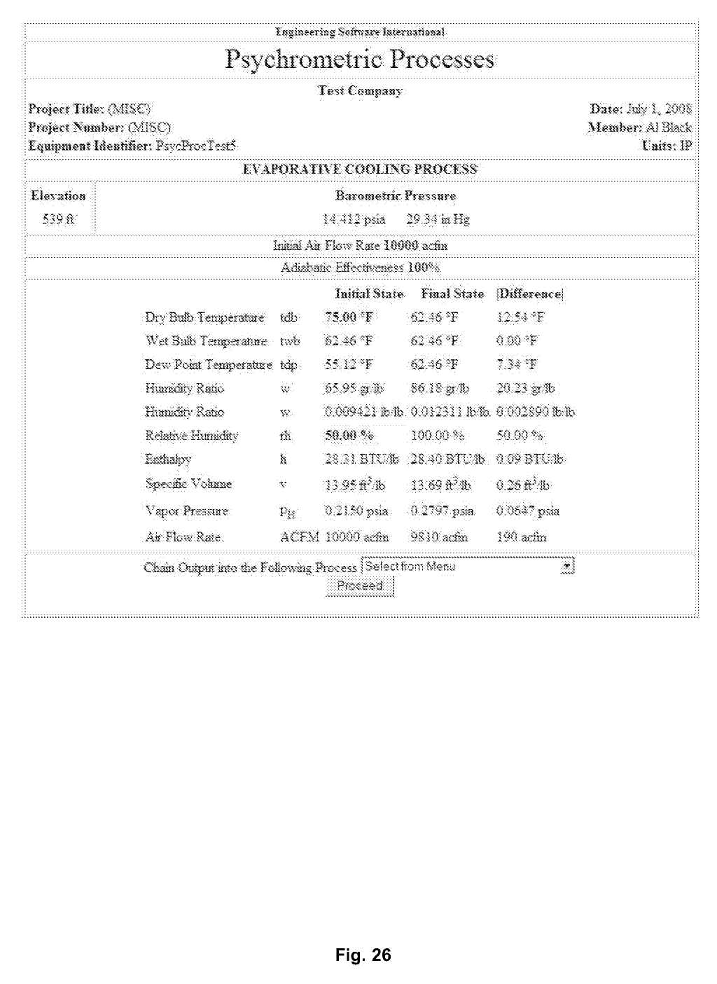

In some configurations, a system of the present teachings can comprise a calculation module for Psychrometric Processes which can include an output web page regarding Evaporative Cooling Process (e.g., FIG. 26), which can comprise data entered into an input web page such as a page represented in FIG. 25, and can also present inputted or calculated values for properties for initial state, final state, and difference for dry bulb temperature, wet bulb temperature, dew point temperature, humidity ratio (grains/lb), humidity ratio (lb/lb) relative humidity, enthalpy, and specific volume, vapor pressure and/or air flow rate. An output page of these configurations can further comprise a selection of Chain Output into another process.

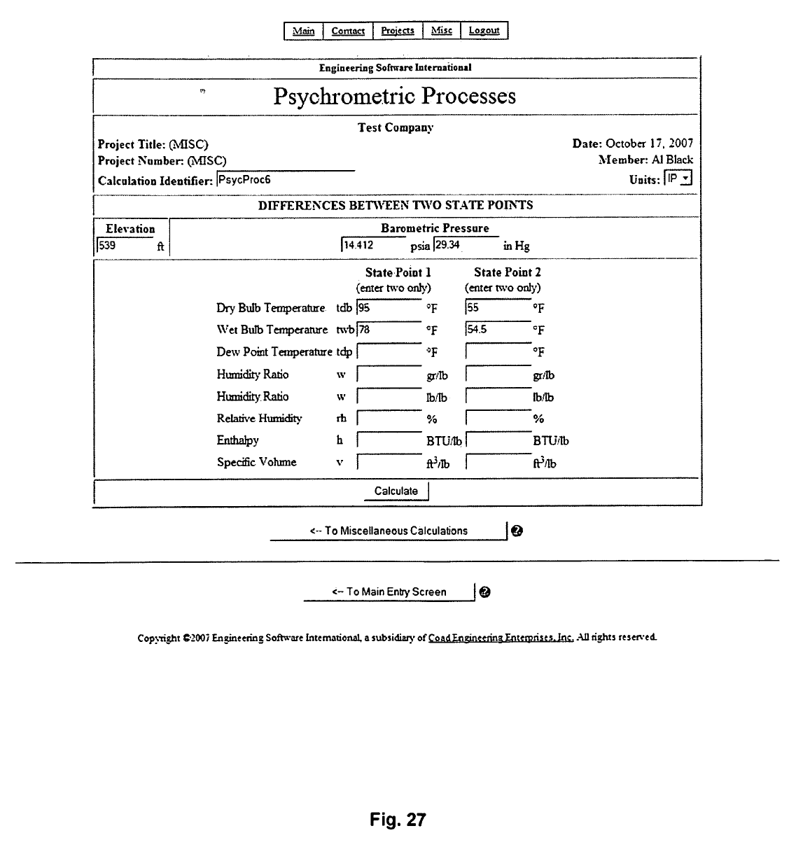

In some configurations, a system of the present teachings can comprise a calculation module for Psychrometric Processes which can include an input web page which can comprise data entry fields regarding differences between two state points (e.g., FIG. 27). These web pages can include data entry fields for calculation identifier, units, elevation, and barometric pressure (in psia and in Hg). A web page of these configurations can further comprise data entry fields for each of two state points (State Point 1 and State Point 2), regarding dry bulb temperature, wet bulb temperature, dew point temperature, humidity ratio (grains/lb), humidity ratio (lb/lb) relative humidity, enthalpy, and/or specific volume.

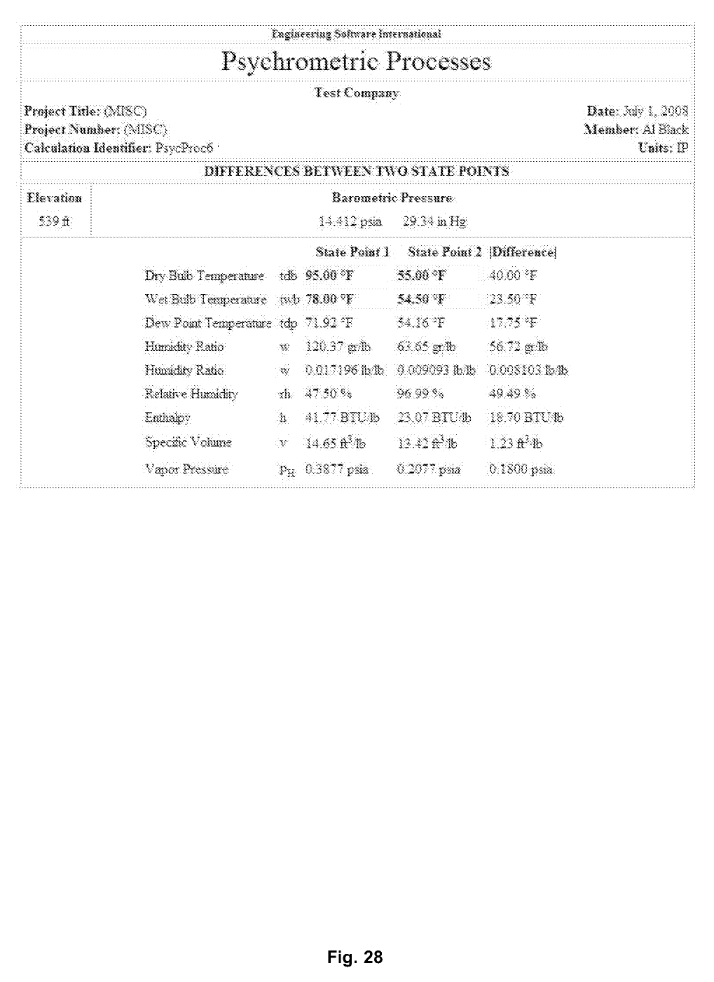

In some configurations, a system of the present teachings can comprise a calculation module for Psychrometric Processes which can include an output web page regarding differences between two state points (e.g., FIG. 28), which comprises data entered into an input web page such as a page represented in FIG. 27, and can also present inputted or calculated values for properties for initial state, final state, and difference for dry bulb temperature, wet bulb temperature, dew point temperature, humidity ratio (grains/lb), humidity ratio (lb/lb) relative humidity, enthalpy, and specific volume, and/or vapor. An output page of these configurations can further comprise a selection of Chain Output into another process.

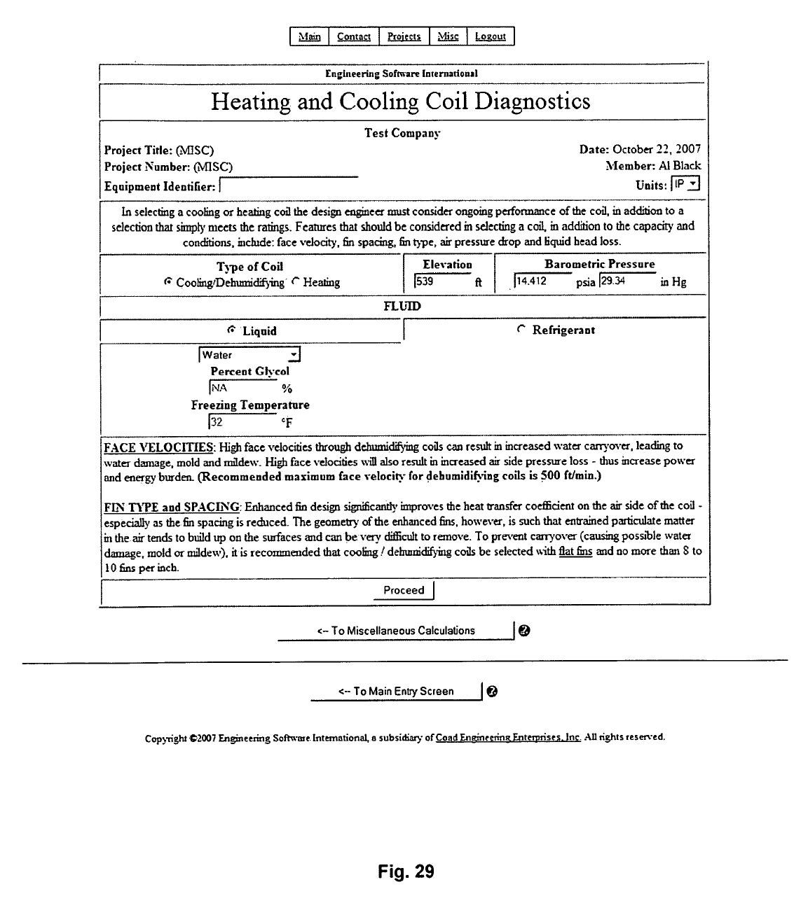

In some configurations, a system of the present teachings can comprise a calculation module for Heating and Cooling Coil Diagnostics regarding Fluid. A web page for this calculation module (e.g., FIG. 29) can include data entry fields for equipment identifier, units, elevation, and barometric pressure (in psia and in Hg), and can further include buttons regarding type of coil (cooling/dehumidifying or heating). A web page of these configurations can further comprise buttons for fluid (either liquid or refrigerant). In some configurations, if liquid is selected for fluid, data entry fields appear for type of liquid (e.g., water), percent glycol, and freezing temperature.

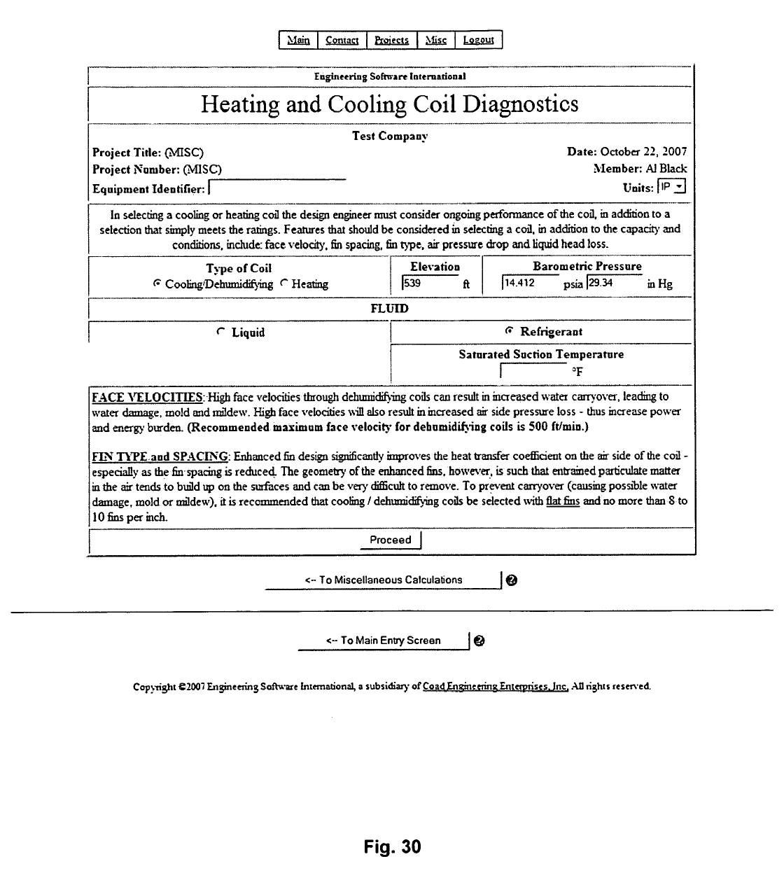

In some configurations, a system of the present teachings can comprise a calculation module for Heating and Cooling Coil Diagnostics regarding Fluid. A web page for this calculation module (e.g., FIG. 30) can include data entry fields for equipment identifier, units, elevation, and barometric pressure (in psia and in Hg), and can further include buttons regarding type of coil (cooling/dehumidifying or heating). A web page of these configurations can further comprise buttons for fluid (either liquid or refrigerant). In some configurations, if Refrigerant is selected for fluid, a data entry field can appear for saturated suction temperature.

In some configurations, a system of the present teachings can comprise a calculation module regarding Cooling/dehumidifying Coil Diagnostics, in which a web page for this calculation module wherein the tube side is liquid water (e.g., FIG. 31) can comprise data input fields regarding Physical Characteristics of Coil. These can include, for example, data input fields for coil height, coil width, rows, circuiting, fin type, fins per inch, and fin spacing. A web page of this module can further comprise data input fields regarding entering conditions, which can include, for example, data input fields for air flow rate actual (ACFM), entering air dry bulb temperature (EDB), entering air wet bulb temperature, (EWB), and/or entering liquid temperature (ELT). A web page of this module can further comprise data input fields regarding performance conditions, which can include, for example, data input fields for leaving dry air bulb temperature (LDB), leaving liquid temperature (LLT), and/or liquid flow rate (GPM).

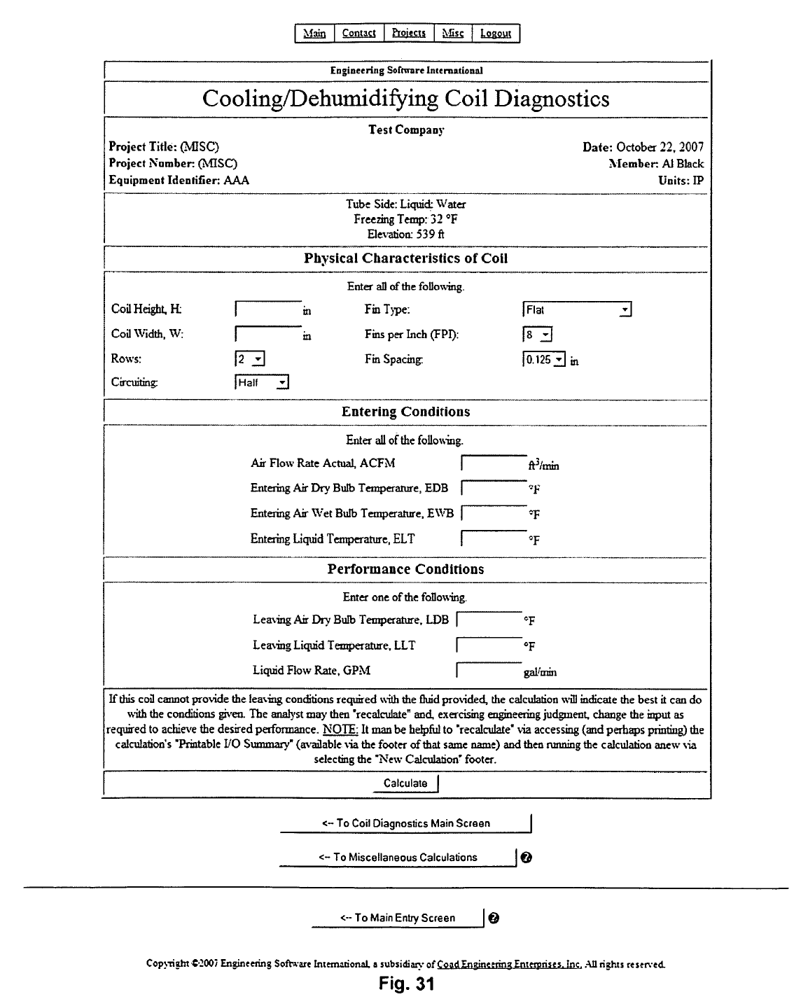

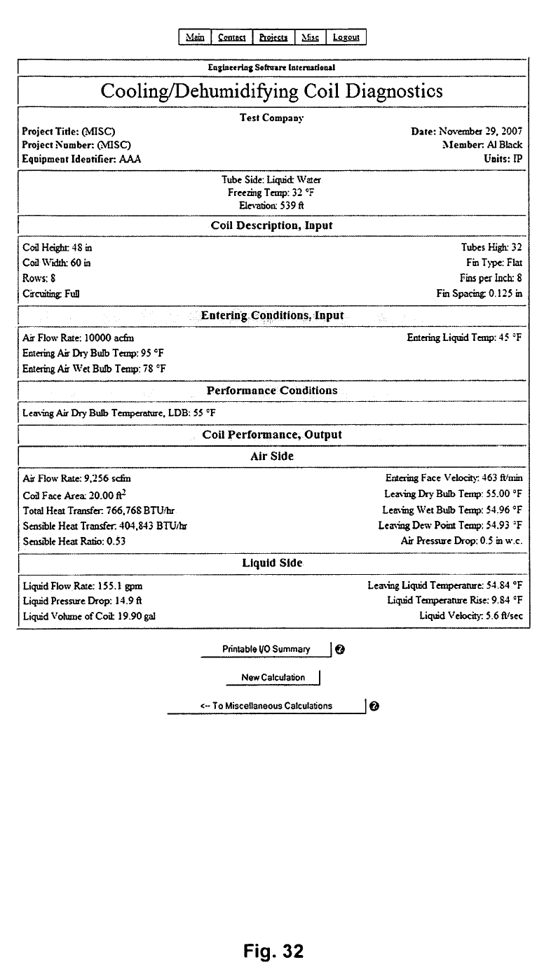

In some configurations, a system of the present teachings can comprise a calculation module regarding Cooling/dehumidifying Coil Diagnostics, in which an output web page for this calculation module for which the tube side liquid is water (e.g., FIG. 32) can comprise input data regarding coil description, entering conditions and performance conditions such as data entered on a web page exemplified in FIG. 31, and can further provide information for coil performance output, such as, for air side: one or more of air flow rate, coil face area, total heat transfer, sensible heat transfer, sensible heat ratio, entering face velocity, leaving dry bulb temperature, leaving wet bulb temperature, leaving dew point temperature, and/or air pressure drop; and for liquid side: one or more of liquid flow rate, liquid pressure drop, liquid volume of coil, leaving liquid temperature, liquid temperature rise, and liquid velocity.

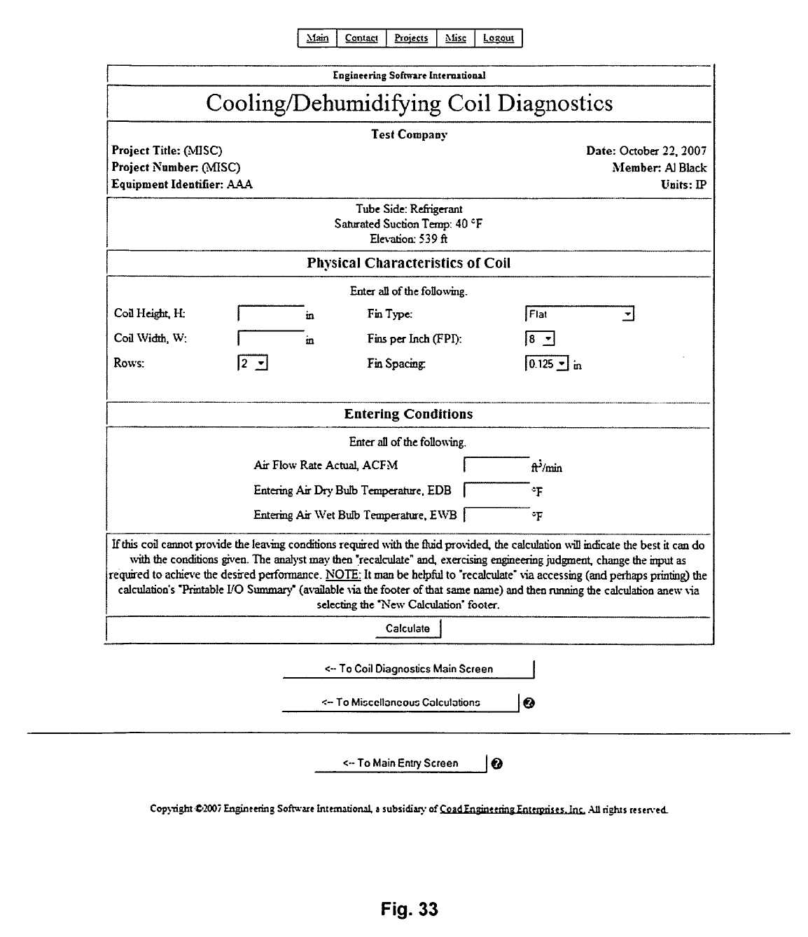

In some configurations, a system of the present teachings can comprise a calculation module regarding Cooling/dehumidifying Coil Diagnostics, in which a web page for this calculation module wherein the tube side is refrigerant, (e.g., FIG. 33) can comprise data input fields regarding Physical Characteristics of Coil. These can include, for example, data input fields for coil height, coil width, rows, circuiting, fin type, fins per inch, and fin spacing. A web page of this module can further comprise data input fields regarding entering conditions, which can include, for example, data input fields for air flow rate actual (ACFM), entering air dry bulb temperature (EDB), and/or entering air wet bulb temperature (EWB).

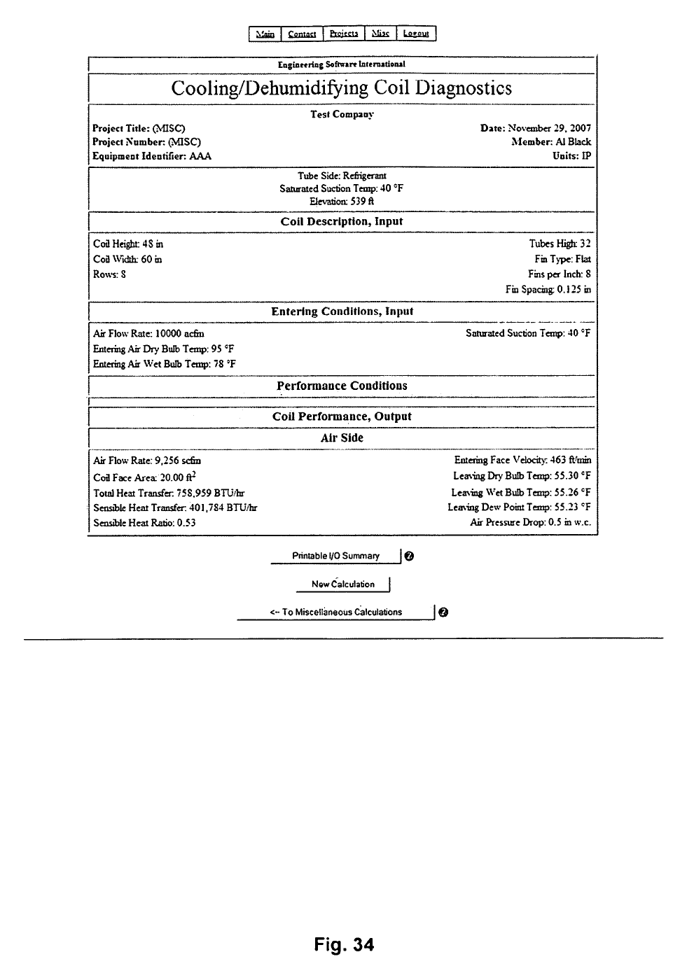

In some configurations, a system of the present teachings can comprise a calculation module regarding Cooling/dehumidifying Coil Diagnostics, in which an output web page for this calculation module for tube side refrigerant (e.g., FIG. 34) can comprise input data regarding coil description, entering conditions and performance conditions such as data entered on a web page exemplified in FIG. 33, and can further provide information for coil performance output, such as, for air side: one or more of air flow rate, coil face area, total heat transfer, sensible heat transfer, sensible heat ratio, entering face velocity, leaving dry bulb temperature, leaving wet bulb temperature, leaving dew point temperature, and/or air pressure drop.

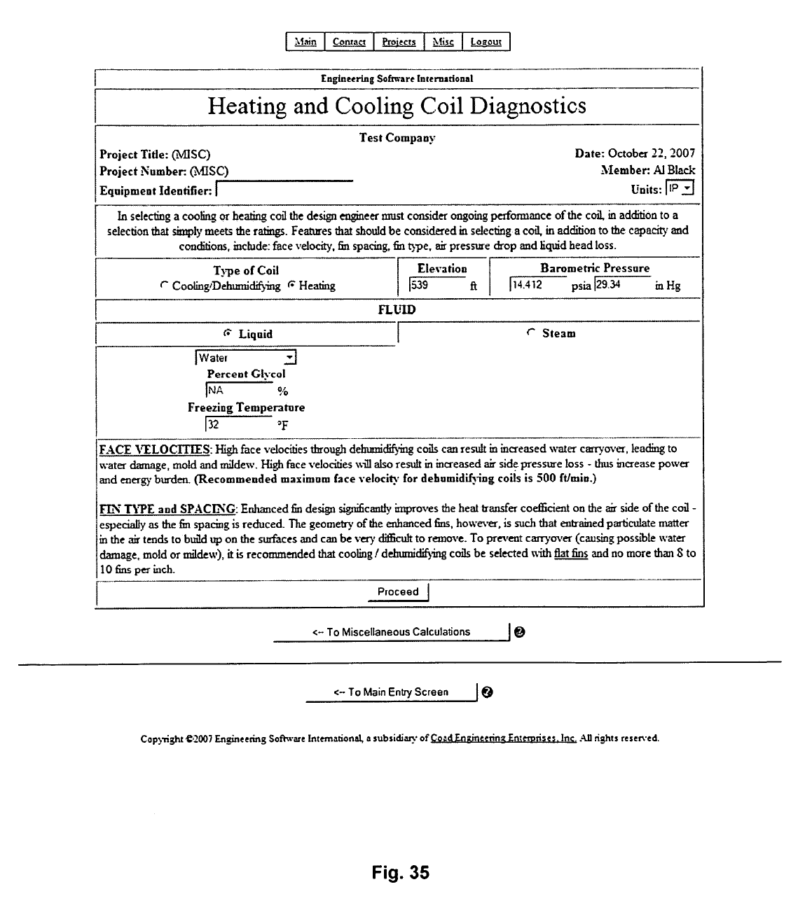

In some configurations, a system of the present teachings can comprise a calculation module for Heating and Cooling Coil Diagnostics including choice of Fluid. A web page for this calculation module (e.g., FIG. 35) can include data entry fields for equipment identifier, units, elevation, and barometric pressure (in psia and in Hg), and can further include buttons regarding type of coil (cooling/dehumidifying or heating). In some configurations, if ‘heating’ is selected for type of coil, a web page can further comprise buttons for fluid (either liquid or steam). If ‘liquid’ is selected for fluid, data entry fields can appear for type of liquid (e.g., water), percent glycol, and freezing temperature.

In some configurations, a system of the present teachings can comprise a calculation module regarding Heating Coil Diagnostics, in which a web page for this calculation module wherein the tube side is liquid water (e.g., FIG. 36) can comprise data input fields regarding Physical Characteristics of Coil. These can include, for example, data input fields for coil height, coil width, rows, circuiting, fin type, fins per inch, and fin spacing. A web page of this module can further comprise data input fields regarding entering conditions, which can include, for example, data input fields for air flow rate actual (ACFM), entering air temperature (EAT), and/or entering liquid temperature (ELT). A web page of this module can further comprise data input fields regarding performance conditions, which can include, for example, data input fields for leaving air temperature (LAT), leaving liquid temperature (LLT), and/or liquid flow rate (GPM).

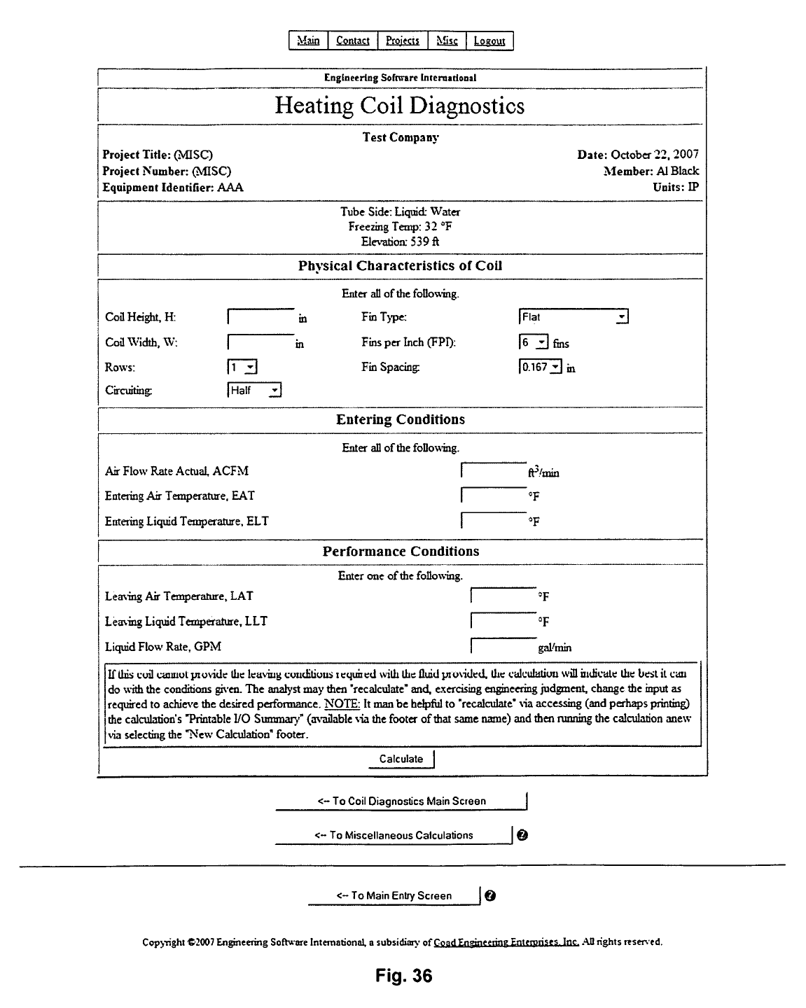

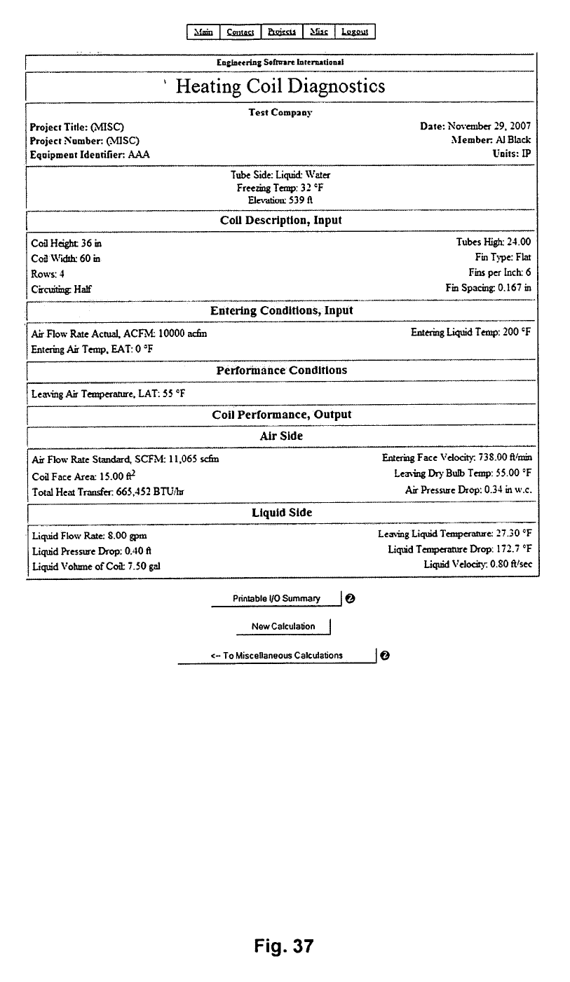

In some configurations, a system of the present teachings can comprise a calculation module regarding Heating Coil Diagnostics, in which an output web page for this calculation module for which the tube side liquid is water (e.g., FIG. 37) can comprise input data regarding coil description, entering conditions and performance conditions such as data entered on a web page exemplified in FIG. 36, and can further provide information for coil performance output, such as, for air side: one or more of air flow rate standard (SCFM), coil face area, total heat transfer, entering face velocity, leaving dry bulb temperature, and/or air pressure drop; and for liquid side: one or more of liquid flow rate, liquid pressure drop, liquid volume of coil, leaving liquid temperature, liquid temperature drop, and liquid velocity.

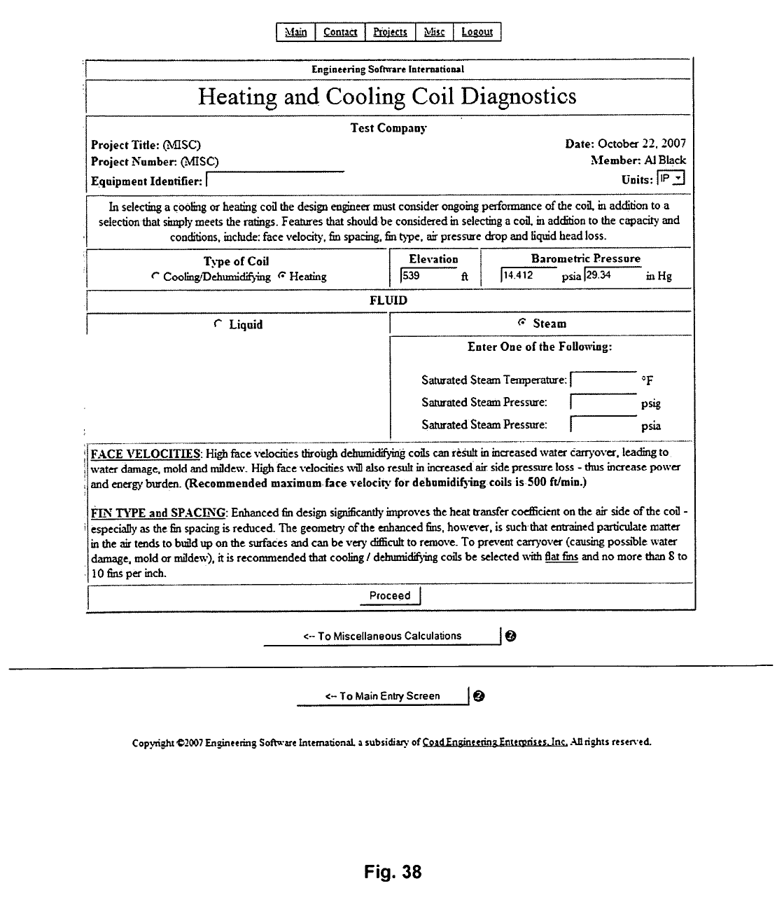

In some configurations, a system of the present teachings can comprise a calculation module on Heating and Cooling Coil Diagnostics, in which a web page for this calculation module (e.g., FIG. 38) can comprise data buttons for type of coil (cooling/dehumidifying or heating), and data input fields for equipment identifier, elevation, and barometric pressure. A web page of these configurations can further comprise buttons for Fluid, either liquid or steam. If a user selects ‘heating’ for type of coil and ‘steam’ for fluid, the web page can comprise data input fields for saturated, saturated steam pressure in psig, and/or saturated steam pressure in psia.

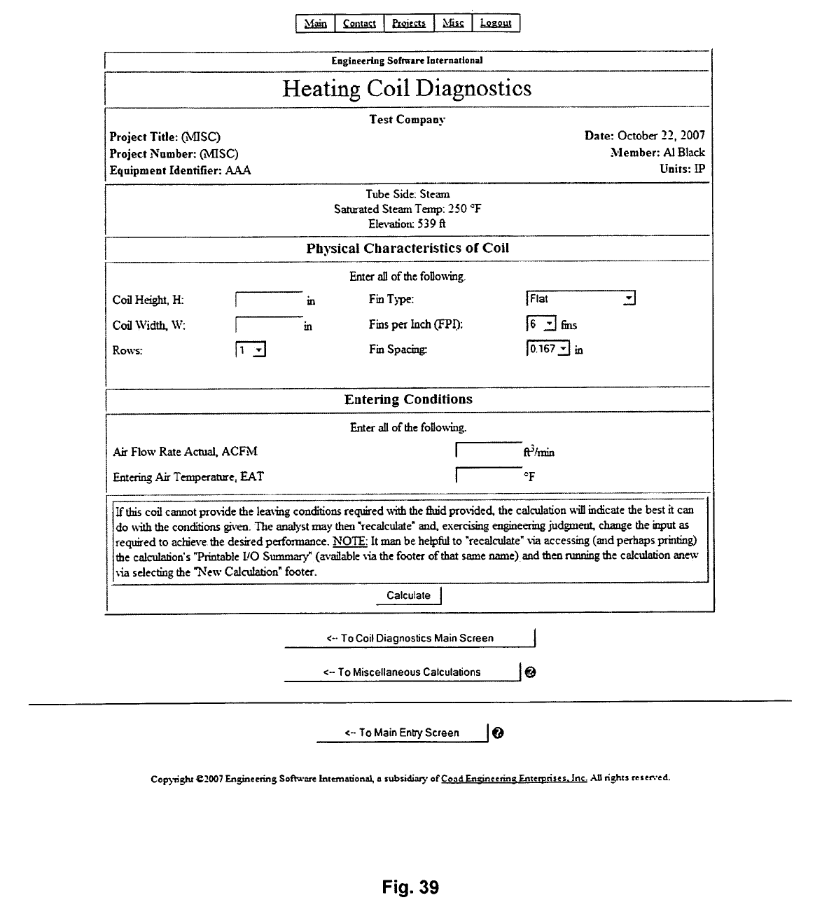

In some configurations, a system of the present teachings can comprise a calculation module regarding Heating Coil Diagnostics, in which a web page for this calculation module wherein the tube side is steam (e.g., FIG. 39) can comprise data input fields regarding Physical Characteristics of Coil. These can include, for example, data input fields for coil height, coil width, rows, fin type, fins per inch, and fin spacing. A web page of this module can further comprise data input fields regarding entering conditions, which can include, for example, data input fields for air flow rate actual (ACFM) and/or entering air temperature (EAT).

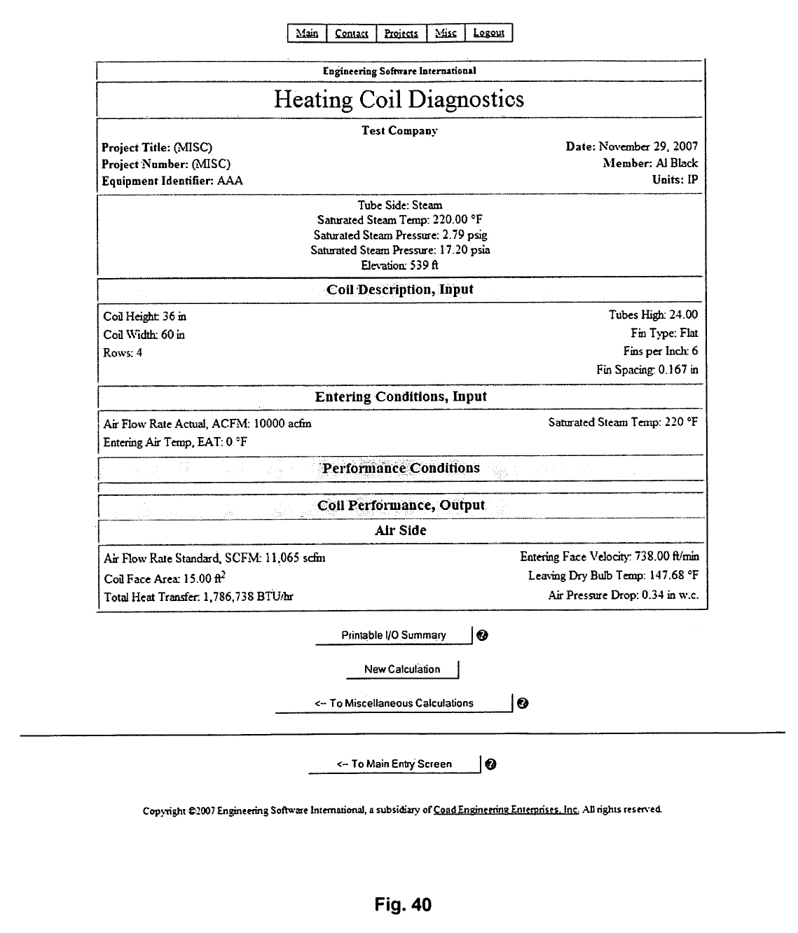

In some configurations, a system of the present teachings can comprise a calculation module regarding Heating Coil Diagnostics, in which an output web page for this calculation module for which the tube side is steam (e.g., FIG. 40) can comprise input data regarding coil description, entering conditions and performance conditions such as data entered on a web page exemplified in FIG. 39, and can further provide information for coil performance output, such as, for air side: one or more of air flow rate standard (SCFM), coil face area, total heat transfer, entering face velocity, leaving dry bulb temperature, and/or air pressure drop.

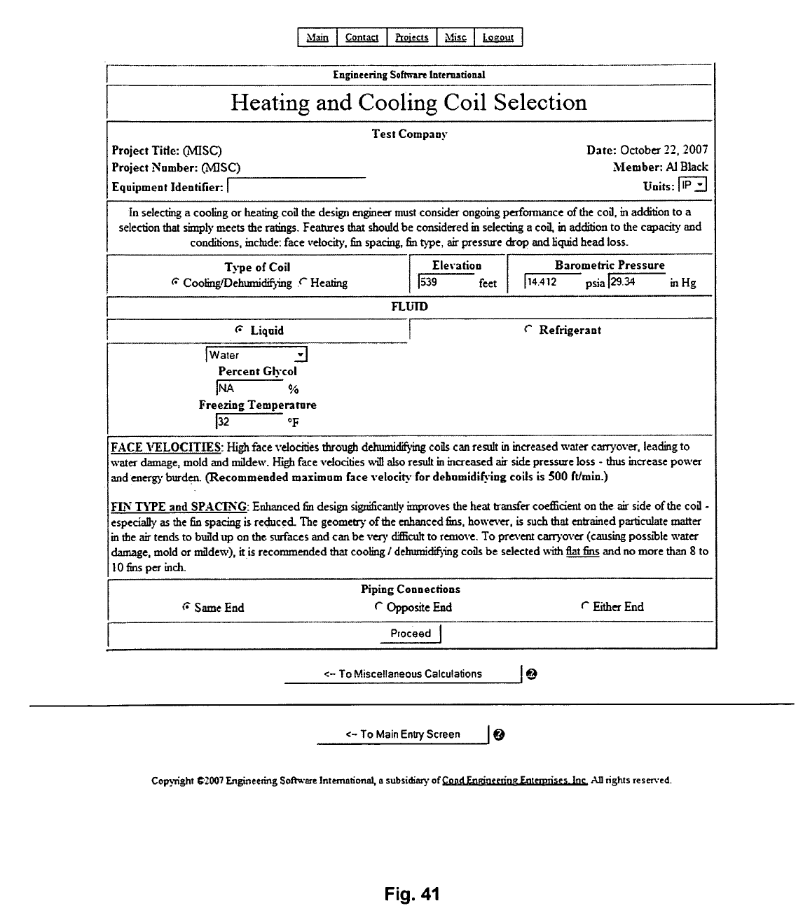

In some configurations, a system of the present teachings can comprise a calculation module on Heating and Cooling Coil Selection, in which a web page for this calculation module (e.g., FIG. 41) can comprise data buttons for type of coil (cooling/dehumidifying or heating), and data input fields for equipment identifier, units, elevation, and barometric pressure. A web page of these configurations can further comprise buttons for Fluid, either liquid or refrigerant. If a user selects ‘cooling’ for type of coil and ‘liquid’ for fluid, the web page can comprise data input fields for liquid type (e.g., water), percent glycol and/or freezing temperature. In some configurations, a web page can further comprise buttons regarding piping connections, for which a user can select amongst same end, opposite end or either end.

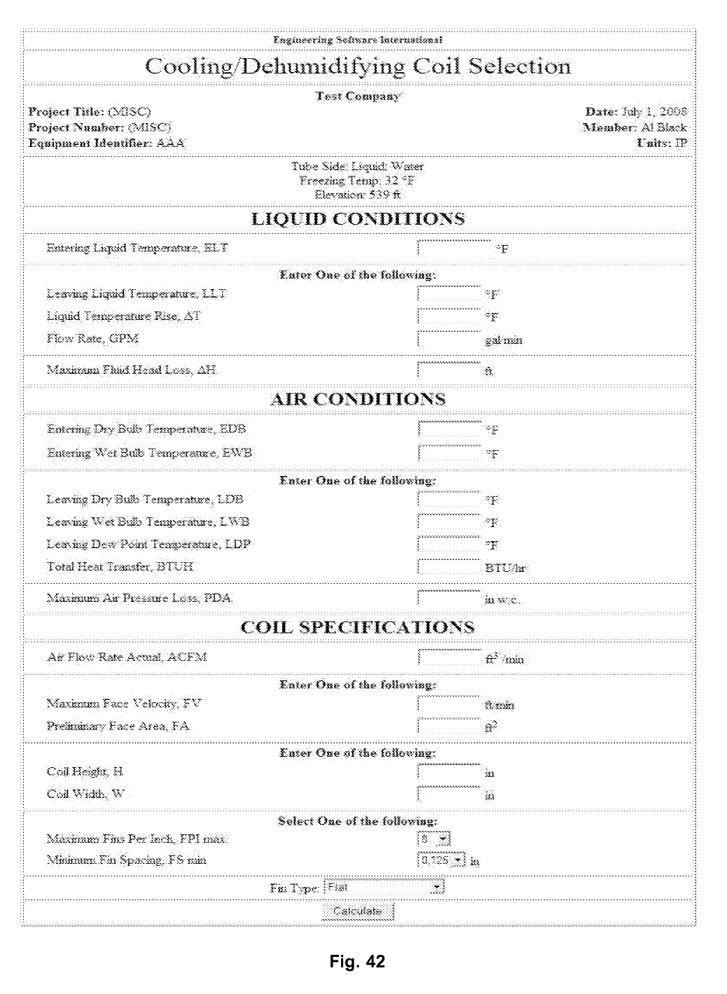

In some configurations, a system of the present teachings can comprise a calculation module regarding Cooling/dehumidifying Coil Selection, in which an output web page for this calculation module for which the tube side liquid is water (e.g., FIG. 42) can comprise input data regarding Liquid Conditions, Air Conditions and Coil Specifications. For Liquid Conditions, data input fields can be included for entering liquid temperature (ELT), leaving liquid temperature (LLT), liquid temperature rise (ΔT), flow rate (GPM), and/or maximum fluid head loss (ΔH). For Air Conditions, data input fields can be included for entering dry bulb temperature (EDB), entering wet bulb temperature (EWB), leaving dry bulb temperature (LDB), leaving wet bulb temperature (LWB), leaving dew point temperature (LDP), total heat transfer (BTUH), and/or maximum air pressure loss (PDA). For Coil Specifications, data input fields can be included for air flow rate actual (ACFM), maximum face velocity (FV), preliminary face area (FA), coil height (H), coil width (W), maximum fins per inch (FPI max), minimum fin spacing (FS min), and/or fin type.

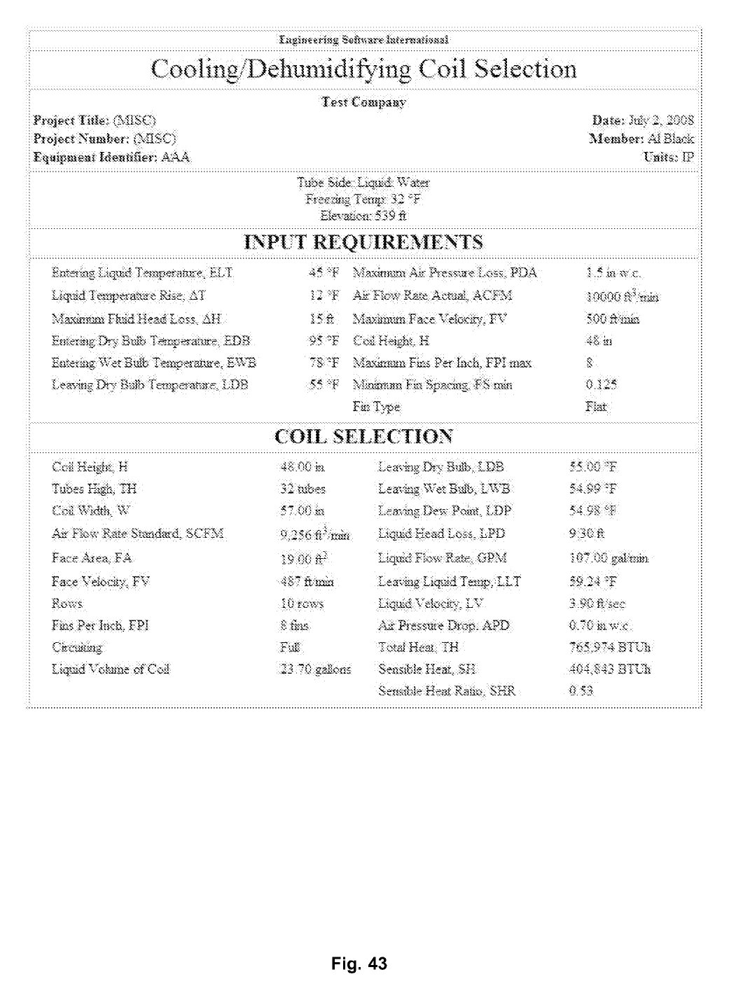

In some configurations, a system of the present teachings can comprise a calculation module regarding Cooling/dehumidifying Coil Selection, in which an output web page for this calculation module for which the tube side liquid is water (e.g., FIG. 43) can display information regarding Input Requirements and/or Coil Selection. For Input Requirements, the web page can display information such as entering liquid temperature (ELT), liquid temperature rise (ΔT), maximum fluid head loss (ΔH), entering dry bulb temperature (EDB), entering wet bulb temperature (EWB), leaving dry bulb temperature (LDB), maximum air pressure loss (PDA), air flow rate actual (ACFM), maximum face velocity (FV), coil height (H), maximum fins per inch (FPI max), minimum fin spacing (FS min), and/or fin type. For Coil Selection, the web page can display information such as coil height (H), tubes high (TH), coil width (W), air flow rate standard (SCFM), face area (FA), face velocity (FV), rows, fins per inch (FPI), circuiting, liquid volume of coil, leaving dry bulb (LDB), leaving wet bulb (LWB), leaving dew point (LDP), liquid head loss (LPD), liquid flow rate (GPM), leaving liquid temperature (LLT), liquid velocity (LV), air pressure drop (APD), total heat (TH), sensible heat (SH) and/or sensible heat ratio (SHR).

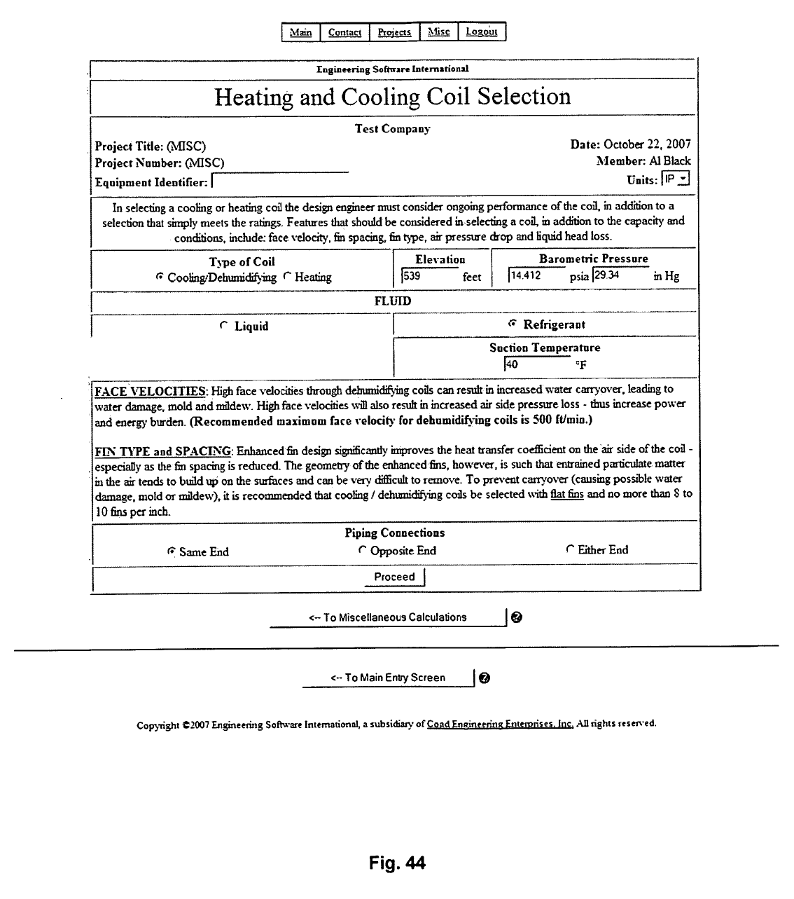

In some configurations, a system of the present teachings can comprise a calculation module for Heating and Cooling Coil Selection including choice of Fluid. A web page for this calculation module (e.g., FIG. 44) can include data entry fields for equipment identifier, units, elevation, and barometric pressure (in psia and in Hg), and can further include buttons regarding type of coil (cooling/dehumidifying or heating). In some configurations, if ‘cooling/dehumidifying’ is selected for type of coil, a web page can further comprise buttons for fluid (either liquid or refrigerant). If ‘refrigerant’ is selected for fluid, a data entry field can appear for suction temperature. In addition, a web page of these configurations can also comprise buttons regarding choices of piping connections, including same end, opposite end, or either end.

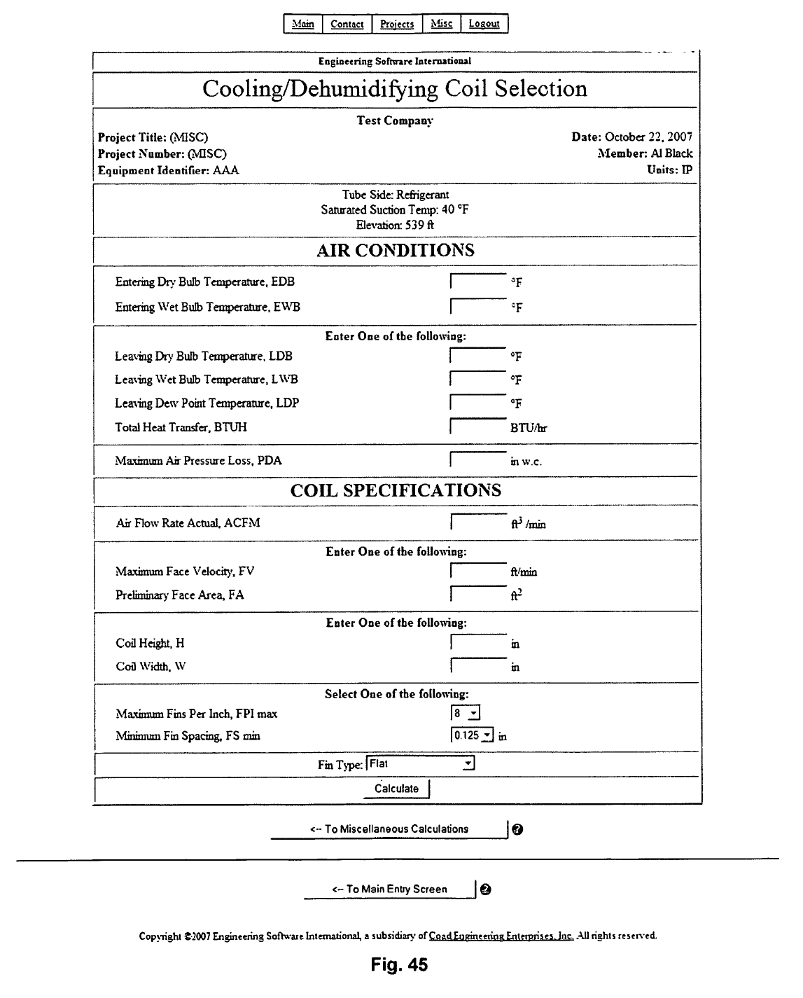

In some configurations, a system of the present teachings can comprise a calculation module regarding Cooling/dehumidifying Coil Selection, in which an output web page for this calculation module for which the tube side liquid is refrigerant (e.g., FIG. 45) can comprise input data regarding Air Conditions and Coil Specifications. For Air Conditions, data input fields can be included for entering dry bulb temperature (EDB), entering wet bulb temperature (EWB), leaving dry bulb temperature (LDB), leaving wet bulb temperature (LWB), leaving dew point temperature (LDP), total heat transfer (BTUH), and/or maximum air pressure loss (PDA). For Coil Specifications, data input fields can be included for air flow rate actual (ACFM), maximum face velocity (FV), preliminary face area (FA), coil height (H), coil width (W), maximum fins per inch (FPI max), minimum fin spacing (FS min), and/or fin type.

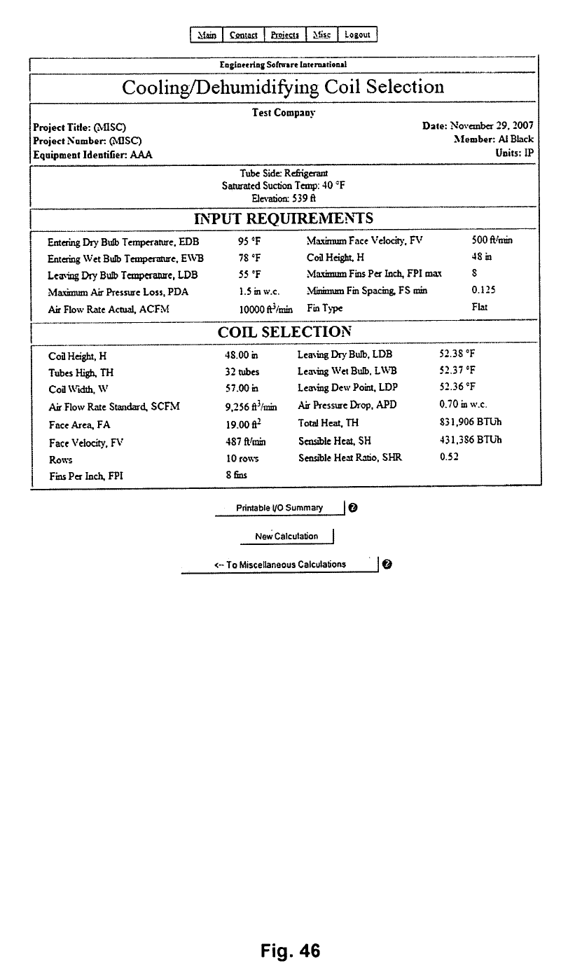

In some configurations, a system of the present teachings can comprise a calculation module regarding Cooling/dehumidifying Coil Selection, in which an output web page for this calculation module for which the tube side liquid is refrigerant (e.g., FIG. 46) can display information regarding Input Requirements and/or Coil Selection. For Input Requirements, the web page can display information such as entering dry bulb temperature (EDB), entering wet bulb temperature (EWB), leaving dry bulb temperature (LDB), maximum air pressure loss (PDA), air flow rate actual (ACFM), maximum face velocity (FV), coil height (H), maximum fins per inch (FPI max), minimum fin spacing (FS min), and/or fin type. For Coil Selection, the web page can display information such as coil height (H), tubes high (TH), coil width (W), air flow rate standard (SCFM), face area (FA), face velocity (FV), rows, fins per inch (FPI), leaving dry bulb (LDB), leaving wet bulb (LWB), leaving dew point (LDP), air pressure drop (APD), total heat (TH), sensible heat (SH) and/or sensible heat ratio (SHR).

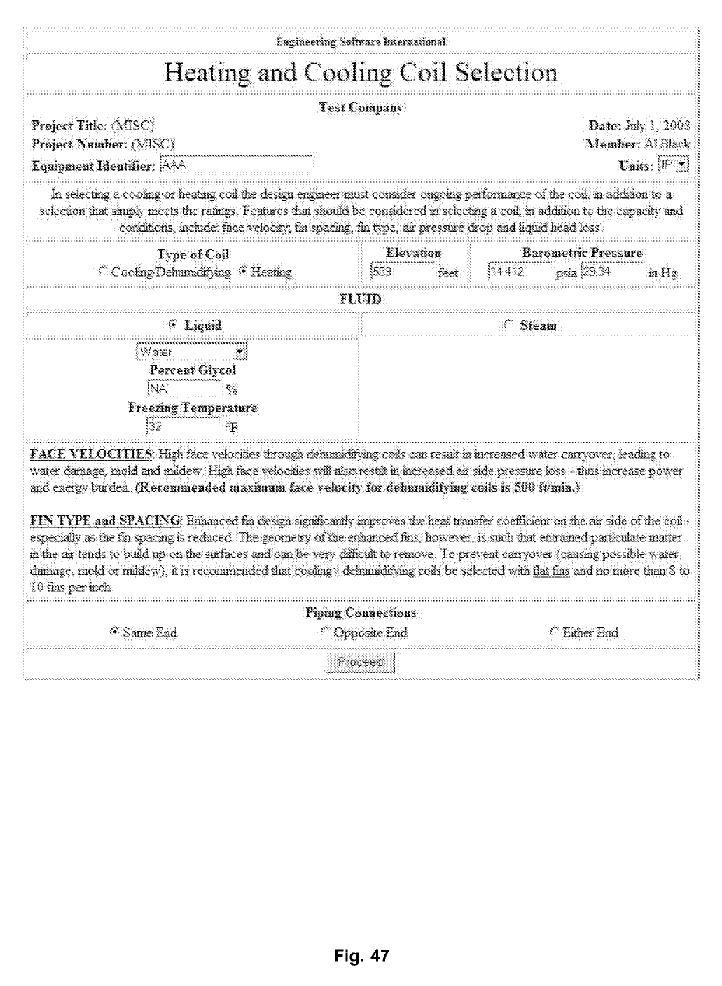

In some configurations, a system of the present teachings can comprise a calculation module for Heating and Cooling Coil Selection including choice of Fluid. A web page for this calculation module (e.g., FIG. 47) can include data entry fields for equipment identifier, units, elevation, and barometric pressure (in psia and in Hg), and can further include buttons regarding type of coil (cooling/dehumidifying or heating). In some configurations, if ‘heating’ is selected for type of coil, a web page can further comprise buttons for fluid (either liquid or steam). If ‘liquid’ is selected for fluid, data entry fields can appear for type of liquid (e.g., water), percent glycol, and freezing temperature. In addition, a web page of these configurations can also comprise buttons regarding choices of piping connections, including same end, opposite end, or either end.

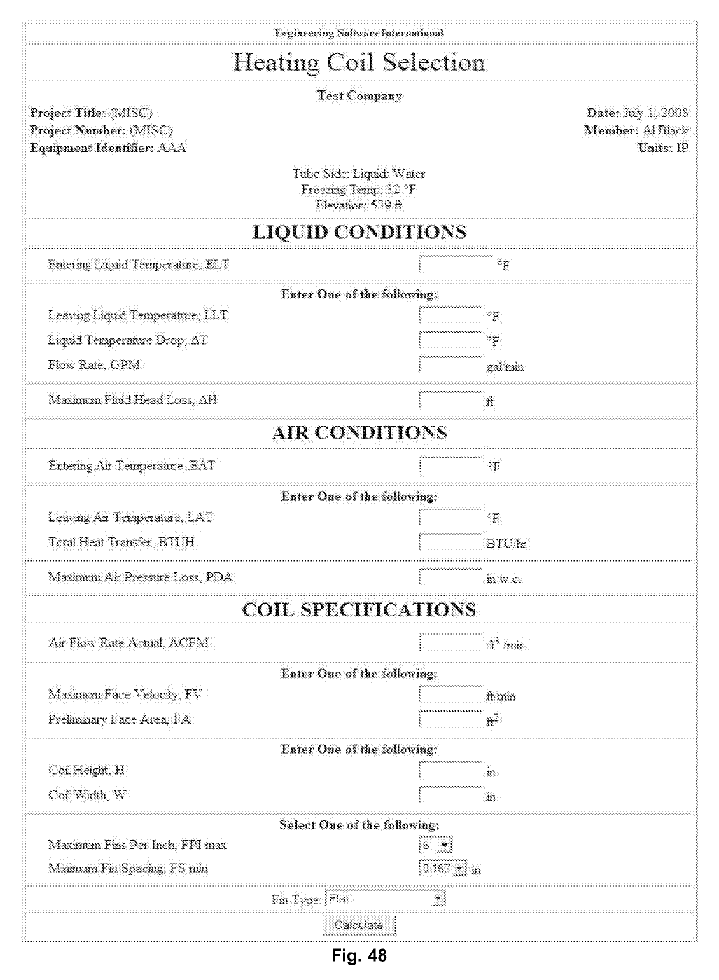

In some configurations, a system of the present teachings can comprise a calculation module regarding Heating Coil Selection, in which an output web page for this calculation module for which the tube side liquid is water (e.g., FIG. 48) can comprise input data regarding Liquid Conditions, Air Conditions and Coil Specifications. For Liquid Conditions, data input fields can be included for entering liquid temperature (ELT), leaving liquid temperature (LLT), liquid temperature rise (ΔT), flow rate (GPM), and/or maximum fluid head loss (ΔH). For Air Conditions, data input fields can be included for entering air temperature (EAT), leaving air temperature (LAT), total heat transfer (BTUH), and/or maximum air pressure loss (PDA). For Coil Specifications, data input fields can be included for air flow rate actual (ACFM), maximum face velocity (FV), preliminary face area (FA), coil height (H), coil width (W), maximum fins per inch (FPI max), minimum fin spacing (FS min), and/or fin type.

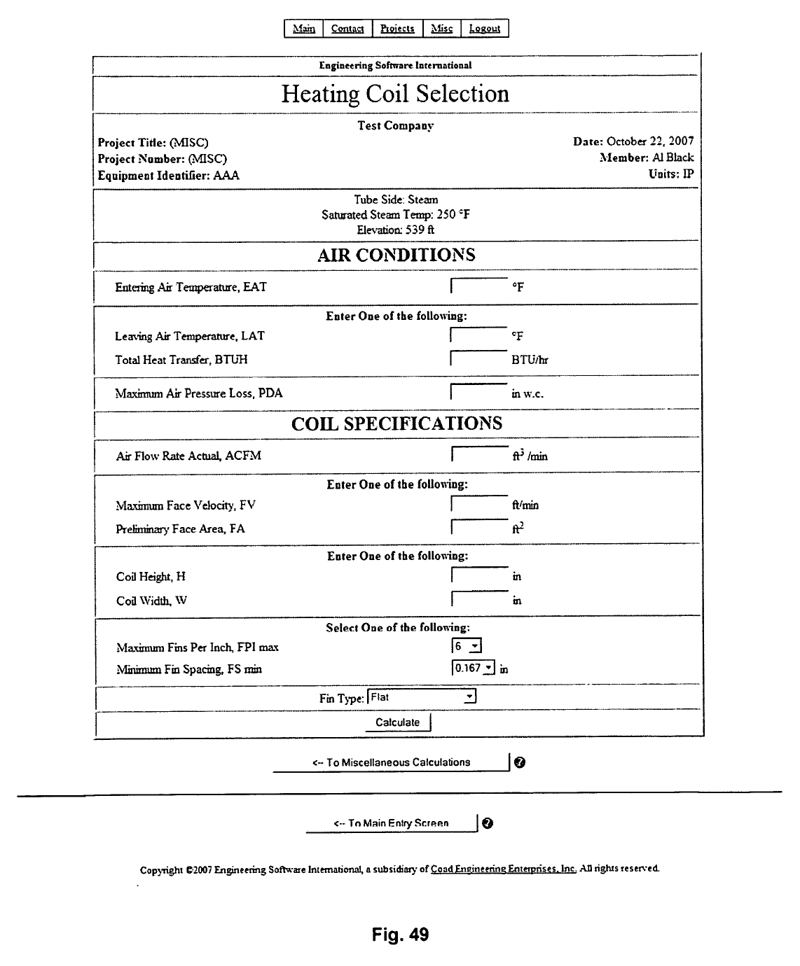

In some configurations, a system of the present teachings can comprise a calculation module regarding Heating Coil Selection, in which an output web page for this calculation module for which the tube side liquid is water (e.g., FIG. 49) can display information regarding Input Requirements and/or Coil Selection. For Input Requirements, the web page can display information such as entering liquid temperature (ELT), leaving liquid temperature (LLT), maximum fluid head loss (ΔH), entering air temperature (EAT), leaving air temperature (LAT), maximum air pressure loss (PDA), air flow rate actual (ACFM), maximum face velocity (FV), coil height (H), maximum fins per inch (FPI max), minimum fin spacing (FS min), and fin type. For Coil Selection, the web page can display information such as coil height (H), tubes high (TH), coil width (W), air flow rate standard (SCFM), face area (FA), face velocity (FV), rows, fins per inch (FPI), circuiting, leaving air temperature (LAT), liquid head loss (LPD), liquid flow rate (GPM), leaving liquid temperature (LLT), liquid velocity (LV), air pressure drop (APD), total heat (TH), and/or liquid volume of coil.

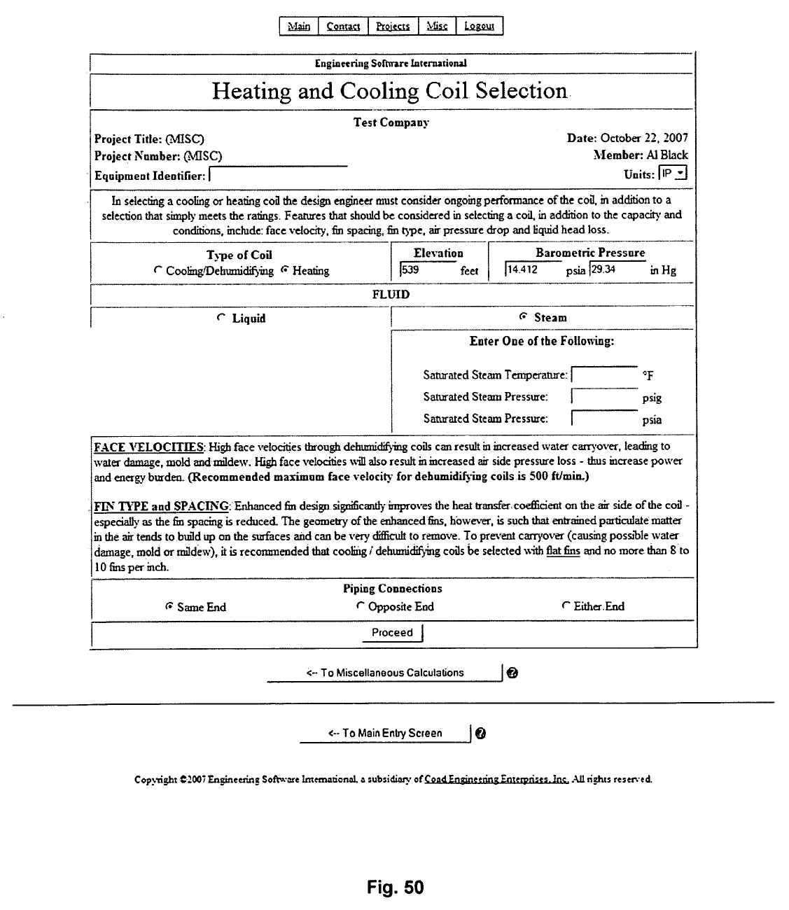

In some configurations, a system of the present teachings can comprise a calculation module for Heating and Cooling Coil Selection including choice of Fluid. A web page for this calculation module (e.g., FIG. 50) can include data entry fields for equipment identifier, units, elevation, and barometric pressure (in psia and in Hg), and can further include buttons regarding type of coil (cooling/dehumidifying or heating). In some configurations, if ‘heating’ is selected for type of coil, a web page can further comprise buttons for fluid (either liquid or steam). If ‘steam’ is selected for fluid, data entry fields can appear for saturated steam temperature, saturated steam pressure in psig, and/or saturated steam pressure in psia. In addition, a web page of these configurations can also comprise buttons regarding choices of piping connections, including same end, opposite end, or either end.

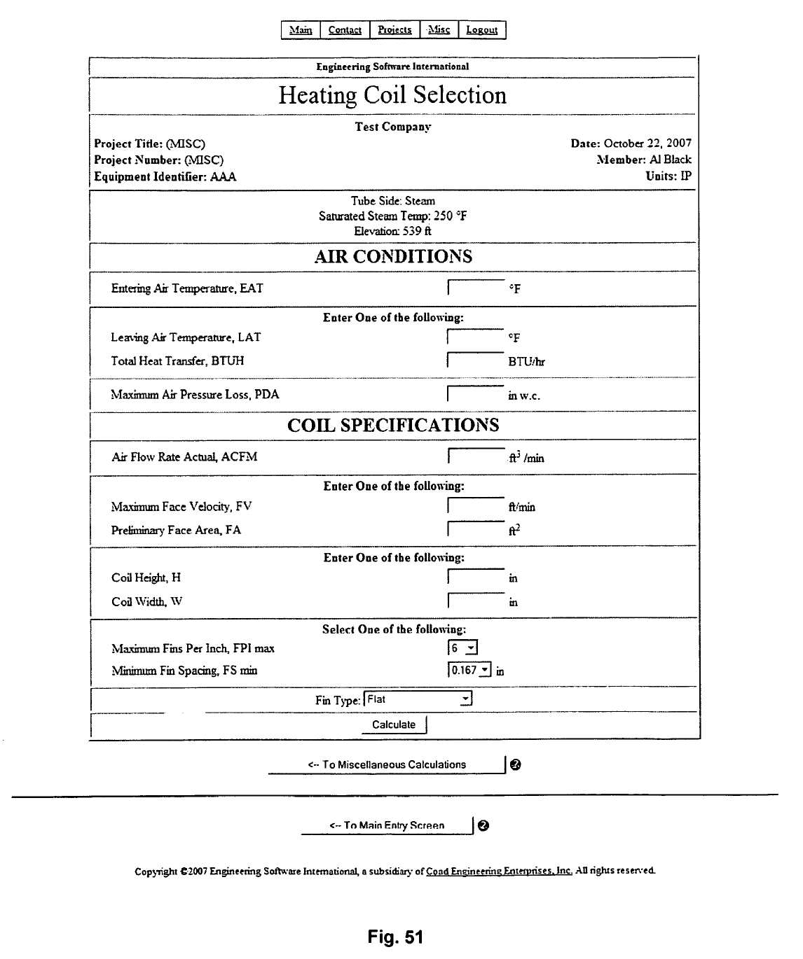

In some configurations, a system of the present teachings can comprise a calculation module regarding Heating Coil Selection, in which an input web page for this calculation module for which the tube side liquid is steam (e.g., FIG. 51) can comprise data input fields regarding Air Conditions and Coil Specifications. For Air Conditions, data input fields can be included for entering air temperature (EAT), leaving air temperature (LAT), total heat transfer (BTUH), and/or maximum air pressure loss (PDA). For Coil Specifications, data input fields can be included for air flow rate actual (ACFM), maximum face velocity (FV), preliminary face area (FA), coil height (H), coil width (W), maximum fins per inch (FPI max), minimum fin spacing (FS min), and/or fin type.

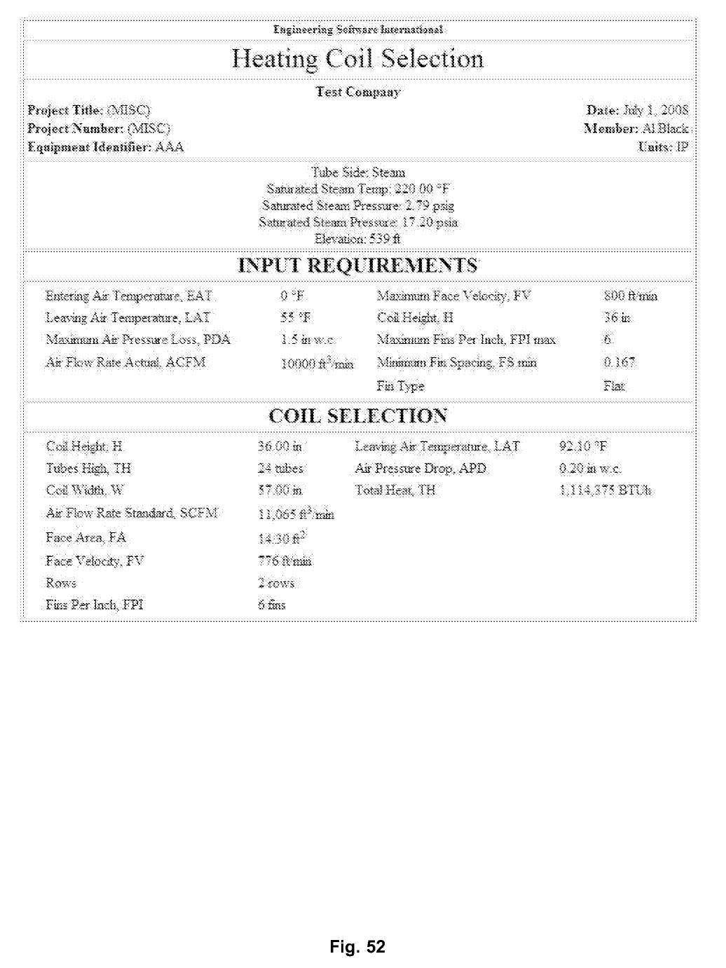

In some configurations, a system of the present teachings can comprise a calculation module regarding Heating Coil Selection, in which an output web page for this calculation module for which the tube side liquid is refrigerant (e.g., FIG. 52) can display information regarding Input Requirements and/or Coil Selection. For Input Requirements, the web page can display information such as entering air temperature (EAT), leaving air temperature (LAT), maximum air pressure loss (PDA), air flow rate actual (ACFM), maximum face velocity (FV), coil height (H), maximum fins per inch (FPI max), minimum fin spacing (FS min), and/or fin type. For Coil Selection, the web page can display information such as coil height (H), tubes high (TH), coil width (W), air flow rate standard (SCFM), face area (FA), face velocity (FV), rows, fins per inch (FPI), leaving air temperature (LAT), air pressure drop (APD), and total heat (TH).

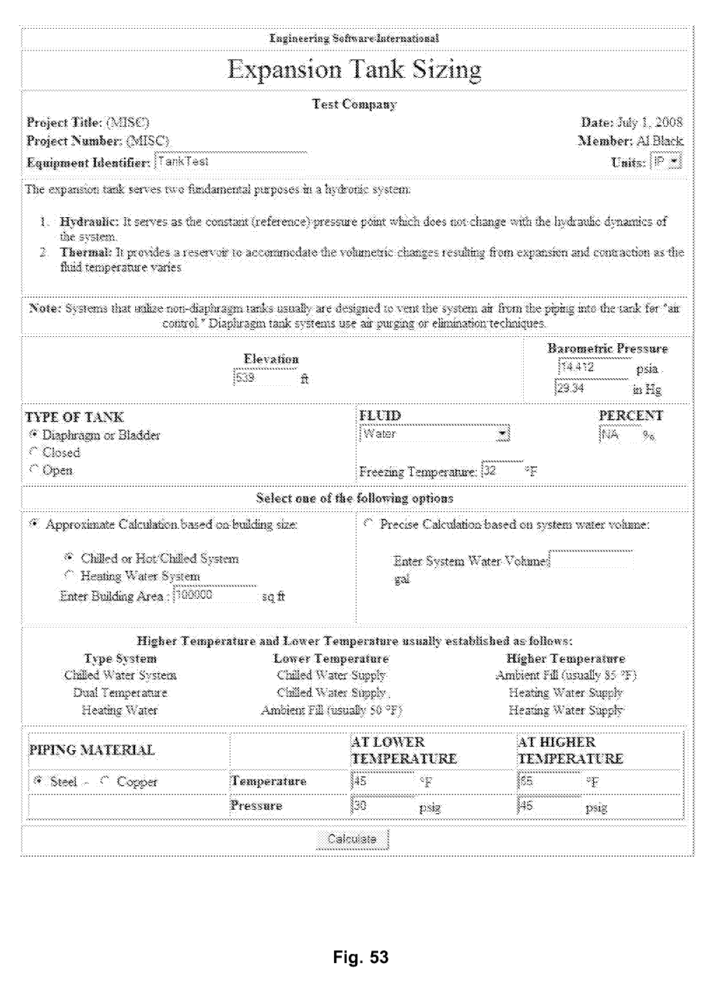

In some configurations, a system of the present teachings can comprise a calculation module regarding Expansion Tank Sizing. A web page for this calculation module (e.g., FIG. 53) can comprise data input fields for equipment identifier, units, fluid type, percent, freezing temperature. A web page of these configurations can further comprise buttons for selection of type of tank, including, e.g., diaphragm or bladder, closed, or open, and buttons for selection of piping material, such as copper or steel. A web page can further comprise buttons for selection of approximate calculation based on building size, chilled or hot/chilled system, heating water system, and/or precise calculation based on system water volume. Furthermore, a web page of these configurations can also include data entry fields for enter building area and/or system water volume, temperature at lower temperature, temperature at higher temperature, pressure at lower temperature, and pressure at higher temperature.

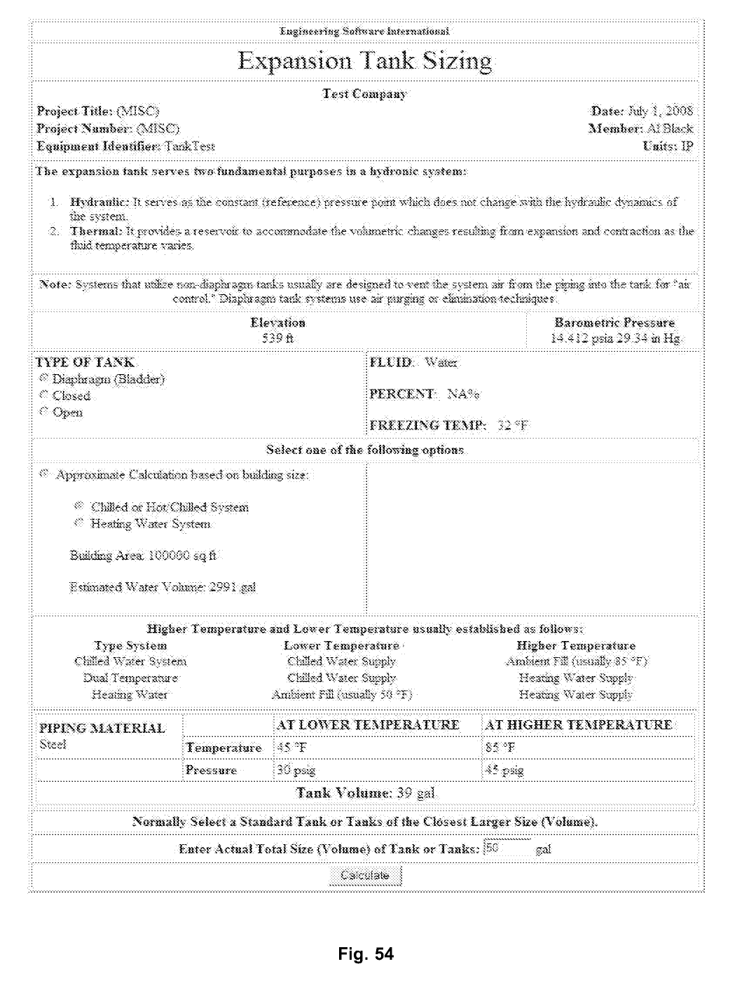

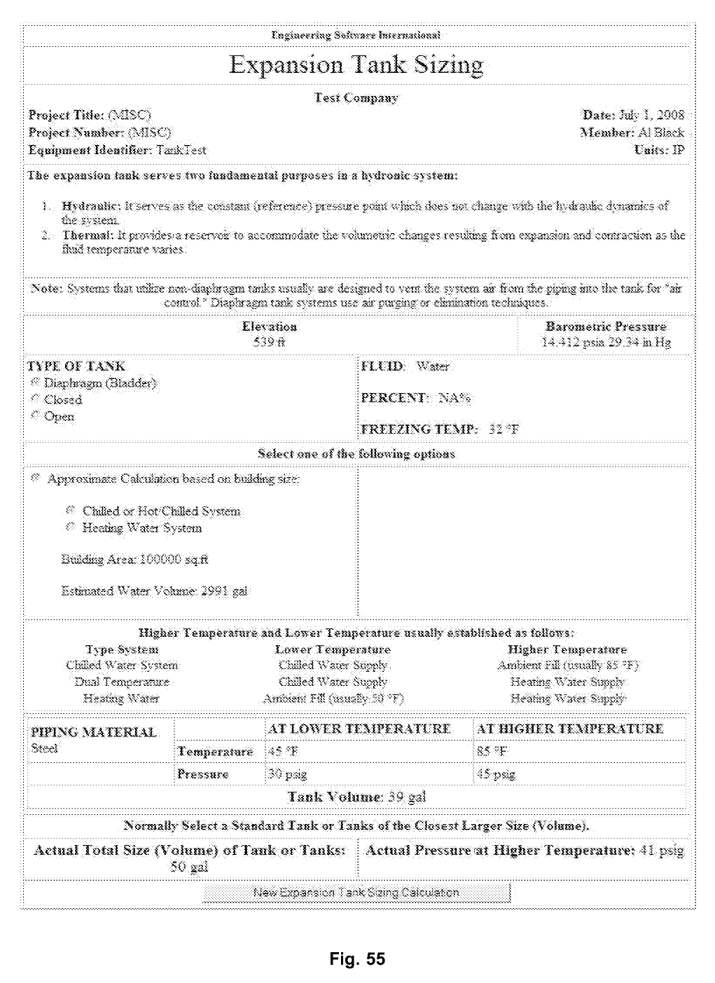

In some configurations, a system of the present teachings can comprise a calculation module regarding Expansion Tank Sizing. A web page for this calculation module (e.g., FIG. 54 or FIG. 55) can be an output web page which can comprise selections and data entered into an input web page such as a page presented in FIG. 53, and/or calculated values, including, for example, type of tank (diaphragm (bladder), closed, or open); fluid type; percent, freezing temperature; selections such as of approximate calculation based on building site, chilled or hot/chilled system, and heating water system; building area, estimated water volume; piping material, temperature at lower temperature, temperature at higher temperature, pressure at lower temperature, and pressure at higher temperature. A web page of these configuration can also comprise a data input field for actual total size (Volume) of tank or tanks.

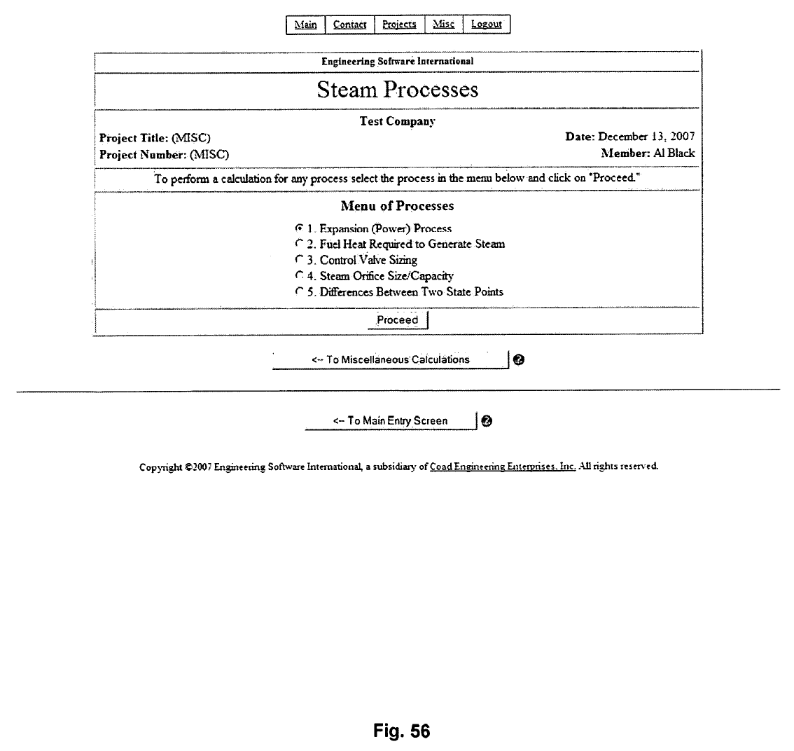

In some configurations, a system of the present teachings can comprise a calculation module for Steam Processes which can include a web page comprising a Menu of Processes (e.g., FIG. 56), with radio buttons for a user to choose from Expansion (Power) Process, Fuel Heat Required to Generate Steam, Control Valve Sizing, Steam Orifice Size/Capacity and/or Differences Between Two State Points.

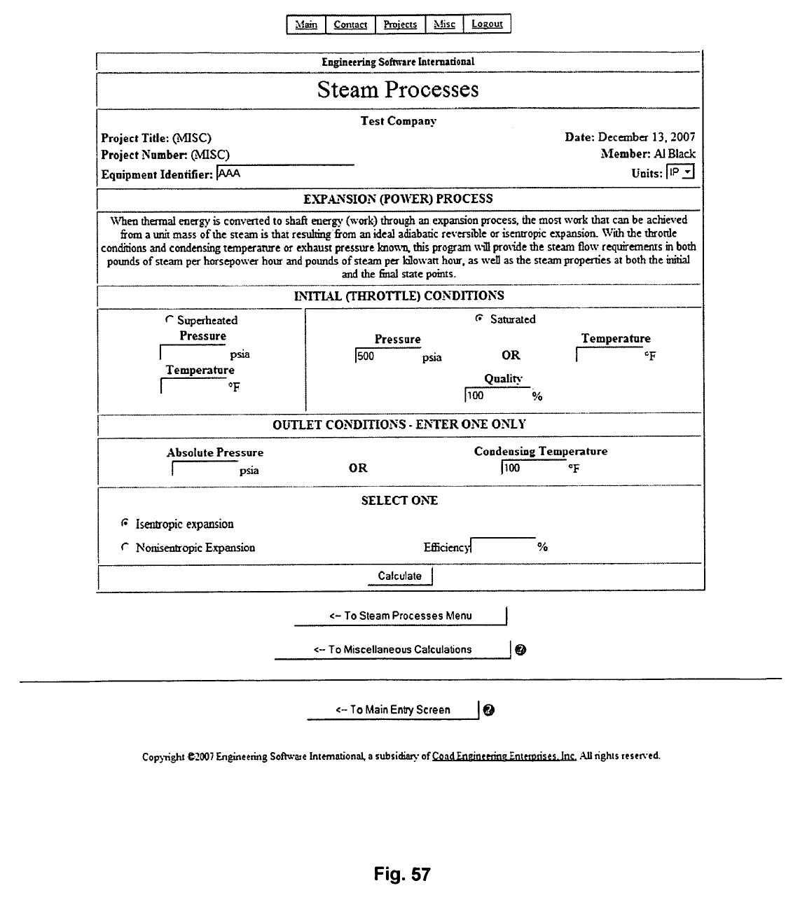

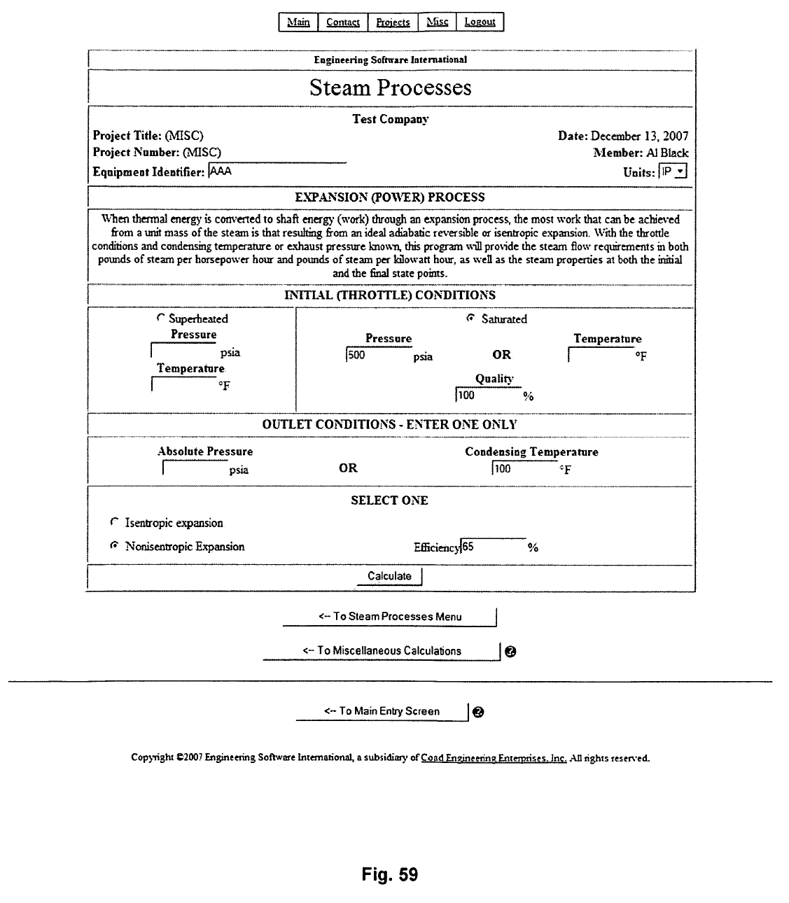

In some configurations, a system of the present teachings can comprise a calculation module for Steam Processes which can include input web pages which can comprise data entry fields regarding Expansion (Power) Process (e.g., FIG. 57, which display a selection of a button for an isentropic expansion, or FIG. 59, which displays a selection of a button a nonisentropic expansion). These web pages can include data entry fields for equipment identifier and units. A web page of these configurations can further comprise buttons and data entry fields regarding initial (throttle) conditions and outlet conditions. Initial (throttle) conditions can include buttons for selection of ‘superheated’ or ‘saturated’ conditions. If ‘saturated’ conditions is selected, data entry fields can include fields for pressure, temperature, and/or quality.

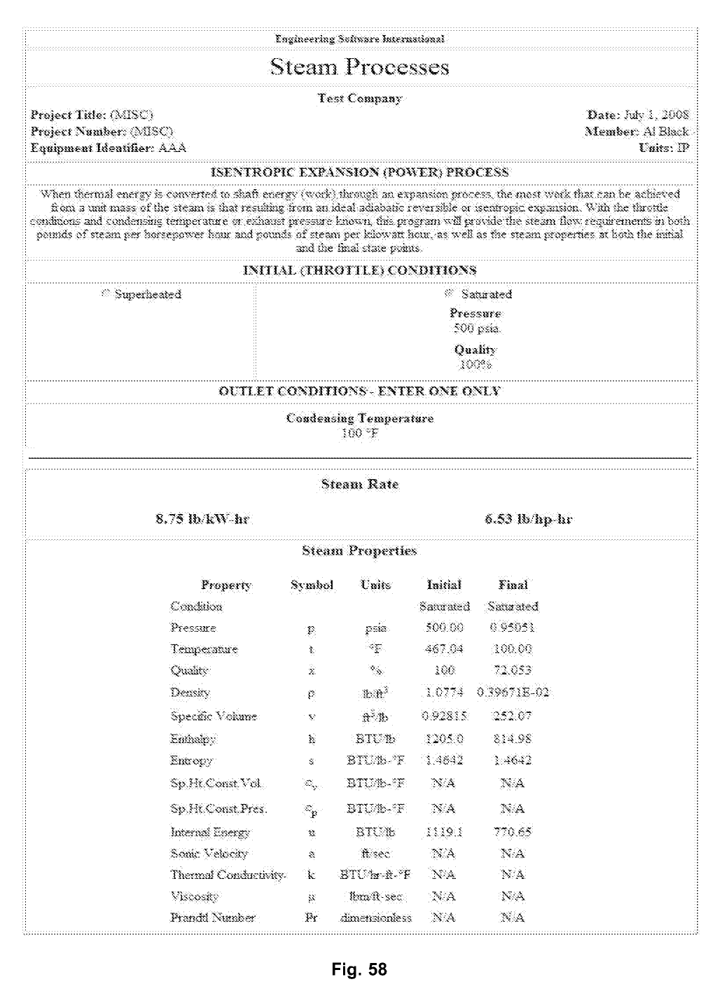

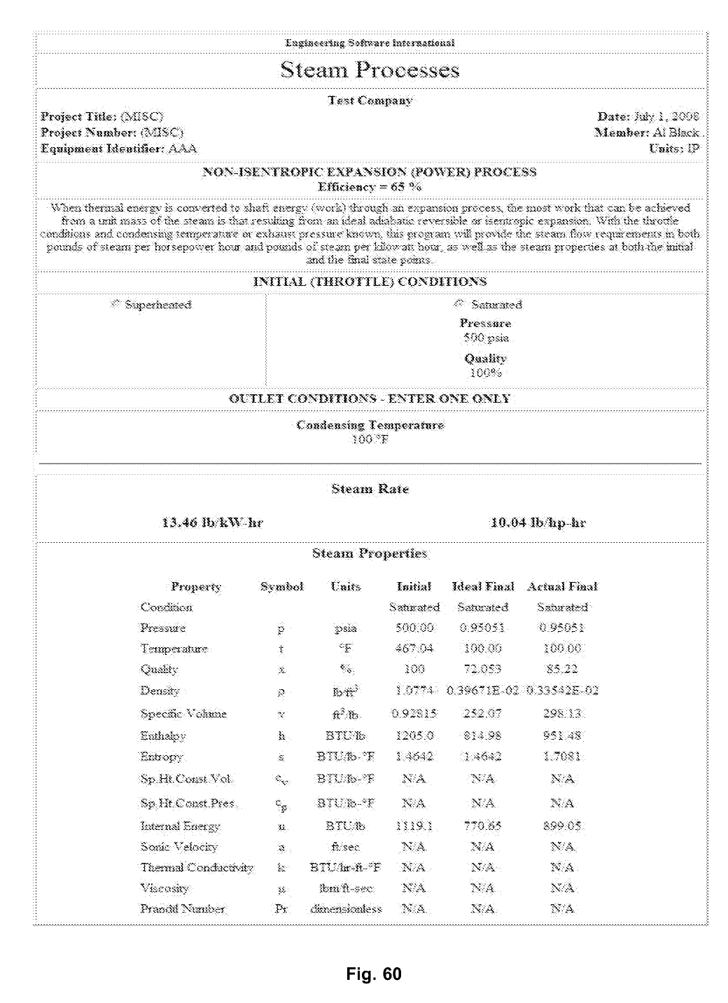

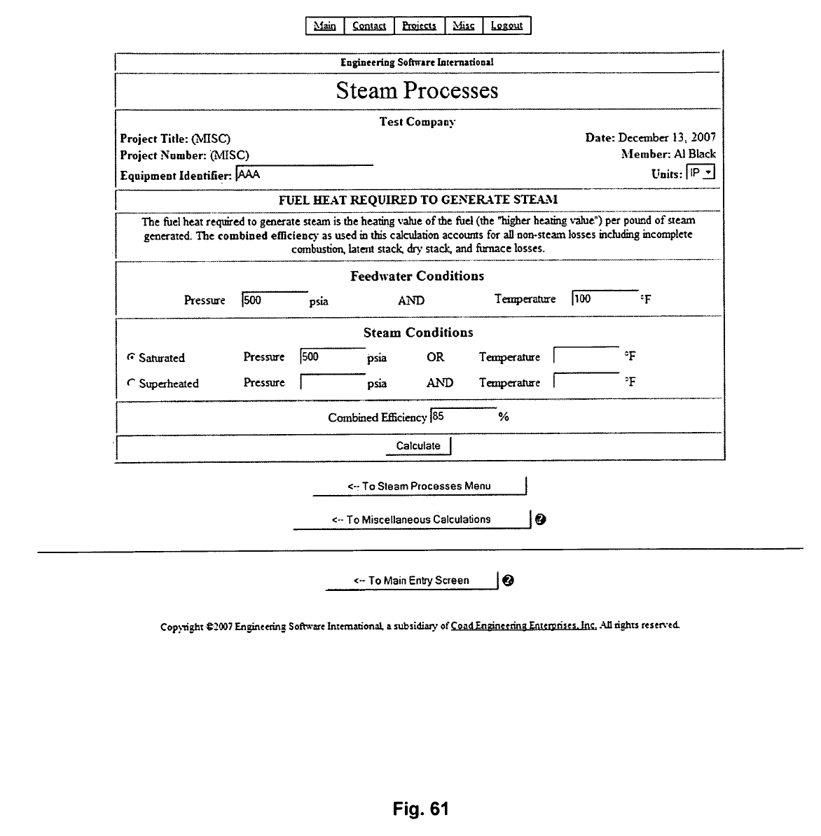

In some configurations, a system of the present teachings can comprise a calculation module for Steam Processes which can include output pages which can display selections, data entries and calculations regarding Expansion Process (e.g., FIG. 58, which displays output from a selection of an isentropic expansion, or FIG. 60, which displays output from a selection of a non-isentropic expansion), including button selections and data entered into data input field in an input web page such as exemplified in FIG. 57 or FIG. 59. These output web pages can display information such as Pressure (e.g., 500 psia), Quality (e.g., 100%), condensing temperature (e.g., 100° F.), steam rate, which can be reported in units such as lb/kW-hr or lb/hp-hr, and steam properties. In some configurations, steam properties can be reported in a table. A table of these configurations can have header categories such as Property, Symbol, Units, Initial and Final. Examples of steam properties which can be included in a table can be properties such as condition, pressure, temperature, quality, density, specific volume, enthalpy, entropy, specific heat constant volume, specific heat constant pressure, internal energy, sonic velocity, thermal conductivity, viscosity, and/or Prandtl Number.

In some configurations, a system of the present teachings can comprise a calculation module for Steam Processes which can include input web pages which can comprise data entry fields regarding Expansion (Power) Process (e.g., FIG. 59). These web pages can include data entry fields for equipment identifier and units. A web page of these configurations can further comprise buttons and data entry fields regarding initial (throttle) conditions and outlet conditions. Initial (throttle) conditions can include buttons for selection of ‘superheated’ or ‘saturated’ conditions. If ‘saturated’ conditions is selected, data entry fields can include fields for pressure, temperature, and/or quality. In addition, outlet conditions can include buttons for selection of ‘isentropic expansion’ or ‘nonisentropic expansion,’ and data input fields for efficiency.

In some configurations, a system of the present teachings can comprise a calculation module for Steam Processes which can include input web pages which can comprise data entry fields regarding Fuel Heat Required to Generate Steam (e.g., FIG. 61). An input web page of these configurations can include data input fields for equipment identifier and units, and can also comprise data input fields for feedwater conditions, such as pressure and temperature; and input fields for steam conditions, including, for each of saturated and superheated conditions, data input fields for pressure and temperature. An input web page of these configurations can also include a data input field for combined efficiency.

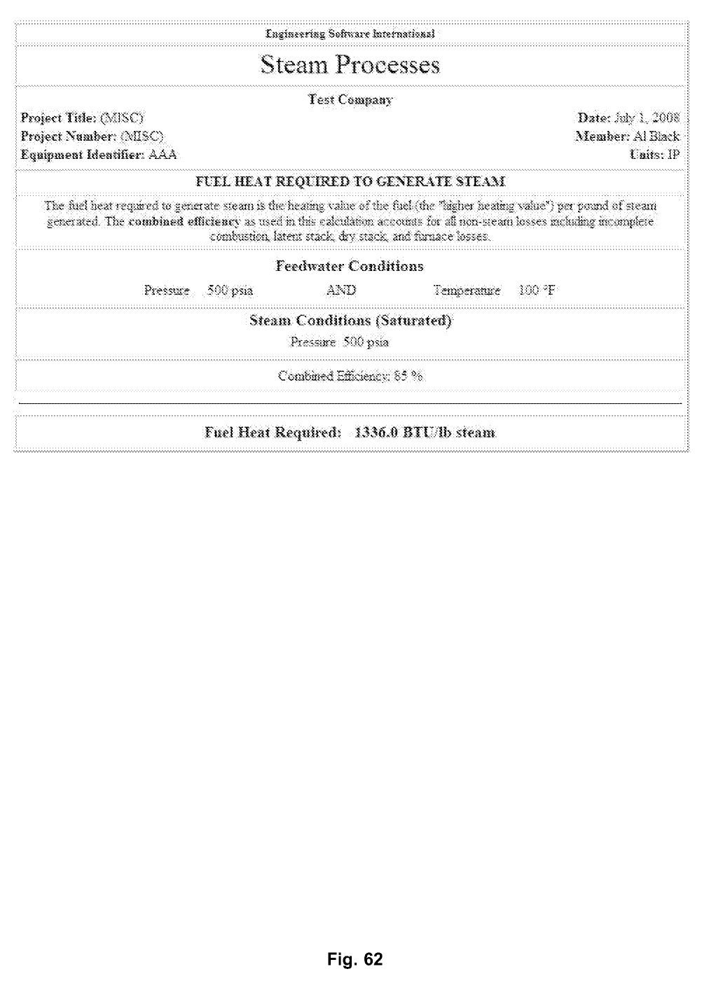

In some configurations, a system of the present teachings can comprise a calculation module for Steam Processes which can include output web pages which can provide inputted data and selections, and calculations regarding Fuel Heat Required to Generate Steam (e.g., FIG. 62). An output web page of these configurations can include, for example, feedwater conditions, such as pressure and temperature; steam conditions, such as, for example, pressure for saturated steam conditions; combined efficiency; and fuel heat required, which can be reported in standard units such as BTU/lb steam.

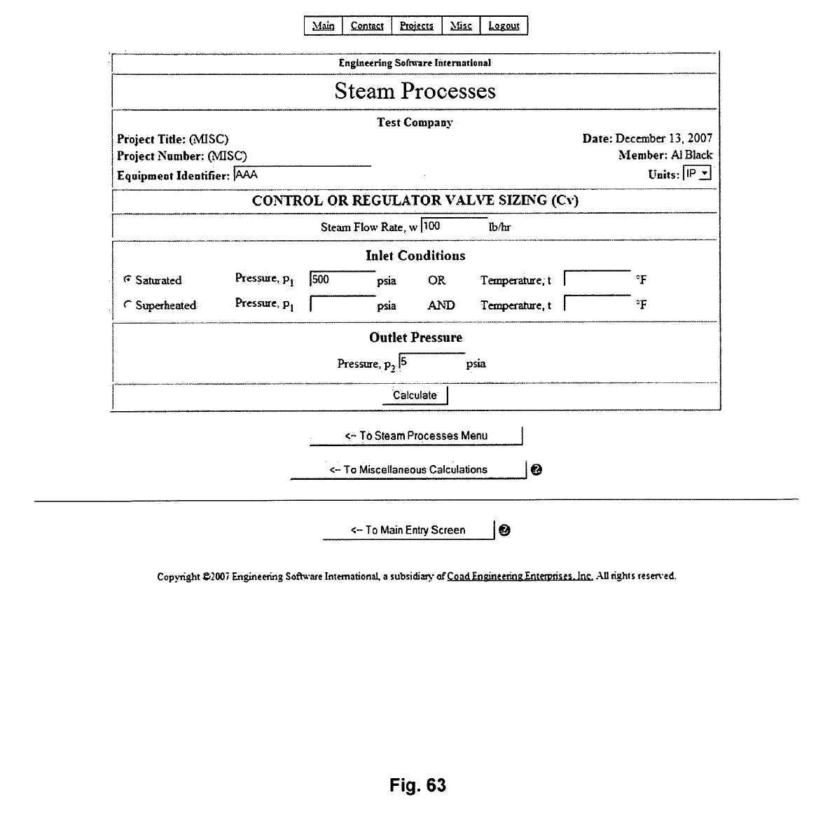

in some configurations, a system of the present teachings can comprise a calculation module for Steam Processes which can include input web pages which can comprise data entry fields regarding Control or Regulator Valve Sizing (Cv) (e.g., FIG. 63). An input web page of these configurations can include data input fields for equipment identifier and units, and can also comprise data input fields for inlet conditions, such as for pressure and temperature for saturated inlet conditions, and pressure and temperature for superheated inlet conditions. An input web page of these configurations can also comprise a data input field for Outlet pressure.

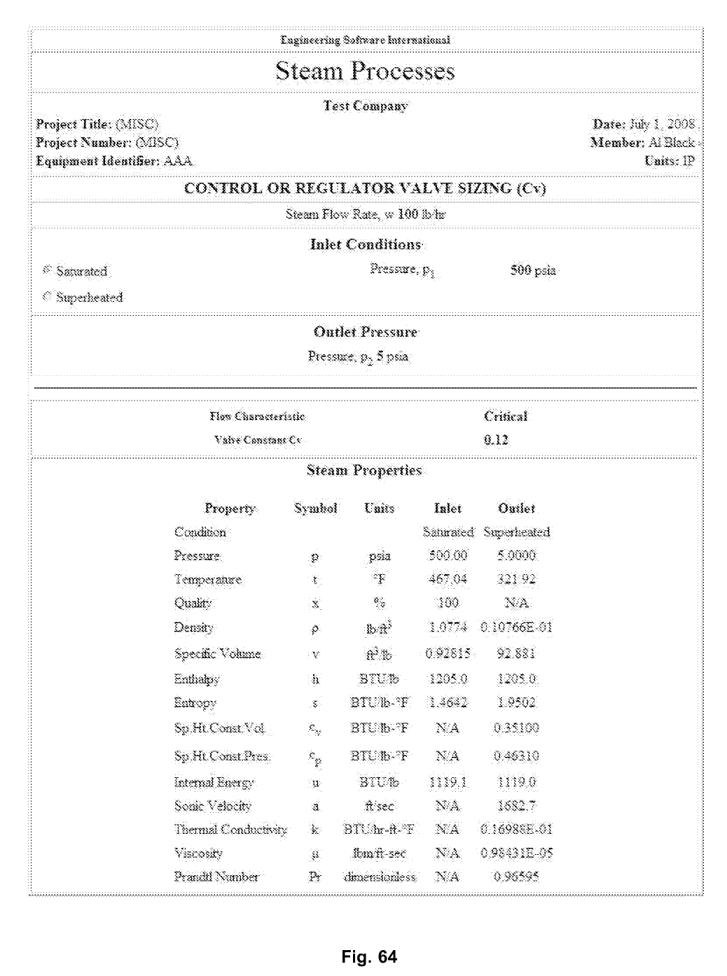

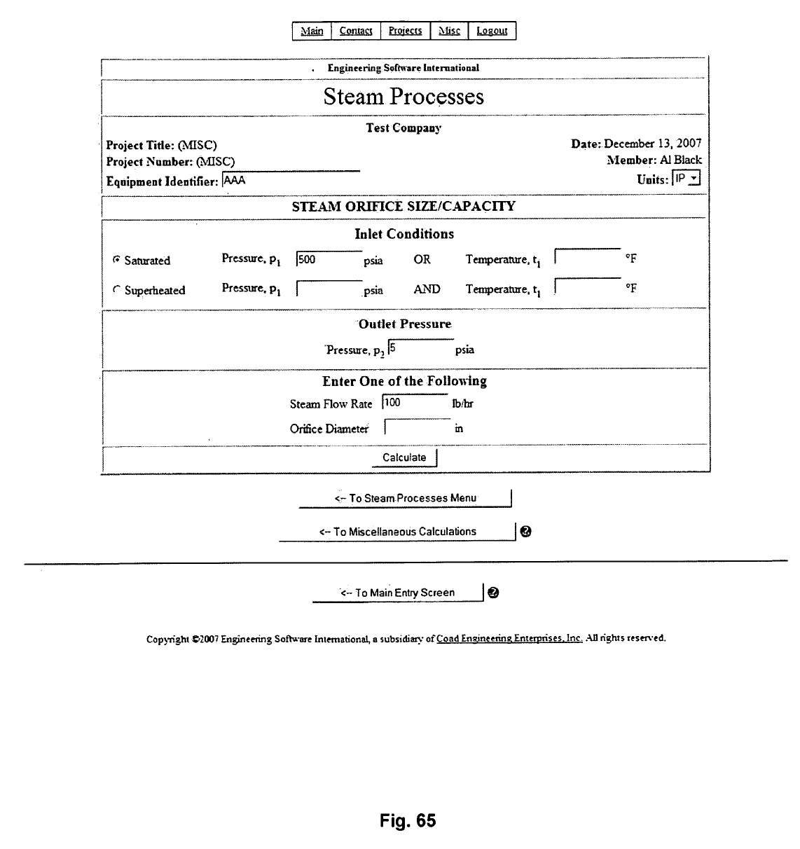

in some configurations, a system of the present teachings can comprise a calculation module for Steam Processes which can include output web pages which can provide inputted data and selections, and calculations regarding Control or Regulator Valve Sizing (Cv) (e.g., FIG. 64). Output web pages of these configurations can display information such as inlet conditions including selection of saturated or superheated, as well as pressure (e.g., 500 psia), and outlet pressure. In some configurations, an output web page can include steam properties, which can be reported in a table. A table of these configurations can have header categories such as Property, Symbol, Units, Inlet and Outlet. Examples of steam properties which can be included in a table can be properties such as condition, pressure, temperature, quality, density, specific volume, enthalpy, entropy, specific heat constant volume, specific heat constant pressure, internal energy, sonic velocity, thermal conductivity, viscosity, and/or Prandtl Number.

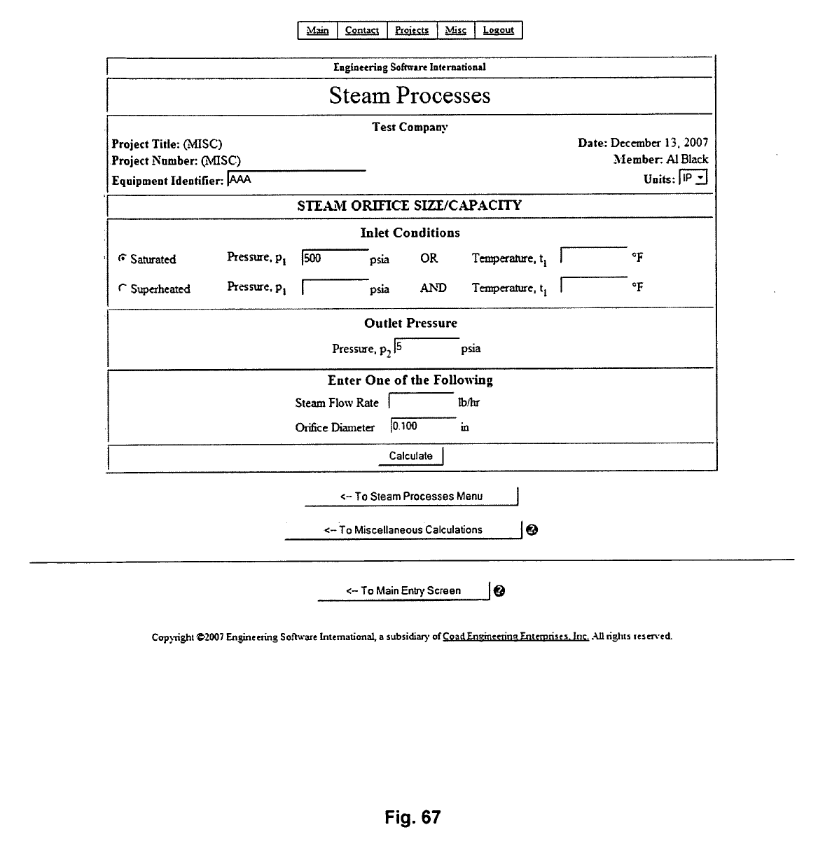

In some configurations, a system of the present teachings can comprise a calculation module for Steam Processes which can include input web pages which can comprise data entry fields regarding Steam Orifice Size/Capacity (e.g., FIG. 65 or FIG. 67). An input web page of these configurations can include data input fields for equipment identifier and units, and can also comprise data input fields for inlet conditions, such as for pressure and temperature for saturated inlet conditions, and pressure and temperature for superheated inlet conditions. An input web page of these configurations can also comprise a data input field for Outlet pressure, and data input fields for steam flow rate (for example, 100 lb/hr as illustrated in FIG. 65) and orifice diameter (for example, 0.100 in. as illustrated in FIG. 67).

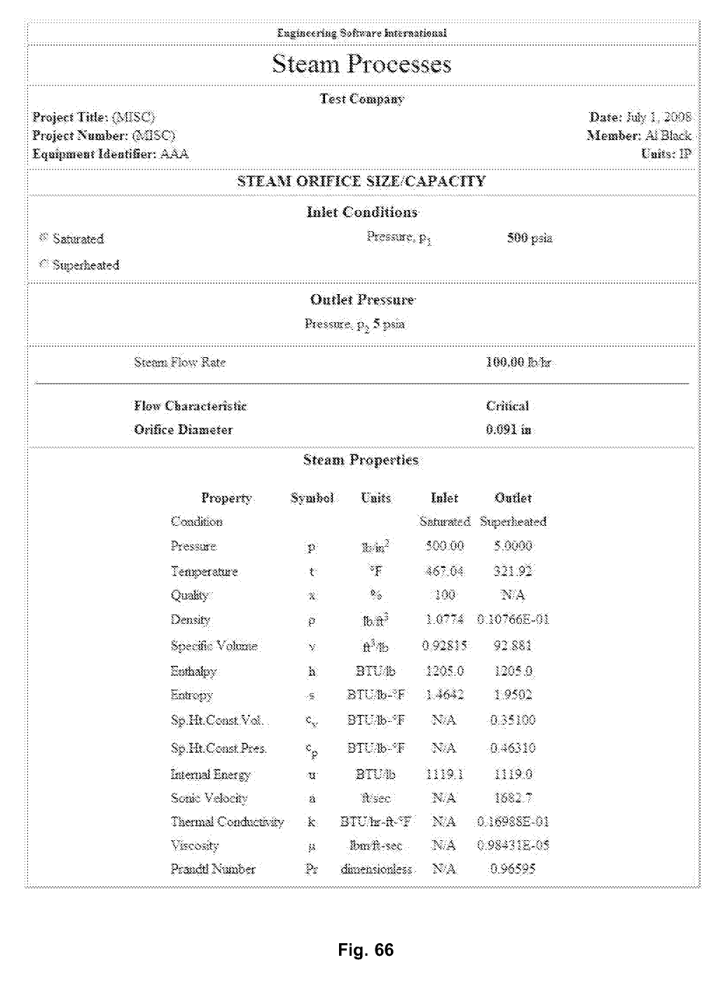

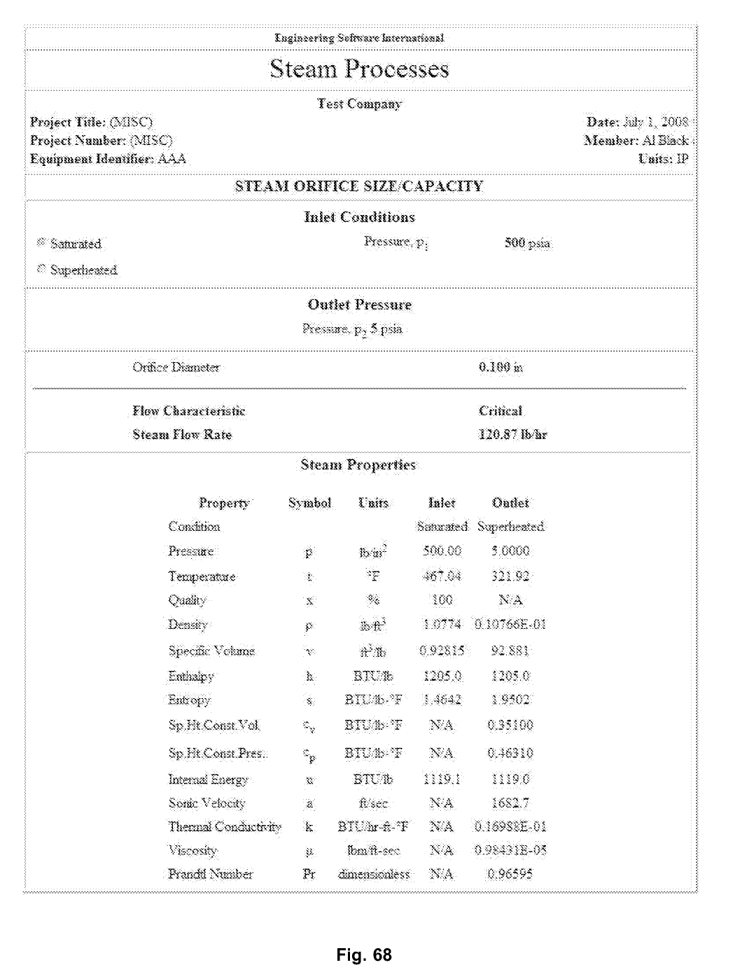

In some configurations, a system of the present teachings can comprise a calculation module for Steam Processes which can include output web pages which can provide inputted data and selections, and calculations regarding Steam Orifice Size/Capacity (e.g., FIG. 66 and FIG. 68). Output web pages of these configurations can display information such as inlet conditions including selection of saturated or superheated, as well as pressure (e.g., 500 psia), and outlet conditions, such as outlet pressure and steam flow rate. An output web page can also include a calculated orifice diameter (e.g., as shown in FIG. 66) or a flow characteristic such as a calculated steam flow rate (e.g., as shown in FIG. 68) In some configurations, an output web page can include steam properties, which can be reported in a table. A table of these configurations can have header categories such as Property, Symbol, Units, Inlet and Outlet. Examples of steam properties which can be included in a table can be properties such as condition, pressure, temperature, quality, density, specific volume, enthalpy, entropy, specific heat constant volume, specific heat constant pressure, internal energy, sonic velocity, thermal conductivity, viscosity, and/or Prandtl Number.

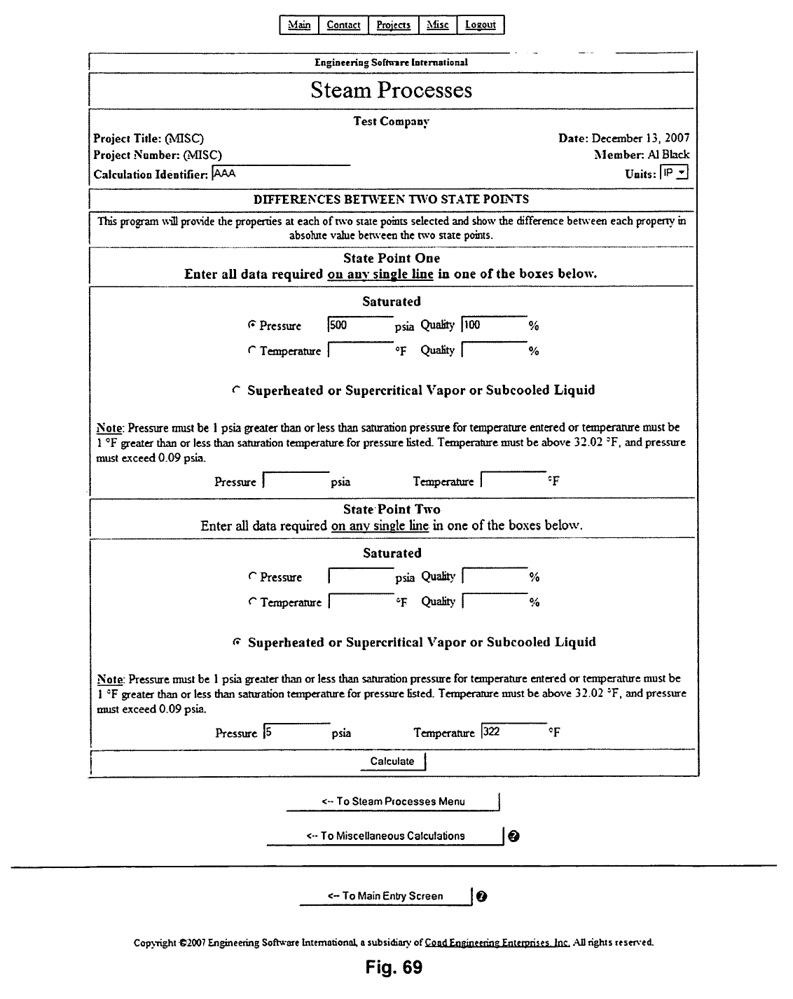

In some configurations, a system of the present teachings can comprise a calculation module for Steam Processes which can include input web pages which can comprise data entry fields regarding Differences between two state points (e.g., FIG. 69). An input web page of these configurations can include data input fields for equipment identifier and units, and can also comprise data input fields each of state point 1 and state point 2, including, for example, saturated conditions for pressure and quality, and temperature and quality, for each of state point 1 and state point 2. Furthermore, a button can provide selection for either state point 1 or state point 2 of superheated or supercritical vapor or subcooled liquid, and data input fields can further include fields for pressure and temperature regarding the selection.

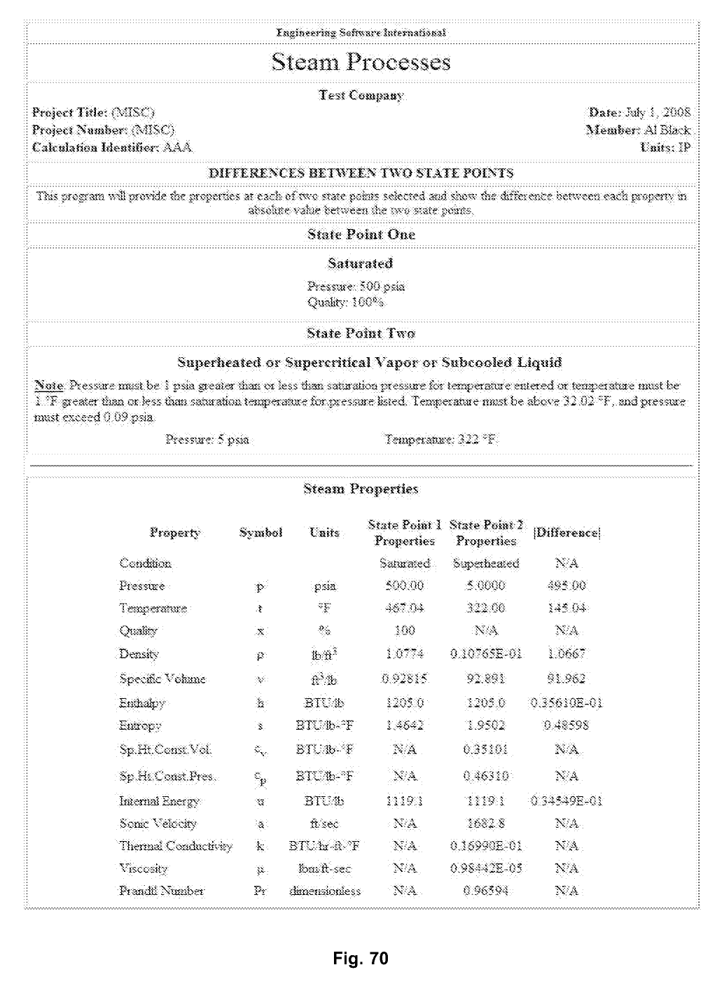

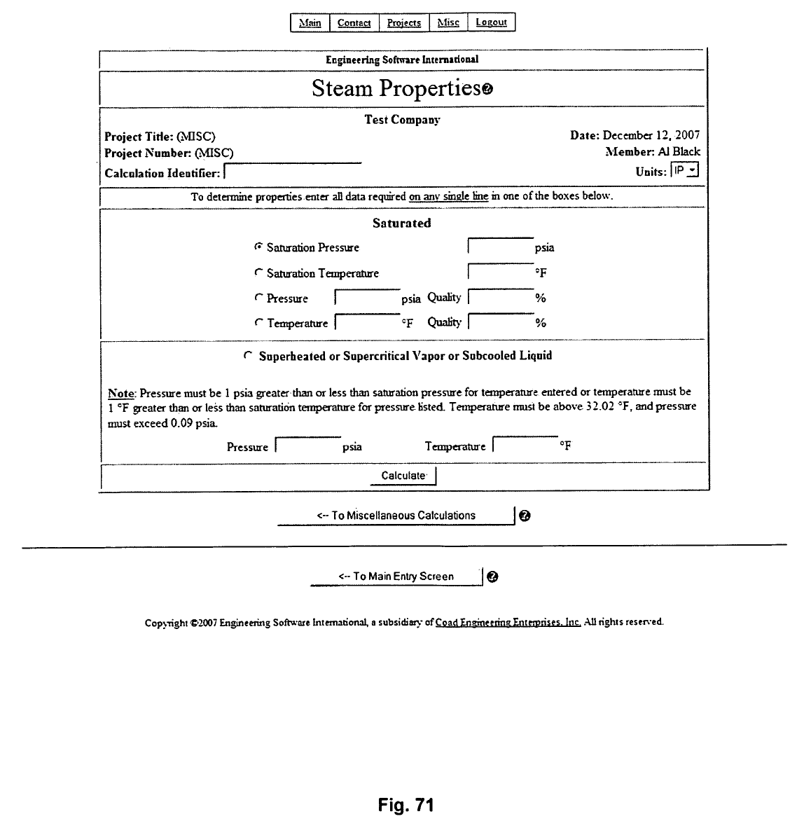

In some configurations, a system of the present teachings can comprise a calculation module for Steam Processes which can include output web pages which can comprise information regarding Differences between two state points (e.g., FIG. 70). An output web page of these configurations can include inputted information for equipment identifier and units, and can also comprise information for each of state point 1 and state point 2, including, for example, saturated conditions for pressure and quality for state point 1, and pressure and temperature for state point 2. In these configurations, steam properties can be reported in a table. A table of these configurations can have header categories such as Property, Symbol, Units, State Point 1 Properties, State Point 2 Properties, and Difference. Examples of steam properties which can be included in a table can be properties such as condition, pressure, temperature, quality, density, specific volume, enthalpy, entropy, specific heat constant volume, specific heat constant pressure, internal energy, sonic velocity, thermal conductivity, viscosity, and/or Prandtl Number.

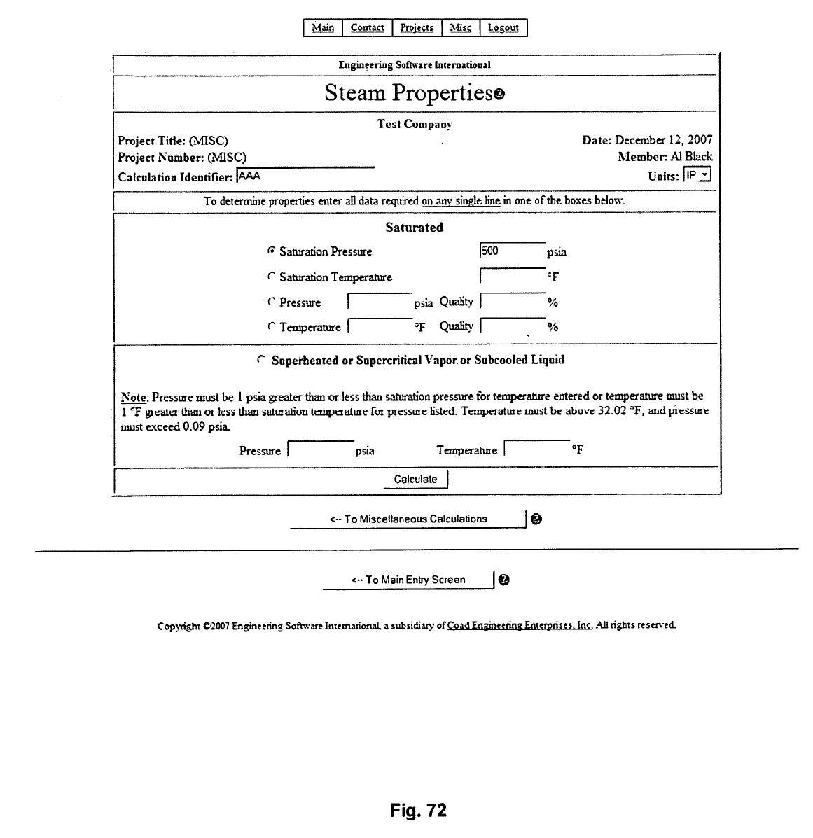

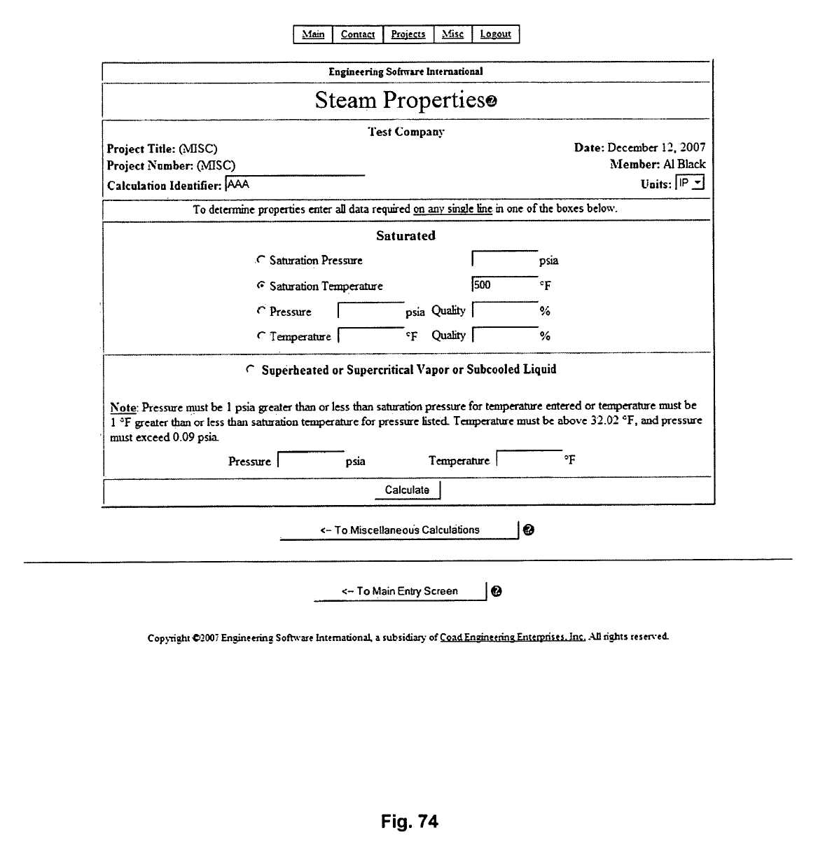

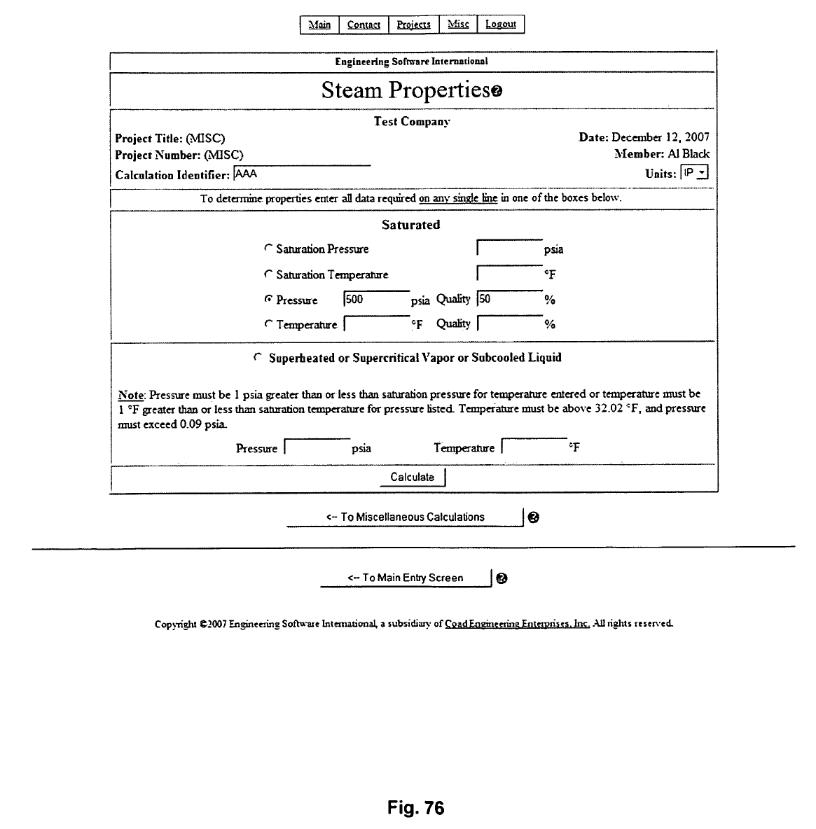

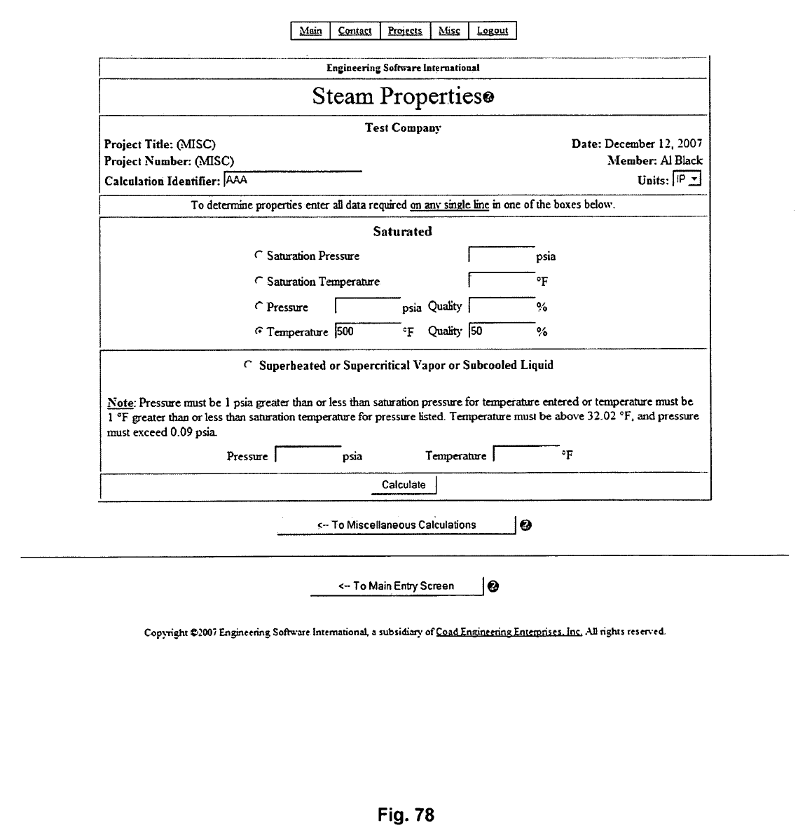

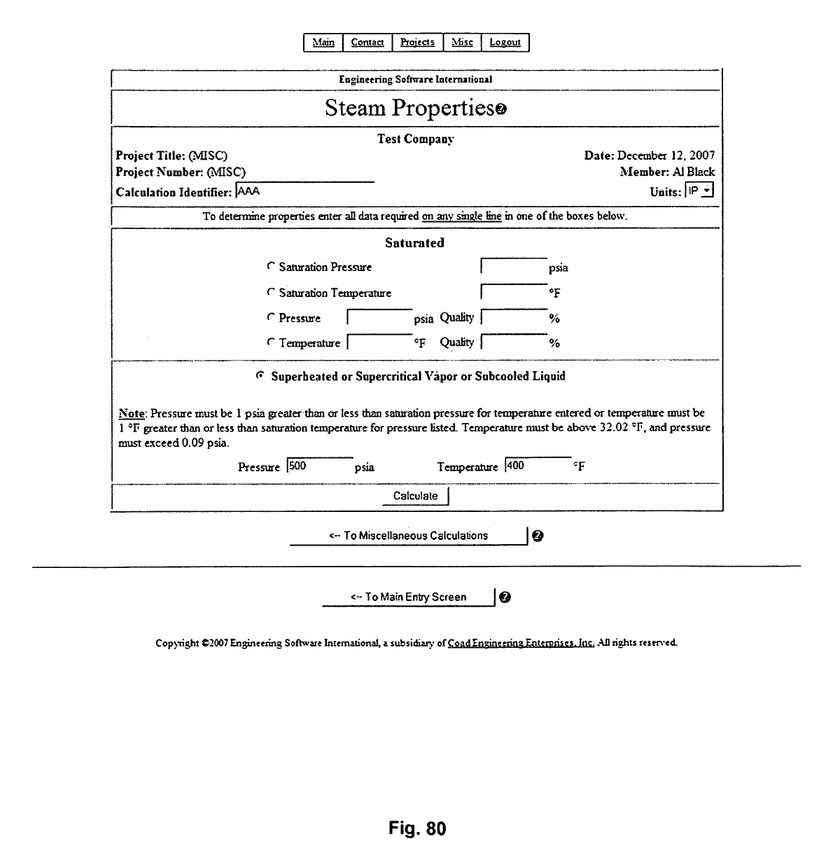

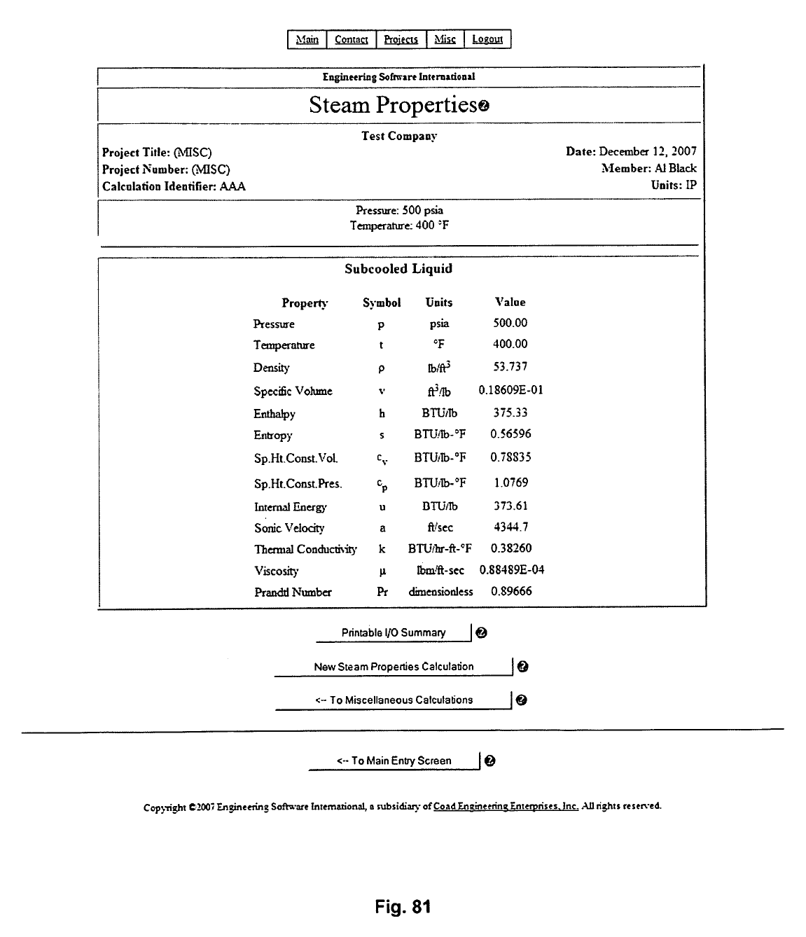

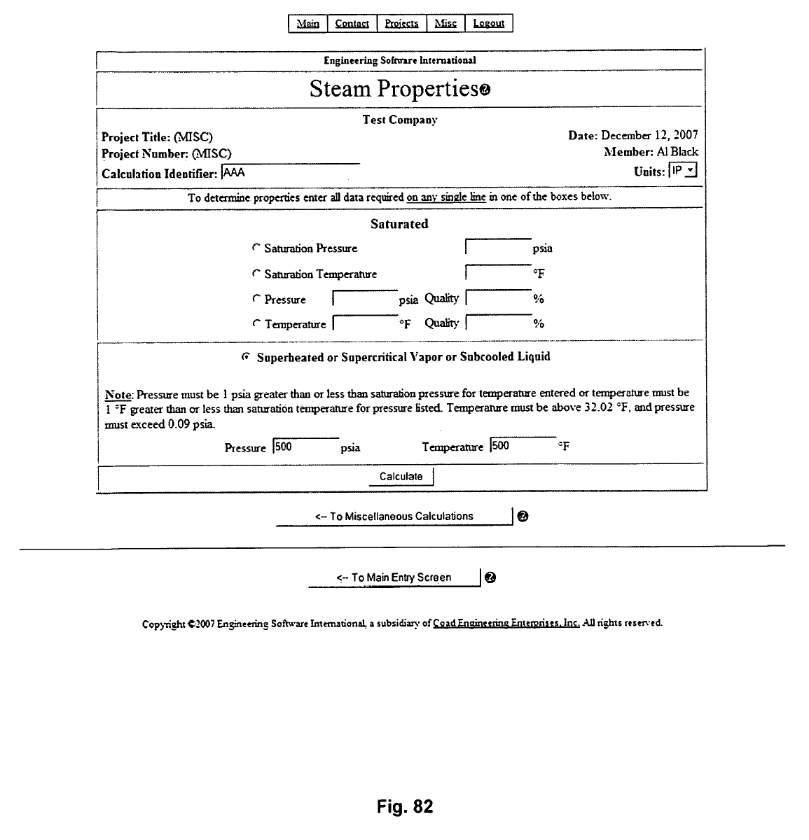

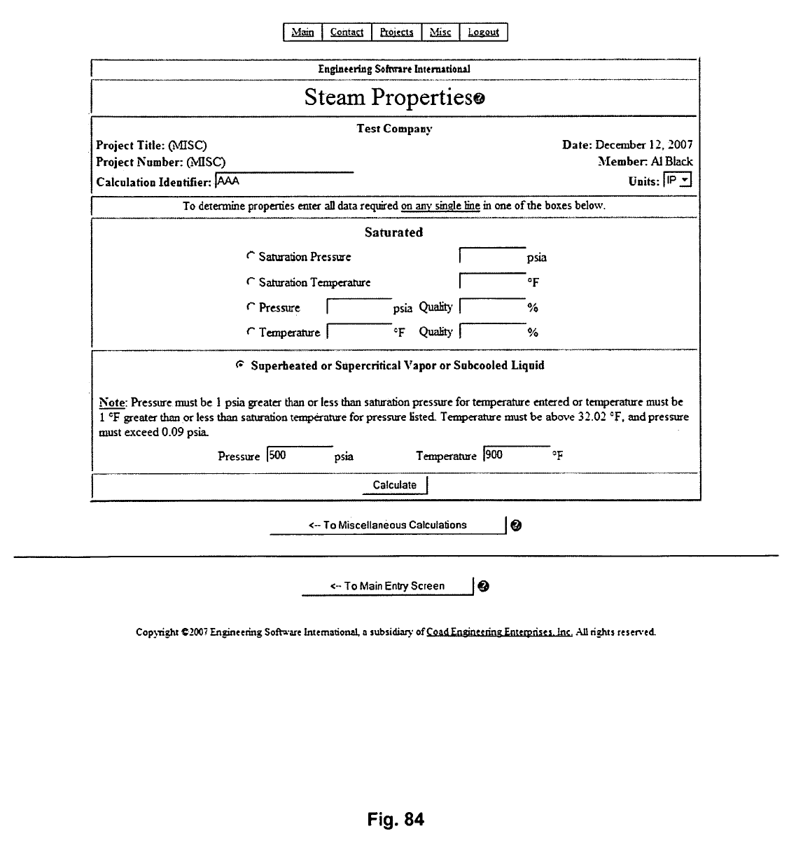

In some configurations, a system of the present teachings can comprise a calculation module for Steam Processes which can include input web pages which can comprise data entry fields regarding Saturated conditions (e.g., FIG. 71, FIG. 72, FIG. 74, FIG. 76, FIG. 78, FIG. 80, FIG. 82, and FIG. 84). A web page of these configurations can include buttons for selection of saturation pressure, saturation temperature, pressure, and temperature, and data input fields for saturation pressure, saturation temperature, pressure, pressure quality, temperature, and temperature quality. Furthermore, a web page can include a button for selection of superheated or supercritical vapor or subcooled liquid, as well as additional data input fields for pressure and temperature. In non-limiting examples, an input web page of these configurations can include a saturation pressure of 500 psia (e.g., FIG. 72), a saturation temperature of 500° F. (e.g., FIG. 74), a pressure of 500 psia and a quality of 50% (e.g., FIG. 76), a temperature of 500° F. and a quality of 50% (e.g., FIG. 78), or in a selection of superheated or supercritical vapor or subcooled liquid, a pressure of 500 psia and a temperature of 400° F. (e.g., FIG. 80), a pressure of 500 psia and a temperature of 500° F. (e.g., FIG. 82), or a pressure of 500 psia and a temperature of 900° F. (e.g., FIG. 84).

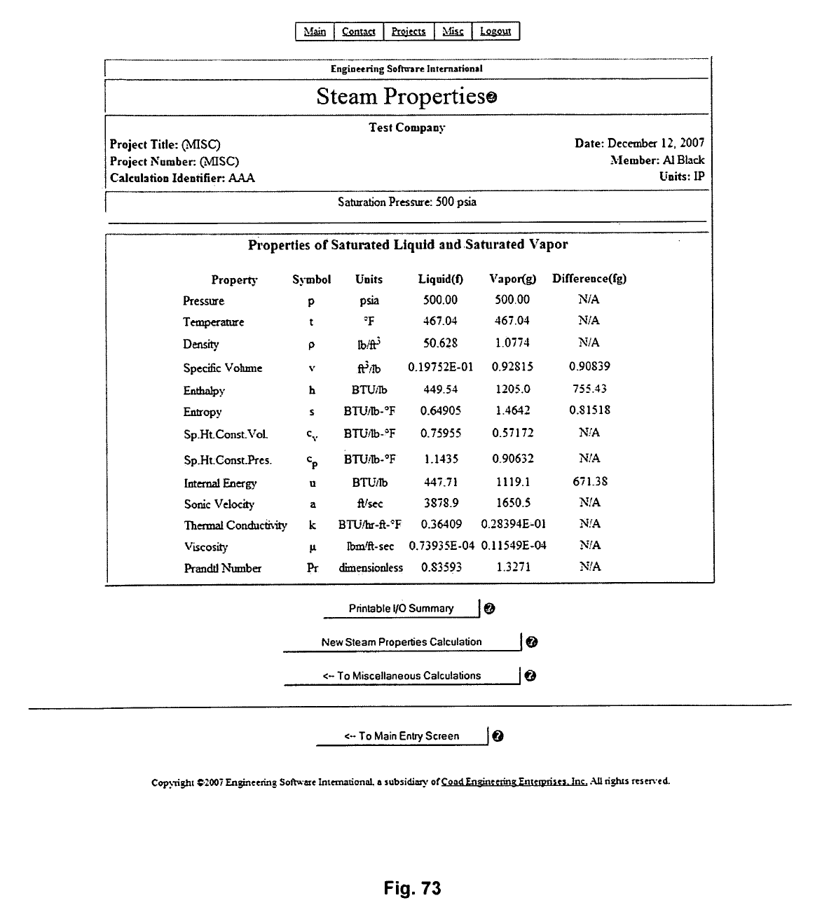

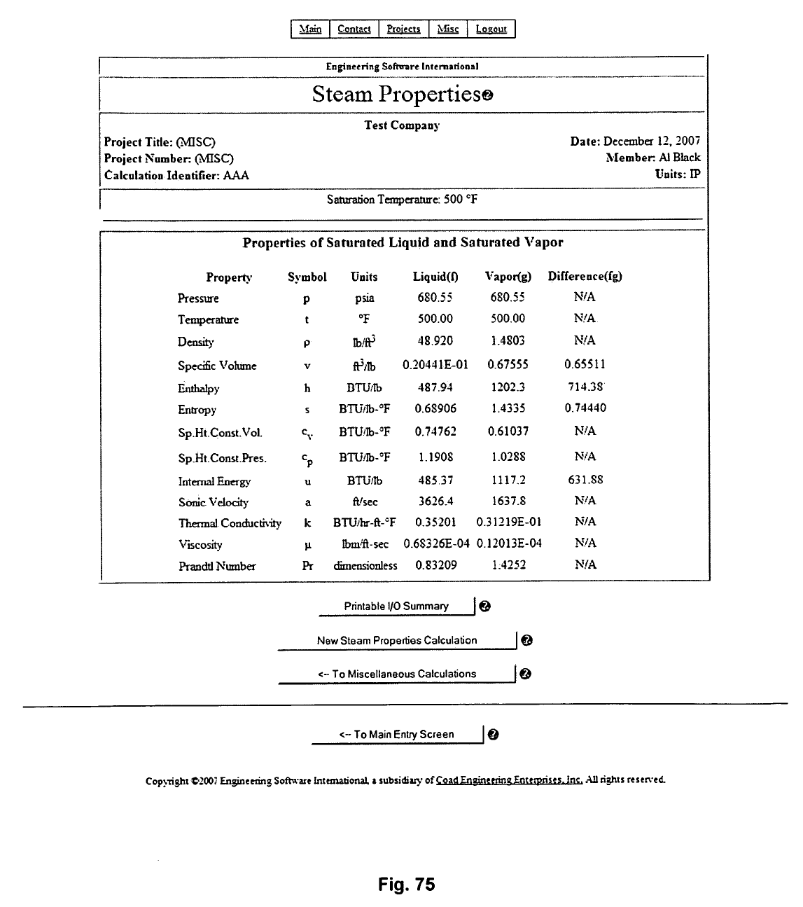

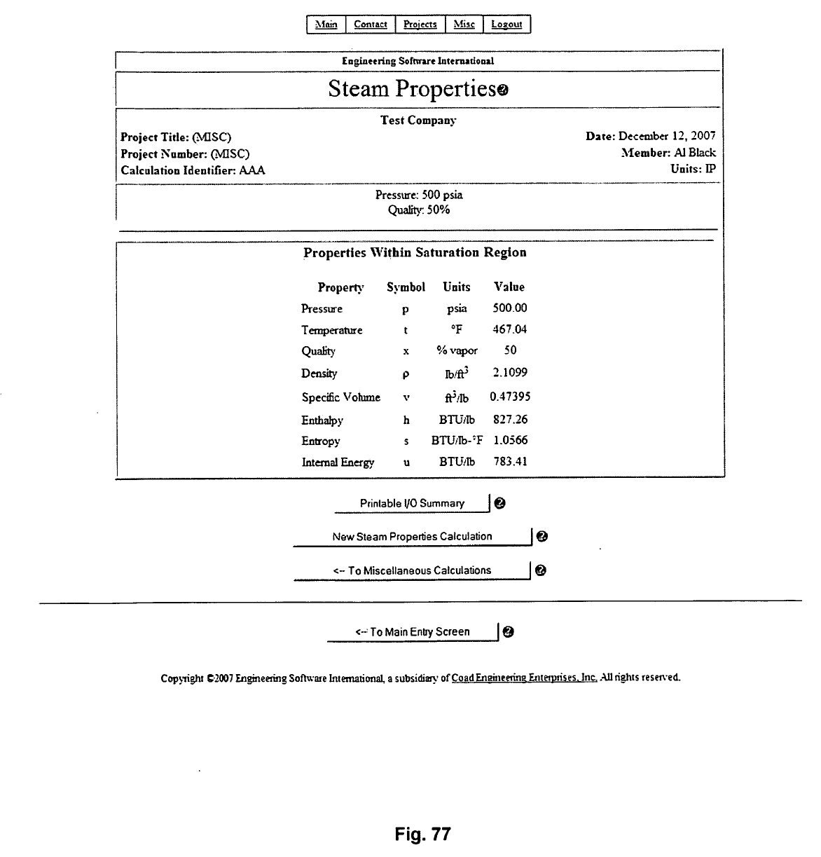

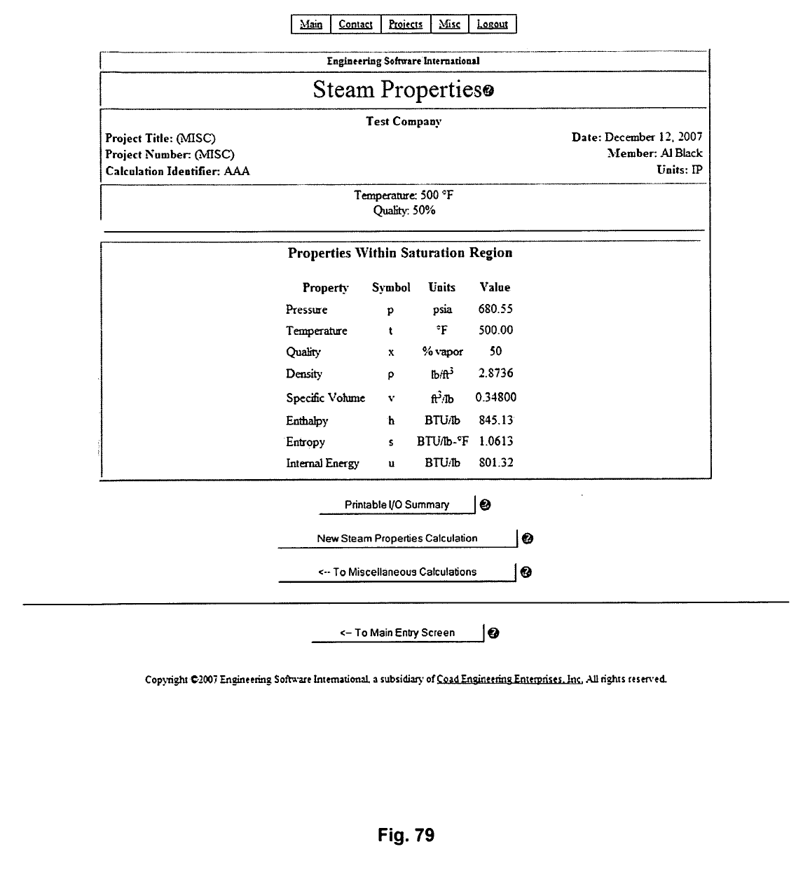

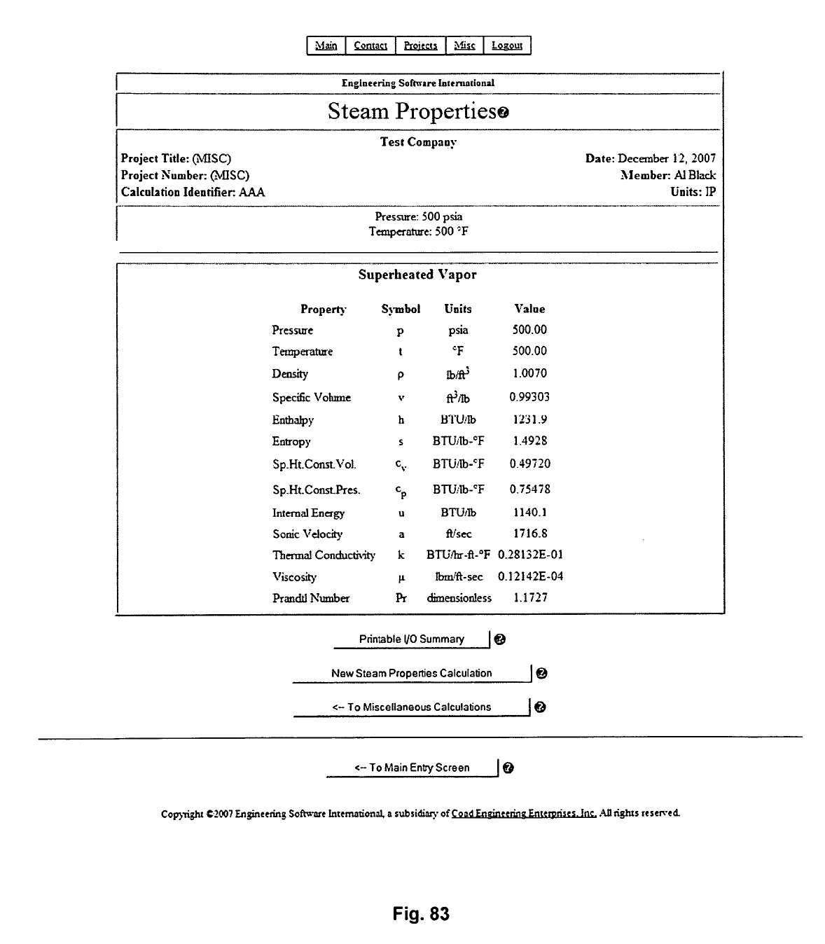

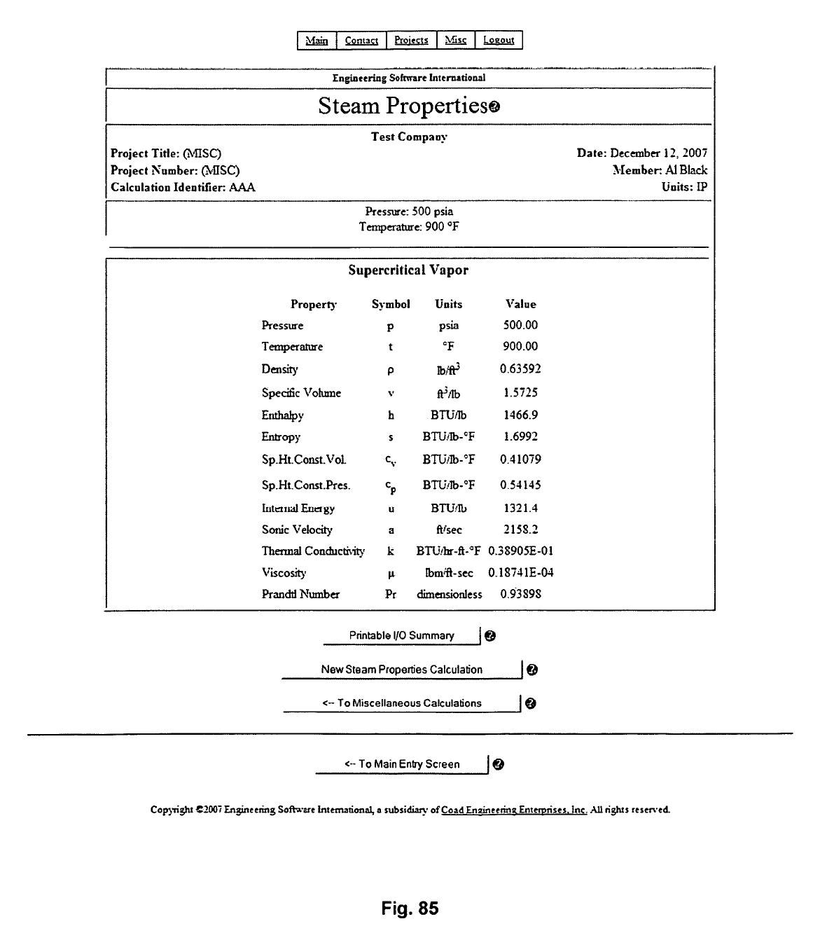

In some configurations, a system of the present teachings can comprise a calculation module for Steam Processes which can include output web pages which can provide inputted data and calculations regarding Saturated conditions (e.g., FIG. 73, FIG. 75, FIG. 77, FIG. 79, FIG. 81, FIG. 83, and FIG. 85). An output web page of these configurations can include, for example, inputted data such as exemplary data entered into fields in FIG. 72, FIG. 74, FIG. 76, FIG. 78, FIG. 80, FIG. 82, or FIG. 84, as well as properties of saturated liquid and saturated vapor. These properties can be provided in a table. A table of these configurations can have header categories such as Property, Symbol, Units, Liquid (f), Vapor (g) and Difference (fg). Examples of properties which can be included in a table can be properties such as pressure, temperature, quality, density, specific volume, enthalpy, entropy, specific heat constant volume, specific heat constant pressure, internal energy, sonic velocity, thermal conductivity, viscosity, and/or Prandtl Number.

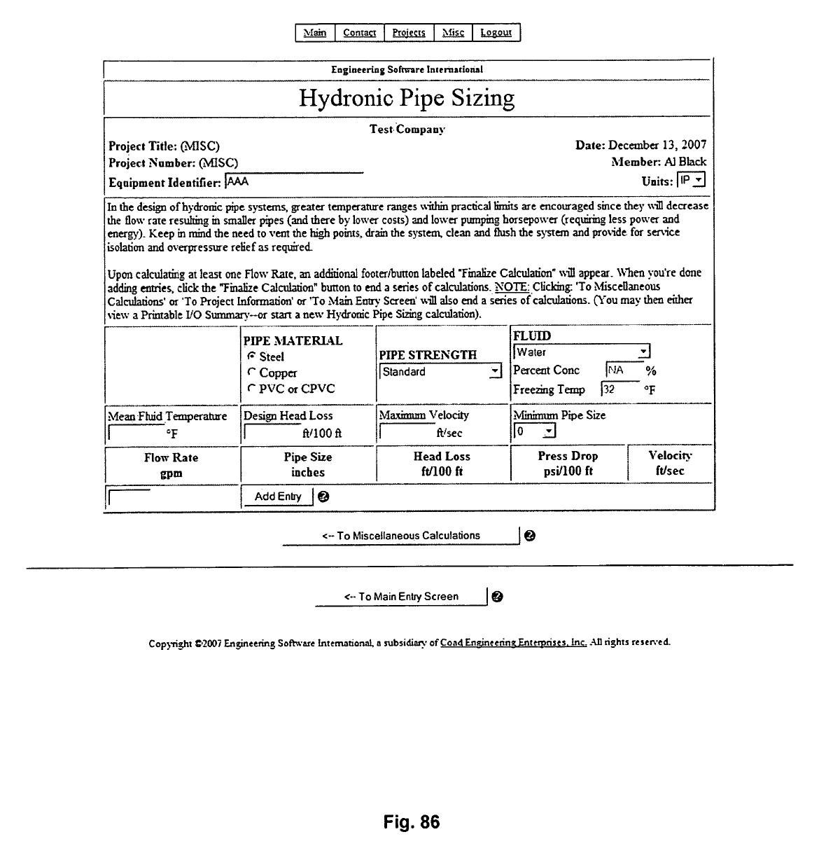

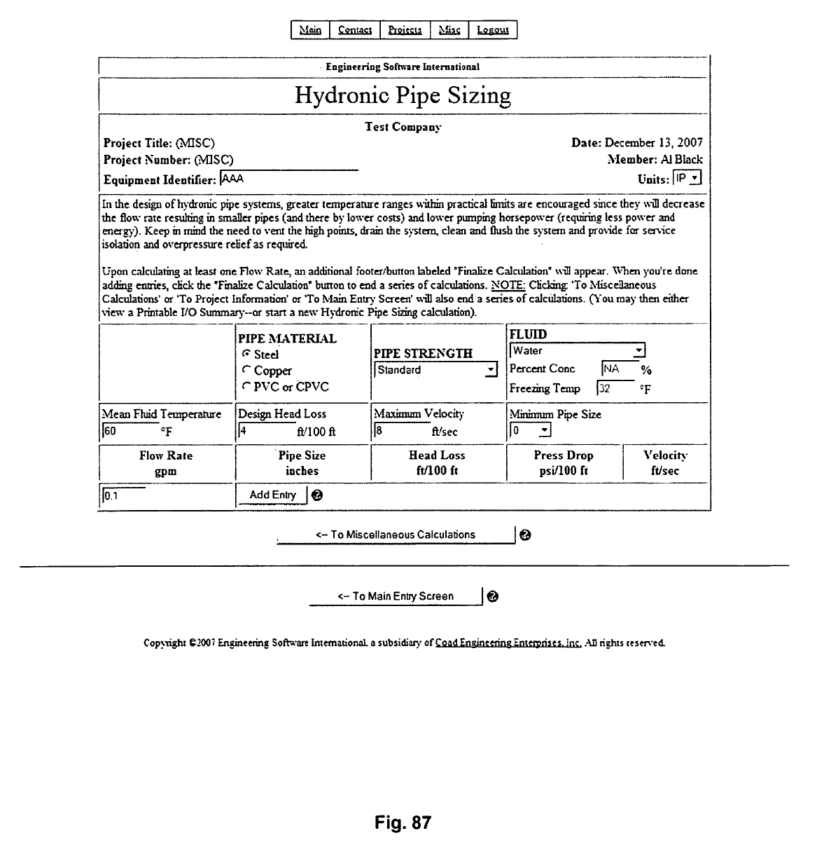

In some configurations, a system of the present teachings can comprise a calculation module for Steam Processes which can include input web pages which can comprise data entry fields regarding Hydronic Pipe Sizing (e.g., FIG. 86 or FIG. 87). An input web page of these configurations can include data input fields for equipment identifier and units, and can also comprise data input fields for pipe strength, fluid, percent concentration freezing temperature, mean fluid temperature, design head loss, maximum velocity, minimum pipe size and flow rate. An input web page of these configurations can also include buttons for pipe material (steel, copper, or PVC/CPVC). FIG. 87 includes exemplary input data, including a mean fluid temperature of 60° F., a design head loss of 4 ft/100 ft, a maximum velocity of 8 ft/sec, a minimum pipe size of 0; and a flow rate (gpm) of 0.1, as well as a selection of steel as pipe material, standard pipe strength, and water as fluid.

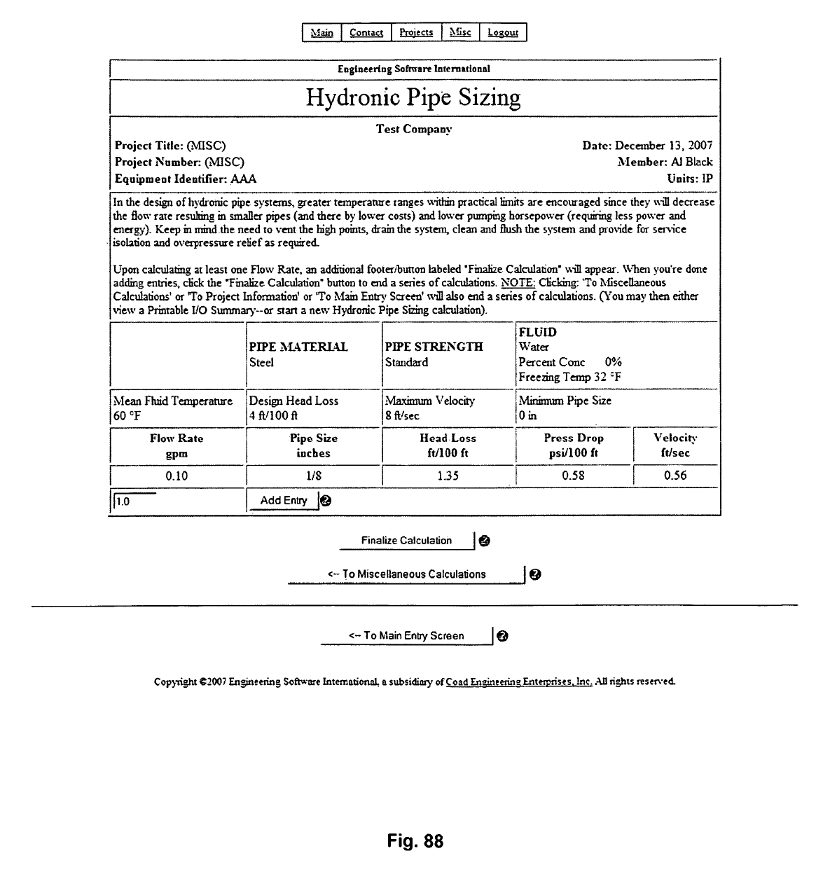

In some configurations, a system of the present teachings can comprise a calculation module for Hydronic Pipe Sizing which can include output web pages which can provide inputted data and selections, as well as calculated Hydronic Pipe Sizing information. For example, FIG. 88 reports a mean fluid temperature of 60° F., a design head loss of 4 ft/100 ft, a maximum velocity of 8 ft/sec, a minimum pipe size of 0; and a flow rate (gpm) of 0.1, as set forth in FIG. 87, it also reports a pipe size of ⅛ inch; a head loss of 1.35 ft/100 ft, a pressure drop of 0.58 psi/100 ft, and a velocity of 0.56.

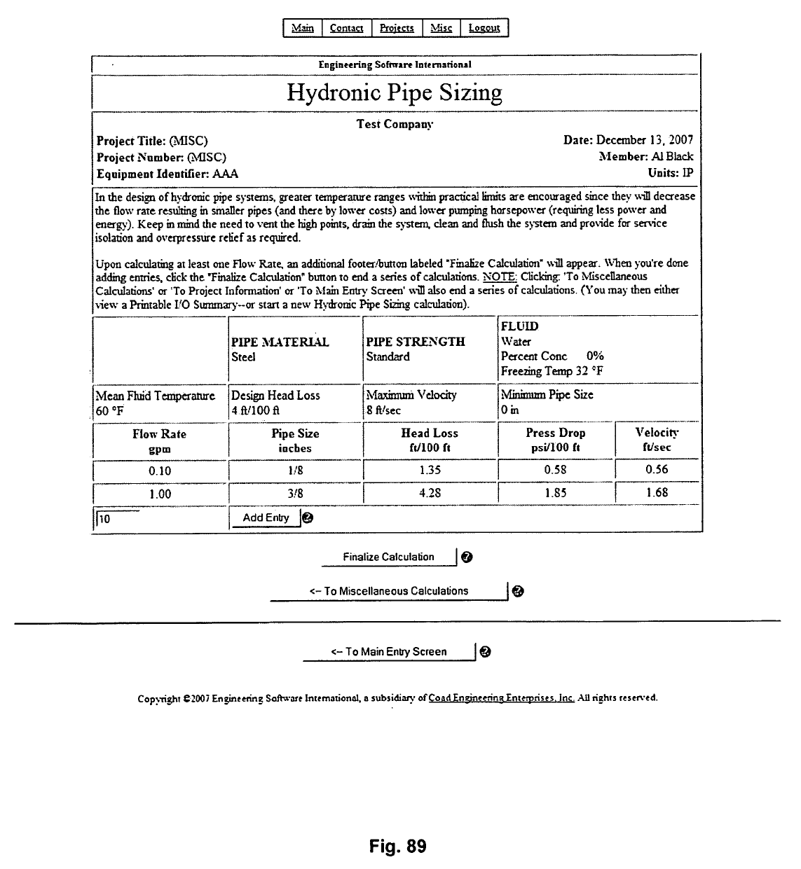

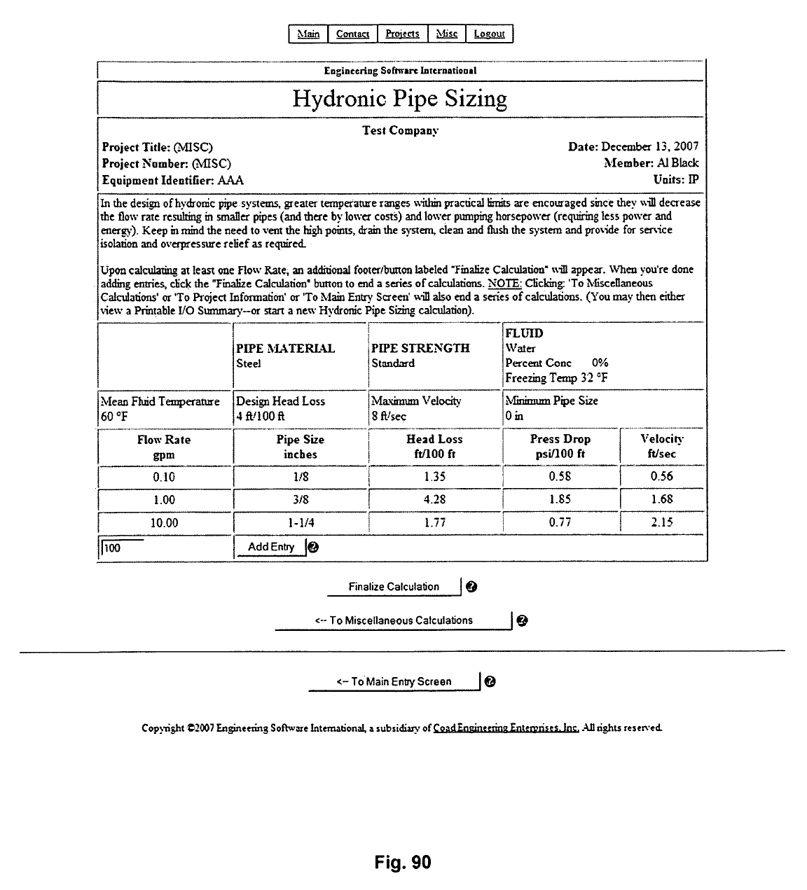

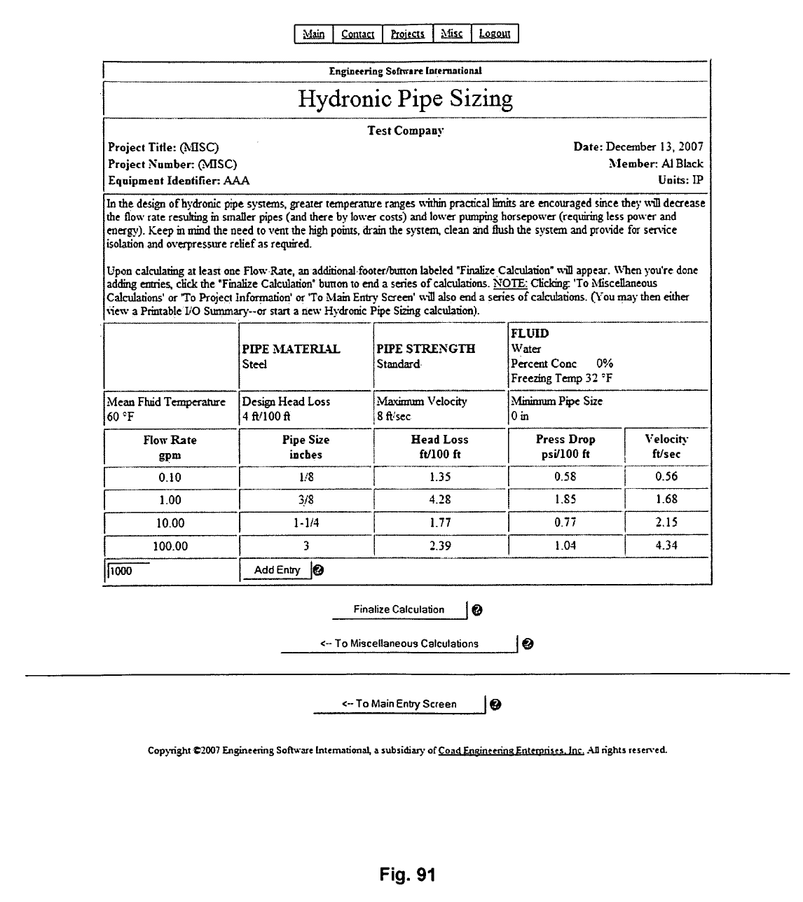

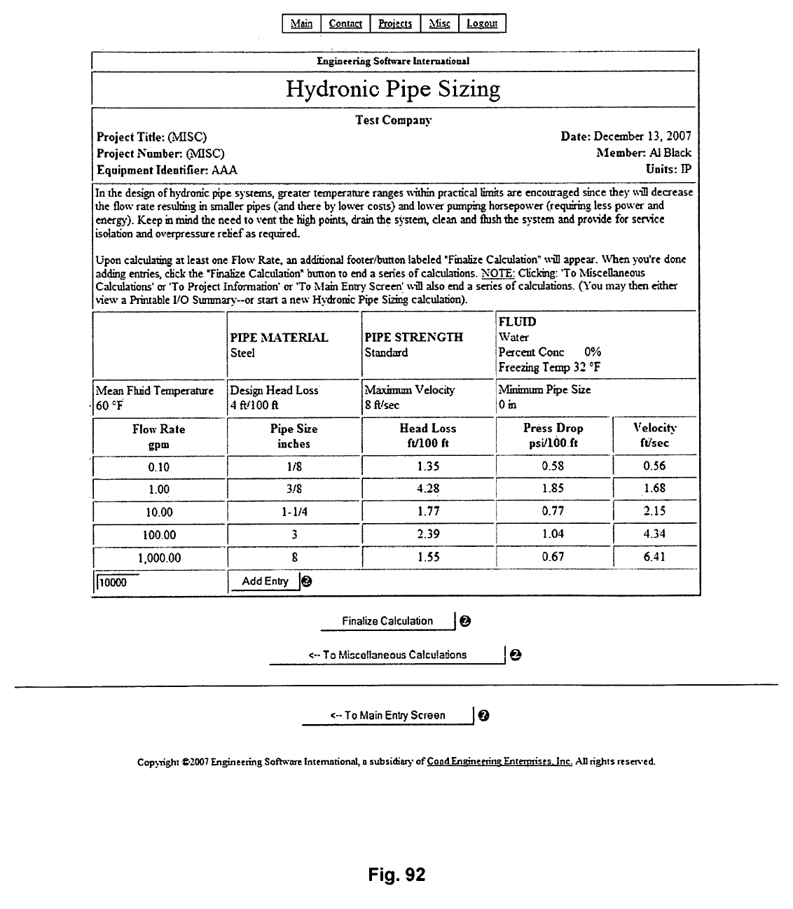

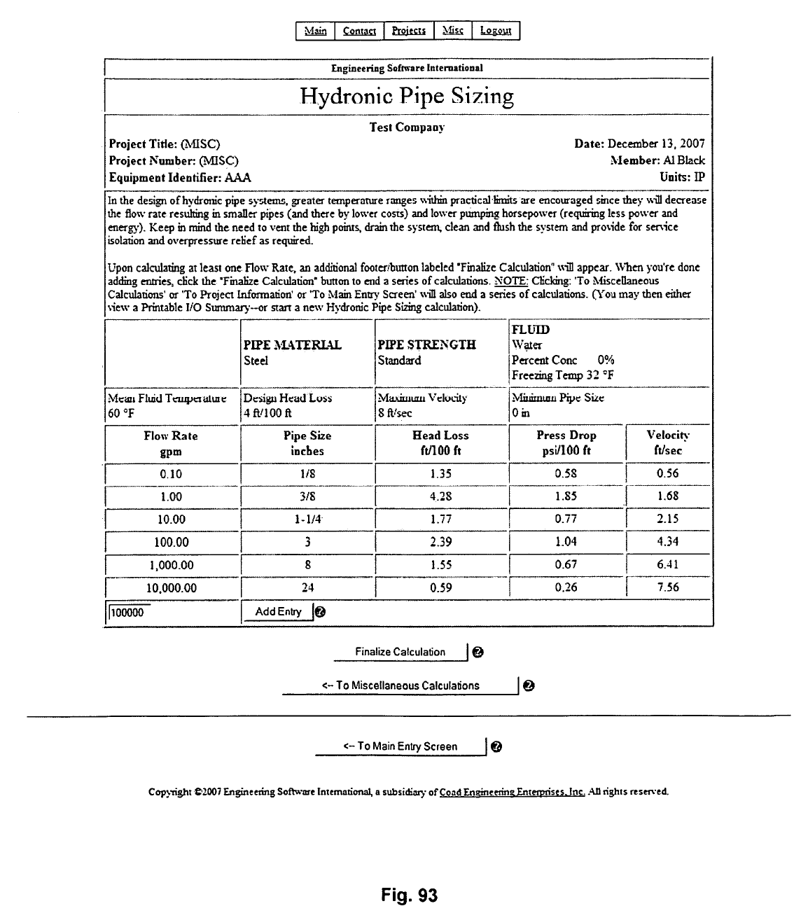

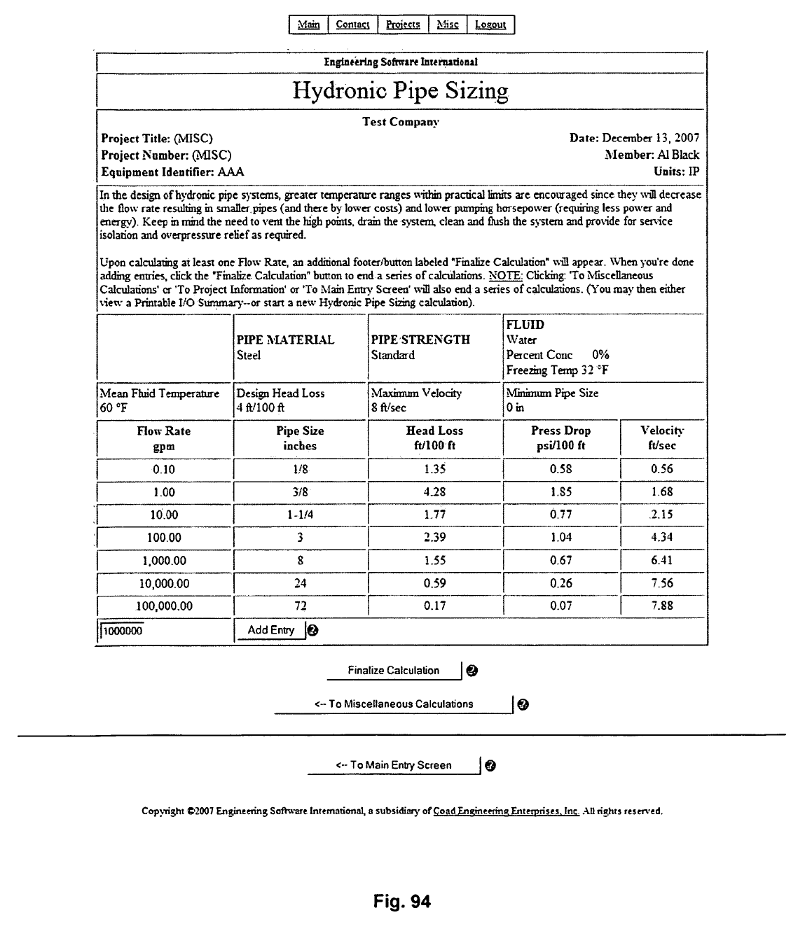

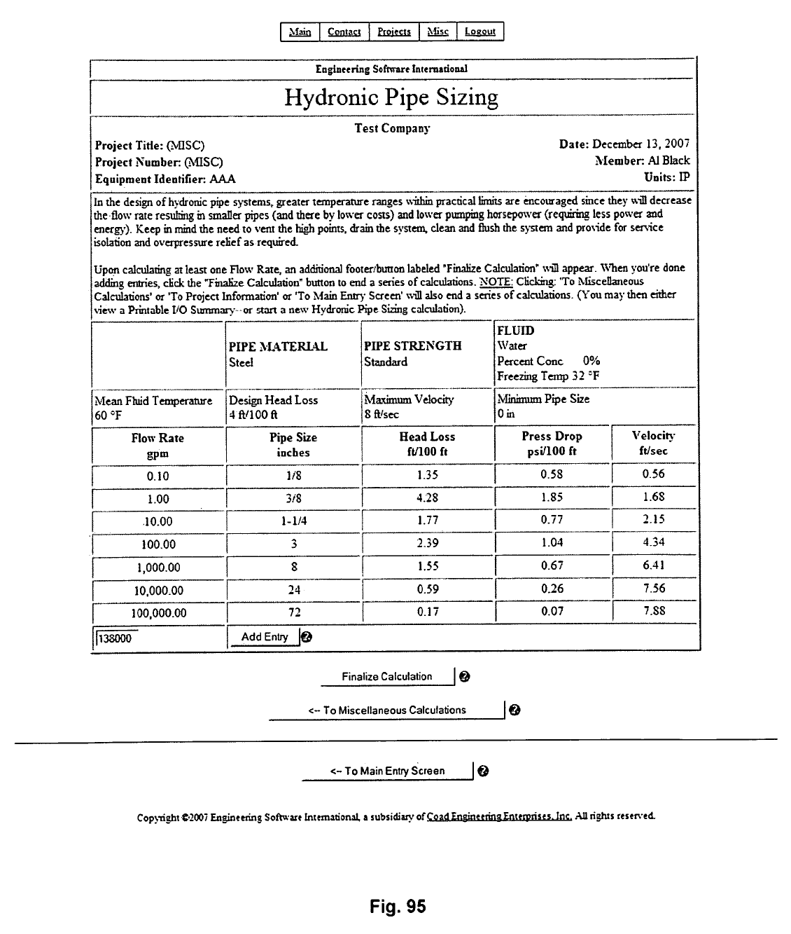

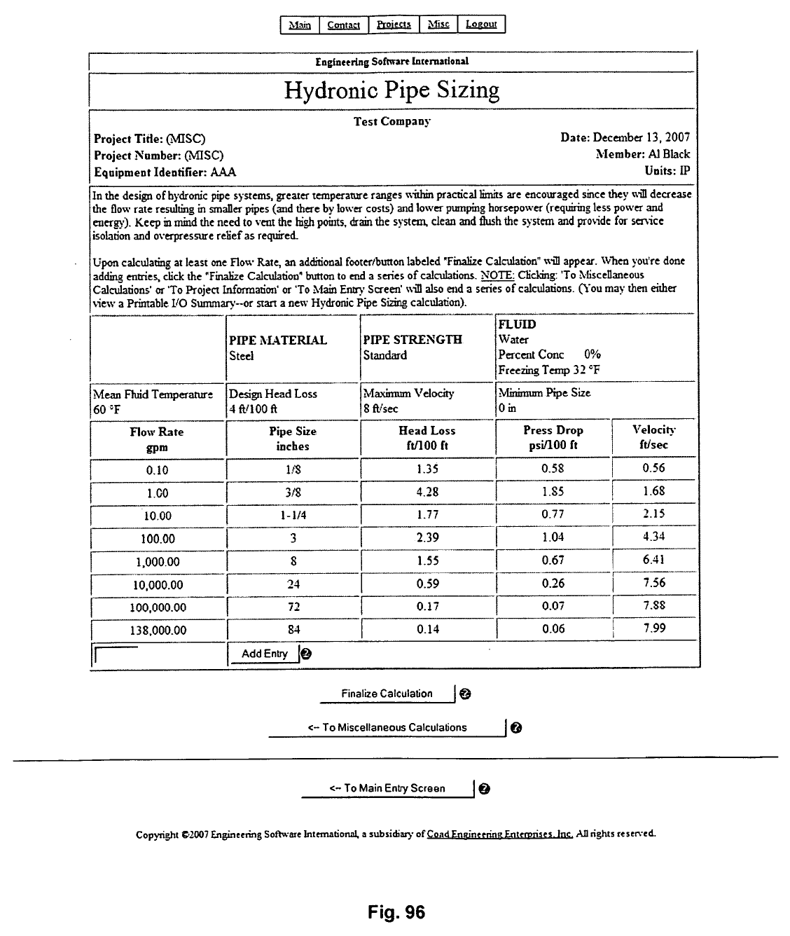

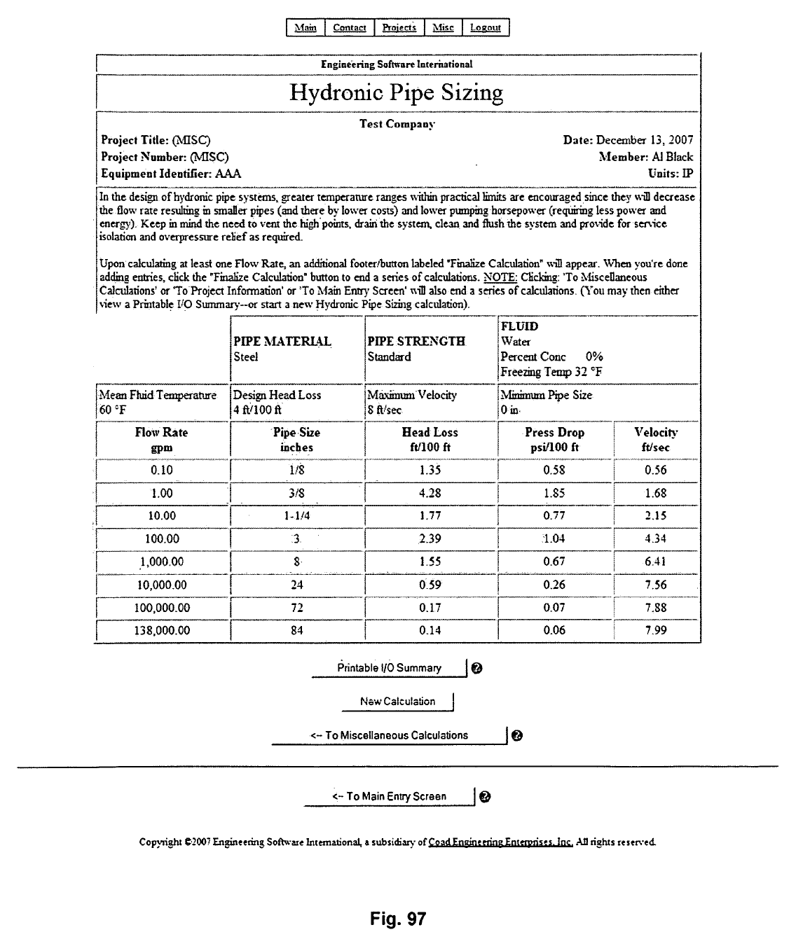

FIG. 89-FIG. 97 each provide further examples of output web pages regarding hydronic pipe sizing, and further illustrate that the system allows a user to submit serially different input values and observe the output that results from the different input on a single web page. For example, FIG. 97 includes 8 different flow rates inputted by a user, and the effects of changing the value of this variable on calculated values for pipe size, head loss, pressure drop and velocity.

### EXAMPLES

The following examples are intended to illustrate various aspects and configurations of the present teachings and are not intended to be limiting of the scope any claim.

Guidance pertaining to materials and methods described in these examples can be found in standard texts such as ASHRAE publications on HVAC engineering (e.g., ASHRAE Handbook of Fundamentals 1972, ASIN: B000QA0RR0; ASHRAE Handbook of Fundamentals 2005 I-P Edition w/CD; ISBN: 81050; ASHRAE HVAC Systems & Equipment Handbook 2004, IP Edition, ISBN: 1-931862-47-8; ASHRAE HVAC Applications Handbook 200 (IP), ISBN: 1933742143; and Wirtz, R., ASHRAE Terminology of HVAC & R, ISBN-10; 1930044224, ISBN-13: 978-1930044227; ESCO Press, 2006, each of which is herein incorporated by reference in its entirety)

### Example 1

This example illustrates the Psychrometric Properties calculation module and its use.

An ASHRAE Handbook of Fundamentals discloses an equation for the saturation vapor pressure for water as a function of temperature. Also provided are other equations with which, given a dry bulb temperature and a wet bulb temperature, it is possible to calculate humidity ratio, enthalpy, relative humidity, specific volume and density for moist air at a specific barometric pressure. Dew point temperature can be obtained by inverting the saturation pressure as a function of temperature equation to give saturation temperature as a function of vapor pressure. Because the saturation vapor pressure equation given is a polynomial with up to quartic terms, along with a reciprocal term and a natural logarithmic term, inversion becomes an iterative procedure, requiring care in execution to ensure convergence.

Similarly, finding all other properties given any two suitably independent properties usually requires an iterative approach. Specifically, properties of interest are dry bulb temperature, wet bulb temperature, dew point temperature, humidity ratio, relative humidity, enthalpy, specific volume (and its reciprocal, density) and vapor pressure. Wet bulb temperature and enthalpy are closely related and do not serve as two appropriate independent properties. Similarly, dew point temperature and humidity ratio are interdependent. Other than these, any two of the above properties can be used to calculate all the others.

Unfortunately, the appropriate ranges of the above properties are not always apparent. For instance, once a dry bulb temperature is selected, the wet bulb temperature cannot be greater than the dry bulb temperature, but also it cannot be lower than that which gives a zero humidity ratio. As an example, for a dry bulb temperature of 95° F., the wet bulb temperature may not exceed 95° F., but it also may not be below 54.9° F. at 14.696 psia atmospheric pressure.

The Psychrometric Properties module calculates limits on the second variable, given the first, and notifies the user when he asks for properties when the second variable is out-of-range. Temperature limits of 200° F. and −80° F. are used.

Psychrometric Properties is a “look-up” program and, as such, it is not automatically filed. It may be accessed (like all other programs) via a Project File, or directly from the Main Entry Screen. The calculation will not be filed unless you enter a Calculation Identifier. If you do provide a Calculation Identifier, it will be filed (either in the appropriate Project File, or as a “Miscellaneous” calculation).

The only units available at this time are inch-pounds (IP).

The elevation shown is the default value from your “Member Preferences” screen. If you desire a different elevation, simply remove the default value from the elevation (or either of the pressure entry fields), and replace it with the value desired. (The next click of the mouse or “tab” key will change the other two entry fields).

To determine the properties at any state point (at the elevation shown), simply define the state point by entering any two properties in the entry fields. After entering two properties, click on “Calculate”, and the remaining properties will appear on the output screen. The boxes in the lower right corner of the screen will indicate whether or not the state point is within the “Comfort Zone” (as defined in ASHRAE Standard 55-2004).

To view the properties in a printable format, click on “Printable I/O Summary”, and the information from the screen will appear in a printable format (for paper filing or saving locally).

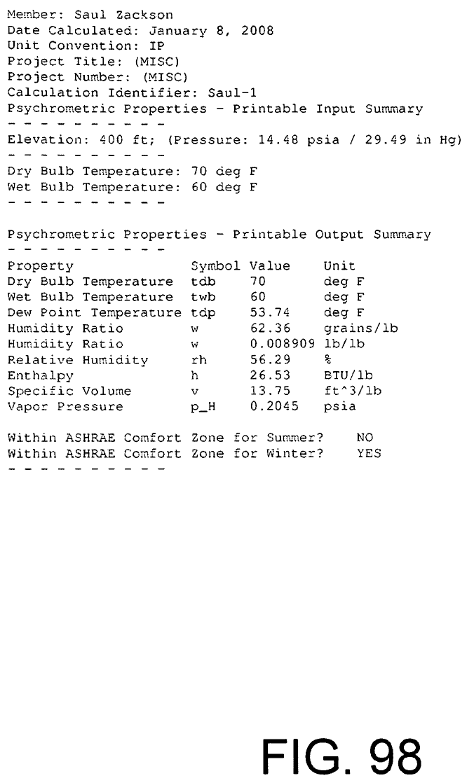

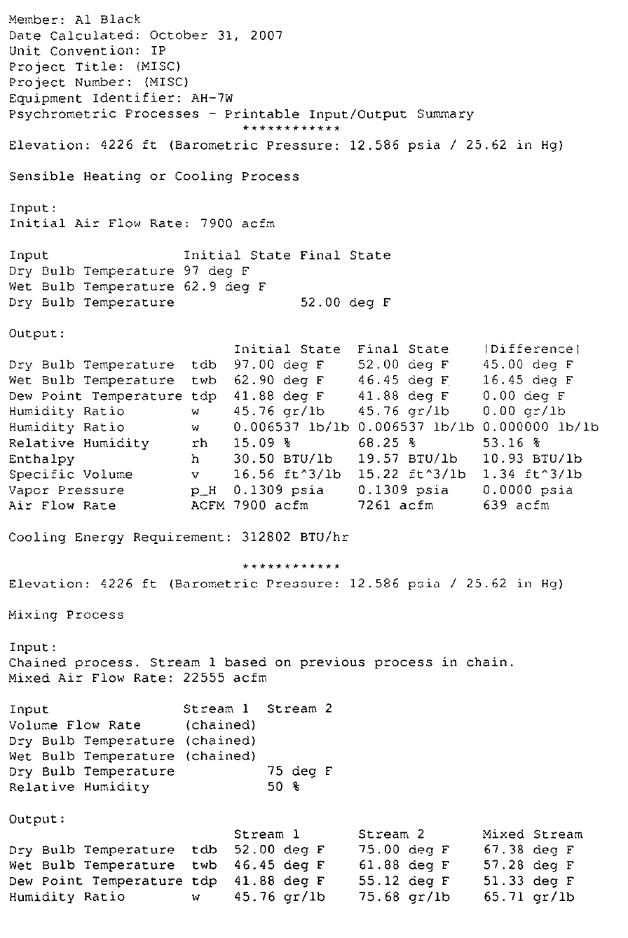

An exemplary Psychrometric Properties Input/Output summary is provided in FIG. 98.

### Example 2

This Example illustrates the Psychrometric Processes calculation module and methods of use.

The Psychrometric Processes module uses the Psychrometric Property module previously described to provide properties needed for calculating processes. Processes specifically available in the Psychrometric Processes module are:

Mixing of Two Streams

Cooling with Dehumidification

Cooling or Heating without Dehumidification/Humidification (Sensible)

Isothermal Humidification

Evaporative Cooling

In addition, Differences Between Two State Points are available.

The Mixing of Two Streams process is the only one in which two separate input streams are used; all other processes have only one stream. In the Mixing process, a total resultant (combined) flow is specified in ACFM along with the flow of one of the component streams, either in percent by mass or by ACFM; the flow of the remaining input stream is calculated by the program. The output gives the properties of the composite stream. Since the process is adiabatic, there is no net heating or cooling associated with this process.

Cooling with Dehumidification calculates the net sensible, latent and total cooling associated with the change of state of the specified input flow from inlet to outlet conditions. The outlet ACFM is also calculated.

Sensible Cooling or Heating calculates the net sensible cooling or heating associated with the change of state of the specified input flow from inlet to outlet conditions. The outlet ACFM is also calculated.

Isothermal Humidification calculates the net latent heating associated with the change of state of the specified input flow from input to outlet conditions. The outlet ACFM is also calculated.

Evaporative Cooling calculates the final state associated with an adiabatic saturation process for a specified flow at given input conditions. The final state is determined by the abiabatic effectiveness of the evaporative cooling device. The outlet ACFM is also calculated.

The Difference Between Two State Points calculates the net change in all properties between input and output states.

Each of the above processes may be calculated as a stand-alone process; however, it is also possible to chain any or all of the above processes (except Difference Between Two State Points) in any order. By specifying the successive process after the completion of a prior one, outputs from the first become inputs to the second. A running total of sensible and latent cooling and heating energy is kept, along with the outlet states of all process.

The Psychrometric Processes programs may be accessed via Miscellaneous Calculations, or a project file, or from the Main Entry Screen. Any program accessed through the Main Entry Screen will be filed as a “Miscellaneous” calculation.

A unique feature of five of these programs is that the analyst may use the outlet state point of one process as the inlet of another—in the same sequence that the air would move through a system from process to process. This procedure of moving through multiple “connected” processes is called “chaining” or “linking”. The following descriptions are of each individual process as a standalone, followed by a description of the chaining process.

The initial screen of Psychrometric Processes is a menu of the processes available. (If a particular process is selected via the Main Entry Screen, this screen will be bypassed). From this menu screen, the user will select a radio button to identify the process desired. Clicking on Proceed will bring up the screen for the desired process. As with all module screens, the other available footers will return you to the “Main Entry Screen” (or “Miscellaneous Calculations”/“Project Information” screen, as appropriate) . . . through which you entered Psychrometric Processes.

The Mixing Process

All Psychrometric Process calculations are filed:

1) Under the project through which they were accessed, or;

2) As a miscellaneous calculation.

Each calculation should be given a unique Equipment Identifier (a name and/or number . . . no punctuation or symbols). The program will not run without an identifier. The IP unit designation is the only one available at this time.

The elevation shown is the default value from your “Member Preferences” screen. If you desire a different elevation, simply remove the default value from the elevation (or either of the pressure entry fields), and replace it with the value desired. (The next click of the mouse or “tab” key will change the other two entry fields).

In the initial input field insert the volumetric air flow rate in actual cubic feet per minute (acfm). (Note: no commas when entering acfm . . . or when entering any numeric input).

The mixing ratio may be expressed in two ways (selected by the radio buttons at the left of the box on the screen:

1) As each stream's percentage of the whole (expressed as % by mass) or;
2) By actual volumetric flow rate of one stream in acfm.

Select the desired radio button then enter the appropriate value in the entry field.

Note: When selecting the mass ratio method, only one value is necessary and the other value will be the complement for the total of 100%. Likewise, when selecting volumetric flow rate, only one value need be entered, since the total flow after the mixing has already been entered; the program will calculate the second stream flow rate.

After entering the mix quantities, any two properties of each stream are entered. After entering these two properties for each stream click on Calculate, to see the output screen, showing all of the properties (plus those of the mixed stream).

The output stream may be input directly into a subsequent process, discussed below under “Chaining.”

The footer options are as follows:

Proceed is used only for linked processes (see below).

Printable I/O Summary will display an I/O Summary, which may be printed as a paper record, or saved locally.

If Recalculate is selected prior to Printable I/O Summary, it will return you to the previous input screen (with the same Equipment Identifier and elevations), and the result of the calculation will not be filed; only the new/recalculated calculation will be filed. If this ‘new’ calculation is not completed, the permanent file will state, “no processes have been run yet.”

If Recalculate is selected after having clicked on Printable I/O Summary, it will return you to the Psychrometric Processes menu screen and the process just completed will be permanently and appropriately filed.

To Psychrometric Processes Menu, To Miscellaneous Calculations, To Project Information, and To Main Entry Screen footers will return you to each of these screens respectively and permanently file the calculation.

Cooling and Dehumidifying Process

Again, as in all other processes, the calculation should be given a unique Equipment Identifier. The (editable) elevation and barometric pressure fields will fill in with the default values from the Member Preferences screen.

Enter the air flow rate (in acfm) entering the process (no commas), and any two properties for the entering stream and the leaving steam. Then click Calculate.

The output screen displays the input properties in bold; the remainder of the properties for each statepoint; the absolute difference between each property of the entering statepoint; and the leaving state point (where relevant) . . . and the sensible, latent, and total heat removed in the process.

The footer options are as follows:

Proceed is used for chaining linked processes.

Printable I/O Summary will complete the calculation and display an “I/O Summary” which may be printed (or saved locally).

If Recalculate is selected prior to Printable I/O Summary, it will return you to the previous input screen (with the same Equipment Identifier and elevations), and the results of the calculation will not be filed; only the new/recalculated calculation will be filed.

If Recalculate is selected after having clicked on Printable I/O Summary, it will return you to the Psychrometric Processes menu screen and the process just completed will be permanently and appropriately filed.

To Psychrometric Processes Menu, To Miscellaneous Calculations, To Project Information, and To Main Entry Screen footers will return you to each of these screens respectively and permanently file the calculation.

Sensible Heating or Cooling Process

The Sensible Heating or Cooling Process, like other Psychrometric processes, requires a Equipment Identifier (for filing purposes). The elevation/barometric pressure default values may be modified. The initial actual airflow rate in acfm should be entered in numerals only (no commas—but decimal points are acceptable).

To define a process, enter any two properties at the initial statepoint. As the process is sensible only, the only property that may be used to define the final statepoint is the dry bulb temperature: so in the second column, simply enter the dry bulb temperature at the final state point, then click Calculate.

The output screen displays all of the properties at the initial state; the final state; the absolute difference between them (where relevant) . . . and the amount of sensible heating or cooling transferred in the process.

The footer options are as follows:

Proceed is used for chaining linked processes.

Printable I/O Summary will complete the calculation and display an “I/O Summary” which may be printed (or saved locally).

If Recalculate is selected prior to Printable I/O Summary, it will return you to the previous input screen (with the same Equipment Identifier and elevations), and the results of the calculation will not be filed; only the new/recalculated calculation will be filed.

If Recalculate is selected after having clicked on Printable I/O Summary, it will return you to the Psychrometric Processes menu screen and the process just completed will be permanently and appropriately filed.

To Psychrometric Processes Menu, To Miscellaneous Calculations, To Project Information, and To Main Entry Screen footers will return you to each of these screens respectively and permanently file the calculation.

Isothermal Humidification Process

After entering a Equipment Identifier and selecting the appropriate elevation, enter the initial air flow rate in actual cubic feet per minute (acfm) . . . in numerals only, no commas. Enter any two properties to define the initial statepoint. Since this is an isothermal process, the final dry bulb temperature will be equal to the initial. Any other final property will define the desired final statepoint.

The next step is to click Calculate. If you click To Miscellaneous Calculations, To Project Information, or To Main Entry Screen, an error signal will appear and ask if you want to abandon the calculation. If you confirm that you do, the data entered on the screen will not be filed.

To complete the calculation, click Calculate. The output screen will provide all of the properties, as well as the acfm at both the initial and final statepoints; the absolute difference between the properties (where appropriate); and the amount of latent heat added in BTU per hour.

The footer options are as follows:

Proceed is used for chaining linked processes.

Printable I/O Summary will complete the calculation and display an “I/O Summary” which may be printed (or saved locally).

If Recalculate is selected prior to Printable I/O Summary, it will return you to the previous input screen (with the same Equipment Identifier and elevations), and the results of the calculation will not be filed; only the new/recalcuilated calculation will be filed.

If Recalculate is selected after having clicked on Printable I/O Summary, it will return you to the Psychrometric Processes menu screen and the process just completed will be permanently and appropriately filed.

To Psychrometric Processes Menu, To Miscellaneous Calculations, To Project Information, and To Main Entry Screen footers will return you to each of these screens respectively and finalize/permanently file the calculation.

Evaporative Cooling Process

After entering a Equipment Identifier and selecting the appropriate elevation, enter the initial air flow rate in actual cubic feet per minute (acfm) in numerals only (no commas).

The entry field for the adiabatic effectiveness will display the default value at 100%. This required value may be edited. The adiabatic effectiveness is primarily a function of the evaporative device used to accomplish this process.

Next enter any two properties of the initial air stream entering the process and click Calculate. The output screen will provide all of the properties (as well as the acfm at both the initial and the final statepoints and the absolute difference between the properties, where appropriate).

The footer options are as follows:

Proceed is used for chaining linked processes.

Printable I/O Summary will complete the calculation and display an “I/O Summary” which may be printed (or saved locally).

If Recalculate is selected prior to Printable I/O Summary, it will return you to the previous input screen (with the same Equipment Identifier and elevations), and the results of the calculation will not be filed; only the new/recalculated calculation will be filed.

If Recalculate is selected after having clicked on Printable I/O Summary, it will return you to the Psychrometric Processes menu screen and the process just completed will be permanently and appropriately filed.

To Psychrometric Processes Menu, To Miscellaneous Calculations, To Project Information, and To Main Entry Screen footers will return you to each of these screens respectively and finalize/permanently file the calculation.

Differences Between Two State Points

This program is different from the other programs in the Psychrometric Processes in two ways. First, it is not a process but merely a quick reference to the difference between any relevant properties at the statepoints of interest. Secondly, it is handled as a look-up program and may be used without a Calculation Identifier. As with other “look-up” programs (i.e., Psychrometric Properties & Steam Properties), if no Calculation Identifier is entered, the program will run but will not be filed.

Enter a Calculation Identifier only if you wish the calculation to be filed. Change the elevation if you desire a value different than the default value. Then, simply enter any two properties for each of the statepoints desired.

Click Calculate, and the remainder of the properties at each statepoint will be displayed (as well as the absolute value of the difference between the two values of each of the properties).

When the calculation is completed footer options are:

The Printable I/O Summary will provide a summary to print for a paper reference.

To Psychrometric Processes Menu, To Miscellaneous Calculations, To Project Information, and To Main Entry Screen footers will return you to each of these screens respectively and finalize/permanently file the calculation.

Chaining Psychrometric Processes

The procedure for chaining psychrometric processes allows the analyst to study multiple processes that an air stream might realize in an air conditioning situation. A common series of processes may comprise:

A Mixing Process between an outdoor air (ventilation air stream) and a return air stream. Then, the mixed air would enter . . . .

A Cooling And Dehumidifying Process as it passes through a chilled water or refrigerant cooling coil. Then, the cooled, dehumidified stream might enter . . . .

A reheat process (Sensible Heating and Cooling Process), where it would be reheated prior to being introduced into the space.

In applying this chaining procedure, the first process selected is the Mixing Process. Use of this program is as described above. The Mixing Process output screen includes the acfm; all of the characteristics of each of the two streams prior to the mixing; and all of the characteristics of the mixed stream.

On the output screen (immediately below the output characteristics) is the text “Chain output into the following process”, followed by a pull down. Click on the pull down arrow to see all other psychrometric processes available for chaining. For the above example, select Cooling and Dehumidifying Process & click Proceed.

This will provide the input screen for that “chained in to” process, which will include the following (hard-wired) inputs:

Equipment Identifier

Units

Elevation (and barometric pressure)

Initial air flow rate in acfm

All of the initial state point properties.

Enter two of the properties to describe the final state (that of the air leaving the Cooling and Dehumidifying Process) and click Calculate.

The output screen provides all of the properties at the Final Statepoint (and the absolute difference between the initial and final states; the initial and final volumetric air flow rates in acfm and the sensible, latent and total cooling requirement in BTU per hour).

To continue the chain (for the given example), select the next process (Sensible Heating or Cooling), and click Proceed. This will bring up the input screen for that process (which will include the same (hard-wired) inputs seen on the first “linked” screen, plus the output values from the Cooling and Dehumidifying Process). For the Sensible Heating and Cooling Process, the only input information required (when linking) is the final state point dry bulb temperature. After entering that value, click Calculate. The output screen will appear with the characteristics of the initial state point; the final state; the absolute difference between all relevant characteristics; the final state volumetric flow rate (in acfm); and the amount of heating required for the reheat (in BTU/hour).

IMPORTANT: We have just completed the last process of this chain (though we have continued chaining processes). When chaining, the I/O summary may be viewed (by selecting Printable I/O Summary) before any chained calculation is finalized . . . in order to review your progress. A Psychrometric Processes calculation is terminated/finalized by clicking any of the other footer navigation bars (except, of course, “Recalculate”). Once finalized, the I/O summary may be viewed by selecting the Equipment Identifier in the Psychrometric Processes Calculation List (via the Miscellaneous Calculations or Project Information screens).

Once finalized, the chain may only be continued by starting over (perhaps with the aid of the I/O Summary), or by commencing a new series.

NOTE: In chaining, the computer keeps track of the cooling and heating requirements, and the Summary will include the Sensible, Latent and Total Heating Requirements and Cooling Requirements.

In addition to the Printable I/O Summary & Recalculate the other footer options are:

To Psychrometric Processes Menu, To Miscellaneous Calculations, To Project Information, and To Main Entry Screen . . . each will return you to these screens respectively and finalize/permanently file the calculation.

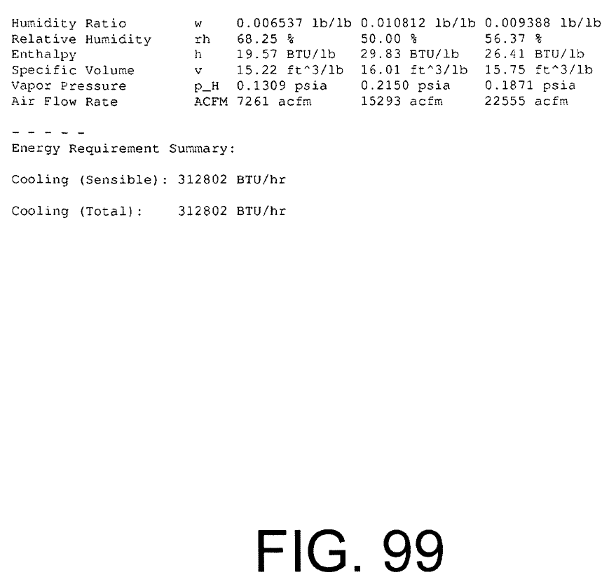

An exemplary Psychrometric Processes Input/Output summary is provided in FIG. 99.

### Example 3

This Example illustrates the Steam Properties calculation module and methods of use.

The kernel of the Steam Properties module allows input of an appropriate two properties from the set of temperature, pressure, quality, enthalpy and entropy. State points may be in the subcooled, saturated, superheated or supercritical regions.

Steam Properties is a “look-up” program (similar to Psychrometric Properties) and as such, is only filed if a Calculation Identifier is provided. It may be accessed, per other programs, through a project file or from the Main Entry Screen. If you do provide a Calculation Identifier, an I-O summary will be saved either in the appropriate project file, or in Miscellaneous Calculations.

The only units available (at this time) are inch pounds (IP). All pressure terms are, in accordance with accepted steam table practice, expressed in pounds per square inch absolute (psia). No barometric pressure or elevation term is required.

The first set of entry fields is for Saturated Steam. The entry fields labeled Saturated provide for four input options. Option one, line one, has an entry field for Saturation Pressure in psia. Option two, line two, is for saturation temperature in ° F.

To use either of these options, click on the appropriate radio button . . . and then enter either the desired Pressure or Temperature. Then click the “Calculate” button. An answer screen will appear with the project and member identifiers, and the saturation condition entered . . . plus a listing of the properties Saturated Liquid (f), Saturated Vapor (g) and the Difference (fg) (for specific volume, enthalpy, entropy and internal energy).

Properties shown for both the saturated liquid and saturated vapor include:

| Properties | Symbol | Units |
|---|---|---|
| Pressure | P | psia |
| Temperature | t | ° F. |
| Density | ρ | lb/Ft³ |
| Specific Volume | ν | Ft³/lb |
| Enthalpy | h | Btu/lb |
| Entropy | s | Btu/lb ° F. |
| Specific Heat at Constant | cᵥ | Btu/lb ° F. |
| Volume | | |
| Specific Heat at Constant | cₚ | Btu/lb ° F. |
| Pressure | | |
| Internal Energy | u | Btu/lb |
| Sonic Velocity | a | Ft/sec |
| Thermal Conductivity | k | Btu/HrFt ° F. |
| Viscosity | μ | lbm/ft.sec. |
| Prandtl Number | Pr | dimensionless |

To view the properties in a printable format click the “Printable I/O Summary” button. This will provide a printable screen which contains the same information as the HTML output screen. Other footers include “New Steam Properties Calculation” (which will return you to the initial Steam Properties input screen, where you can look up another statepoint), “To Miscellaneous Calculations” or “To Project Information” (depending upon where you entered Steam Properties from), and the “To Main Entry Screen” button.

The third and fourth entry options under Saturated are for selecting a specific statepoint within the saturation dome. The third line requires Saturated Pressure in psia and quality in % (lbs. Steam/lb. Mixture×100). Select the appropriate radio button, enter the appropriate property and quality, and click the “Calculate” button.

An answer screen will appear with the identifying headers, the property and quality which had been entered, and a list of the properties for the specific point within the saturation region. Note: Since this is a mix of saturated liquid and saturated vapor, only those properties which can be expressed as a mixture are presented. These include:

| Property | Symbol | Units |
|---|---|---|
| Pressure | p | psia |
| Temperature | t | ° F. |
| Quality | x | % vapor |
| Density | ρ | lb/Ft³ |
| Specific Volume | ν | Ft³/lb |
| Enthalpy | h | Btu/lb |
| Entropy | s | Btu/lb ° F. |
| Internal Energy | u | Btu/lb |

The footers/navigation options are the same as those for the saturated liquid/vapor options above.

The other input option is for any steam condition other than saturated. This is identified on the input screen as Superheated or Supercritical Vapor or Subcooled Liquid. To select a statepoint for any of these conditions, select the radio button, then simply fill in the pressure and the temperature of the statepoint and click the “Calculate” button.

An answer screen will appear with identifying headers, and the pressure and temperature entered. At the top of the section with the values of the properties at that statepoint will be the “condition” . . . either Subcooled Liquid, Superheated Vapor or Supercritical Vapor. This screen displays these other properties at the selected statepoint:

| Property | Symbol | Units |
|---|---|---|
| Pressure | P | psia |
| Temperature | t | ° F. |
| Density | ρ | lb/Ft³ |
| Specific Volume | ν | Ft³/lb |
| Enthalpy | h | Btu/lb |
| Entropy | s | Btu/lb ° F. |
| Specific Heat at Constant | cᵥ | Btu/lb ° F. |
| Volume | | |
| Specific Heat at Constant | cₚ | Btu/lb ° F. |
| Pressure | | |
| Internal Energy | u | Btu/lb |
| Sonic Velocity | a | Ft/sec |
| Thermal Conductivity | k | Btu/HrFt ° F. |
| Viscosity | ν | lbm/ft.sec. |
| Prandtl Number | Pr | dimensionless |

The footers/navigation are the same as other output screens for Steam Properties.

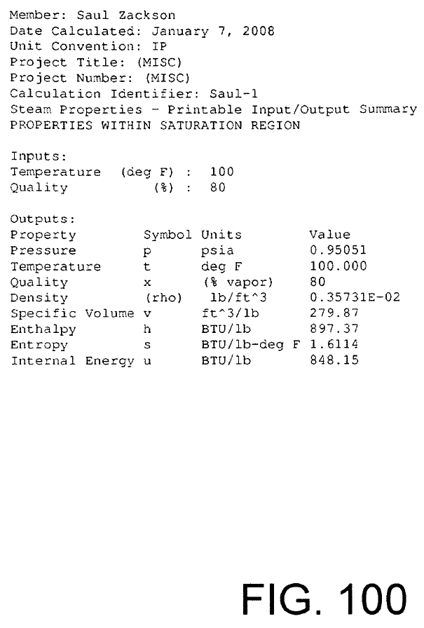

An exemplary Steam Properties Input/Output summary is provided in FIG. 100.

### Example 4

This Example illustrates the Hydronic Pipe Sizing calculation module and its use.

Typical pipe flow algorithms calculate pressure drop or head loss as a function of pipe specifications (material, internal diameter, roughness), fluid properties and flow velocity, using the Darcy-Weisbach equation

$$\frac{Δ p}{L} = \frac{f}{D} ρ \frac{{V}^{2}}{2} .$$

The friction factor is usually given by the Colebrook equation:

$$\frac{1}{\sqrt{f}} = 1.74 - 2 log ( \frac{2 ɛ}{D} + \frac{18.7}{Re \sqrt{f}} ) ,$$

an expression which expresses the friction factor as a function of relative roughness and Reynolds number; the expression is nonlinear and implicit in the friction factor (the friction factor appears on both the left and right sides of the equation). An iterative solution is used.

The Hydronic Pipe Sizing module has a kernel which will accept as input any two of head loss or pressure drop, volume flow, flow velocity and pipe internal diameter. Within the module, fluid properties are calculated for water at a specified mean temperature or for aqueous solutions of ethylene glycol or propylene glycol at a specified mean temperature and concentration from 0 to 60%.

When calculating hydronic pipe size, the user specifies a piping material (steel, copper or plastic), a strength grade (which specifies pipe wall thickness), design head loss (ft/100 ft), maximum flow velocity (ft/sec) and minimum pipe size and the desired volume flow; the module returns a pipe size selection within all criteria. Repeated volume flows may be input, and a pipe size is selected for each.

The Hydronic Pipe Sizing program may be accessed through the project files or the Main Entry Screen. If accessed directly through the Main Entry Screen, calculations will be filed under Miscellaneous Calculations (otherwise they will be filed under Project Information). It is necessary to provide an Equipment Identifier. The Equipment Identifier is helpful for future reference . . . especially if it relates to the physical location of the particular section of piping (concerning either the geometry of the building or the flow diagram; for example: “Chiller to AHU-1” or “Mains-AHU-1 to AHU-8” and so forth). Regarding Units, the only units available at this time are Inch Pounds (IP).

This program is not a network analysis or pump head calculation program. It is designed to assist the system designer in sizing the pipe only (in the least amount of time and with the most accurate information needed to conduct further system design activities).

The first block of input data required includes the Pipe Material, Pipe Strength (or wall thickness description) and the type of Fluid.

The Pipe Material is selected (by radio button) from three options: Steel; Copper; and PVC or CPVC. Selection of the Pipe Material prior to the Pipe Strength is necessary (as it will change the options available in the Pipe Strength draw-down field). If Steel pipe is selected, the strength options are Standard, Extra Strong and Double Extra Strong (as defined by the ASME Standard B31.9). For Copper pipe the strength options are Type K, Type L and Type M (as defined by ASME Standard B88). If PVC or CPVC are selected, the options are schedule 40 and Schedule 80 (as defined by the Plastic Pipe Industry Standards).

The third section of this block is for Fluid type. The default fluid is Water (with N/A in the Percent Concentration field, and 32° F. in the Freezing Temperature field). Fluid type has draw down selections of ethylene glycol and propylene glycol. When either of the glycol options are selected, the entry field for Percent Concentration will read 0% . . . and for the Freezing Temperature will read 32° F. (both of these are editable and will fill in the proper value in the other; i.e., select the Percent Concentration and the Freezing Temperature will be indicated, or selected the Freezing Temperature and Percent Concentration by weight will be indicated).

The next block includes four design options. The first field is for Mean Fluid Temperature (this is usually simply the sum of the design supply fluid temperature and the design return temperature divided by 2). The second field is for Design Head Loss (expressed in feet of fluid per 100 feet of pipe—a value of the designer's choice). The third field is for Maximum Velocity of the fluid in the pipe. If the Maximum Velocity is exceeded before the design head loss is reached, the maximum velocity will determine the pipe size. The last field is for Minimum Pipe Size. A draw-down field selects a minimum pipe size. Usually designers select a minimum pipe size for either structural purposes or to prevent fouling or blockage of very small pipes.

NOTE: For design conditions of the head loss, maximum velocity, and minimum pipe size refer to the appropriate chapter(s) in the ASHRAE Handbooks.

The next set of entry fields has one field beneath Flow Rate, gpm. Starting either at the source end of a piping branch (largest number) or a load end (smallest number) enter the flow rate for the first section of pipe and click Add Entry. The screen will be replaced by an answer screen which will include data for the Flow Rate, gpm; Pipe Size, inches; Head Loss, ft/100 ft.; Pressure Drop, psi/100 ft. and Velocity, ft/sec. Beneath that line another entry field for Flow Rate, gpm will be available. Fill in the flow rate in the next section of pipe, and after the flow rate in the initial section has entered (and the size, losses and velocity calculated), each subsequent section can be calculated by clicking Add Entry.

After entering the flow rates for each section (of this branch of the piping) and calculating the sizes, losses and velocities click the “Finalize Calculation” button. This will terminate this series of pipe size selections and provide the following footers:

The Printable I/O Summary” button which, of course provides a summary of all of the input and output information just calculated. (This can be printed for filing and/or for study and reference. A permanent copy of this printable I/O is automatically stored in either the project file or in the Miscellaneous Calculations, as appropriate). The “New Calculation” button will return you to a blank Hydronic Pipe Sizing input screen. The “To Project Information” button or the “To Miscellaneous Calculations” button . . . depending on where you entered the Hydronic Pipe Sizing program.

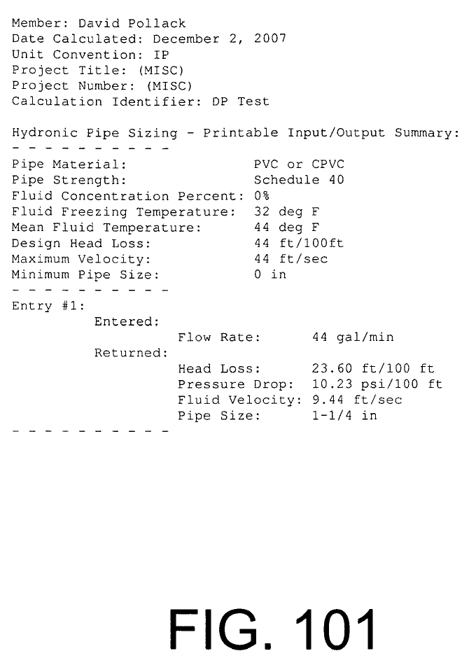

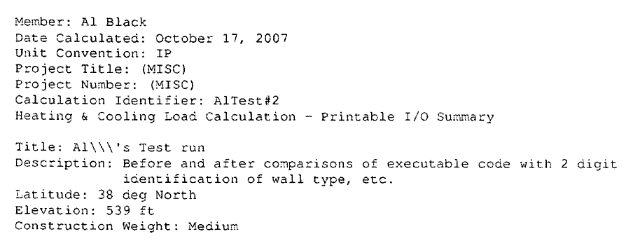

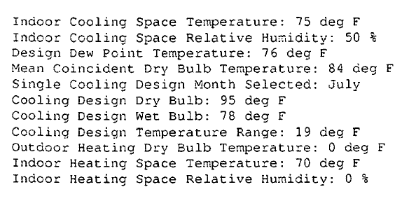

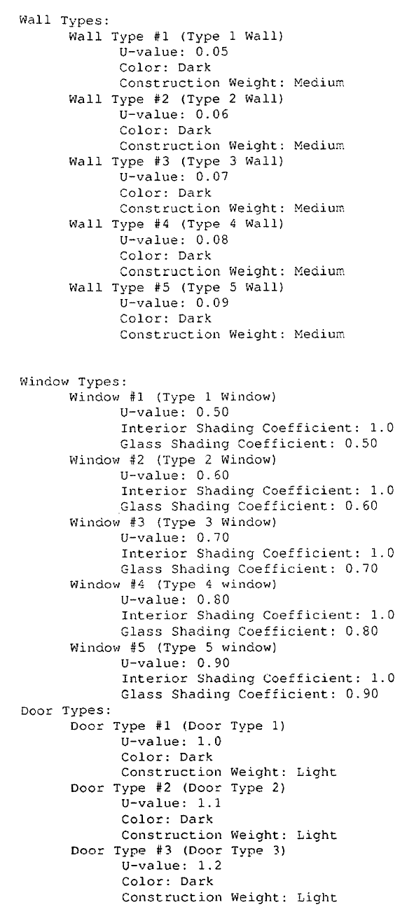

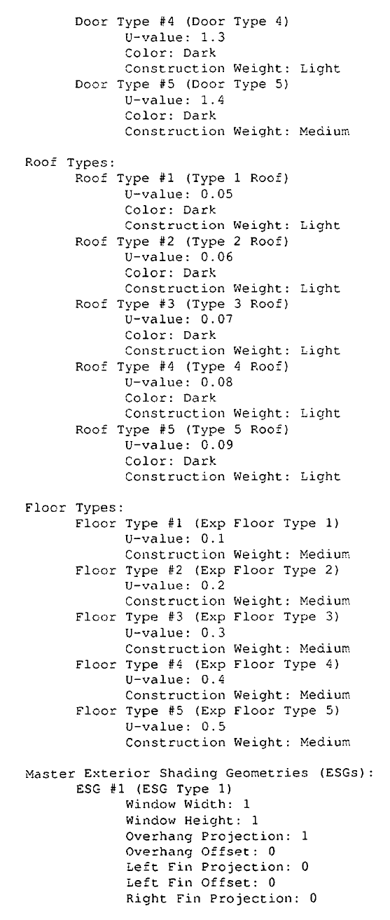

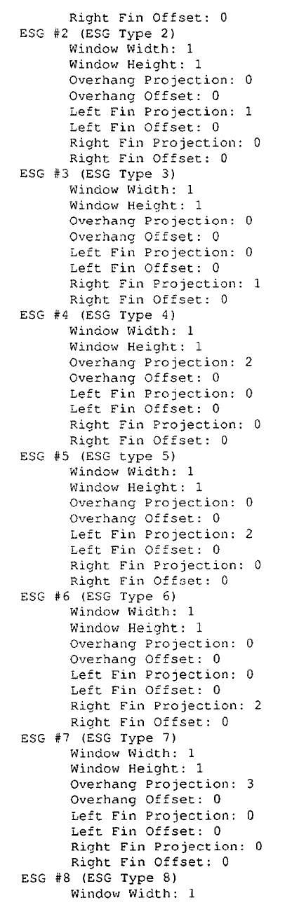

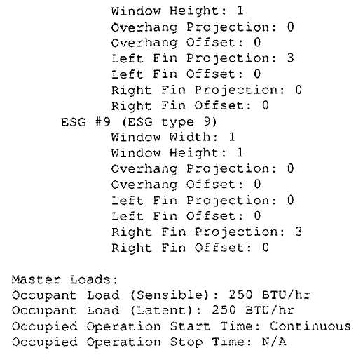

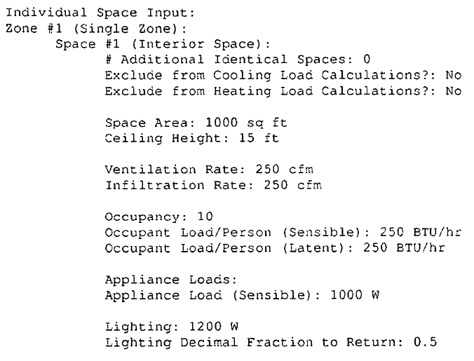

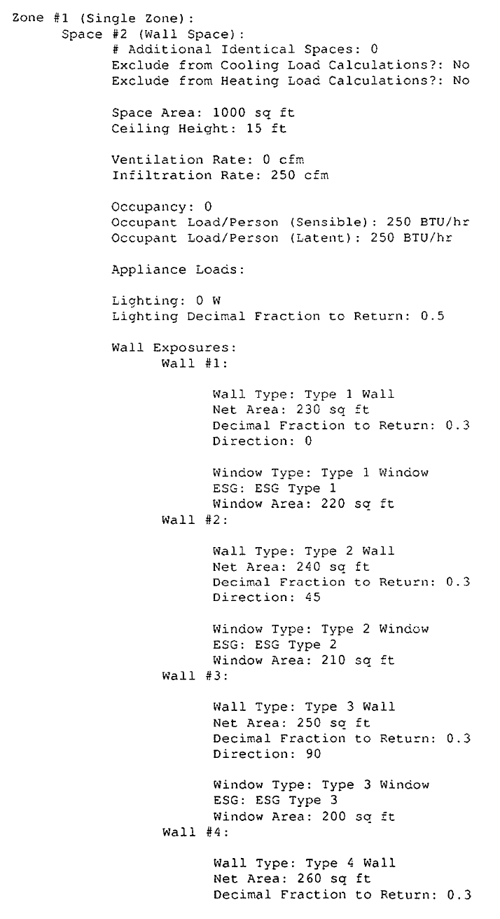

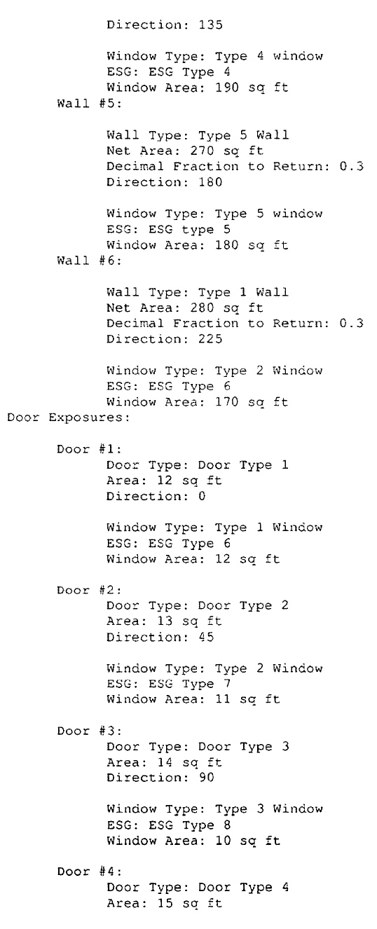

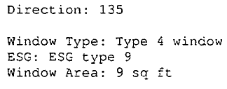

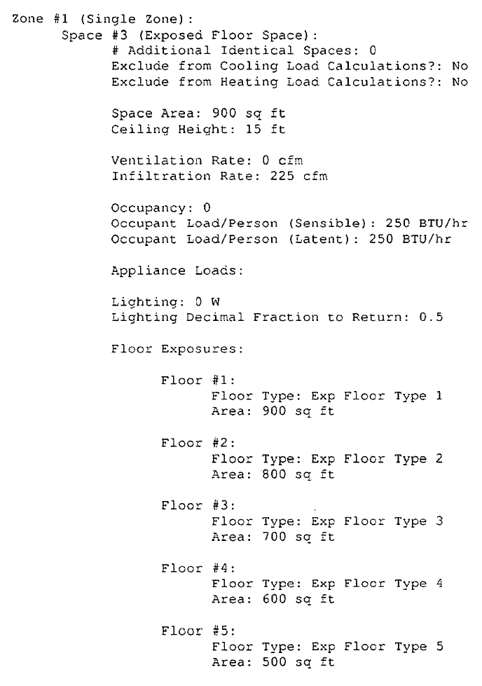

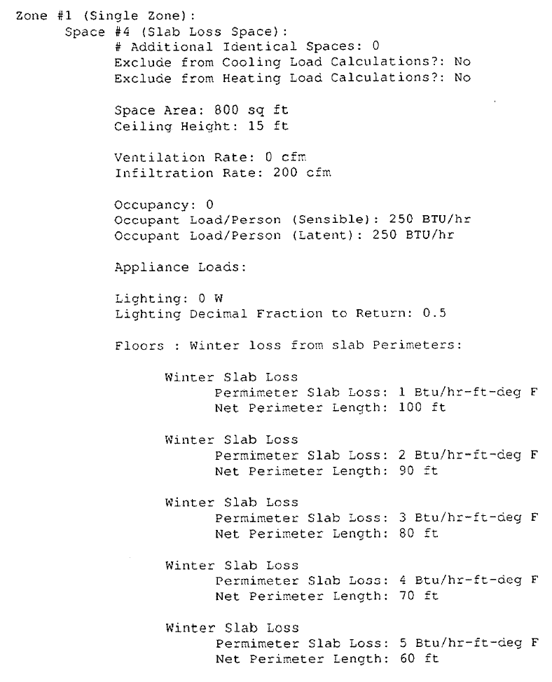

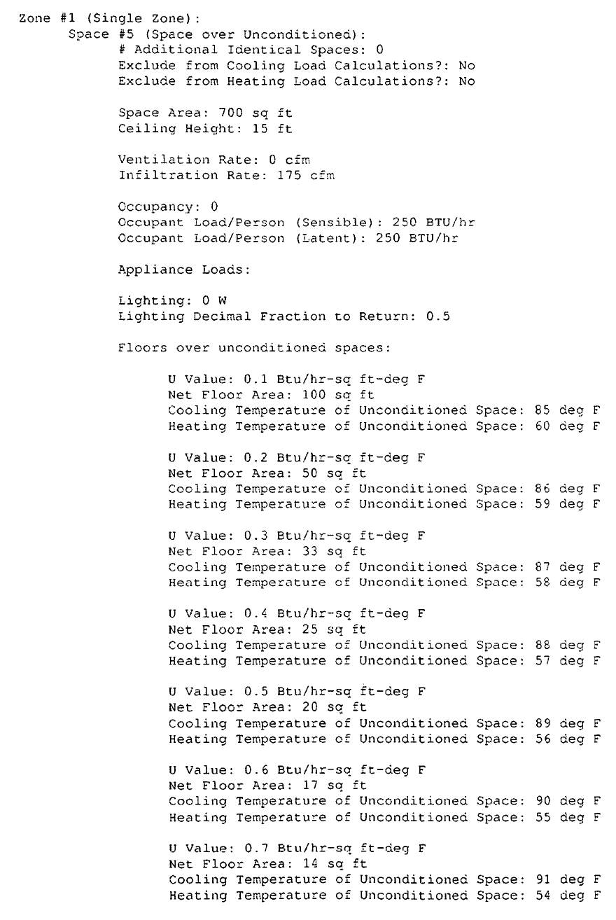

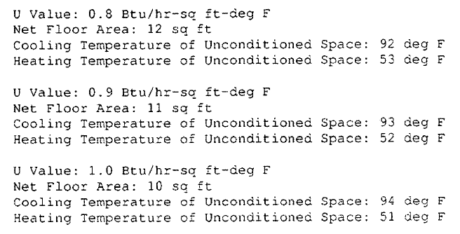

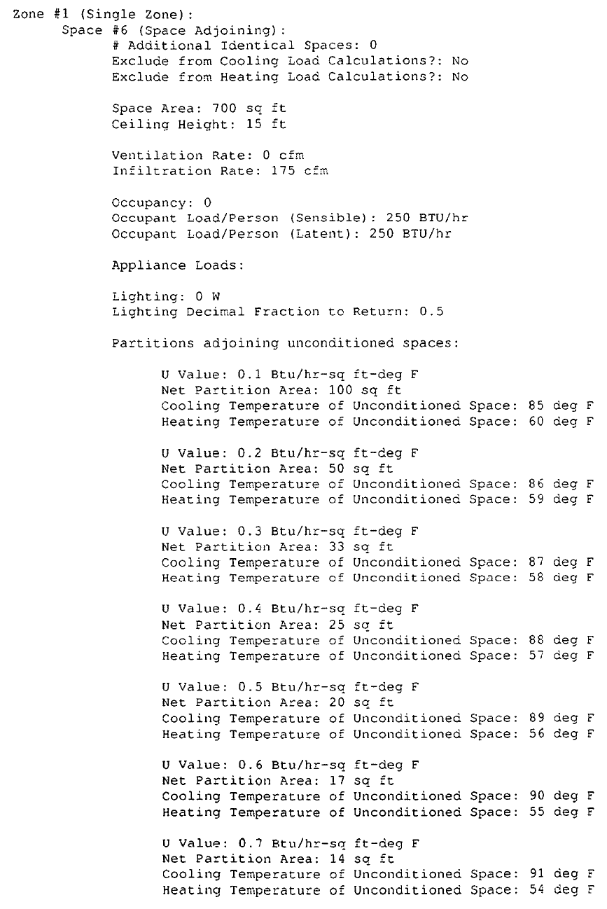

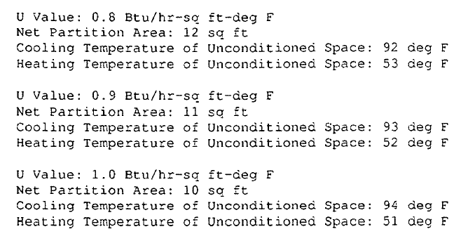

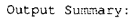

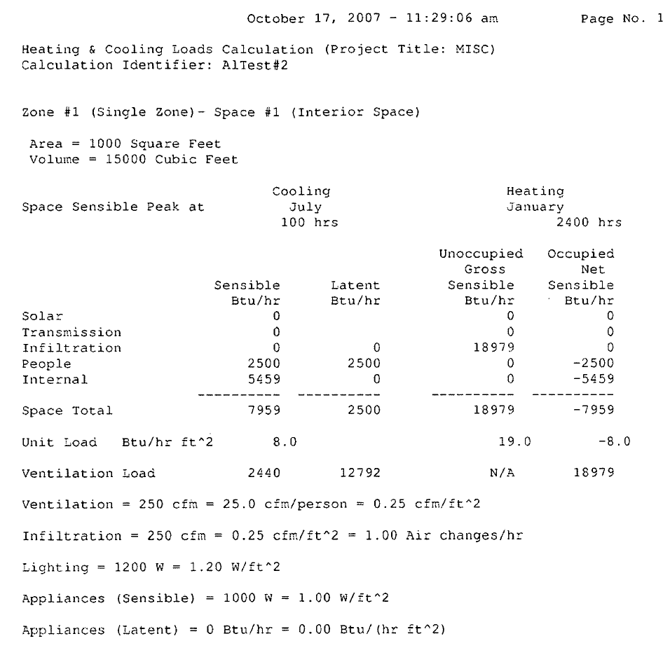

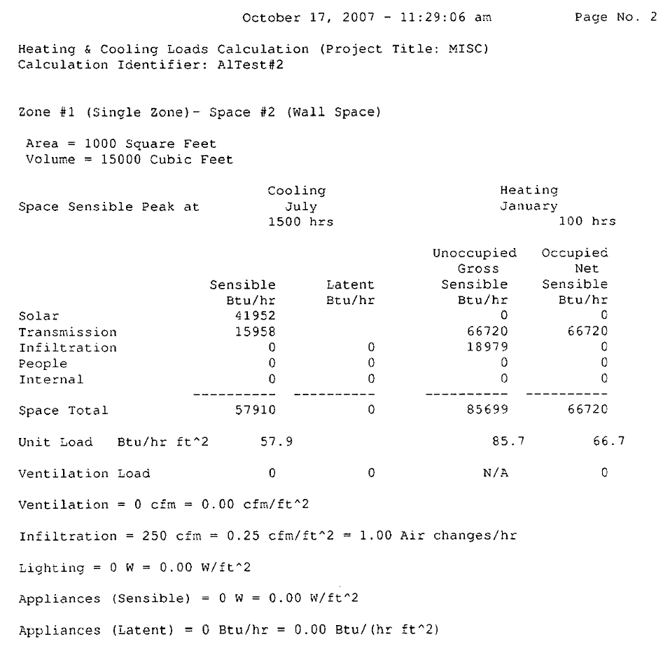

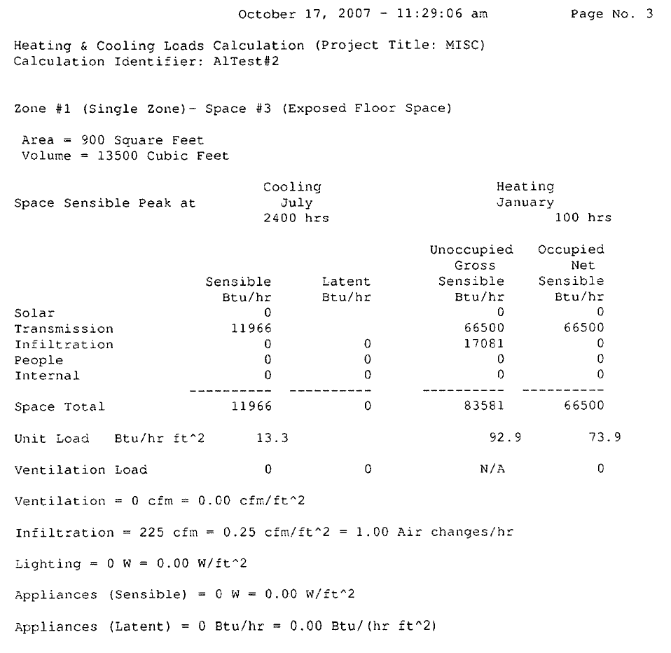

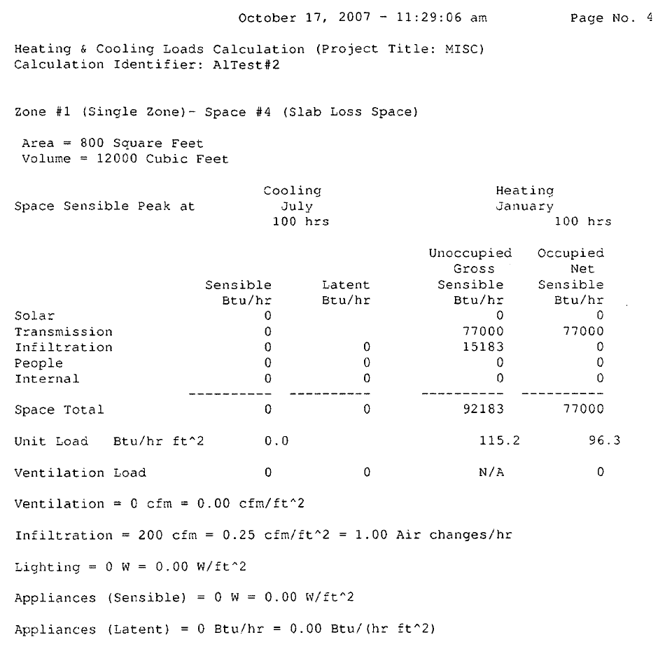

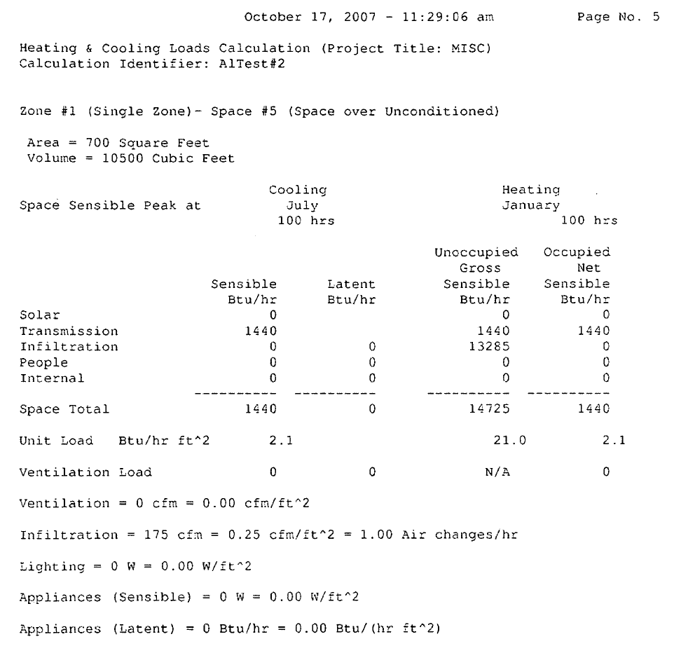

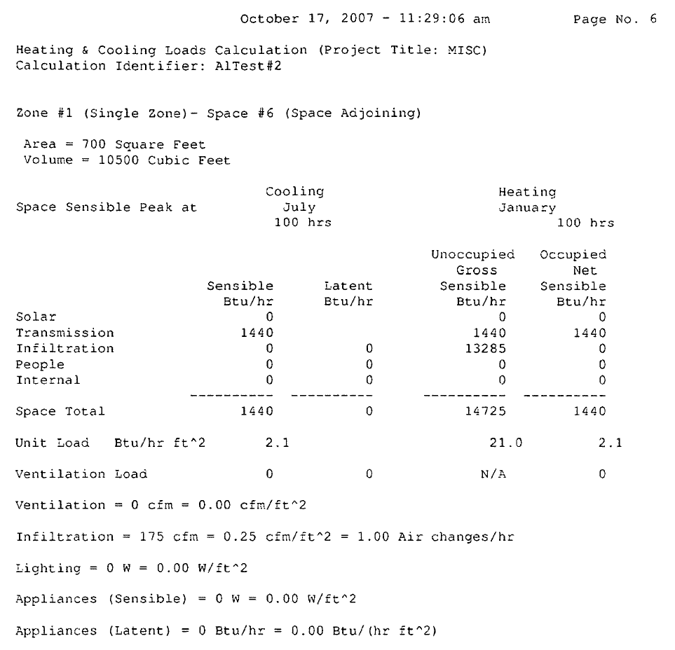

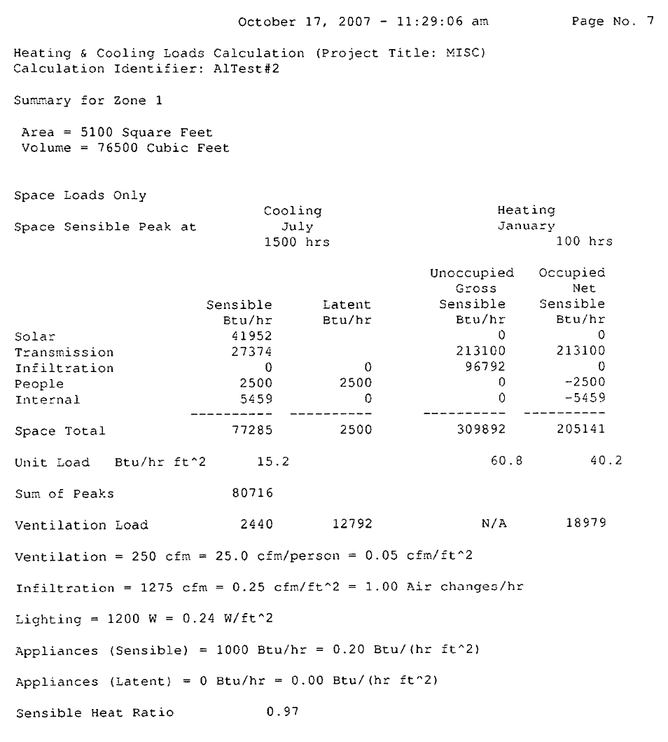

An exemplary Hydronic Pipe Sizing Input/Output summary is provided in FIG. 101.

### Example 5

This Example illustrates the Heating and Cooling Loads calculation module and its use.

The Heating and Cooling Loads module is a general purpose loads program which considers solar loads, both on transparent surfaces and opaque surfaces, transmission through windows, walls, roofs, floors, etc., ventilation and infiltration loads, both sensible and latent, internal loads such as lights, appliances, people, etc., and partition and slab loads. A 24 hour occupancy schedule is used, either for a single cooling design month or for the 12 months of a year.

Solar loads calculations use ASHRAE equations for sun angles as a function of month and hour of the day. Shading from external projections (horizontal overhangs and vertical fins) is treated by two-dimensional calculations. Transmission loads are calculated using wall response factors subjected to hourly variations in exterior temperature (outside air temperature for conduction loads, sol-air temperature excess for solar loads through opaque surfaces). Within spaces, room loads comprise immediate loads (convection) and delayed (radiation); room response factors calculate instantaneous cooling loads as a function of instantaneous heat gains within the space.

Wall response factors express instantaneous heat gains through the surface as a function of an infinite series of past temperature differences across the wall. For 24 hour load calculations, each 24 hour period is regarded the same as every other 24 hour period, allowing the inside surface heat gain to be expressed as a function of only 24 past temperature differences. Mathematically, |qₜ|=|Y_{t,j}∥T_{o,j}−Tᵢ|, where |qₜ| is a 24 element vector (24 hourly instantaneous heat gains), |Y_{t,j}| is a 24×24 square matrix of the transfer function and |T_{o,j}−Tᵢ| is a 24 element vector of 24 hourly outside-to-inside temperature differences.

Separating the immediate (convection) component from the delayed (radiation) can be expressed in a similar manner; i.e., |Qₜ|=|r_{t,j}∥qⱼ|, where |Qₜ| is the instantaneous cooling load, |r_{t,j}| is a transfer function for room response and |qⱼ| is the instantaneous heat gain. If the room response is reasonably uniform from one space to another, the two matrix equations may be combined: |Qₜ|=|r_{t,j}∥Y_{t,j}∥T_{o,j}−Tᵢ| or |Qₜ|=|R_{t,j}∥T_{o,j}−Tⱼ| where the 24×24 matrix |R_{t,j}| is the product |r_{t,j}∥Y_{t,j}|. Thus for each surface, the 24 hourly cooling loads are found as the product of the transfer matrix with the 24 hourly outside-to-inside temperature differences.

Solar and transmission loads through opaque surfaces are calculated separately: the transmission component is driven by the temperature difference between the outside air temperature and the room temperature. The solar loads are driven by the sol-air temperature excess, that is the difference between the sol-air temperature and the outside air temperature.

In the 1972 Handbook of Fundamentals, ASHRAE published tables of transfer functions for exterior walls, roofs and interior walls, partitions, floors and ceilings. These were presented for an equation of the form:

$${q}_{c , τ} = A [ {\sum }_{n = 0}^{6} {b}_{n} ( {t}_{n , τ - n Δ} ) - {\sum }_{n = 1}^{6} {d}_{n} ( \frac{{q}_{c , r - n Δ}}{A} ) - {t}_{rc} {\sum }_{n = 0}^{6} {c}_{n} ]$$

where q_{e,r} is the heat gain to the room at the inner wall, A is the surface area, t_{e,r-nΔ} is the exterior surface temperature of the wall, τ is the time variable (usually hours), Δ is the time interval (usually one hour), n is the summation index and t_{rc} is the constant room temperature. Constants bₙ, cₙ and dₙ are tabulated in Chapter 22 of the 1972 ASHRAE Handbook of Fundamentals. There is a different set of constants for each of 96 wall constructions, 36 roof constructions and 47 interior walls. Rearranging terms in the above equation:

$$\vert \frac{{q}_{e}}{A} \vert \vert d \vert = \vert b \vert \vert {t}_{e} - {t}_{r} \vert , where \vert \frac{{q}_{e}}{A} \vert$$

is a 24 element vector of inside surface heat gains, |t_{c}−tᵣ| is a 24 element vector of 24 outside-to-inside temperature differences and |b| and |d| are 24×24 matrices of b and d coefficients. Multiplying both sides of the equation by the inverse of the d matrix:

$${\vert d \vert}^{- 1} \vert \frac{{q}_{e}}{A} \vert \vert d \vert = {\vert d \vert}^{- 1} \vert b \vert \vert {t}_{e} - {t}_{r} \vert$$

and recognizing that multiplying a matrix by its inverse gives the identity matrix, the equation becomes

$$\vert \frac{{q}_{e}}{A} \vert = {\vert d \vert}^{- 1} \vert b \vert \vert {t}_{e} - {t}_{r} \vert .$$

The |d|⁻¹|b| product is the same as the |rᵢⱼ| two paragraphs back. Thus the tabulated b and d coefficients can be converted to wall response factor form and the wall response matrix can be pre-calculated after the appropriate wall is selected in the table. Further, as shown above, the room response factor can also be multiplied in, reducing calculating the 24 hour load profile from any wall to a matrix multiplication. The air-to-room temperature difference is calculated using a two-term sine wave fit of the outside air temperature (maximum=design air temperature, minimum=design air temperature minus daily temperature range). Extremes of the air temperatures are assumed to occur at 0600 hours (minimum) and 1500 hours (maximum).

To simplify the entering of information about the b and d factors, three typical walls have been selected from the table: #26, frame wall (light construction), #44, 8 inch concrete block (medium construction) and #33, 12 inch concrete wall (heavy construction) and the appropriate sets of b and d factors are written into the executable program. The user selects No Lag, Light, Medium or Heavy for the thermal mass characteristic of the wall being considered. The U factor for each wall implied by the b and d factors can be calculated as:

$$U = {\sum }_{n = 0}^{6} {b}_{n} / {\sum }_{n = 1}^{6} {d}_{n} .$$

If the user desires a U value other than that for which the b and d pertain, the b factors may be scaled by the ratio U_{new}/U_{old}. Roofs are treated in a similar manner.

Cooling load calculations are performed for 17 components of load and stored in three 2×17×24×12 matrices (cooling/heating, component, 24 hours per day, 12 months per year), with one matrix for the individual space being considered, one for a zone subtotal and one for a building total. Thus there is no practical limit to the number of zones or spaces being calculated. As each space is calculated, several subtotals of loads are calculated, and the time and value of the estimated space sensible peak are determined and displayed. The components are also added into zone and building totals. When a new space is in a new zone, the old zone totals are printed. After no more individual spaces are encountered, the last zone totals and the building totals are printed.

The Load Calculation program was designed and developed as a diagnostic and design load analysis program by a leading mechanical/electrical consulting engineering company (to provide precise load information taking into account the dynamics of transient heat transfer). The program utilizes the transfer function/response factor method originally published by ASHRAE. Some of the useful features of this program are:

1. An abbreviated quick-input building block load or single space load is available for preliminary calculations or diagnostics on a single space.

2. In a multiple space calculation, such as a room-by-room calculation for a building, the printout shows the instantaneous design load for each zone and for the entire building (as well as the sum of the peaks). Which of these should be used to size the zone air-handling units (or other elements of the machinery) is the designer's choice (depending upon the system design).

3. The space loads are calculated, reported, and integrated into the overall calculation separately from the ventilation loads, so that the designer can handle them separately in developing the system design.

4. Because of changing solar dynamics and their effects on the cooling loads, the designer or analyst has the option of calculating the load for a single design day, or for a design cooling day for each of the twelve months (utilizing the current published ASHRAE weather data).

How to input the load data efficiently

### Assembling the Input Data

The first step in performing a load calculation is to download a set of the input forms. Before proceeding, it is recommended that you go to the initial screen of the Heating and Cooling Load program, the Loads Menu, and click the “View/Print Input Forms” link.

A printable version of “Input Forms 1 through 6” will be displayed in Adobe PDF format.

These forms are numbered sequentially. They are to be used in the same sequence as the input screens. If the forms are used as described below, the task of performing a load calculation should require a minimum of time.

We recommend that you do not start inputting the data for a load calculation (on you computer screen) until you have filled in all of the relevant printed input forms. A brief description of each form and how it is used follows:

### 1. Initiating Load Calculation

The Project Title and Project Number should be the same as those in the project file. When you access the load calculation program through the Project Information screen (in turn accessed via the Project File Contents screen) the Project Title and Project Number, along with the date and the analyst (member) will be displayed.

The “Description” should be similar to that on the Project Information screen, except it generally includes a statement regarding the purpose of the specific calculation.

The Weight/Room Construction is quite important in the calculation, but is totally judgmental. Refer to the information in the ASHRAE Handbook of Fundamentals or the ASHRAE Publication Fundamentals of Heating, Ventilating, and Air Conditioning to assist with this judgment (if you are not familiar with this aspect).

### 2. Design Conditions

The form requires the indoor and outdoor design conditions.

For the Indoor Conditions, if the space is not going to be designed for winter humidification, place a Zero (0) in the space for “Space Relative Humidity for Heating.” In the Cooling Outdoor Conditions “For Ventilation Only,” use the “Dehumidification DP/MCDB” values from the 2005 ASHRAE Handbook of Fundamentals. This is used to calculate the ventilation load for cooling in warm climates.

The “For Space Load Only” selection allows you to select a single design day for a “Design Cooling Month” (as is usually done) or to select “For 12 Month Calculation” (in which case you assign a cooling design day for each month which will calculate the design load for each space considering both outdoor temperature effects and solar effects). The data for each month can be found in the electronic version of the 2005 ASHRAE Handbook of Fundamentals.

### 3. Thermal Characteristics of Building Elements (3 Pages)

These forms accommodate numerous construction options for the various opaque and transparent materials that form the building envelope, or separation from other thermal environments (partitions, floors, etc.). The thermal characteristics (such as U value (1/R), glass shading coefficients, interior shading coefficient, etc.) may be found in the ASHRAE Handbook of Fundamentals; the ASHRAE publication “Principles of HVAC”; manufacturer's literature; or, in the case of opaque wall sections, can be calculated using fundamental heat transfer principles. (Once this data is entered into the Load program, it becomes a “pull down” selection where needed).

### 4. Master Load Data

Except for the “Operating Hours,” this data provides default values for all of the individual space load calculations. However, any such defaults values will be editable (on the HTML input screens) in the event that the master data does not apply to any particular space. Load calculations assume that neither lighting, nor ventilation nor occupants are present (or “on”) during a building's unoccupied cycle. The program also assumes that the buildings are pressurized with positive ventilation systems during occupied cycles, and that infiltration will only occur during non-occupied cycles. If this is not applicable to your building (and there is no positive controlled ventilation), the infiltration quantity should be entered in the “ventilation” box (but when utilizing the output values, the ventilation must be manually added to the space load).

The radiation components of all heat gains are time delayed. In addition to the normal delays between the time that solar and transmission gains become cooling loads, the Load program assumes that the internal heat sources commence at the “start occupied” time, and cease at the “stop occupied” time. Care should be taken to assure that the “Start Occupied” time and the “Stop Occupied” time do not coincide. For 24-hours per day operation, select the word “continuous” in the first column.

### 5. Zones and Spaces

At this point, the analyst or designer works with the building drawings, with all spaces either named or numbered. The first step is to list the zones and in some way describe them. For purposes of this load calculation, a zone is defined as all of the spaces served from a single air-handling unit. For example, if a single air-handling unit conditions a floor of a multi-story building, that floor would be considered a zone (even though there might be multiple exposures independently controlled).

The “Zones and Spaces” must be developed sequentially. This is so because when it comes to entering the spaces individually into the program, a space cannot be entered unless it is assigned to a zone that is already entered. So, on this page, list all of the zones that are planned for the building (describing them simply and understandably).

This “Zones and Spaces” page and the following page, “Zones and Spaces—Space Designations”, may be printed or photocopied for as many zones and spaces as are necessary for the building.

The “Zones and Spaces—Space Designations” page is where the real “take-off” phase of the load calculation begins. It is the most time consuming task in calculating the load. It is suggested that it be done in two steps. Step 1 is “getting organized.” This is accomplished by sitting at a comfortable “flat space” with the building plans and the load calculation input forms (available via the “View/Print Input Forms” link on the Loads Menu screen). The next step (following the Zone Designations) is to go through the plans, listing each room or space on the appropriate form for the zone in which it will be assigned. Once each and every space in the building has been so assigned, you are ready to use the individual space input form.

### 6. Individual Space Input

The “Individual Space Input” form is two pages. A pair of these forms will be required for each room or space within the building. It is suggested that, with the “Space Designations” form in front of you, starting with the first zone, you fill out the “individual Space Input” forms in the sequence in which they are listed on the “Zones and Spaces” form. Items that are shaded will be filled in as default items as you transfer the data to the computer screens. However, if there are more exacting values available, fill those in if more correct. (Example: if watts of lighting are more accurate by fixture count, the default value can be overridden to fill in this space on the input form). For wall designation, window designation, etc., you must use the same names as entered on Form 3 (“Thermal Characteristics of Building Elements”), since these will be pull downs as you enter them into the Load program, and are thus the only options available.

When an Individual Space Input form has been completed for each space, you are ready for the next step: Data Entry.

A. Inputting the Assembled Data

You are now ready to input the data from the input forms to the Load calculation program. There are several ways to access the Load program:
1. If it is a new load calculation for an existing project (that has already been set-up), (1) from the Main Entry Screen click on “Project File Contents”; (2) click in the “Project Title” desired and you will get the “Project Information” screen; (3) click on “Heating and Cooling Load Calculation” link and you will get the (Heating and Cooling Load Calculation) “Loads Menu” screen. On that screen, the input field labeled Calculation Identifier must be filled in. In this field you will typically state which load calculation this is (such as “preliminary,” “block load”, “room-by-room load,” etc.).
   All other fields will be filled in by default but they may be changed. (Note: All of data for this screen is transferred directly from Form 1 “Initiating Load Calculation”).
2. If it is a revision or “Update” to an earlier completed load calculation for an existing project, (1) from the Main Entry Screen click on “Project File Contents”; (2) click on the title of the project and you will get the “Project Information” screen; (3) click on the file cabinet icon [symbol] adjacent to the “Heating and Cooling Load Calculation” link, and you will get a listing of all of the Load calculations for that project. You now have three options:
   1. For a completed calculation, if you click on a Calculation Identifier (without an asterisk (*)), you will get a printable input/output summary of that calculation.
   2. For a calculation has not been completed, the Calculation Identifier will have an asterisk (*). When you select a Calculation Identifier with an asterisk (*), you will be able to continue/edit (and complete) that calculation (from where you left off, via the HTML input screens).
   3. If you click on Update, you will get the Loads Menu screen with links to each of the 7 input screens any of which may be revised or “updated.” (Thereby allowing a revision or “clone” of an existing, completed calculation . . . without the time-consuming reentry of data).
3. For a diagnostic analysis or a load calculation which is not identified with a project (i.e., a “Miscellaneous” calculation), you can access the Heating and Cooling Load Calculation program by clicking on the “Heating and Cooling Loads Calculation” link on either the Main Entry Screen menu or the Miscellaneous Calculations menu.
4. If it is a revision or “Update” of an earlier completed miscellaneous load calculation (or a continuation of a miscellaneous load calculation has not been completed), steps are similar to those outlined above for a project calculation.

Once the input forms have been filled in and you've accessed the Heating and Cooling Load Calculation—“Loads Menu” screen, click on the “Continue” button/footer and enter the information sequentially from one screen to the next. The screens will lead you through the entry of data from the input forms to the screens. A few helpful hints:

Screen 1 Initiating Load Calculations
On a project that has been “set up” everything except the Calculation Identifier, the Project Title, and Project Description will be filled in by default. However, all default values are editable. The Calculation Identifier must be filled in before you can continue.
The remainder of the information on Form 1 Initiating Load Calculation is added. When the screen is completed, click on the button that says the “Continue to Design Conditions.”

Screen 2 Design Conditions
This screen should be filled out directly from the information on the load input sheets.
Note: There are radio buttons to select between the “Design Cooling Month Only” and the “Twelve Month Calculation.” Care must be taken when filling in all of the entry fields in the selected mode. (Note: The default selection is the design month only, and this must be moved to the “Twelve Month Cooling Calculation” option if that is your desire).
   To continue click on:
   The “Continue to Thermal Characteristics” button.

Screen 3 Thermal Characteristics of Building Elements
This screen shows one set of option blanks for each type of envelope closure (i.e., walls, roofs, etc.). Fill in the first type from the input form, and then click on the “Enter” button. Enter . . . this action will enter your choice and simultaneously provide another input line. You can enter as many types of, say, opaque walls as are needed. When complete there will be a blank line. Don't worry about this. Proceed to the next type of closure (such as, say, windows (fenestrations)).
Each Designation is a descriptive term of your choice; for example, exterior walls might be designated masonry, concrete, curtain wall, etc., for a typical wall construction used on this project.
Existing lines may be edited—make changes and click the “Update” button. Existing lines may also be deleted with the “Delete” button.
Enter information from the load forms for opaque walls, fenestrations, roofs, exterior doors, floors exposed to outside and exterior shading types. Floors over unconditioned spaces and partitions are fully specified on Form 6, Individual Space Input. If you do not have one of the closure types shown, just leave that line blank and proceed to the next type you do have.
After filling in each relevant line, click on the “Continue to Master Load Data” button.
Continue to Master Load Data.

Screen 4 Master Load Data
Enter the data from the input forms. The “Start Occupied Operation” and “Stop Occupied Operation” should not coincide. Note: For the “Operating Hours” . . . “Continuous” is the default value. If “Continuous” is selected, the load will calculate on a continuous schedule basis.
When screen 4 inputs are complete, click on the Continue to Zone and Spaces Input Data button.

Screen 5 Zones and Spaces
Fill in the Zones from input Form 5. The spaces are not filled in on this screen. They will fill in automatically as you proceed to the Individual Space Input screen
Important: After typing in each “New Zone Designation”, click on the “Enter” button and an entry field for another zone will appear. When you have no more zones to enter, leave the last entry field blank, and proceed by clicking the “To Individual Space Input” button.
If you are “Updating” (i.e., cloning) a completed calculation, and you want to add a space to a zone, go to this “Zones and Spaces” screen. It will list all of the zones and spaces previously entered. On the line that lists the zones, to the right are the words/link “Add Space(s)”—click on this link and an “Individual Space Input” screen will appear with the zone filled in (in editable format). Then proceed as follows:

Screen 6 Individual Space Input
Some of the data will be already filled in on this screen. These are default values provided from earlier screens. However, all default values are editable (i.e., may be deleted and replaced), if this provides more appropriate data.
In the appropriate entry fields fill in the information from the input forms. The first four sections (above the “Update Space” footer) relate to the internal and ventilation loads. When the entry fields have all been filled in, click on the “Continue to Exposures for this Space” button and the remainder of the screen will appear (please scroll down the screen). The remainder relates to transmission and solar load . . . that are a function of the thermal characteristics of the building materials, and the orientation and geometry of the space (this information was entered on Screen 3, “Thermal Characteristics of Building Elements).
In organizing the transfer of this information from the input forms to the screen, you should have the Individual Space input forms arranged in the same sequence as the spaces are listed in Form 5—Zones and Spaces (Space Designations).

After inputting the first four sections (above the “Update Space” footer), the “take-off” dimensional and orientation data for each element of building or space closure is input. Initially there is one input line for each envelope or closure surface. As each line is completed it is necessary to click on the “Enter” button. When this is done the entered data will be fixed (though editable) and a new line will appear. When no new data for this type surface is required, skip the blank line and proceed to the next surface. The surfaces or elements on the screen are Walls, Roofs, Exposed Doors, Exposed Floors, Slab Floors, Floors over Unconditioned Spaces, Partitions and so on. For each of these, if “None” is selected from the Designation dropdown, continue to the next element. If any category is irrelevant, simply move on the next relevant category.

Also note, that after any element is “entered” a “Delete” & an “Update” button will appear, enabling the correction of an error (or the ability to delete/update for any other purpose).

When all data for that space has been input, go to the next space by clicking the footer “Create New Space(s).”

When you have completed inputting all of the information for the spaces, click on the footer To Zones and Spaces—This will return you to Screen 5 (the “Zones and Spaces” screen), which will list all of the Zones and all of the Spaces for the building.

Before calculating (via the “Calculate” button), you may wish to click the Show Input Summary button to review all of the input data (which you may print or save).
After verifying that all of the input data, including the zones and spaces, are correct . . . click on the “Calculate” button, and the next screen will display a summary of the calculation by showing:

| | |
|---|---|
| Space Cooling Load | Tons |
| Ventilation Cooling Load | Tons |
| Total Cooling Load | Tons |
| Total Heating Load | MBH |

For a complete I/O printout of the load analysis, click on the “Printable I/O Summary” button. The Load input data and output data in room-by-room, zone-by-zone, and total building bases will be displayed (and may be printed or saved locally). The calculation I/O may be subsequently reviewed (& easily “updated”) via the Project (or Miscellaneous) “Heating & Cooling Calculations: Calculation List.”

Once a Load Calculation is completed, it is saved and cannot be modified; however, by choosing the “Update” option for the completed run in the Heating & Cooling Load “Calculation List”, the completed run may be easily modified and rerun; it will be filed as a new Load calculation.

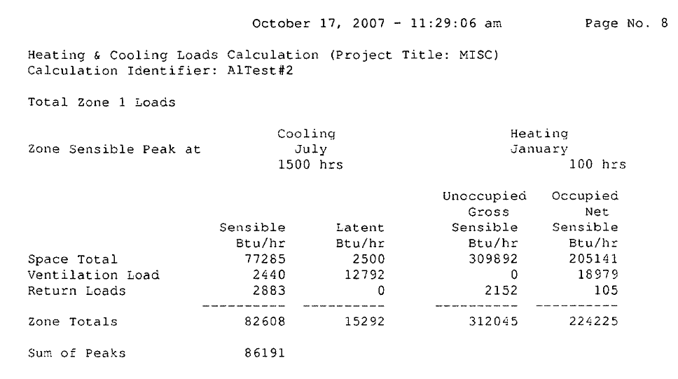

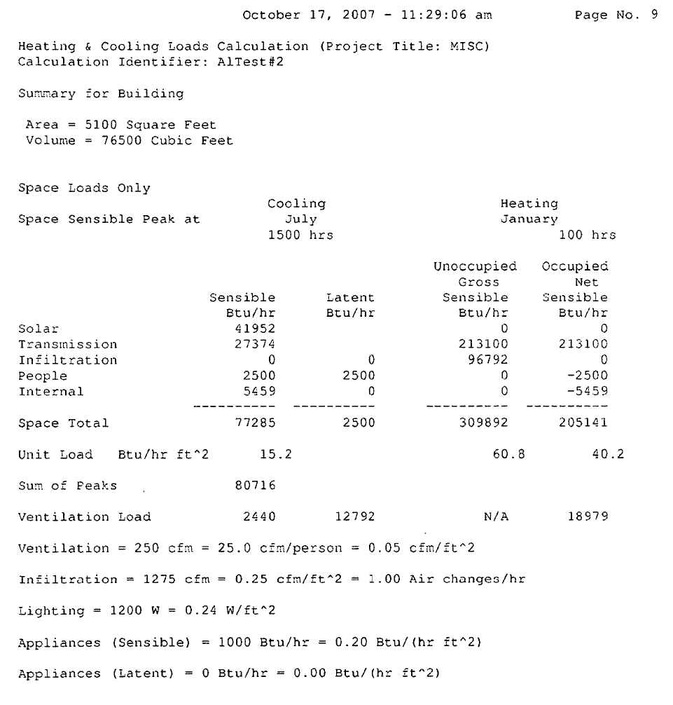

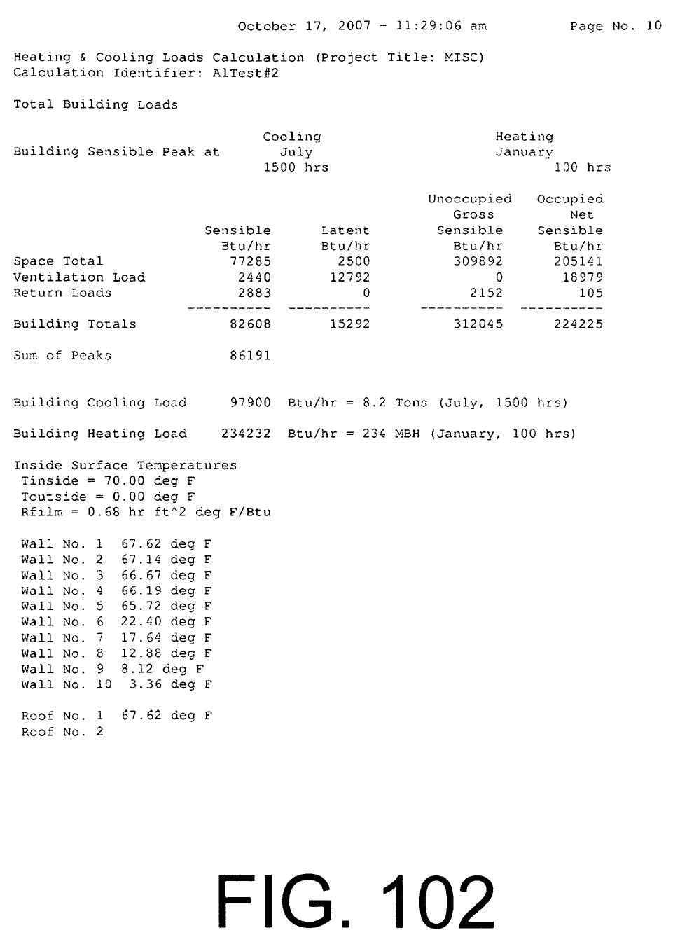

An exemplary Heating and Cooling Loads Input/Output Summary is provided in FIG. 102.

### Example 6

This Example illustrates the Heating and Cooling Coil (Selection & Diagnostics) calculation module and its use.

Calculation algorithms for finned cooling and heating coils are published as ARI Standard 410, Standard for Forced Circulation Air-Cooling and Air-Heating Coils, from the Air-Conditioning and Refrigeration Institute, an industry trade association. As part of this standard, procedures are established for specifying construction of air coils and for testing of completed assemblies. Manufacturers within the industry seek ARI certification that their coils have been tested and rated in conformance with the standard before coils are marketed.

The programs use algorithms from Standard 410, and thus should give answers very similar to those from coil manufacturers' ARI 410 programs.

The performance of heating coils is considerably simpler to calculate than that of cooling coils: heating of moist air is always a sensible process, in which the temperature of the air changes but the moisture content does not. On the other hand, cooling coils are usually employed to cool and to dehumidify moist air, a combination of sensible and latent cooling. The algorithms for combined sensible and latent cooling are more involved than for sensible heating or cooling.

The simplest type of calculation for either heating or cooling is one in which the flows of both fluids (inside the tubes and flowing over the outside of the tubes) are specified (entering and leaving temperatures, flow rates) and certain physical aspects of the coil are specified (tube-to-tube spacing, face area, circuiting). The calculation algorithms will yield the necessary depth of coil (length in the air-flow direction). Most calculations will not give a whole number of rows; since it is not physically possible to provide partial rows, the number of rows is rounded up to the next available value. In practice, the user rarely has exit conditions and liquid flow. The coil programs allow the user to specify known or desired quantities (e.g., liquid temperature change or leaving air dew point temperature) as input and provide several alternatives for output.

The coil programs are classified as either Selection or Diagnostic; for Selection, an exhaustive search of available configurations is made and the apparent best choice is identified, along with a list of alternative selections. For Diagnostic, the performance of a specified configuration is calculated. Selection is appropriate when the user is seeking a coil to provide a specified amount of heating or cooling and/or dehumidifying, subject to constraints such as pressure drops and flow velocities. Diagnostic is appropriate when the user wishes to know the performance capabilities of a specific coil configuration with specified flows.

For either the Selection program or the Diagnostic program, coil performance can be calculated for tube-side liquids (water, ethylene glycol, propylene glycol, the latter two with specified concentration or freezing temperature) or phase-change fluids (refrigerants for cooling, steam for heating). On the air side, elevation or barometric pressure can be specified. All calculations are performed for a specified actual air flow (acfm), specified entering air dry bulb and wet bulb temperatures and maximum allowable air pressure drop through the coil. On the tube side, all calculations are performed for specified entering fluid temperature (or saturation temperature for phase-change fluids).

For the Selection program, the user may select same end, opposite end or either end connections for the tube-side liquids. With same end connections, only even numbers of rows will be calculated; with opposite end connections, odd rows will be used. Either end allows any number of rows to be calculated (but limited to the range 2 to 12 for cooling, 1 to 12 for heating). On the tube side, leaving liquid temperature or liquid temperature change or flow rate (gpm) is specified, along with a maximum allowable liquid head loss. Given air flow rate and entering dry bulb and wet bulb temperatures, the desired performance on the air side is specified in terms of leaving dry bulb temperature, leaving wet bulb temperature or leaving dew point temperature or in terms of total heat transfer (BTUH). An upper limit for fin density (fin/inch) is set, as well as a specification of fin configuration (flat, mildly enhanced or severely enhanced). Calculations are performed for three circuitings (half, full and double). The selected coil will have the smallest number of rows and still make capacity, subject to pressure drop and liquid velocity limitations.

For the Diagnostic program, end connections are not specified because the number of rows used is specified. Similarly, there is no stated limit on either liquid or air pressure losses because the flow rate is specified. The circuiting, height and width and fins per inch or gin spacing are also to be specified by the user. Performance is based on specified leaving dry bulb air temperature, leaving liquid temperature or liquid flow rate (gpm).

Output for both Selection and Diagnostic cooling/dehumidifying programs includes leaving air and liquid conditions, total and sensible heat transfer and sensible heat ratio (shr), liquid flow rate (gpm), liquid velocity (fps), coil height, coil width, coil rows, coil face area, coil face velocity and coil volume. For heating programs, total heat transfer is entirely sensible heat transfer and the sensible heat ratio will always be one.

Because constructional details can change performance, the user should obtain certified calculations from the chosen manufacturer for the coil selected. By setting minimum criteria for coil parameters, the user will have better control of the choice of coil ultimately used.

### Example 7

This Example illustrates the Expansion Tank Sizing calculation module and its use.

The Expansion Tank Sizing program uses equations given in Chapter 12 of the 2004 ASHRAE Systems Handbook; separate equations are given for open tanks, closed tanks with an air/water interface and diaphragm tanks.

The user may select a working fluid of water or ethylene glycol or propylene glycol, the latter two with specified concentration or freezing temperature. The volume of the system is an important input to the calculation, but at the earliest stages of design, the user may not have an accurate calculation of the volume. As an alternative to creating a preliminary design for the piping system and estimating its volume, the program contains a function which estimates the volume of the piping system as a function of the conditioned building floor area and whether the system is heating only or heating/cooling. The program output shows the estimate of volume made by the program. Once the piping system has been designed, the expansion tank size may be recalculated on the basis of the improved estimate of system volume.

The user specifies the material of the system (i.e., steel or copper), extremes of temperature the system will see (start-up temperature and operating temperature), the initial fill pressure and the final allowable pressure at the operating temperature. The program then calculates the required size of expansion tank. Because the calculated size will rarely coincide with a manufactured size, the user may then recalculate the final operating pressure based on the size of a catalogued tank.

Expansion Tank Sizing can be accessed either through the Project File Contents or through the Menu of Programs (on the Main Entry Screen). The first block of information displays the Company Name, Project Title, Project Number, Date and Member (or Engineer's Name) . . . along with entry fields for the (required) Equipment Identifier and Units. (At the present time, only inch-pound or IP units are available).

Following two instructional blocks is a block for Elevation (with editable default values from your Member Preferences screen). As with other blocks for Elevation, all three fields can be changed by erasing the value in any one of them and entering, a new value. If you change one value, the other two will change to comply with that new value.

On the next block, select the Type of Tank (by use of the radio buttons). The tank type selections are: 1) a Diaphragm or Bladder tank; 2) a Closed (or pressurized) tank; and 3) an Open or vented tank. The block to the right of Type of Tank is for the Fluid to be used in the system. The default value in the Fluid draw down is water (with the fields for Percent showing “NA” and for Freezing Temperature showing 32° F.). The draw-down selections for Fluid are: Water; Ethylene Glycol; and Propylene Glycol. If either of the glycols is selected, the Percent field changes to 0%, and the Freezing Temperature remains at 32° F.

You now have two options. You can fill in the percent by weight of the glycol in the mixture (and the next click of the mouse will show the freezing temperature), or you can enter the freezing temperature (and the next click of the mouse will show the Percent (by weight) to achieve that level of freeze protection).

There are two options in selecting the tank, either an Approximate Calculation (based on building size) or Precise Calculation (based on system water volume). Either one is selected by use of the radio buttons. The Approximate Calculation is usually used in preliminary system design (to allow the analyst to proceed with the layout of equipment rooms, locate the tank in the building, etc.). However, after the piping has been sized and other equipment selected, a final Precise Calculation should be performed to assure the proper size tank.

If the Approximate Calculation is selected, the type of system must be selected (for either a Chilled or Hot/Chilled System or a Heating Water System). The entry field titled Enter Building Area must be filled in (in this field use whole numbers with no commas & no decimal points). NOTE: A sub-routine actually calculates a statistical volume of water for the selected system type for a building that size. This is an estimate only, and prior to final design, a recalculation should be run with the actual system volume!

If Precise Calculation (based on system water volume) is selected, the entry field Enter System Water Volume must be filled in (using whole numbers, with no commas & no decimal points).

The box to the lower left is the selection of the piping material in the system, either steel or copper. If plastic pipe is used the copper selection is recommended and it will simply result in the selection of a tank a little larger than actually required (erring on the safe side).

The boxes to the lower right are for the limits of the operating pressures at the expansion tank, and the system temperatures. Just above these boxes are helpful hints regarding the normal practice for selecting the design temperature limits. The pressures depend upon many system features such as both static and dynamic system hydraulics, relative elevation of tank, pump vs. tank location, relief value settings, materials, pressure limitations, etc.

After filling in the fields for the pressure and temperature limits, click the “Calculate” button and the output screen will appear (showing the input information, and, beneath the temperature and pressure design limits, will be the calculated required Tank Volume. Since actual tanks cannot be purchased in all sizes, there is an additional box at the bottom of the screen titled Enter Actual Total Size (Volume) of Tank or Tanks, with an accompanying entry field. If multiple tanks are used, they should be piped together (in parallel) with a single point of connection into the piping system. In this entry field enter the total volume of all such parallel tanks. (Normally you would select a total available or standard Tank volume greater than the calculated volume). Click the “Calculate” button. The resulting output screen will show the size of the tank selected, and the resulting Actual Pressure at the higher temperature.

If you elect to design or analyze a system with an open tank, the same procedure is used for filling in the data on the input screen. However, the output screen will not include system pressure values since they relate only to the elevation of the water level in the tank above the point of reading of the pressure.

After calculating a tank size, the footers for navigating to your next task include the “New Expansion Tank Sizing Calculation” (which will present you with a fully filled in and fully editable input screen . . . the only blank entry field is the “Equipment Identifier” field which must be entered. All other fields may be revised as you consider the next calculation). Other footers include “Printable I/O Summary”; “To Project Information” or the “To Miscellaneous Calculations” button (depending upon where you entered the Expansion Tank Size program), and the “To Main Entry Screen” button.

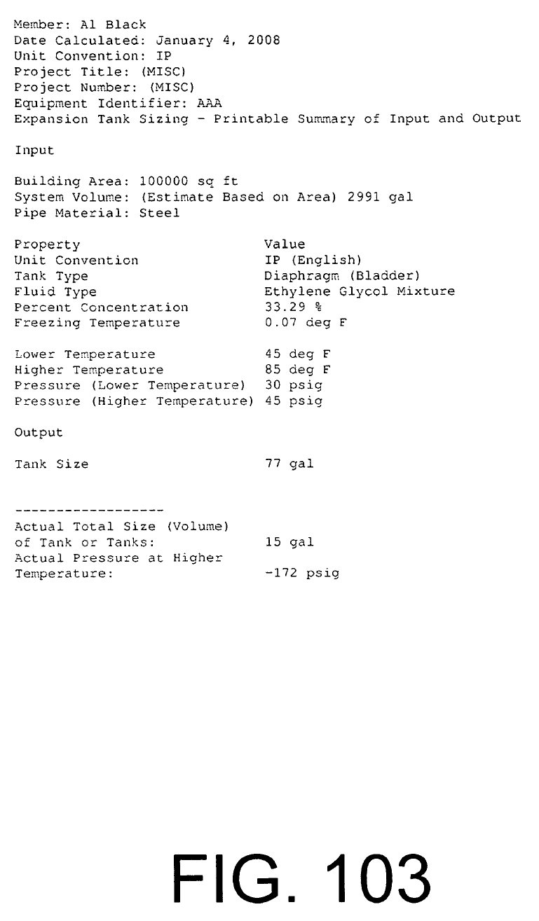

An exemplary Expansion Tank Sizing Input/Output summary is provided in FIG. 103.

### Example 8

This Example illustrates the Heating and Cooling Coil Diagnostics calculation module and methods of its use.

These programs can be accessed through the project files or the Main Entry Screen. If accessed through the Main Entry Screen, they will be filed under Miscellaneous. Prior to entering any information, an Equipment Identifier must be provided. The only units available at this time are Inch-Pounds (IP).

The programs analyze the performance of an existing coil (for any purpose, including enhancing energy economics, increasing capacity, improving environmental comfort or air quality, etc.). They can also be used in designing new systems after selecting a coil for certain design conditions (i.e., to analyze the anticipated performance of that coil under various part load conditions).

### Analyzing a Chilled Water or Water/Glycol Cooling Coil

Under Type of Coil are two selections, Cooling/Dehumidifying and Heating. The radio button will be in the default position for Cooling/Dehumidifying. The next field is Elevation, with the (editable) default value you filled in on the Member Information screen. The barometric pressure fields reflect the standard Barometric Pressure at the elevation selected. The Barometric Pressure may be entered either in psia or inches of mercury (the other values will re-calculate to show the conditions at the selected value).

If a Cooling/Dehumidifying coil is selected, the next line will have radio buttons for either a Liquid fluid in the tubes or Refrigerant. For a water or water/glycol coil, select Liquid. The pull-down adjacent to Water can be used to change the Water to Ethylene Glycol or Propylene Glycol. If Water is selected, the entry fields will read NA and 32° F. If either Glycol is selected, those entry fields will change to 0% and 32° F. (both editable). Replace the “0” with the percentage by weight of the glycol mix and the freezing temperature will appear. If you know the freezing temperature you want, enter that prior to the percentage of the glycol mix and the percentage of the glycol required will appear.

Proceed to the bottom of the screen and click the “Proceed” button. A new screen will appear (with the fluid shown in an uneditable format). This screen has fields for the physical features of the coil, the entering fluid conditions; and the performance to be analyzed.

The first section is Physical Characteristics of the Coil. The coil height and width are the measured finned height and width between the frames of the coil . . . with the height in increments of 3 inches and the width in increments of 2 inches. The field for “Rows” has a pull down for any number of rows, even or odd, from 2 through 12. The field for “Circuiting” has a pull down for half circuit (Half); Full circuit (Full); or Double circuit (Double). The Fin Type field has pull down selections for Flat (flat or non-enhanced fins), Enhanced/Mild (for mild or slightly enhanced fins), and Enhanced/Severe (for severely enhanced fins).

For the fin spacing, there are two interdependent fields (with a pull down for either “fins per inch” or spacing of fins, center to center, in “inches”. When either of these is entered, the corresponding value will calculate.

Under Entering Conditions, all four fields must be entered (with whole numerals (no commas), and up to two decimal places. The information required is: Airflow Rate Actual (in actual cubic feet per minute (ACFM)); Entering Air Dry Bulb Temperature (EDB) in degrees F.; Entering Air Wet Bulb Temperature (EWB) in degrees F.; and Entering Liquid Temperature (ELT) in degrees F.

The next section, Performance Conditions, provides for one of three selections. They are Leaving Air Dry Bulb Temperature (LDB) in degrees F., Leaving Liquid Temperature (LLT) in degrees F., and Liquid Flow Rate (GPM) in gallons per minutes. (Only one of these fields is to be filled in). If two entries are attempted an error signal will appear when you attempt the sizing calculation,

After all fields have been filled, click on the “Calculate” button. An answer screen will show all input data, plus the following air side and water side performance conditions:

### Air Side

Air Flow rate in Standard Cubic Feet Per Minute (scfm)

Coil Face Area in Square Feet

Total Heat Transfer in BTU/Hr

Sensible Heat Transfer in BTU/Hr

Sensible Heat Ratio

Entering Face Velocity, Ft/min.

Leaving Dry Bulb Temperature, ° F.

Leaving Wet Bulb Temperature, ° F.

Leaving Dewpoint Temperature, ° F.

Air Pressure Drop (wet-coil), inches w.c.

### Liquid Side

Liquid Flow Rate, gpm

Liquid Pressure Drop, feet of fluid

Liquid Volume of Coil, gallons

Leaving Liquid Temperature, ° F.

Liquid Temperature Rise, ° F.

Liquid Velocity, ft/second

The footers include “Printable I/O Summary,” and “New Calculation” (which will return you to the first input screen) . . . “To Project information” or the “To Miscellaneous Calculations” (depending upon where you initiated from), and the “To Main Entry Screen”.

### Analyzing a Refrigerant (Direct Expansion) Coil

After entering the Equipment Identifier, and selecting the Cooling/Dehumidifying option (and the Elevation), select the radio button for Refrigerant (under the Fluid heading). A new screen (under Refrigerant) will appear . . . for entering Saturated Suction Temperature (i.e., the saturation temperature for the specific refrigerant corresponding to the pressure at which the coil will operate).

To initiate the analysis, enter the Saturated Suction Temperature, and click the “Proceed” button. A new screen will appear with the Equipment Identifier, the Refrigerant Suction Temperature and the Elevation, plus a series of data entry fields under Physical Characteristics of Coil and Entering Conditions.

Under Physical Characteristics of Coil are entry fields for the Coil Height and the Coil Width. These dimensions are measured by distance between the frames. The height is in increments of 3 inches, and the width is (usually) in increments of 2 inches. The four pull downs are for number of Rows (2 through 12), Fin Type (Flat, Enhanced (mild) and enhanced (severe)) . . . and the coupled fields of Fins per Inch and Fin Spacing.

Under Entering Conditions three features of the entering air to be conditioned are required . . . the Air Flow Rate Actual (ACFM) in ft³ per minute, the Entering Air Dry Bulb Temperature (EDB) and the Entering Air Wet Bulb Temperature (EWB).

The CFM must be entered in whole numbers with no commas. The air temperatures can be entered with (up to) two decimal places. When all fields have been filled in, click the “Calculate” button.

An answer screen will show all the input data, plus the following information on the air side coil performance capabilities:

Air Flow Rate in Standard CFM. (scfm)

Coil Face Area, square feet

Total Heat Transfer, BTU/Hour

Sensible Heat Transfer, BTU/Hour

Sensible Heat Ratio

Entering Face Velocity, Ft. per minute

Leaving Dry Bulb Temperature, ° F.

Leaving Wet Bulb Temperature, ° F.

Leaving Dewpoint Temperature, ° F.

Air Pressure Drop (inches w.c.)

The footers include “Printable I/O Summary,” and “New Calculation” (which will return you to the first input screen). Either the “To Project Information” or the “To Miscellaneous Calculations” button will appear (depending upon where you initiated from), as well as the “To Main Entry Screen” button.

### Analyzing a Hot Water or Glycol Heating Coil

After filling in the Equipment Identifier, select the radio button for Heating (in the box titled Type of Coil). This will change the word Refrigerant to Steam in the Fluid box. When analyzing a heating water or glycol mix coil, the radio button should be selected for that option (default position). If the desired coil is a water coil, it will already appear in the entry field (default) under the word Liquid (the Percent Glycol field should read NA and the Freezing Temperature field should read 32° F.).

If a water/glycol mix is used, the entry field under the word Liquid has a pull-down which provides for either Ethylene Glycol or Propylene Glycol. The glycol percent by weight of the mixture may be selected by entering the concentration value in the Percent Glycol field. When this is done, the freezing temperature will appear in the Freezing Temperature field. Optionally, the freezing temperature desired can be typed in that field, and a mouse click will provide the required concentration percent by weight for that level of protection.

Proceed to the bottom of the screen and click the “Proceed” button. A new screen will appear with the identifiers and the fluid. This screen has fields for the physical features of the coil, the entering fluid conditions available, and the performance to be analyzed.

The first section is Physical Characteristics of the Coil. The coil height and width are the measured finned height and width between frames of the coil (in inches) . . . normally in full numbers (no fractions or decimals) with the height in increments of 3 inches, and the width in increments of 2 inches. The field for “Rows” has a pull down for any number of rows, even or odd, from 1 through 12. The field for “circuiting” also has a pull down for half circuit (Half), Full circuit (Full) or Double circuit (Double). The Fin Type field has pull down for Flat (for flat or non-enhanced fins), Enhanced (Mild) (for mild or slightly enhanced fins), and Enhanced (Severe) (for severely enhanced fins). The next field is for the fin spacing with pull down selection expressed in either “fins per inch” or spacing of fins center to center in “inches”. When either is filled in, the corresponding value will appear.

Under Entering Conditions, all four entry fields must be filled in with whole numerals (no commas), and up to two decimal values. The information required is: the Airflow Rate Actual in actual cubic feet per minute (ACFM); the Entering Air Temperature (EAT) in degrees F.; and the Entering Liquid Temperature (ELT) in degrees F.

The next section, Performance Conditions, provides three entry fields, only one of which is to be filled in. They are: Leaving Air Dry Bulb Temperature (LAT) in degrees F.; Leaving Liquid Temperature (LLT) in degrees F.; and Liquid Flow Rate (GPM) in gallons per minutes. If two entries are attempted an error signal will appear.

After all appropriate entry fields have been filled, click the “Calculate” button. An answer screen will show all input data plus the following air side and water side performance conditions:

### Air Side

Air Flow Rate in Standard CFM, scfm

Coil Face Area, Square Feet

Total Heat Transfer, BTU/Hour

Entering Face Velocity, feet/minute

Leaving Air Dry Bulb Temperature, ° F.

Air Pressure Drop, inches w.c.

### Liquid Side

Liquid Flow Rate, gpm

Liquid Pressure Drop, feet of fluid

Liquid Volume of Coil, gallons

Leaving Liquid Temperature, ° F.

Liquid Temperature Drop, ° F.

Liquid Velocity, feet/second

Footers include “Printable I/O Summary,” “New Calculation,” and “To Project Information” or “To Miscellaneous Calculations” (depending upon where you initiated from) . . . and “To Main Entry Screen.”

### Analyzing a Steam Heating Coil

After entering the Equipment Identifier, in Type of Coil select the radio button for Heating. This will change Refrigerant to Steam in the Fluid box. Click on the radio button adjacent to Steam. The entry fields under Liquid will disappear and the new screen will contain three entry fields under Steam . . . with instructions to Enter One of the Following. The three options are Saturated Steam Temperature in ° F., Saturated Steam Pressure in psig and Saturated Steam Pressure in psia. The steam pressure in psig is the pressure in psia less the atmospheric pressure shown on the screen. To initiate the analysis fill in one of the descriptors for steam temperature or steam pressure and click the “Proceed” button. A new screen will appear with the Equipment Identifier and steam conditions displayed, and a series of entry fields under Physical Characteristics of Coil and Entering Conditions.

Under Physical Characteristics of Coil are entry fields for the Coil Height and the Coil Width. Similar to the liquid fluid coils, these dimensions are measured by distance between the frames. (The height in increments of 3 inches; the width in increments of 2 inches). The four pull down fields are for number of Rows (2 through 12), Fin Type (Flat, Enhanced (mild)), and Enhanced (severe)) . . . and then the coupled fields of Fins per Inch and Fin Spacing.

Under Entering Conditions two features of the entering air to be heated are required. They are Air Flow Rate Actual (ACFM) in cubic feet per minute, and the Entering Air Temperature (EAT). The CFM must be entered in whole numbers with no commas, and the air temperatures can be entered with up to two decimal places. When all entries have been filled in, click on the “Calculate” button.

This will display an answer screen showing all input data, including the steam conditions in temperature (° F.) and both absolute (psia) and gauge (psig) pressure . . . plus information on the following air side coil performance capabilities:

Air Flow Rate Standard, CFM (scfm)

Coil Face Area, square feet

Total Heat Transfer, BTU/Hour

Entering Face Velocity, feet per minute

Leaving Dry Bulb Temperature, ° F.

Air Pressure Drop, inches w.c.

Footers include “Printable I/O Summary,” “New Calculation,” “To Project Information” or “To Miscellaneous Calculations” (depending upon where you initiated from) and “To Main Entry Screen.”

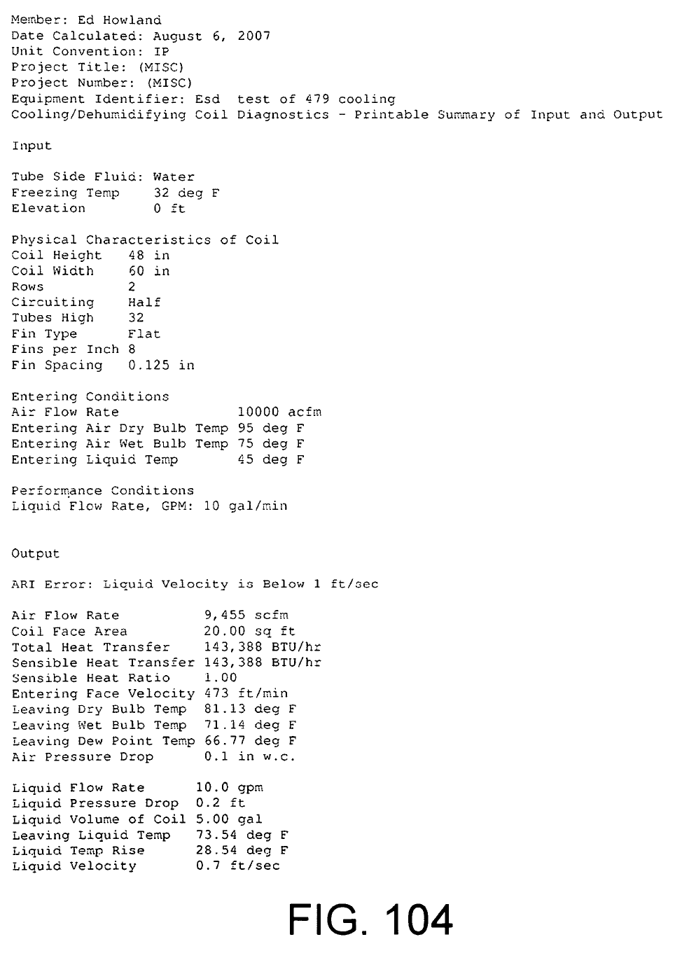

An exemplary Heating and Cooling Coil Diagnostics Input/Output Summary is provided in FIG. 104.

### Example 9

This Example illustrates the Heating and Cooling Coil Selection calculation module and methods of its use.

These programs can be accessed through the project files or directly through the Main Entry Screen. If accessed directly through the main entry screen they will be filed under miscellaneous. Also, for filing purposes, prior to inputting any coil information it is necessary to provide a Calculation Identifier. Regarding the units selection, the only units available at this time are Inch Pounds (IP).

### Selecting a Chilled Water or Water/Glycol Cooling Coil

Under the heading “Type of Coil” there are two selections Cooling/Dehumidifying and Heating. The radio button will be in the default position for Cooling Dehumidifying. The next entry field is the elevation. The default value shown will be the elevation you had filled in on your member information form but it is editable. The barometric pressure fields will reflect standard barometric pressure at the elevation selected also, the barometric pressure can be entered either in psia or inches of mercury (and the other two values will re-calculate to show the conditions at the selected value).

If a cooling dehumidifying coil has been selected, the next line will have radio buttons with a selection for either a liquid fluid in the tubes or refrigerant. For a water or water/glycol coil select “liquid” (this is the radio button default position). The pull down arrow adjacent to the field in which the word “water” appears can be used to change the “water” to “Ethylene Glycol” or “Propylene Glycol”. If water is selected the entry fields below will simply read NA and 32° F. If either glycol is selected those two fields will change to 0% and 32° F. respectively (both editable). Replace the “0” with the percentage by weight of the glycol mix and with the next click of the mouse, the freezing temperature will appear. If you know the freezing temperature you want, simply enter that prior to the percentage of the glycol mix (and a ‘tab’ will show the percentage of the glycol required).

The next selection is the Piping Connections at the bottom of the screen. The default position is Same End, with the other options being Opposite Ends and Either End. The selection is usually dictated by the layout of the equipment room.

After selecting the desired piping connection, click the “Proceed” button at the bottom of the screen. A new screen will appear, with the identifiers and the fluid shown. This screen has fields for Liquid Conditions, Air Conditions, and Coil Specifications (dimensions, configuration, etc.).

The requirements for the liquid conditions are Entering Liquid Temperature (enter as a whole number or up to two decimal places). You then have one of three selections (leaving liquid temperature, temperature rise, or flow rate). The last field under Liquid Conditions is for the maximum fluid head loss, which should be entered in Feet of Head.

For the air conditions you must enter both the dry bulb temperature and the wet bulb temperature for the entering conditions. For leaving conditions there are four options (the dry bulb temperature, the wet bulb temperature, the dewpoint temperature or the total heat transfer capacity). The last entry field under air conditions is the maximum air pressure loss (in inches of water).

The first entry field under “Coil Specifications” is for the air flow rate in actual cubic feet per minute (ACFM). This is entered in whole numbers . . . with no commas or periods. The next field provides a selection of either the maximum face velocity or the estimated face area.

Caution! In selecting a dehumidifying coil, if the face velocity is too high it could cause excessive water carryover resulting in water damage . . . or the growth of mold and mildew in the downstream sections of the system.

The coil dimensions are, of course, related to both the face area and the air velocity (dictated by the air handling unit size and location). Only one (usually the most critical) dimension of the coil is necessary, and the analyst need only enter one dimension, either the coil height or the coil width (tube length). The width should be in even numbers and the height in increments of 1½ inches.

Fin spacing may be expressed in either fins per inch or fin spacing in inches. For coils which will have dehumidifying loads, fin spacing closer than ⅛ inch (8 fins per inch) is not recommended since the draining condensate could bridge (i.e., fill the space between two fins. When this occurs, the air pressure will force droplets of water off the leaving face of the coil causing water carryover).

The last entry field, the fin type, is a pull down with three options: Flat, Enhanced (Mild) and Enhanced (Severe). Severe enhancement is not recommended for a dehumidifying coil because of the high air side pressure drop, and its tendency to foul (and the extreme difficulty of removing accumulated dirt when it does become fouled). From the standpoint of maintenance and performance, flat fins are recommended for dehumidifying service.

After all the inputs have been entered, click the “Calculate” button. The output screen will appear with uneditable values, and the coil selection. The coil selection will be coil with the least rows that will best satisfy all of the parameters you entered. For an I/O summary, click the “Printable I/O Summary” button, which will provide the input requirements, and multiple coil selections that would satisfy those requirements. As with all I/O summaries, you may save a copy locally, and/or print a copy (for your paper file or a report).

The footers provide various options, including to go to the Main Entry Screen, or to perform another coil calculation. If the latter is selected, it will return you to the first “Heating and Cooling Coil” selection screen and you're ready to start on another coil selection.

### Selecting a Refrigerant (Direct Expansion) Coil

After entering the Calculation Identifier, and selecting the Cooling/Dehumidifying option (and the elevation), click on the radio button for Refrigerant. The screen will change (with the water/glycol options disappearing) to a new entry screen (under Refrigerant) for entering suction temperature. This is the saturation temperature for the specific refrigerant corresponding to the pressure at which the coil will operate.

The Piping Connections for refrigerant coils can, like the water coils, be selected for Same End, Opposite End or Either End (but usually, for a refrigerant coil, the piping configuration is selected on the basis of serviceability).

After selecting the Piping Connections click on the “Proceed” button. A new screen will appear with a series of data entry fields under Air Conditions and Coil Specifications.

Like the liquid coils, the first block under Air Conditions requires the entering air conditions (in Entering Dry Bulb Temperature and Entering Wet Bulb Temperature). Decimal points may be used (to 2 decimal places). Also, as with the liquid coils, only one of the four entry options for the coil leaving conditions should be provided (either Leaving Dry Bulb Temperature, Leaving Wet Bulb Temperature, Leaving Dew Point Temperature or Total Heat Transfer).

The last input information required under Air Conditions is the Maximum Air Pressure Loss (in inches of water).

The Coil Specifications include four input fields. The first field is for Air Flow Rate Actual, in actual CFM. Then either the Maximum Face Velocity or the Preliminary Face Area.

Again, as with water coils, a face velocity in excess of 500 Feet per minute is not recommended for dehumidifying coils.

Also, as with the water coil, either the Coil Width or Coil Height is entered in the appropriate entry field. This value is usually a function of the dimensional constraints of the air handling unit or the space in which it is to be located.

The fin selection requirements are similar to those for water coils. When the coil is functioning as a dehumidifying coil, no more than 8 fins per inch are recommended (and the fins should be either Flat or Enhanced).

When all of the entry fields have been input, click on the “Calculate” button to obtain the coil selection. The resulting screen, will show all the input values and all relevant output values relating to the coil selection.

The footer selections include “Printable I/O Summary,” “New Calculation” and “To Main Entry Screen.” Clicking “Printable I/O Summary” will generate a window showing the inputs and all coil selections that satisfy (or come close to satisfying) the input data . . . including the “selected” coil which satisfies the input requirements with the least costly coil. The summary may be saved locally or printed (for paper files or report illustrations). “To Miscellaneous Calculation” or “To Project File Contents” will lead you back to the File contents for the file in which the calculation has been filed.

The “New Calculation” button will send you to the opening screen for heating and cooling coil selection. The “To Main Entry Screen” button will, of course, return you to the Main Entry Screen.

### Selecting a Hot Water or Glycol Heating Coil

After filling in the Calculation Identifier, in the box Type of Coil select the radio button for Heating. This will change the word Refrigerant to steam in the “FLUID” box. When selecting a heating water or glycol mix coil, the radio button should already be selected for that option. If the desired coil is a water coil it will appear in the entry field under the word Liquid (and the Percent Glycol field should read “NA” . . . and the Freezing Temperature should read 32° F.). If a water/glycol mix is to be used, the entry field under the word Liquid has a drawdown which provides for a selection of either ethylene glycol or propylene glycol. The glycol percent by weight of the mixture can be selected by entering the concentration value in the Percent Glycol field. When this is done, the freezing temperature will appear in the Freezing Temperature field. Optionally, the freezing temperature desired can be typed in that field, and the click of the mouse will provide the required concentration present by weight (for that level of protection).

The next step is to select the appropriate radio button under “Piping Connections”. Again, for a water coil, the piping connection configuration usually depends upon the dimensional characteristics of the unit location and the servicing/maintenance requirements. To continue click the “Proceed” button.

The second screen will appear with the type Liquid, the freezing temperature and the elevation displayed in a non-editable form. As with cooling coils, there will be three main sections of the screen with appropriate entry fields under LIQUID CONDITIONS, AIR CONDITIONS, and COIL SPECIFICATIONS.

Under LIQUID CONDITIONS the first selection is Entering Liquid Temperature. The next selection requires one of the three options; the Leaving Liquid Temperature, or the Liquid Temperature Drop, or the Flow Rate. The third selection is for Maximum Fluid Head Loss.

In the AIR CONDITIONS section are Entering Air Temperature, Leaving Air Temperature (or the Total Heat Transfer in BTU per hour), and the Maximum Air Pressure Loss (in inches of water column).

COIL SPECIFICATIONS requires inputs for the Air Flow Rate . . . for either the maximum face velocity or preliminary face area (then either the coil height or the coil width, and finally the fin spacing). Since water carryover is not a problem with heating coils, the major concerns regarding the fin spacing is to assure that the coil can be cleaned (and to limit the air pressure drop for greater fan energy efficiency).

After selecting the fin spacing (via the Maximum Fins per Inch, or the Minimum Fin Spacing, and the Fin Type) click the “Calculate” button. The resulting screen will display all the input data and all the specifications for the coil selection.

For a printable I/O, click the “Printable I/O Summary” button. This summary displays all input values and several coil selections.

The other footer options include “New Calculation” (which returns you to the initial Heating and Cooling Coil Selection screen). Additional options are

“To Main Entry Screen” . . . or to the Miscellaneous or Project file (from which you entered this program).

### Selecting a Steam Heating Coil

After entering the Equipment Identifier, for Type of Coil select the radio button for Heating. This will change the word Refrigerant to Steam in the FLUID box. Click on the radio button for Steam. The entry fields for Liquid will disappear, and the new screen will contain 3 entry fields under Steam . . . with instructions to Enter One of the Following. The options are Saturated Steam Temperature, Saturated Steam Pressure (in psig) and Saturated Steam Pressure (in psia). NOTE: The steam pressure in psig is the pressure in psia less the atmospheric pressure shown on the screen. After filling in one of the fields, select the appropriate piping connections and click Proceed.

This will bring up a screen with steam conditions and entry fields under Air Conditions and Coil Specifications. Fill in the Entering Air Temperature, then either the Leaving Air Temperature or Total Heat Transfer, and, finally, the Maximum Air Pressure Loss.

Under Coil Specifications enter the Air Flow Rate Actual in ACFM, either the Maximum Face Velocity or a Preliminary Face Area, either a Coil Height or Coil Width in inches, and select from the pull down entry fields either a Maximum Fins Per inch or a Minimum Fin Spacing. The last entry is the Fin Type pulldown. As for the hot water heating coil, the primary concerns about fin spacing and type are those relating to cleanability and pressure loss.

With all entries complete, click the “Calculate” button. The resulting screen provides a summary of the inputs and the most appropriate coil selection.

The footers include “Printable I/O Summary,” “New Calculation,” and either “Miscellaneous Calculations” or “Project File Summary” . . . to return you to the file from which you initiated the calculation.

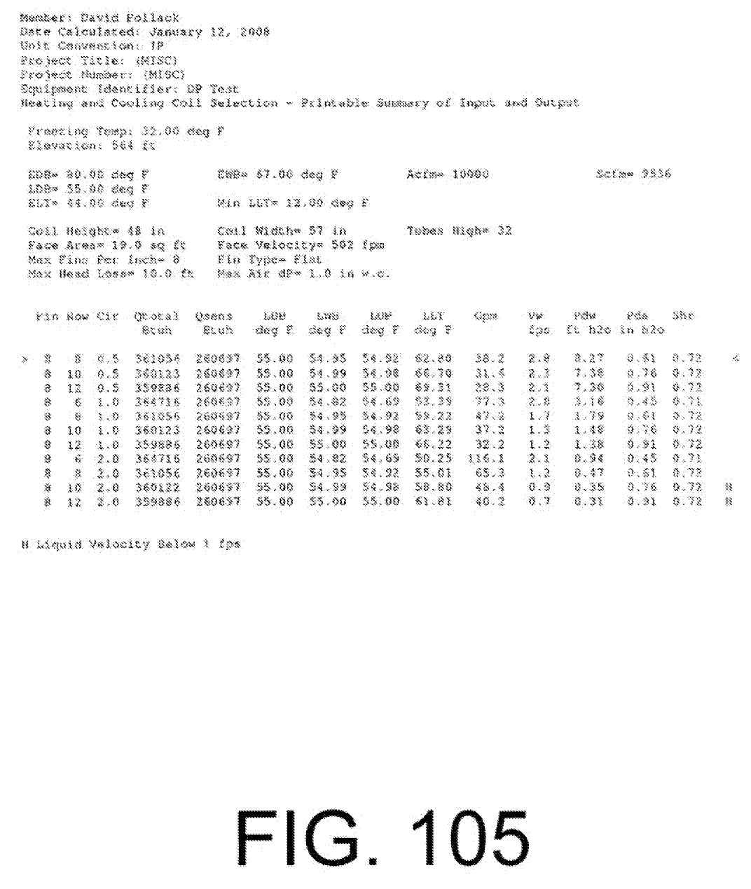

An exemplary Heating and Cooling Coil Selection Input/Output Summary is provided in FIG. 105.

### Example 10

This example illustrates the Steam Processes calculation module and methods of use.

The Steam Processes programs may be accessed through a project file (Project File Contents screen) or from the Main Entry Screen. If accessed through the project file, the calculation will be identified for that project and will be filed in that project file. Any program accessed through the Main Entry Screen will, of course, be filed as a Miscellaneous Calculation. As Steam Processes calculations are not “look-up” programs (like Psychrometric Properties and Steam Properties), they will be automatically and permanently filed.

When you select the Steam Process program, beneath the identification block (and a brief instructional block) will appear the Menu of Processes:

Expansion (power) Process

Fuel Heat Required to Generate Steam

Control Valve Sizing

Steam Orifice Size/Capacity

Difference Between two Statepoints

Select the program you want via the appropriate radio button and click the “Proceed” button.

Expansion (Power) Process

Within the identification block (with the Company Name, Project Title, Project Number, Date and Member Name), is an entry field for the Equipment Identifier and a pull down field for Units. (In this version of the programs, only inch pound (IP) units are available). An Equipment Identifier is required as without an identifier your calculation cannot be filed.

Following the identification block (and an instructional section) are input sections for Initial (Throttle) Conditions, Outlet Conditions, and Efficiency.

For Initial (Throttle) Conditions, there are sections for Superheated condition and Saturated condition. (One or the other of these is selected by clicking on the appropriate radio button). If you have a Superheated inlet statepoint, click on that radio button, and fill in the entry fields for the absolute Pressure (in psia), and the Temperature (in ° F.). If the throttle or inlet statepoint is Saturated click in that radio button and fill in the field for either the Pressure or the Temperature, and for the quality. (Note: If you enter both a Pressure and a Temperature an error message will prevent you from continuing).

Steam turbine systems are designed to exhaust to either a condenser or a steam distribution system. Systems designed for condenser service exhaust to a design condensing temperature . . . whereas systems designed to exhaust into a steam distribution system (such as cogeneration plants) exhaust to a design pressure. For these reasons, in the Outlet Conditions box, enter either the exhaust pressure or the condensing temperature (of the exhaust condenser). If you enter both an exhaust pressure and a condensing temperature you will receive an error signal when attempting to calculate.

The last section of the input screen relates to the isentropic efficiency. If your analysis is to determine the turbine or engine steam rate under ideal (isentropic expansion) conditions, select the radio button for Isentropic Expansion. If it is to determine the steam rate under actual conditions, select Nonisentropic Expansion (and enter an appropriate efficiency in percent in the entry field provided). The efficiency is defined as the ideal steam rate (in pounds per horsepower hour) divided by the actual steam rate (in identical units). In addition to the affect of the efficiency upon the steam rate, it also will have a significant impact upon the statepoint of the exhaust steam.

After the input screen has been completed, click the “Calculate” button at the bottom of the screen. The output screen will present the Initial (Throttle) Conditions, and the Outlet Conditions . . . followed by the output, consisting of: 1) the steam rate in pounds of steam per kilowatt-hour and pounds of steam per horsepower hour; and 2) the statepoint of the inlet steam and exhaust steam as defined by 14 relevant properties.

Footer bars include “Printable I/O Summary,” and “Recalculate” (which will present the input screen with all of the initial input values except the Equipment Identifier, which must be filled in to run a new calculation. All other entry fields are editable to allow you to change the input as needed).

Other footers bars include options to return “To Steam Processes Menu”, “To Project File Contents” or “Miscellaneous Calculations” (depending upon from where you entered Steam Processes), and “To Main Entry Screen.”

### Fuel Heat Required to Generate Steam

Again, the identification block requires an Equipment Identifier and the Units (which, at this time, are only inch pounds (IP)). Following an instructional block are the two blocks for input conditions, the first of which is Feedwater Conditions.

The feedwater Pressure (stated in psia) is usually equal to the boiler pressure plus the pressure drop across the feedwater control assembly. The feedwater temperature is usually the temperature leaving the feedwater reservoir or feedwater heater.

The Steam Conditions are the steam conditions (statepoint) leaving the boiler. There are two options, Saturated or Superheated. Selection is made with the appropriate radio button. If Saturated is selected, you must then enter either the saturation pressure or temperature. If Superheated is selected, you must enter both the temperature and the pressure.

The last block is for the Combined Efficiency of the boiler. Combined Efficiency is defined as the difference between the energy content of the steam leaving the boiler (or super heater nozzle) and the feedwater (expressed in BTU per hour divided by the HHV of the fuel input in equivalent units . . . expressed as a percent). In an analysis to determine size or capacity, the efficiency would normally be a power ratio at design capacity. To analyze a quantity used over time (annual, seasonal, etc.) the efficiency is usually calculated on a time integrated basis (and is usually considerably lower).

After providing the information required, click the “Calculate” button. An output screen will provide all of the input values, and the fuel heat required in BTU per pound of steam.

Footers include “Printable I/O Summary” and “Recalculate.” “Recalculate” will return you to the input screen, with the input fields filled in as you had just calculated . . . and, after providing a new Equipment Identifier, any of the other values or radio button selections can be revised or edited. Other footers include “To Steam Processes Menu” (which returns you to the initial Steam Processes menu screen); “To Miscellaneous Calculations” or “To Project File Contents” (depending on from where you entered Steam Processes); and “To Main Entry Screen.”

### Control Valve Sizing

The identification block requires an Equipment Identifier and the Units (which, at this time, are only inch pounds (IP)). Following the identification block is an entry field for the Steam Flow Rate (in pounds of steam per hour, which should be entered in numerals only (no comma), but decimal points are acceptable). The next two blocks are for Inlet Conditions and Outlet Pressure. The inlet conditions of Saturated and Superheated are selected by radio buttons. For Saturated enter either the saturation pressure or temperature (in the respective entry field); for superheated, enter both the pressure and temperature. In the Outlet Pressure block, only the outlet Pressure is required.

When all entries are complete click the “Calculate” button. The initial sections of the output screen provide all the input data and the outlet pressure. The outlet pressure will indicate the flow characteristics (either Critical or Retarded), and the Valve Constant Cv. The last section will reveal the “condition” of the steam at the valve inlet and outlet (either saturated or superheated), and will define the statepoint in terms of 14 properties as applicable.

Footers include “Printable I/O Summary” and “Recalculate.” “Recalculate” will return you to the input screen, with the input fields filled in as you had just calculated . . . and, after providing a new Equipment Identifier, any of the other values or radio button selections can be revised or edited. Other footers include “To Steam Processes Menu” (which returns you to the initial Steam Processes menu screen); “To Miscellaneous Calculations” or “To Project File Contents” (depending on from where you entered Steam Processes); and “To Main Entry Screen.”

### Steam Orifice Size/Capacity

The identification block requires an Equipment Identifier and the Units (which, at this time, are only inch pounds (IP)). Following the identification block are three blocks for input information.

The first block is for the steam Inlet Conditions. As with the other steam processes, the first step in the Inlet Conditions is to select either saturated or superheated (via the radio buttons). For Saturated, must enter either the saturation pressure or the saturation temperature—but not both. For Superheated, enter both the pressure and the temperature. If one of the two is omitted, an error signal will appear when you attempt to Calculate.

The next block is for the Outlet Pressure (which simply requires the downstream pressure).

In the third input block you can enter either the Steam Flow Rate or the Orifice Diameter. If the flow rate is entered the calculation program will tell you the required orifice diameter. If the orifice diameter is entered, calculation program will give you the Steam Flow Rate.

After filling in the required information click the “Calculate” button. The resulting output screen will present all of the input data, followed by either the steam flow rate or the orifice diameter . . . and will indicate the flow characteristics (either Critical or Retarded), and the orifice diameter if steam flow rate were input or the steam flow rate had the orifice diameter been input.

The last block displays the “condition” of the steam at the orifice inlet and outlet (either saturated or superheated), and will define the statepoint in terms of 14 properties (as applicable).

Footers include “Printable I/O Summary” and “Recalculate”. “Recalculate” will return you to the input screen, with the input fields filled in as you had just calculated and, after providing a new Equipment Identifier, any of the other values or radio button selections can be revised or edited. Other footers include “To Steam Processes Menu” (which returns you to the initial Steam Processes menu screen); “To Miscellaneous Calculations” or “To Project File Contents” (depending on from where you entered Steam Processes); and “To Main Entry Screen.”

### Differences Between Two Statepoints

This program is different from the other programs in Steam Processes in two ways. First, it is not a process but a quick reference to the difference between any relevant properties at the statepoints of interest. Secondly, as it is only a quick reference of the differences, it is handled as a look-up program and thus may be used without entering a Calculation Identifier. However, if no Calculation Identifier is entered, the calculation will not be filed.

To use, simply enter any two properties for each of the statepoints desired. Note: For a saturated condition of either statepoint, it is necessary to include the quality at any value between 0 and 100%.

Click the “Calculate” button and the remainder of the properties at each statepoint will be displayed . . . as well as the absolute value of the difference between the two values of the following properties: pressure, temperature, density, specific volume, enthalpy, entropy, and internal energy.

When the calculation is completed, footers include “Printable I/O Summary” and “Recalculate.” “Recalculate” will return you to the input screen, with the input fields filled in as you had just calculated . . . and, after providing a new Equipment Identifier, any of the other values or radio button selections can be revised or edited. Other footers include “To Steam Processes Menu” (which returns you to the initial Steam Processes menu screen); The “To Miscellaneous Calculations” or “To Project File Contents” (depending on from where you entered Steam Processes); and “To Main Entry Screen”.

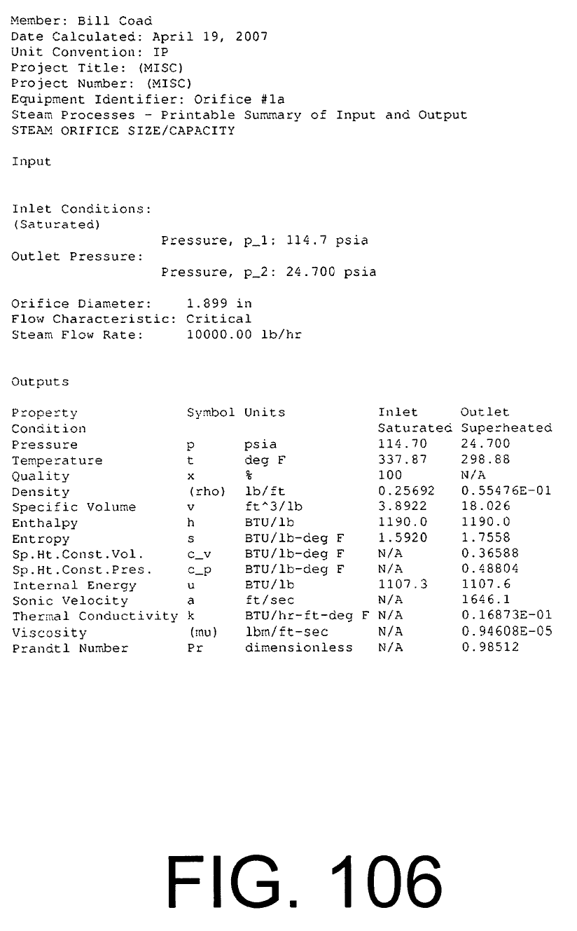

An exemplary Steam Processes Input/Output summary is provided in FIG. 106.

What is claimed is:

1. A method of providing one or more HVAC design features for a building to one or more users, the method comprising:
a) providing a web-based user interface comprising a plurality of web pages, wherein one or more web pages are configured to receive as input information one or more descriptors, each descriptor selected from a descriptor of a building, a descriptor of a portion of a building and a descriptor of a building environment;
b) receiving, from at least one user accessing the web-based user interface at a terminal located remote from a server comprising software encoding the web-based user interface, at least one selection of a program comprising at least one web page configured to receive one or more input information items and at least one calculation module;
c) receiving one or more input information items from the at least one user;
d) determining at least one HVAC building design specification using at least one HVAC building design executable program and at least one input information item of the one or more input information items, and
e) providing at least one HVAC building design specification as at least one output information item.

2. A method in accordance with claim 1, wherein the server is a secure server connected to the Internet.

3. A method in accordance with claim 1, wherein the at least one user accesses the web site over the Internet.

4. A method in accordance with claim 1, wherein the server performs input validation on the one or more input information items.

5. A method in accordance with claim 1, wherein the server provides software code that performs error checking on the one or more input information items.

6. A method in accordance with claim 1, wherein access to the one or more web pages configured to receive the one or more descriptors requires entry of at least one password.

7. A method in accordance with claim 6, wherein the user interface is accessed by the at least one user on a subscription basis.

8. A method in accordance with claim 6, further comprising generating or adding to a record of an HVAC design project for a building.

9. A method in accordance with claim 8, wherein the generating or adding to a record of the project comprises recording at each session, one or more of: the at least one user's identification, a title of the project, date of the session, the at least one selection of a web page, at least one input information item, and at least one output information item.

10. A method in accordance with claim 9, wherein after the determining of the at least one HVAC building design specification, at least one of a) the date of the session, b) the at least one input information item and c) the at least one output information item, cannot be erased or altered during a subsequent session of use by a user accessing the web-based user interface at a terminal located remote from the server.

11. A method in accordance with claim 10, wherein one or more web pages of the plurality of web pages comprises one or more data input fields configured to receive at least one input information item for at least one calculation not comprised by the project.

12. A method in accordance with claim 1, wherein the web-based user interface is a graphical user interface.

13. A method in accordance with claim 1, wherein the output information is displayed at the terminal.

14. A method in accordance with claim 1, wherein the providing the at least one output information item comprises providing a printable report.

15. A method in accordance with claim 14, wherein the printable report is configured to be saved by the at least one user.

16. A method in accordance with claim 1, wherein a calculation module is selected from the group consisting of a heating and cooling load calculation module, a psychrometric mixing process calculation module, a psychrometric cooling and dehumidifying process calculation module, a psychrometric sensible heating or cooling process calculation module, a psychrometric isothermal humidification process calculation module, a psychrometric evaporative cooling process calculation module, a psychrometric differences between two state points calculation module, a heating and cooling coil selection calculation module, a heating and cooling coil diagnostics calculation module, a steam properties calculation module, a hydronic pipe sizing calculation module, a steam expansion (Power) process calculation module, a fuel heat required to generate steam calculation module, a steam control valve sizing calculation module, a steam orifice size/capacity calculation modules, a steam differences between two state points calculation module and an expansion tank calculation module.

17. A method in accordance with claim 16, wherein the plurality of web pages further comprise a web page comprising at least one data entry field linking to calculation modules of psychrometric processes, wherein the psychrometric processes include one or more of mixing process, cooling and dehumidifying process, sensible heating or cooling process, isothermal humidification process, evaporative cooling process, and differences between two state points.

18. A method in accordance with claim 16, wherein the plurality of web pages further comprise a web page comprising a menu linking to calculation modules for steam processes, wherein the steam processes include one or more of expansion (power) process, fuel heat required to generate steam, control valve sizing, steam orifice size/capacity, and differences between two state points.

19. A method in accordance with claim 1, wherein a calculation module generates an input/output summary.

20. A method in accordance with claim 15, wherein the input/output summary is a flat text file.

21. A method in accordance with claim 20, wherein the flat text file is configured to be printed as a WYSIWYG document by the at least one user at a terminal located remote from the server.

22. A method in accordance with claim 8, wherein a calculation module retains the input information items prior to or after completion of data entry into the module by the at least one user.

23. A method in accordance with claim 16, wherein the module is the heating and cooling load calculation module.

24. A method in accordance with claim 1, wherein the at least one user comprises a plurality of collaborative users.

25. A method in accordance with claim 1, wherein at least one web page comprises educational guidance for HVAC design.

26. A system for facilitating determination of one or more HVAC design features for a building, the system comprising:
a server configured to a) provide a web-based user interface comprising a plurality of web pages, wherein one or more web pages are configured to receive as input information one or more descriptors, each descriptor selected from a descriptor of a building, a descriptor of a portion of a building and a descriptor of a building environment; b) receive, from at least one user via at least one terminal operably connected over the Internet to the server, at least one selection of a program comprising at least one web page configured to receive one or more input information items and at least one calculation module; and c) receive one or more input information items from the at least one user via the at least one terminal; and
the at least one terminal.

27. A system for facilitating determination of one or more HVAC design features for a building in accordance with claim 26, wherein the server is further configured to d) determine at least one HVAC building design specification using at least one HVAC design executable program for a building and at least one input information item of the one or more input information items.

28. A system for facilitating determination of one or more HVAC design features for a building in accordance with claim 27, wherein the server is further configured to e) provide at least one HVAC building design specification as at least one output information item.

29. A system for facilitating determination of one or more HVAC design features for a building in accordance with claim 26, wherein the least one terminal is communicatively connected to the server via the Internet.

30. A system for facilitating determination of one or more HVAC design features for a building in accordance with claim 26, wherein the server is a secure server.

31. A system for facilitating determination of one or more HVAC design features for a building in accordance with claim 26, wherein the server is further configured to require entry of at least one password for user access to the at least one selection of a program.

32. A system for facilitating determination of one or more HVAC design features for a building in accordance with claim 26, wherein the server is further configured to allow user access to the at least one selection of a program on a subscription basis.

33. A system for facilitating determination of one or more HVAC design features for a building in accordance with claim 31, wherein the server records a session of use of a building HVAC design project upon the at least one user entering a user identification and at least one password.

34. A system for facilitating determination of one or more HVAC design features for a building in accordance with claim 33, wherein the server stores the record.

35. A system for facilitating determination of one or more HVAC design features for a building in accordance with claim 33, wherein the record cannot be erased or altered during a subsequent session of use by the at least one user from the at least one terminal operably connected to the server.

36. A system for facilitating determination of one or more HVAC design features for a building in accordance with claim 33, wherein one or more web pages of the plurality of web pages comprises one or more data input fields configured to receive at least one input information item for at least one calculation not comprised by the project.

37. A system for facilitating determination of one or more HVAC design features for a building in accordance with claim 26, wherein the server validates the one or more input information items.

38. A system for facilitating determination of one or more HVAC design features for a building in accordance with claim 26, wherein the server checks for errors on the one or more input information items.

39. A system for facilitating determination of one or more HVAC design features for a building in accordance with claim 26, wherein the at least one output information is displayed on a web page of the plurality of web pages.

40. A system for facilitating determination of one or more HVAC design features for a building in accordance with claim 26, wherein the at least one output information is comprised by a printable report.

41. A system for facilitating determination of one or more HVAC design features for a building in accordance with claim 26, wherein a calculation module is selected from the group consisting of a heating and cooling load calculation module, a psychrometric mixing process calculation module, a psychrometric cooling and dehumidifying process calculation module, a psychrometric sensible heating or cooling process calculation module, a psychrometric isothermal humidification process calculation module, a psychrometric evaporative cooling process calculation module, a psychrometric differences between two state points calculation module, a heating and cooling coil selection calculation module, a heating and cooling coil diagnostics calculation module, a steam properties calculation module, a hydronic pipe sizing calculation module, a steam expansion (Power) process calculation module, a fuel heat required to generate steam calculation module, a steam control valve sizing calculation module, a steam orifice size/capacity calculation modules, a steam differences between two state points calculation module and an expansion tank calculation module.

42. A system for facilitating determination of one or more HVAC design features for a building in accordance with claim 41, wherein the psychrometric processes include one or more of mixing process, cooling and dehumidifying process, sensible heating or cooling process, isothermal humidification process, evaporative cooling process, and differences between two state points.

43. A system for facilitating determination of one or more HVAC design features for a building in accordance with claim 42, wherein the plurality of web pages further comprise a web page comprising a menu linking to calculation modules for steam processes, wherein the steam processes include one or more of expansion (power) process, fuel heat required to generate steam, control valve sizing, steam orifice size/capacity, and differences between two state points.

44. A system for facilitating determination of one or more HVAC design features for a building in accordance with claim 26, wherein a calculation module comprises an input/output summary.

45. A system for facilitating determination of one or more HVAC design features for a building in accordance with claim 44, wherein the input/output summary is a flat text file.

46. A system for facilitating determination of one or more HVAC design features for a building in accordance with claim 41, wherein a calculation module retains the input information items upon the at least one user ending a session prior to completion of data entry into the module.

47. A system for facilitating determination of one or more HVAC design features for a building in accordance with claim 46, wherein the module is the heating and cooling load calculation module.

48. A system for facilitating determination of one or more HVAC design features for a building in accordance with claim 26, wherein the at least one user comprises a plurality of collaborative users.

49. A system for facilitating determination of one or more HVAC design features for a building in accordance with claim 48, wherein the plurality of collaborative users consists of persons employed by a business entity employing the at least one user.

50. A system for facilitating determination of one or more HVAC design features for a building in accordance with claim 26, wherein the at least one web page further comprises educational guidance for HVAC design.

51. A system for facilitating determination of one or more HVAC design features for a building in accordance with claim 26, wherein the calculation module is configured to receive one or more psychrometric properties input information items,

52. A system for facilitating determination of one or more HVAC design features for a building in accordance with claim 51, wherein the calculation module is configured to receive one or more input information items, wherein an input information item is selected from an elevation information item, a barometric pressure information item, and properties information items selected from a dry bulb temperature information item, a wet bulb temperature information item, a dew point temperature information item, a humidity ratio in grains/lb information item, a humidity ratio in lb/lb information item, a relative humidity information item, an enthalpy information item, and a specific volume information item.

53. A system for facilitating determination of one or more HVAC design features for a building in accordance with claim 52, wherein the calculation module is further configured to provide as output information items, the properties information items not provided by the at least one user.

54. A system for facilitating determination of one or more HVAC design features for a building in accordance with claim 31, wherein at least one web page comprises a menu configured to receive a request from the at least one user to initiate a new load calculation, continue a previously initiated load calculation, review a previously initiated load calculation, provide master load data, provide a printable input summary, or calculate loads, wherein a load calculation is selected from the group consisting of design conditions, thermal characteristics of building elements, and zones and spaces.

55. A method of designing heating, ventilation and/or air conditioning for a building or a portion thereof, the method comprising:
accessing from a terminal a web-based user interface comprised by a server, wherein the user interface comprises a plurality of web pages configured to receive data for at least one selection of an HVAC design calculation module of a plurality of HVAC design calculation modules;
submitting to the web-based user interface at least one selection of a plurality of selections of HVAC design calculation modules;
submitting input data for a building design or a portion thereof; and
receiving from the web-based user interface one or more calculated HVAC building parameters.

56. A method in accordance with claim 55, wherein the terminal is operatively connected to the server via the Internet.

57. A method in accordance with claim 55, wherein the server is a secure server.

58. A method in accordance with claim 55, wherein at least one web page comprises a web-based interactive user interface.

59. A method in accordance with claim 55, wherein the server validates the one or more input information items.

60. A method in accordance with claim 55, wherein the server checks for errors on the one or more input information items.

61. A method in accordance with claim 55, wherein the accessing from a terminal a web-based user interface comprises providing at least one password.

62. A method in accordance with claim 61, wherein the accessing from a terminal a web-based user interface further comprises providing at least one user identification.

63. A method in accordance with claim 55, wherein the server is configured to allow user access to the at least one selection of a program on a subscription basis.

64. A method in accordance with claim 61, further comprising initiating a session of use of a building HVAC design project.

65. A method in accordance with claim 64, wherein the server records data entered during the session of use.

66. A method in accordance with claim 88, wherein the server generates or adds to a record of a project, data entered during the session of use.

67. A method in accordance with claim 66, wherein the server records, in the record at each session, one or more of: the at least one user's identification, a title of the project, date of the session, the at least one selection of a web page, at least one input information item, and at least one output information item.

68. A method in accordance with claim 55, wherein the providing the at least one output information item comprises providing a printable report.

69. A method in accordance with claim 55, wherein the at least one user comprises a plurality of collaborative users.

70. A web service comprising the system of claim 26, wherein the system comprises an SSL secure server.

71. A web service in accordance with claim 70, wherein an IT staff maintains all server hardware, all server software and a record of a building HVAC design project.

72. A web service in accordance with claim 70, further comprising at least one mirrored hard drive.
